(19) United States
(12) Patent Application Publication
(10) Pub. No.: US 2026/0223837 A1
(43) Pub. Date: Aug. 6, 2026

(54) NATURAL LIPID PARTICLE FORMULATIONS FOR AGRICULTURAL APPLICATIONS

(71) Applicant: INVAIO SCIENCES, INC., Cambridge, MA (US)

(72) Inventors: Marta RIERA-BONET, Barcelona (ES); Jayce William BRANDT, Cambridge, MA (US); Maria DEL MAR MARQUÉS BUENO, Barcelona (ES); Anjan Kumar DAS, Durham, NC (US); Ana Isabel CAÑO-DELGADO, Barcelona (ES); Zhengxin FU, Guangdong (CN); Hailey Deanne HANSCOM, Durham, NC (US); Kian HERSHBERGER, Lexington, MA (US); Joseph Lucas LITTLE, Charlotte, NC (US); Behnam NAZARI, Belmont, MA (US); Meghan Lois POWERS, Arlington, MA (US); Bardia SOLTANZADEH, Cambridge, MA (US); Andrew Garrett STEWART, Cambridge, MA (US); Sönke SVENSON, Arlington, MA (US); Yuji TAKEDA, Wellesley, MA (US); Yunlong YANG, Cambridge, MA (US); Rama Krishna SIMHADRI, Cambridge, MA (US); Douglas Clinton BOYES, Cambridge, MA (US); Joseph Arthur CHRISTENSEN, Northfield, IL (US); Eric M. WEBER, Northfield, IL (US); Christopher M. PAWLING, Northfield, IL (US)

(21) Appl. No.: 19/155,004

(22) PCT Filed: Feb. 8, 2024
(86) PCT No.: PCT/US2024/015064

§ 371 Date: Aug. 8, 2025

Related U.S. Application Data
(60) Provisional application No. 63/444,331, filed on Feb. 9, 2023.
(60) Provisional application No. 63/447,834, filed on Feb. 23, 2023.

(51) Int. Cl. A01N 25/04; A01N 25/30; A01N 37/40; A01N 53/00; A01P 3/00; A01P 7/04; A01P 13/00

(52) U.S. Cl. CPC A01N 25/04; A01N 25/30; A01N 37/40; A01N 53/00; A01P 3/00; A01P 7/04; A01P 13/00

(57) ABSTRACT

Disclosed herein are compositions including a plurality of nature-derived lipid particles comprising phospholipids, non-polar lipids and surface modifiers, and further comprising bioactives, for use in a variety of agricultural methods.

### CROSS-REFERENCE TO RELATED APPLICATIONS

This application claims priority to U.S. Provisional Application No. 63/444,331, filed on Feb. 9, 2023, and U.S. Provisional Application No. 63/447,834, filed on Feb. 23, 2023, the contents of which are hereby incorporated herein by reference in their entireties.

### BACKGROUND

The efficacy of an agricultural agent, e.g., a pesticide, applied to soil, can be limited by the degree to which the agent interacts with soil. A high affinity for soil negatively affects the ability of the agent to reach the intended target, e.g., a plant or a plant pest. Likewise, agricultural agents with a negligible affinity for soil are rapidly washed out into the ground water, thereby limiting their ability to interact with the intended target as well. Therefore, a need exists in the art for compositions and methods capable of altering the interactions of agricultural agents with soil, thereby affecting their mobility in soil and ability to reach their intended target.

Further, the efficacy of a heterologous functional agricultural agent, e.g., a pesticide, can be limited by the degree to which the agent is taken up by plants. Therefore, a need exists in the art for compositions and methods capable of improving the interactions of an agent with the plant, or plant part, e.g. by enhancing uptake of the agent by the plant or plant part.

### SUMMARY

In one aspect, the disclosure provides an agricultural composition, the composition comprising a plurality of nature-derived lipid particles (NLPs) each comprising at least one phospholipid, at least one non-polar lipid; and at least one surface modifier, wherein the NLPs comprise a hydrophobic core. In some embodiments, the at least one surface modifier alters the mobility of the agricultural composition through soil as compared to a composition not comprising the surface modifier. In some embodiments, the hydrophobic core is comprised of lipids. In some embodiments, an agricultural agent is provided in the hydrophobic core.

In some embodiments, the at least one phospholipid is selected from the group consisting of phosphatidylcholine, phosphatidylethanolamine, phosphatidylinositol, phosphatidic acid, phosphatidyl serine, and 1,2-dimyristoyl-sn-glycero-3-phosphate. In some embodiments the at least one phospholipid is derived from a lecithin. In some embodiments, the lecithin is a soybean lecithin, or a sunflower lecithin.

In some embodiments the at least one non-polar lipid comprises at least one fatty acid chain selected from the group consisting of a poly-unsaturated fatty acid chain, a mono-unsaturated fatty acid chain, and a saturated fatty acid chain.

In some embodiments the NLP comprises at least one phospholipid layer. In some embodiments the NLP phospholipid layer is a phospholipid bilayer.

In some embodiments, the NLPs have a micellar structure. In some embodiments the NLP comprises a hydrophobic core. In some embodiments the hydrophobic core comprises the at least one non-polar lipid.

In some embodiments the hydrophobic core is solid.

In some embodiments the surface modifier is integrated in the phospholipid layer. In some embodiments the surface modifier is selected from the group consisting of a glycolipid, a polysaccharide, a fatty acid ethoxylate, a linear alcohol ethoxylate, acetyl trimethyl, a Linear isopropylamine dodecybenzene sulfonate, a tristyrlphenol ethoxylate phosphate ester, a modified styrene acrylic co-polymer, a hydrophobically modified polycarboxylate polymer, an anionic polymer, a non-ionic acrylic copolymer, a non-ionic combination polymer, a tristyrlphenol polyalkylene oxide block copolymer, or a head group modified PEG lipid. In some embodiments the head group modified PEG lipid is PEG2000-C18, or PEG5000-C18. In some embodiments the glycolipid is a rhamnolipid, or a sophorolipid. In some embodiments the anionic polymer is Atlox 500L, Atlox 4917, or Atlox CS100B. In some embodiments the polysaccharide is a C8-C10 alkylpolysaccharide.

In some embodiments the surface modifier stabilizes the integrity of the NLP. In some embodiments the surface modifier affects the binding of the NLP to one or more components present in soil. In some embodiments the surface modifier affects the affinity of the NLP for one or more components present in soil.

In some embodiments the surface modifier affects the surface charge of the NLP. In some embodiments the NLPs exhibit a negative surface charge as evidenced from a negative zeta potential. In some embodiments the negative zeta potential ranges between −10 and −100 mV. In some embodiments the negative zeta potential increases the mobility of the NLP through soil.

In some embodiments the agricultural composition further comprises a co-solvent. In some embodiments the co-solvent is selected from the group consisting of a fatty acid methyl ester, a non-ionic emulsifier, propylene glycol, ethyl lactate, a non-ionic block copolymer surfactant, or a nonionic polyalkylene glycol ether, dichloromethane and isopropyl myristate.

In some embodiments the NLP further comprises at least one heterologous agricultural agent. In some embodiments the at least one heterologous agricultural agent is selected from the group consisting of a pesticidal agent, a fertilizing agent, a herbicidal agent, a plant-modifying agent, an insect attractant, a plant growth promoting agent, a biostimulant, and a plant immunity elicitor. In some embodiments, the pesticidal agent is selected from the group consisting of an antifungal agent, an anti-oomycete agent, an antibacterial agent, an insecticidal agent, a molluscicidal agent, a nematicidal agent, a herbidical agent, and a virucidal agent. In some embodiments, the NLP comprises a combination of two or more heterologous agricultural agents. In some embodiments, the NLP comprises two or more agricultural agents independently selected from the group consisting of an antifungal agent, an anti-oomycete agent, an antibacterial agent, an insecticidal agent, a molluscicidal agent, a nematicidal agent, a herbidical agent, and a virucidal agent. In some embodiments, the NLP comprises at least two insecticidal agents with different modes of action. In some embodiments, the NLP comprises at least two antifungal agents with different modes of action. In some embodiments, the NLP comprises at least two anti-oomycete agents with different modes of action. In some embodiments, the NLP comprises at least two antibacterial agents with different modes of action. In some embodiments, the NLP comprises at least two molluscicidal agents with different modes of action. In some embodiments, the NLP comprises at least two nematicidal agents with different modes of action. In some embodiments, the NLP comprises at least two herbidical agents with different modes of action. In some embodiments, the NLP comprises at least two virucidal agents with different modes of action.

In some embodiments, (a) the antifungal agent includes at least one of azoxystrobin, mancozeb, prothioconazole, folpet, tebuconazole, difenoconazole, captan, bupirimate, fosetyl-AI, a strobilurin, dimoxystrobin, enestroburin, fluoxastrobin, kresoxim-methyl, metominostrobin, picoxystrobin, pyraclostrobin, trifloxystrobin, orysastrobin, a carboxamide, a carboxanilide, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M, methfuroxam, metsulfovax, ofurace, oxadixyl, oxycarboxin, penthiopyrad, pyracarbolid, salicylanilide, tecloftalam, thifluzamide, tiadinil, an N-biphenylamide, bixafen, boscalid, a carboxylic acid morpholide, dimethomorph, flumorph, a benzamide, flumetover, fluopicolid, zoxamid, a carboxamide, carpropamid, diclocymet, mandipropamid, silthiofam, an azole, a triazole, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, an imidazole, cyazofamid, imazalil, pefurazoate, prochloraz, triflumizole, a benzimidazole, benomyl, carbendazim, fuberidazole, thiabendazole, ethaboxam, etridiazole, hymexazol, a pyridine, fuazinam, pyrifenox, pyrimidines, cyprodinil, ferimzone, fenarimol, mepanipyrim, nuarimol, pyrimethanil, a piperazine, triforine, a pyrrole, fludioxonil, fenpiclonil, a morpholine, aldimorph, dodemorph, fenpropimorph, tridemorph, a dicarboximide, iprodione, procymidone, vinclozolin, acibenzolar-S-methyl, anilazine, captafol, dazomet, diclomezin, fenoxanil, folpet, fenpropidin, famoxadon, fenamidon, octhilinone, probenazole, proquinazid, pyroquilon, quinoxyfen, tricyclazole, a carbamate, a dithiocarbamate, ferbam, maneb, metiram, metam, propineb, thiram, zineb, ziram, diethofencarb, flubenthiavalicarb, iprovalicarb, propamocarb, a guanidine, dodine, iminoctadine, guazatine, kasugamycin, a polyoxin, streptomycin, validamycin A, a fentin salt, a sulfur-containing heterocyclyl compound, isoprothiolane, dithianone, an organophosphorous compound, edifenphos, fosetyl, fosetyl-aluminum, iprobenfos, pyrazophos, tolclofos-methyl, an organochlorine compound, thiophanate-methyl, chlorothalonil, dichlofluanid, tolylfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon, N-2-cyanophenyl-3,4-dichloroisothiazol-5-carboxamide, N-(3′,4′,5′-trifluorobiphenyl-2-yl)-3-difluoromethyl-1-methylpyrazole-4-carboxamide, 3-[5-(4-chlorophenyl)-2,3-dimethylisoxazolidin-3-yl]-pyridine, N-(3′,4′-dichloro-4-fluorobiphenyl-2-yl)-3-difluoromethyl-1-methylpyrazol-e-4-carboxamide, 5-chloro-7-(4-methylpiperidin-1-yl)-6-(2,4,6-trifluorophenyl)-[1,2,4]tria-zolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazo-le-1-sulfonamide, methyl-(2-chloro-5-[1-(3-methylbenzyloxyimino)-ethyl]benzyl)carbamate, methyl-(2-chloro-5-[1-(6-methylpyrid in-2-ylmethoxy-imino)ethyl]benzyl)carbamate, methyl 3-(4-chlorophenyl)-3-(2-isopropoxycarbonylamino-3-methyl butyryl-amino)propionate, 4-fluorophenyl N-(1-(1-(4-cyanophenyl)ethanesulfonyl)but-2-yl)carbamate, N-(2-(4-[3-(4-chlorophenyl)prop-2-ynyloxy]-3-methoxyphenyl)ethyl)-2-metha-nesulfonylamino-3-methylbutyramide, N-(2-(4-[3-(4-chlorophenyl)prop-2-ynyloxy]-3-methoxyphenyl)ethyl)-2-ethan-esulfonylamino-3-methylbutyramide, N-(4′-bromobiphenyl-2-yl)-4-difluoromethyl-2-methylthiazol-5-carboxamide, N-(4′-trifluoromethylbiphenyl-2-yl)-4-difluoromethyl-2-methylthiazol-5-carboxamide, N-(4′-chloro-3′-fluorobiphenyl-2-yl)-4-difluoromethyl-2-methylt-hiazol-5-carboxamide, methyl 2-(ortho-((2,5-dimethylphenyloxy-methylene)phenyl)-3-methoxyacrylate, oxathiapiprolin, and esters and salts thereof;
(b) the antibacterial agent includes at least one of a hypochlorite, sodium hypochlorite, a chloramine, dichloroisocyanurate, trichloroisocyanurate, wet chlorine, chlorine dioxide, a peroxide, peracetic acid, potassium persulfate, sodium perborate, sodium percarbonate, urea perhydrate, iodine, iodpovidone, ethanol, 1-propanol, 2-propanol, 2-phenoxyethanol, phenol, a cresol, a halogenated phenol, hexachlorophene, triclosan, trichlorophenol, tribromophenol, pentachlorophenol, a cationic surfactant, benzalkonium chloride, cetyl trimethylammonium bromide, cetyl trimethylammonium chloride, didecyldimethylammonium chloride, cetylpyridinium chloride, benzethonium chloride, chlorhexidine, glucoprotamine, octenidine dihydrochloride, an ozone solution, colloidal silver, silver nitrate, mercury chloride, phenylmercury salts, copper sulfate, copper oxide-chloride, copper hydroxide, copper octanoate, copper oxychloride sulfate, copper sulfate pentahydrate, phosphoric acid, nitric acid, sulfuric acid, amidosulfuric acid, toluenesulfonic acid, sodium hydroxide, potassium hydroxide, calcium hydroxide, sorbic acid, benzoic acid, lactic acid, salicylic acid, a penicillin, a cephalosporin, vancomycin, a polymyxin, a rifamycin, a lipiarmycin, a quinolone, a sulfonamide, an aminoglycoside, kasugamycin, a macrolide, a lincosamide, a tetracycline, a cyclic lipopeptide, daptomycin, a glycylcycline, tigecycline, an oxazolidinone, linezolid, fidaxomicin, rifampicin, ciprofloxacin, doxycycline, ampicillin, polymyxin B, gramicidin, isoniazid, pyrazinamide, ethambutol, myambutol, streptomycin, and esters and salts thereof;
(c) the insecticidal agent includes at least one of a chloronicotinyl, a neonicotinoid, acetamiprid, clothianidin, dinotefuran, imidacloprid, nitenpyram, nithiazine, thiacloprid, thiamethoxam, imidaclothiz, (2E)-1-[(2-chloro-1,3-thiazol-5-yl)methyl]-3,5-dimethyl-N-nitro-1,3,5-tri-azinan-2-imine, an acetylcholinesterase (AChE) inhibitor, a carbamate, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chloethocarb, dimetilan, ethiofencarb, fenobucarb, fenothiocarb, formetanate, furathiocarb, isoprocarb, metam-sodium, methiocarb, methomyl, metolcarb, oxamyl, phosphocarb, pirimicarb, promecarb, propoxur, thiodicarb, thiofanox, triazamate, trimethacarb, XMC, xylylcarb, an organophosphate, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, a pyrethroid, acrinathrin, allethrin (d-cis-trans, d-trans), cypermethrin (alpha-, beta-, theta-, zeta-), permethrin (cis-, trans-), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cyphenothrin, DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda, metofluthrin, phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralocythrin, tralomethrin, transfluthrin, ZXI 8901, a pyrethrin, pyrethrum, an oxadiazine, indoxacarb, an acetylcholine receptor modulator, a spinosyn, Spinosad, a cyclodiene, camphechlor, chlordane, endosulfan, gamma-HCH, HCH, heptachlor, an organochlorine, lindane, methoxychlor, a fiprole, acetoprole, ethiprole, vaniliprole, fipronil, a mectin, abamectin, avermectin, emamectin, emamectin-benzoate, fenoxycarb, hydroprene, kinoprene, methoprene, ivermectin, lepimectin, epofenonane, pyriproxifen, milbemectin, milbemycin, triprene, a diacylhydrazine, chromafenozide, halofenozide, methoxyfenozide, tebufenozide, a benzoylurea, bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron, an organotin, azocyclotin, cyhexatin, fenbutatin oxide, a pyrrole, chlorfenapyr, a dinitrophenol, binapacyrl, dinobuton, dinocap, DNOC, a METI, fenazaquin, fenpyroximate, pyrimidifen, pyridaben, tebufenpyrad, tolfenpyrad, rotenone, acequinocyl, fluacrypyrim, a microbial disrupter of the intestinal membrane of insects, a Bacillus thuringiensis strain, an inhibitor of lipid synthesis, a tetronic acid, a tetramic acid, spirodiclofen, spiromesifen, spirotetramat, cis-3-(2,5-dimethylphenyl)-8-methoxy-2-oxo-1-azaspi ro[4.5]dec-3-en-4-yl ethyl carbonate, a carboxamide, flonicamid, an octopaminergic agonist, amitraz, an inhibitor of the magnesium-stimulated ATPase, propargite, a ryanodin receptor agonist, a phthalamide, rynaxapyr, N2-[1,1-dimethyl-2-(methylsulphonyl)ethyl]-3-iodo-N1-[2-methyl-4-[1,2,2,2-tetrafluoro-1-(trifluoromethyl)ethyl]phenyl]-1,2-benzenedi-carboxamide, spidoxamat, nicofluprole, tetraniliprole, tioxazafen, flupyradifuron, fluopyram, flubendiamide, deltametrin, permethrin, dimpropyridaz, broflanilide, afidopyropen, fluopyram, fluazaindolizine, triflumezopyrim, sulfoxaflor, spinetoram, chlorpyrifos, spinosad, cyantraniliprole, chlorantraniliprole, cypermethrin, plinazolin, cyclobutrifluram, spiropidion, fluensulfone, pymetrozine, thiamethoxam, lamda cyhalothrin, oxazosulfyl, benzpyrimoxan, dichloromezotiaz, flupentiofenox, fluhexafon, fluxametamide, flupyrimin, cyhalodiamide, acynonapyr, cyclaniliprole, cyetpyrafen, cyproflanilide, tetrachlorantraniliprole, isocycloseram, broflanilide, spiropidion, and esters and salts thereof;
(d) the molluscicidal agent includes at least one of a metal salt, iron phosphate, aluminum sulfate, ferric sodium EDTA, metaldehyde, methiocarb, and an acetylcholinesterase inhibitor;
(e) the nematicidal agent includes at least one of a fumigant, D-D, 1,3-dichloropropene, ethylene dibromide, 1,2-dibromo-3-chloropropane, methyl bromide, chloropicrin, metam sodium, dazomet, methyl Isothiocyanate (MITC), sodium tetrathiocarbonate, a carbamate, aldicarb, aldoxycarb, carbofuran, oxamyl, cleothocarb, an organophosphate, ethoprophos, fenamiphos, cadusafos, fosthiazate, fensulfothion, thionazin, lsazofos, and a biochemical; and
(f) the herbicidal agent includes at least one of glufosinate, propaquizafop, metamitron, metazachlor, pendimethalin, flufenacet, diflufenican, clomazone, nicosulfuron, mesotrione, pinoxaden, sulcotrione, prosulfocarb, sulfentrazone, bifenox, quinmerac, triallate, terbuthylazine, atrazine, oxyfluorfen, diuron, trifluralin, chlorotoluron, a benzoic acid herbicide, dicamba, a phenoxyalkanoic acid herbicide, 2,4-D, MCPA, a 2,4-DB ester, an aryloxyphenoxypropionic acid herbicide, clodinafop, cyhalofop, fenoxaprop, fluazifop, haloxyfop, a quizalofop ester, a pyridinecarboxylic acid herbicide, aminopyralid, picloram, a clopyralid ester, a pyrimidinecarboxylic acid herbicide, an aminocyclopyrachlor ester, a pyridyloxyalkanoic acid herbicide, fluoroxypyr, triclopyr, a hydroxybenzonitrile herbicide, bromoxynil, ioxynil, an arylpyridine carboxylic acid, an arylpyrimidine carboxylic acid, acetochlor, acifluorfen, alachlor, ametryn, amitrole, asulam, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate, DCPA, desmedipham, dichlobenil, diclofop, diclosulam, diethatyl, difenzoquat, diflufenzopyr, dimethenamid-p, diquat, DSMA, endothall, EPTC, ethalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glyphosate, halosulfuron, haloxyfop, hexazinone, imazamethabenz, imazamox, imazapic, imazaquin, imazethapyr, isoxaben, isoxaflutole, lactofen, linuron, MCPB, methazole, metolachlor-s, metribuzin, metsulfuron, molinate, MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triflusulfuron, vernolate, and esters and salts thereof.

In some embodiments the pyrethroid is deltamethrin.

In some embodiments the heterologous functional agent comprises a plant-modifying agent. In some embodiments the heterologous functional agent comprises an insect-modifying agent.

In some embodiments the composition is formulated for application to soil. In some embodiments the composition is formulated for delivery to a plant, a plant part, or a plant pest. In some embodiments the mobility of the heterologous functional agent in soil is increased. In some embodiments the mobility of the heterologous functional agent in soil is decreased.

In some embodiments, the agricultural composition is formulated for delivery to a plant, a plant part, or a plant pest. In some embodiments, the plant part is a plant seed. In some embodiments, the NLPs are detected in germinated seeds. In some embodiments, the heterologous functional agent is a volatile agent. In some embodiments, the volatile agent is a fumigant, a pheromone, or an essential oil. In some embodiments, the at least one surface modifier enhances the uptake of the agricultural composition by a plant or plant part as compared to a composition not comprising the surface modifier. In some embodiments, the at least one surface modifier enhances the biodistribution of the agricultural composition by a plant or plant part as compared to a composition not comprising the surface modifier. In some embodiments, the NLP targets the meristem region.

In some embodiments the encapsulated heterologous functional agent is protected from UV radiation.

In some aspects an agricultural composition is provided, wherein the composition comprises a mixture of: a) a first plurality of NLPs comprising: at least one phospholipid; at least one non-polar lipid; and at least one surface modifier; and a first heterologous functional agent; and b) a second plurality of NLPs comprising: at least one phospholipid; at least one non-polar lipid; and at least one surface modifier; and a second heterologous functional agent; wherein the first plurality of NLPs comprise a hydrophobic core.

In some aspects, an agricultural composition is provided, wherein the composition comprises a mixture of: a) a plurality of NLPs comprising: at least one phospholipid; at least one non-polar lipid; and at least one surface modifier; and a first heterologous functional agent; and b) an unencapsulated agent, wherein the plurality of NLPs comprise a hydrophobic core.

In some aspects, an agricultural composition is provided, comprising a plurality of NLPs each comprising a heterologous functional agent, wherein the NLPs are produced by the process of applying energy to a solution comprising: at least one phospholipid; at least one non-polar lipid; at least one surface modifier; a heterologous functional agent, and an aqueous solution; wherein the plurality of NLPs comprise a hydrophobic core.

In some aspects, a method is provided of making an agricultural composition comprising a plurality of NLPs, the method comprising the step of: applying energy to a solution comprising at least one phospholipid, at least one non-polar lipid, at least one surface modifier, a heterologous functional agent, and an aqueous solution, thereby forming the NLPs, wherein the NLPs comprise a hydrophobic core.

In some aspects, a method is provided of altering the binding of a heterologous functional agent to at least one component in soil, the method comprising: applying to soil a composition comprising a heterologous functional agent encapsulated in a NLP comprising: at least one phospholipid; at least one non-polar lipid; and at least one surface modifier; wherein the binding of the encapsulated heterologous functional agent to soil is different than the binding of the unencapsulated heterologous functional agent to soil.

In some aspects, a method is provided of altering the mobility of a heterologous functional agent in soil, the method comprising: applying to soil a composition comprising a heterologous functional agent encapsulated in an NLP comprising: at least one phospholipid; at least one non-polar lipid; and at least one surface modifier; wherein the mobility of the encapsulated heterologous functional agent in soil is different than the mobility of the unencapsulated heterologous functional agent in soil.

In some aspects, a method is provided of reducing the viability of a root worm, the method comprising: applying to soil comprising root worm a composition comprising: at least one phospholipid; at least one non-polar lipid; at least one surface modifier; and a heterologous functional agent; wherein the heterologous functional agent contacts the root worm, thereby reducing the viability of the root worm. In some embodiments, the NLPs are applied to soil as a soil drench. In some embodiments, the NLPs are applied to soil in furrow. In some embodiments, the root worm is a member of the Diabrotica genus. In some embodiments, the root worm is Diabrotica virgifera virgifera.

In some aspects, a method is provided of reducing the viability or a fungus, the method comprising: applying to soil comprising a fungus a composition comprising: at least one phospholipid; at least one non-polar lipid; at least one surface modifier; and a heterologous functional agent; wherein the heterologous functional agent contacts the fungus, thereby reducing the viability of the fungus in the soil. In some embodiments, the fungus belongs to a family selected from the group consisting of Sciaridae, Diadocidiidae, Ditomyiidae, Keroplatidae, Bolitophilidae, and Mycetophilidae and Sclerotiniaceae. In some embodiments, the fungus is Botrytis cinerea.

In some aspects, a method is provided of preventing a plant from developing a disease caused by a plant pest, the method comprising: applying to soil a plurality of NLPs, wherein the NLPs each comprise: at least one phospholipid; at least one non-polar lipid; at least one surface modifier; and a heterologous functional agent; wherein the heterologous functional agent contacts the plant pest, thereby killing the pest, thereby preventing the plant from developing a disease. In some embodiments, the NLPs are applied to soil as a soil drench. In some embodiments the NLPs are applied to soil in furrow. In some embodiments, the plant pest is a member of the Coleopteran or the Hemipteran order.

In one aspect a method is provided of increasing the uptake of a heterologous functional agent by a plant or plant part, the method comprising: contacting a plant or plant part with a composition comprising a heterologous functional agent encapsulated in a NLP, wherein the NLP comprises: at least one phospholipid; at least one non-polar lipid; and at least one surface modifier; wherein the NLPs comprise a hydrophobic core, and wherein the uptake of the encapsulated heterologous functional agent by the plant or plant part is higher than the uptake of the unencapsulated heterologous functional agent by the plant or plant part.

In one aspect a method is provided for delivering a heterologous functional agent to a plant or a plant part, the method comprising: contacting a plant or plant part with a composition comprising: at least one phospholipid; at least one non-polar lipid; at least one surface modifier; and a heterologous functional agent; wherein the NLPs comprise a hydrophobic core, thereby delivering the heterologous functional agent to the plant.

In some embodiments, the plant part is a plant seed.

In one aspect, a method is provided of delivering a heterologous functional agent to the meristem, the method comprising: contacting a plant or plant part with a composition comprising a heterologous functional agent encapsulated in a NLP, wherein the NLP comprises: at least one phospholipid; at least one non-polar lipid; and at least one surface modifier.

In one aspect a method is provided of distributing a heterologous functional agent in soil, the method comprising: contacting a plant seed with a composition comprising: at least one phospholipid; at least one non-polar lipid; at least one surface modifier; and a heterologous functional agent; wherein the NLPs comprise a hydrophobic core, and incubating the plant seed in soil, thereby distributing the heterologous functional agent in the soil.

In one aspect a method is provided of distributing a heterologous functional agent in a plant, the method comprising: contacting a plant seed with a composition comprising: at least one phospholipid; at least one non-polar lipid; at least one surface modifier; and a heterologous functional agent; wherein the NLPs comprise a hydrophobic core, and incubating the plant seed under conditions that cause germination, thereby distributing the heterologous functional agent in the plant.

In some embodiments the contacting is by means of injecting the composition in the plant or plant part. In some embodiments the composition is injected into one or more leaves.

In some embodiments the composition is injected into a tree. In some embodiments the composition is injected at several positions into a tree.

In one aspect a method is provided of treating a disease in a plant, the method comprising: contacting a plant or plant part with a composition comprising: at least one phospholipid; at least one non-polar lipid; at least one surface modifier; and a heterologous functional agent; wherein the NLPs comprise a hydrophobic core, thereby threating the disease in a plant.

In some embodiments the disease is caused by Candidatus Liberibacter asiaticus (CLas). In some embodiments the disease is citrus greening. In some embodiments the disease is caused by Xylella.

In one aspect a method of preventing a plant from developing a disease, the method comprising: contacting a plant or plant part with a composition comprising: at least one phospholipid; at least one non-polar lipid; at least one surface modifier; and a heterologous functional agent; wherein the NLPs comprise a hydrophobic core, thereby preventing a disease in a plant.

In one aspect a method is provided of altering the volatility of a heterologous functional agent, the method comprising encapsulating the volatile heterologous functional agent in a composition comprising at least one phospholipid, at least one non-polar lipid; and at least one surface modifier, wherein the NLPs comprise a hydrophobic core.

In one aspect a method is provided of sequestering a volatile heterologous functional agent, the method comprising encapsulating the heterologous functional agent in a composition comprising at least one phospholipid, at least one non-polar lipid; and at least one surface modifier, wherein the NLPs comprise a hydrophobic core.

In one aspect a method is provided for the controlled release of a volatile heterologous agent into the environment, the method comprising encapsulating the heterologous functional agent in a composition comprising at least one phospholipid, at least one non-polar lipid; and at least one surface modifier, wherein the NLPs comprise a hydrophobic core.

In some embodiments the volatile heterologous functional agent is a herbicide, a fumigant, a pheromone, or an essential oil. In some aspects, a kit is provided comprising an agricultural composition, the composition comprising a plurality of nature-derived lipid particles (NLPs) each comprising: at least one phospholipid; at least one non-polar lipid; and at least one surface modifier; wherein the NLPs comprise a hydrophobic core, and wherein the at least one surface modifier alters the mobility of the agricultural composition through soil as compared to a composition not comprising the surface modifier.

### BRIEF DESCRIPTION OF THE DRAWINGS

FIG. 1A-1C depict a comparison of the lipid profile of extracted crude lipids (FIG. 1C) and the phospholipid profile (FIG. 1A) and non-polar lipid profile (FIG. 1B) in enriched fractions from freeze-dried lemons analyzed by HPLC with Evaporative Light Scattering Detector (ELSD).

FIG. 2A-2C depict lipid analysis of the enriched fractions by comparison to a soybean lipid standard. FIG. 2A, enriched phospholipid fraction from lemon (LM) lipids; FIG. 2B, soy phospholipid standard comprising phosphatidic acid (PA), phosphatidyl ethanolamine (PE), phosphatidyl choline (PC) and phosphatidyl inositol (PI); FIG. 2C, the experimental sample spiked with the soy phospholipid standard.

FIG. 3A-3C depict the screening of a total of 127 NLP formulations comprising deltamethrin at 80 ug per ml of NLP suspension and Exalite 594 (hereinafter: Exalite) at 1 ug per ml of NLP suspension for binding to soil. The compositions of the formulations evaluated are provided in Table 15. FIG. 3A, results in a soil retention assay. The percentage of the sample that remains in the supernatant (unbound, leaching from soil) is shown. Of the 127 NLPs tested, 27 had greater than 10% soil detachment, and are shown in the figure, along with three immobile NLPs (NLP518, NLP519 and NLP536). Unformulated deltamethrin was immobile in soil. The data points represent the average of an experiment performed in triplicate. Two experiments were carried out for each formulation and the bars represent the average of those two. FIG. 3B depicts the screening of the 27 formulations, that showed decreased affinity for soil in the affinity assay, in a soil mobility assay. Samples were loaded to a soil column and eluted with artificial rain as the mobile phase. The percent of the total sample applied that is leaching out from the column is shown. FIG. 3C, comparison of NLP binding in the soil retention assay and the soil mobility assay.

FIG. 4 depicts the evaluation of NLP formulations prior to soil exposure and soil leachates of NLP formulations against Western Corn Rootworm (WCRW). The soil leachates of all NLP formulated deltamethrin (DE) have significantly higher average efficacy (p<0.05) against WCRW than the soil leachate of a commercially available deltamethrin formulation (Suspend SC, last bar in bar graph).

FIG. 5A-5E depict the activity of NLP580 produced with the DCM method comprising deltamethrin at 400 ug per ml of suspension (NLP580-DE) against WCRW in a soil drench assay. NLP comprising DE can improve plant mass of corn seedlings by preventing damage from corn rootworm larvae. Water treatment (FIG. 5A) did not rescue the seedlings from corn rootworm damage. NLP580-DE (FIG. 5D) matches the level of control achieved by Bifenture®, a commercially available product for soil treatment (FIG. 5B). Deltamethrin made into a soluble liquid formulation (FIG. 5C) using organic solvents did not show the same level of efficacy as the NLP with deltamethrin (FIG. 5D). The quantitative data of the plant mass are shown in FIG. 5E. P-values indicating the significance of relevant comparisons are indicated at the top of the figure.

FIG. 6A-6E depict the activity of NLP580 produced with the DCM method comprising deltamethrin at 400 ug per ml of suspension (NLP580-DE) against WCRW in an in-furrow assay. FIG. 6A, uninfested plants, showing growth as expected; FIG. 6B, WCRW-infested plants treated with water. Water treatment did not rescue the seedlings from corn rootworm damage; FIG. 6C, Bifenture® treated plants infested with WCRW larvae; FIG. 6D, NLP580-DE treated plants infested with WCRW larvae. The efficacy of the NLP580-DE treatment matches the efficacy by Bifenture®. The quantitative data of the plant mass are shown in FIG. 6E. P-values indicating the significance of relevant comparisons are indicated at the top of the figure.

FIG. 7A-7B depict the delivery of a hydrophobic and water insoluble dye (Exalite) when formulated in NLP580. NLP580 was produced with the DCM method comprising 1 ug Exalite per ml of suspension. Delivery into green bean seeds was assessed. The positive control is Acid Red 52 (12 part per million, ppm), a water-soluble fluorescent dye that is readily taken up by seeds. Exalite is a hydrophobic and water insoluble dye that is unable to enter the seeds. However, NLP580 comprising Exalite entered seedlings showing that NLP enabled hydrophobic molecules to enter the seeds. FIG. 7A, visualization of the fluorescence in beans exposed to NLP comprising Exalite; FIG. 7B, quantitation of the fluorescent signal.

FIG. 8A-8B depict delivery of low water soluble Emamectin benzoate (EM) when formulated in lemon NLP into leaves (shoots) of 5-day-old corn seedlings. The controls are free EM, and no EM (water only). FIG. 8A, when EM is formulated in NLP (lemon) at a final concentration of 32 ug per ml of suspension, significantly higher EM concentration in corn leaves are achieved compared to the unformulated EM (in water). FIG. 8B, the ratio of the EM concentration in leaves normalized by EM concentration in seeds was higher in treatment with NLP comprising EM than in free EM treatment.

FIG. 9A-9B depict the efficacy of NLP580 comprising 400 ug deltamethrin per ml of suspension (NLP580-DE (400 ug per ml)) against Western stern Corn Root Worm (WCRW) in a corn seed treatment phytagel assay. FIG. 9A, the NLP580-DE treated seeds reached a greater fresh corn seedling weight than that of seeds treated with the unformulated deltamethrin (DE-only). FIG. 9B, NLP580-DE treated seeds showed a higher WCRW control percentage than that of the unformulated deltamethrin (DE-only).

FIG. 10A-10R depict the confocal microscopy images of 6-day-old Arabidopsis roots incubated with NLP580, NLP487 and NLP544 formulations. FIGS. 10A-10D and 10I-10M, differentiation zone; FIGS. 10E-10H and 10N10R, root meristem. FIGS. 10A, 10E, 10J, and 10N, Exalite at 1 ug/ml; FIGS. 10B, 10F, 10K, and 10P, NLP580; FIGS. 10C, 10G, 10L, and 10Q, NLP487; FIGS. 10D, 10H, 10M, and 10R, NLP544; FIGS. 10J, 10O, NLP580 without bioactive (with EX but without DE). Roots were incubated for 30 minutes (FIG. 10A-FIG. 10H), or 24 hours (FIG. 10I-FIG. 10R). Differential dye accumulation within different cellular compartments is visualized for different NLP compositions. Insets show endomembrane localization. Arrows point to NLP580 with or without bioactive accumulation in the root vasculature (v), whereas NLP487 and NLP544 are preferentially accumulated in the epidermis (ep) in the differentiation zone of the root.

FIG. 11A-11D depict the confocal microscopy images of NLP580 produced with the DCM method comprising 1 ug Exalite and 80 ug deltamethrin per ml of suspension (NLP580), within epidermal cells of tomato seedlings. NLP580 is taken up by tomato roots when treated for 24 hours in solution (in triplicate, FIG. 11B-11D), whereas dye control with Exalite showed no fluorescence in root epidermis cells (FIG. 11A). Arrowheads point to NLPs with Exalite signal.

FIG. 12A-12J depict confocal microscopy images of NLP 580, NLP487 and NLP544 each produced with the DCM method and comprising 1 ug Exalite and 80 ug DE per ml of suspension in Arabidopsis organs. FIGS. 12A and 12F, no treatment; FIG. 12B and FIG. 12G Exalite only treatment at 1 μg/ml ( ); FIG. 12C, 12H, NLP580; FIG. 12D, 12J, NLP487; FIG. 12E, 12J, NLP544. FIG. 12A-12E: Cotyledons, FIG. 12F-12J: Hypocotyl. Fluorescence can be detected in cotyledons (FIG. 12C-FIG. 12E) and hypocotyls (FIG. 12H-FIG. 12J) when the plant roots are exposed to the NLP formulations. Exalite alone showed no fluorescence in any of the roots nor in areal plant tissues analyzed.

FIG. 13A-13H depict confocal microscopy images of NLP580, NLP487 and NLP544 each produced with the DCM method and comprising 1 ug Exalite and 80 ug deltamethrin per ml of suspension. FIGS. 13A and 13E, Exalite only; FIG. 13B, 13F, NLP580; FIG. 13C, 13G, NLP487; and FIG. 13D, 13H, NLP544, in Arabidopsis with and without Brefeldin A (BFA) treatment. NLP and BFA treatment (FIG. 13B-13D) with the counter staining with calcofluor white (1 ug/ml) (FIG. 13F-13H), showed that NLP580 (FIG. 13B) and NLP487 (FIG. 13C) are aggregating in endomembranes (arrows point endomembranes aggregating in BFA bodies), whereas NLP544 (FIG. 13D) is insensitive to BFA. Control experiments using 1 ug/ml Exalite and BFA show low fluorescence in outer tissues and no fluorescence in cytoplasm or endomembranes (FIGS. 13A and 13E).

FIG. 14A-14G depict confocal microscopy images of Nicotiana benthamiana leaves injected with NLPs comprising 1 ug/ml of Exalite and 80 ug/ml of deltamethrin, or with Exalite only at 1 μg/ml in 0.5×MS, or non-infiltrated leaves as a control. NLPs were infiltrated and visualized after 24 hours. NLP487 (FIG. 14A) is localized at the plasma membrane whereas NLP530 (FIG. 14E) is mainly localized in aggregates next to the membranes. NLP580 (FIG. 14B), NLP533 (FIG. 14C) and NLP527 (FIG. 14D), NLP646 (FIG. 14F), NLP655 (FIG. 14G) and NLP649 (FIG. 14H) show both localization at the plasma membrane and in aggregates next to the membranes. In the case of NLP649 (FIG. 14H) a detail of the cell shows fluorescence signal in the nuclear envelope and in the cytosol (arrows) Control experiments using 1 μg/ml Exalite (FIG. 14I) and untreated plants (FIG. 14J) show that Exalite alone had no fluorescence in any of the roots nor in the aerial plant tissues analyzed.

FIG. 15A-15F depict stereoscope images of cut sections of melon plants injected with NLP487, NLP544 and NLP580, each produced with the DCM method and each comprising 1 ug Exalite and 80 ug deltamethrin per ml of. Detection of NLP signal 24 hours post-injection, from left to right, NLP487 (FIG. 15A), NLP544 (FIG. 15B) and NLP580 (FIG. 15C). All NLP analyzed were localized in the pith and NLP580 was also detected in the vascular bundle (white arrows). Control experiments using 1 μg/ml Exalite only (FIG. 15D) and untreated plants (FIG. 15E) show that Exalite alone is not detected in any of the roots nor in aerial plant tissues analyzed. FIG. 15F shows a stem slide image under bright field.

FIG. 16A-16B depict the confocal microscopy images of NLP580 produced with the DCM method comprising 1 ug Exalite and 80 ug deltamethrin per ml of suspension, in melon leaves after injection in the stem. Results show the detection of NLP580 signal in the vasculature of the leaf 24 hours post-injection (FIG. 16B). Arrow points to the leaf vasculature. FIG. 16A, control experiments using 1 μg/ml Exalite only.

FIG. 17A-17B depict a tomato seedling root uptake assay, followed by an infestation with Colorado Potato Beetle (CPB). Various NLP containing deltamethrin added to roots of tomato seedlings cause mortality of CPB, a foliar chewing Coleopteran insect. FIG. 17A, the numbers below the petri dishes indicate the following treatments: 1) water; 2) NLP018 comprising no deltamethrin (empty NLP018); 3) NLP018 comprising 160 ug deltamethrin per ml of suspension (NLP018 [160 ug/ml DE]); 4) treatment #1 diluted 10-fold such that the deltamethrin concentration was 16 ug per ml of suspension (NLP018 [16 ug/ml DE]); 5) treatment #1 diluted 100-fold such that deltamethrin concentration was 1.6 ug per ml of suspension (NLP018 [1.6 ug/ml DE]); 6) NLP472 comprising 160 ug deltamethrin per ml of suspension (NLP472 [160 ug/ml DE]); 7) NLP495 comprising 160 ug per ml of suspension (NLP495 [160 ug/ml DE]); 8) deltamethrin at 160 ug/ml in DCM (unformulated); 9) clothianidin at 100 ug/ml. Unformulated deltamethrin causes phytotoxicity to the tomato seedlings, which makes it unsuitable for the feeding assay (number 8 in FIG. 17A); FIG. 17B, larval control (%) exhibited by the indicated NLP formulations. All NLPs were produced with the DCM method.

FIG. 18 depicts Tomato HornWorm control (THW) control in a tomato seedling root uptake assay, followed by an infestation with THW. NLP580 produced with the DCM method comprising 400 ug deltamethrin per ml of suspension (NLP580 [400 ug/ml]) added to tomato seedlings cause mortality of THW, a foliar chewing Lepidopteran insect. Larval control (%) exhibited by water, clothianidin at 50 ug/ml, 25 ug/ml, 12.5 ug/ml and 6.25 ug/ml, and NLP580 [400 ug/ml] are shown.

FIG. 19 depicts the results from ICP-MS analysis of Gadolinium (Gd) in tomato organs after exposing the roots of the tomato seedlings to various treatments. The treatments are 1) free Gd, 2) NLP527 comprising DTPE complexed Gd (Gd-DTPE), 3) NLP529 comprising Gd-DTPE, 4) NLP580 comprising Gd-DTPE, 5) nanoparticles made from HSPC lipids NLP comprising Gd-DTPE, 6) DOTA complexed Gd. Plants whose roots were exposed to NLPs comprising Gd showed far better uptake and translocation to various plant organs compared to those treated with free Gd or DOTA complexed Gd. NLP580 performed similar to HSPC (Gd), and they were taken up and distributed better than free Gd or DOTA complexed Gd, but worse than NLP527 and NLP529.

FIG. 20 depicts the experimental set up of the tomato seedling root uptake experiments and Pseudodomonas syringae infection, and bacterial growth readouts.

FIG. 21A-21I depict the results of a UV stability assay testing the lemon NLP (FIG. 21B), carrot NLP (FIG. 21C), algae-autotrophic NLP (FIG. 21F), and algae-mixotrophic NLP (FIG. 21G) comprising deltamethrin and the unformulated deltamethrin (deltamethrin in methanol in FIG. 21A) were exposed under UV irradiation for 1, 2, 3 or 6 days. The 4 NLPs were also mixed with 3% lignosulfonate (FIGS. 21D, 21E, 21H, 21I) and tested in the same UV stability assay. After 6 days of UV exposure, the 4 NLPs protect deltamethrin better than deltamethrin in methanol, with 55 to 62% deltamethrin (active ingredient; AI) retention rate (actual deltamethrin/input deltamethrin) (FIGS. 21B, 21C, 21F, 21G) compared to 15% deltamethrin retention rate from deltamethrin in methanol treatment (FIG. 21A). The 4 NLPs mixed with 3% lignosulfonate (FIGS. 21D, 21E, 21H, 21I) had even higher deltamethrin retention rate, between 71 and 84%.

FIG. 22A-22P depict confocal microscopic images showing NLP transport from root to the aerial plant organs: FIGS. 22A-22D and 22I-22L, cotyledon; FIGS. 22E-22H and 22M-22P: hypocotyl. FIG. 22A, 22E, water treatment; FIG. 22B, 22F, Exalite only at 1 ug/ml; FIG. 22C, 22G, NLP533; FIG. 22D, 22H, NLP578; FIG. 22I, 22M, NLP551; FIG. 22J, 22N, NLP544; FIG. 22K, 220, NLP600; FIG. 22L, 22P, NLP620. Arrows point to the vascular tissue. Each NLP suspension was produced with the DCM method and comprised 80 ug/ml DE and 1 ug/ml Exalite.

FIG. 23A-23R depict confocal microscopic images of 5-day-old primary roots of Arabidopsis showing the uptake of NLPs in the plant differentiation zone (FIGS. 23A-23D and 23I to 23M) and root meristem (FIGS. 23E-23H and FIG. 23N-23R). Upon 30 minutes of incubation with the indicated NLP suspensions, uptake and transport is monitored. Differential accumulation of different NLP compositions within the different cell types and cellular compartments are visualized: FIGS. 23A-23D and 23I-23M, differentiation zone; FIGS. 23E-23H and 23N-23R: root meristem. FIG. 23A, 23E, Exalite only at 1 ug/ml; FIG. 23B, 23F, NLP551; FIG. 23C, 23G, NLP533; FIG. 23D, 23H, NLP578; FIG. 23I, 23N, NLP600; FIG. 23J, 230, NLP620; FIG. 23K, 23P, NLP699; FIG. 23L, 23Q, NLP700; FIG. 23M, 23R, NLP544. Each NLP suspension was produced with the DCM method and comprised 80 ug/ml DE and 1 ug/ml Exalite.

FIG. 24A-24R depict confocal microscopic images of Arabidopsis primary roots showing the uptake of NLPs by the plant. Upon 24 hours of incubation with the indicated NLPs suspensions, uptake and transport along the Arabidopsis root tissue is monitored: FIGS. 24A-24D and 24I-24M, differentiation zone; FIGS. 24E-24H and 24N-24R: root meristem. FIG. 24A, 24E, Exalite only at 1 ug/ml; FIG. 24B, 24F, NLP551; FIG. 24C, 24G, NLP533; FIG. 24D, 24H, NLP578; FIG. 24I, 24N, NLP600; FIG. 24J, 24O, NLP620; FIG. 24K, 24P, NLP699; FIG. 24L, 24Q, NLP700; FIG. 24M, 24R, NLP544. Insets show the endomembrane region and localization (n>15). Each NLP suspension was produced with the DCM method and comprised 80 ug/ml DE and 1 ug/ml Exalite.

FIG. 25A-25H depict confocal microscopic images showing that NLPs can be transported to the shoot apical meristem. Uptake was assessed after 24 hours of root treatment with NLPs formulations. FIG. 25A, water only; FIG. 25B, Exalite only at 1 ug/ml; FIG. 25C, NL487; FIG. 25D, NLP580; FIG. 25E, NLP578; FIG. 25F, NLP533; FIG. 25G, NLP544; FIG. 25H, NLP551. Each NLP suspension was produced with the DCM method and comprised 80 ug/ml DE and 1 ug/ml Exalite. Arrows indicate the shoot apical meristem.

FIG. 26A-26T depict confocal microscopic images showing the subcellular localization of NLPs. Panels showing Exalite fluorescence from labeled NLP (panels in first and third columns) and calcofluor counterstaining fluorescence (1 μg/ml) (panels in second and fourth columns). BFA promotes aggregation of endomembranes into bigger compartments (called BFA bodies) and calcofluor white stains the cellulose of the cell wall. FIG. 26A, 26B, Exalite only at 1 ug/ml; FIG. 26C, 26D, NLP578; FIG. 26E, 26F, NLP544; FIG. 26G, 26H, NLP551; FIG. 26I, 26J, NLP533; FIG. 26K, 26L, NLP600; FIG. 26M, 26N, NLP580; FIG. 26O, 26P, NLP620; FIG. 26Q, 26R, NLP699; FIG. 26S, 26T, NLP700. Arrows point to endomembranes aggregating in BFA bodies. Each NLP suspension was produced with the DCM method and comprised 80 ug/ml DE and 1 ug/ml Exalite. Arrowheads point to endomembranes aggregating in BFA bodies.

FIG. 27A-27G depict confocal microscopic images showing NLP localization close to plasma membranes in Nicotiana benthamiana leaves. An aliquot of 200 ul of the indicated NLP formulations were infiltrated using a 1 ml needleless syringe, followed by visualization of fluorescence using a confocal microscope after 24 h. FIG. 27A, NLP544; FIG. 27B, NLP551; FIG. 27C, NLP578; FIG. 27D, NLP600; FIG. 27E, NLP620; FIG. 27F, Exalite only at 1 ug/ml; FIG. 27G, control, non-infiltrated. White arrows, nuclear envelope. Each NLP suspension was produced with the DCM method and comprised 80 ug/ml DE and 1 ug/ml Exalite.

FIG. 28A-28D depict confocal microscopic images showing that injected NLP are localized in the vascular system of melon plants. 5 week-old plants were injected with 200 ul of the indicated NLP formulations using 1 ml syringe attached to an Invaio's 3 mm Trecise™ injector followed by visualization using a confocal microscope after 24 h. FIG. 28A, NLP533; FIG. 28B, NLP551; FIG. 28C, water (control); FIG. 28D, Exalite only at 1 ug/ml. White arrows, vascular bundle. Each NLP suspension was produced with the DCM method and comprised 80 ug/ml DE and 1 ug/ml Exalite.

FIG. 29A-29N depict confocal microscopic images to evaluate NLP maize seed uptake. FIG. 29A-29F, pre-germination assay: FIG. 29A, water only (24 h), FIG. 29B, NL620 (24 h); FIG. 29C, water only (24 h); FIG. 29D, NLP600 (24 h); FIG. 29E, water only (48 h); FIG. 29F, NLP580 (48 h). Images show seed cross sections after incubation with the indicated treatments. FIG. 29G-29J, germination in NLP solution: FIG. 29G, water only (4 days), FIG. 29H, NL580 (4 days); FIG. 29I, water only (5 days); FIG. 29J, NLP580 (5 days). Images show seed cross sectioned after incubation with the indicated treatments. FIG. 29K-29N, imbibition in the indicated NLP suspensions for 24 h followed by germination in water (5 days): FIG. 29K, water control (5 days, imaged with white light); FIG. 29L, water control (5 days; imaged with fluorescent light); FIG. 29M, NLP580 (5 days; imaged with white light); FIG. 29N, NLP580 (5 days; imaged with fluorescent light). Each NLP suspension was produced with the DCM method and comprised 80 ug/ml DE and 1 ug/ml Exalite.

FIG. 30A-30G depict confocal microscopic images showing that NLPs injected in maize plants are localized in the vascular system. Five-week-old plants were injected with 200 ul of the indicated NLP formulations using 1 ml syringe attached to an Invaio's 3 mm Trecise™ injector, followed by visualization of fluorescence in a confocal microscope after 24 h. FIG. 30A, 30D, water only; FIG. 30B,30F NLP487; FIG. 30C, 30G, NLP646; FIG. 30D, NLP544. FIG. 30A-30D: maize stem sections; FIG. 30E-30G, maize leaves. Each NLP suspension was produced with the DCM method and comprised 80 ug/ml DE and 1 ug/ml Nile Red.

FIG. 31A-31B depict efficacy of nine NLP formulations against western corn rootworm (WCRW) in a small scale in furrow assay. Results are shown for the efficacy testing of 9 NLPs (NLP533, NLP551, NLP487, NLP646, NLP644, NLP647, NLP659, NLP660, and NLP654 each produced with the HHPH method and comprising DE at 2 mg/ml) against WCRW in an in-furrow assay conducted at a greenhouse. Both the fresh whole seedling weight (FIG. 31A) and root mass (FIG. 31B) indicate the efficacy of the treatment against WCRW of all nine formulations tested. Uninfested plants show normal growth as expected. Water (WCRW-infested plants treated with water) treatment did not rescue the seedlings (or roots) from WCRW damage. Bifenture® treatment served as the positive control. The efficacy of the 9 NLP (comprising deltamethrin treatments matches the efficacy by Bifenture® treatment. Unformulated deltamethrin at 2 mg/ml is less effective in protecting whole plant mass (FIG. 31A) or root mass (FIG. 31B) from WCRW infestation than any of the 9 NLPs comprising deltamethrin at the same concentration (2 mg/ml). Data presented are the average of two independent experiments each with 9-10 replicates (plants) per treatment. All NLP suspensions were produced with the HHPH method.

FIG. 32A-32B depict the activity of two NLP compositions (NLP644 and NLP647) comprising deltamethrin at various concentrations (80, 400 and 2,000 ug/ml suspension) against western corn rootworm (WCRW) in an in-furrow assay at greenhouse, measuring the protective effect against whole plant mass (FIG. 32A) and root mass (FIG. 32B). *, P<0.05 by comparison to unformulated DE at the corresponding concentration. The NLPs compositions were produced with the HHPH method.

FIG. 33 depicts the efficacy of NLP644 comprising deltamethrin at 2 mg/ml against western corn rootworm (WCRW) in an in-furrow assay in an open field trial. The NLPs composition was produced with the HHPH method. Data presented are an average of 20 separate replicates.

FIG. 34 depicts the antifungal efficacy of azoxystrobin encapsulated in ten different NLPs, as measured in a resazurin based Fusarium inhibition assay. Assay 1 was conducted in duplicate (screen 1-1 and screen 1-2), evaluating NLP580, NLP533, NLP551, NLP487, and NLP608. Assay 2 was conducted in duplicate (2-1 and 2-2), evaluating NLP600, NLP603, NLP530, NLP527, and NLP532.

FIG. 35 depicts the percentage of deltamethrin recovered from soil in the soil mobility assay after incubating deltamethrin or NLPs comprising deltamethrin in the soil for 0 hour, 24 hour, and 7 days. The NLP compositions were produced with the HHPH method. Data presented are an average of 3 replicate columns per each treatment.

### DETAILED DESCRIPTION

Featured herein is an agricultural composition comprising a plurality of nature-derived lipid particles (NLPs) that each comprise a phospholipid component, a non-phospholipid component, and at least one surface modifier. In some embodiments, the surface modifier promotes the mobility of the NLP through soil as compared to an NLP not comprising the surface modifier. NLPs can optionally include agents (e.g., heterologous functional agents, (e.g., a heterologous agricultural agent (e.g., pesticidal agent, fertilizing agent, herbicidal agent, plant-modifying agent, an insect attractant, plant growth promoting agent, biostimulants, or plant immunity elicitors) or a heterologous therapeutic agent (e.g., an antifungal agent, an anti-oomycete agent, an antibacterial agent, a virucidal agent, an anti-viral agent, an insecticidal agent, a nematicidal agent, an antiparasitic agent, or an insect repellent), In some embodiments, the heterologous functional agent is hydrophobic. In some embodiments, the heterologous functional agent is encapsulated. In some embodiments, the encapsulated heterologous functional agent is a pyrethroid, e.g., deltamethrin. In some embodiments, encapsulated pyrethroid is capable of moving through soil as compared to unencapsulated pyrethroid, thus offering a solution to the problem of the binding of deltamethrin to soil.

Several embodiments relate to methods and compositions for altering the movement of a heterologous functional agent through the soil. In some embodiments, a heterologous functional agent with high soil affinity is encapsulated in an NLP comprising a phospholipid component, a non-phospholipid component, and at least one surface modifier, wherein the surface modifier alters a characteristic of the NLP that promotes mobility through soil as compared to an NLP not comprising the surface modifier. In other embodiments, a heterologous functional agent with low soil affinity is encapsulated in an NLP comprising a phospholipid component, a non-phospholipid component, and at least one surface modifier, wherein the surface modifier alters a characteristic of the NLP that increases soil affinity as compared to an NLP not comprising the surface modifier.

Further featured herein are compositions comprising mixtures of NLPs each comprising a different heterologous functional agent. Further featured herein are mixtures comprising a plurality of NLPs and an unencapsulated agent. The NLP compositions and methods described herein can be used in a variety of agricultural and therapeutic methods.

### Definitions

As used herein, an “agriculturally acceptable” carrier is one that is suitable for use in agriculture, e.g., for use on plants. In certain embodiments, the agriculturally acceptable carrier does not have undue adverse side effects to the plants, the environment, or to humans or animals who consume the resulting agricultural products derived therefrom commensurate with a reasonable benefit/risk ratio.

As used herein, “delivering” or “contacting” refers to applying an NLP composition as described herein either directly to a plant, animal (e.g., insect, nematode, etc.), fungus, or bacterium, or adjacent to the plant, animal, fungus, or bacterium, in a region where the composition is effective to alter the fitness of the plant, animal, fungus, or bacterium. In methods where the composition is directly contacted with a plant, animal, fungus, or bacterium, the composition may be contacted with the entire plant, animal, fungus, or bacterium or with only a portion of the plant, animal, fungus, or bacterium. In some embodiments, the NLP composition may be ingested by a plant pest, such as an insect or nematode.

As used herein, “decreasing the fitness of a plant” refers to any disruption of the physiology of a plant (e.g., a weed) as a consequence of administration of a composition described herein (e.g., an NLP composition including a heterologous functional agent as described herein), including, but not limited to, decreasing a population of a plant (e.g., a weed) by about 10%, 20%, 30%, 40%, 50%, 60%, 70%, 80%, 90%, 95%, 99%, 100% or more. A decrease in plant fitness can be determined in comparison to a plant to which the composition has not been administered.

As used herein, the term “effective amount,” “effective concentration,” or “concentration effective to” refers to an amount of a heterologous functional agent provided in a NLP composition as described herein, sufficient to affect the recited result or to reach a target level (e.g., a predetermined or threshold level) in or on a target organism.

As used herein, “increasing the fitness of a plant” refers to an increase in the production of the plant, for example, an improved yield, improved vigor of the plant, or improved quality of the harvested product from the plant as a consequence of administration of a composition described herein (e.g., an NLP composition including a heterologous functional agent as described herein). An improved yield of a plant relates to an increase in the yield of a product (e.g., as measured by plant biomass, grain, seed or fruit yield, protein content, carbohydrate or oil content or leaf area) of the plant by a measurable amount over the yield of the same product of the plant produced under the same conditions, but without the application of the instant compositions or compared with application of conventional agricultural agents. For example, yield can be increased by at least about 0.5%, about 1%, about 2%, about 3%, about 4%, about 5%, about 10%, about 20%, about 30%, about 40%, about 50%, about 60%, about 70%, about 80%, about 90%, about 100%, or more than 100%. Yield can be expressed in terms of an amount by weight or volume of the plant or a product of the plant on some basis. The basis can be expressed in terms of time, growing area, weight of plants produced, or amount of a raw material used. An increase in the fitness of plant can also be measured by other means, such as an increase or improvement of the vigor rating, increase in the stand (the number of plants per unit of area), increase in plant height, increase in stalk circumference, increase in plant canopy, improvement in appearance (such as greener leaf color as measured visually), improvement in root rating, increase in seedling emergence, protein content, increase in leaf size, increase in leaf number, fewer dead basal leaves, increase in tiller strength, decrease in nutrient or fertilizer requirements, increase in seed germination, increase in tiller productivity, increase in flowering, increase in seed or grain maturation or seed maturity, fewer plant verse (lodging), increased shoot growth, or any combination of these factors, by a measurable or noticeable amount over the same factor of the plant produced under the same conditions, but without the administration of the instant compositions or with application of conventional agricultural agents.

As used herein, the term “heterologous” refers to an agent that is exogenous to the plant or plant part that is contacted with the NLP (e.g., originating from a source that is not the plant itself, e.g., the pesticidal agent incorporated in an NLP may be heterologous). In some embodiments, one or more components of the NLP are heterologous.

As used herein, the term “functional agent” refers to an agent (e.g., an agricultural agent (e.g., pesticidal agent, insecticidal, bactericidal agent, nematocidal, fertilizing agent, herbicidal agent, plant-modifying agent, insect attractant, etc.) or a therapeutic agent (e.g., an antifungal agent, an anti-oomycete agent, an antibacterial agent, a virucidal agent, an anti-viral agent, an insecticidal agent, a nematocidal agent, an antiparasitic agent, or an insect repellent)) that is or can be associated with an NLP composition as described herein (e.g., loaded into or onto NLPs (e.g., encapsulated by, embedded in, or conjugated to NLPs)) and is capable of effecting the recited result (e.g., increasing or decreasing the fitness of a plant, plant pest, plant symbiont, animal (e.g., human) pathogen, or animal pathogen vector) in accordance with the present compositions or methods. In some aspects, the functional agent is a polynucleotide. In some aspects, the functional agent is a polypeptide. In some aspects, the functional agent is a small molecule. In some embodiments, the functional agent is a volatile agent and has a high vapor pressure. In some embodiments, the volatile functional agent is a fumigant. In some embodiments the volatile functional agent is a pheromone. In some embodiments, the volatile functional agent is an essential oil. As used herein, the term “agricultural agent” refers to an agent that can act on a plant, a plant pest, or a plant microorganism (e.g. a plant symbiont), such as a pesticidal agent, pest repellent, fertilizing agent, plant-modifying agent, plant growth promoting agent, biostimulants, plant immunity elicitors or plant-microorganism modifying agent.

As used herein, the term “fertilizing agent” refers to an agent that is capable of increasing the fitness of a plant (e.g., a plant nutrient or a plant growth regulator). In some embodiments the fertilizing agent is a plant symbiont (e.g., nitrogen fixing bacteria).

As used herein, the term “pesticidal agent” refers to an agent, composition, or substance therein, that controls or decreases the fitness (e.g., kills or inhibits the growth, proliferation, division, reproduction, or spread) of an agricultural, environmental, or domestic/household pest, such as an insect, mollusk, nematode, fungus, oomycete, bacterium, weed, or virus. Pesticides are understood to include naturally occurring or synthetic insecticides (larvicides or adulticides), insect growth regulators, acaricides (miticides), molluscicides, nematicides, ectoparasiticides, bactericides, fungicides, or herbicides. The term “pesticidal agent” may further encompass other bioactive molecules such as antibiotics, antivirals, pesticides, antifungals, antihelminthics, nutrients, and/or agents that stun or slow insect movement.

As used herein, the term “plant-modifying agent” refers to an agent that can alter the genetic properties (e.g., increase gene expression, decrease gene expression, or otherwise alter the nucleotide sequence of DNA or RNA), epigenetic properties, or biochemical properties of a plant in a manner that results in a change (e.g., increase or decrease) in plant fitness.

As used herein, the term “therapeutic agent” refers to an agent that can act on an animal, e.g., a mammal (e.g., a human), an animal pathogen, or a pathogen vector, such as an antifungal agent, an antibacterial agent, a virucidal agent, an anti-viral agent, an insecticidal agent, a nematicidal agent, an antiparasitic agent, or an insect repellent.

As used herein, the term “formulated for delivery to a plant” refers to an NLP composition that includes an agriculturally acceptable carrier. As used herein, an “agriculturally acceptable” carrier is one that is suitable for use in agriculture without undue adverse side effects to the plants, the environment, or to humans or animals who consume the resulting agricultural products derived therefrom commensurate with a reasonable benefit/risk ratio. Non-limiting examples of agriculturally acceptable carriers or excipients are known in the art; see, e.g., the Compendium of Herbicide Adjuvants.

As defined herein, the term “nucleic acid” and “polynucleotide” are interchangeable and refer to RNA or DNA that is linear or branched, single or double stranded, or a hybrid thereof, regardless of length (e.g., at least 2, 3, 4, 5, 6, 7, 8, 9, 10, 20, 30, 40, 50, 100, 150, 200, 250, 500, 1000, or more nucleic acids). The term also encompasses RNA/DNA hybrids. Nucleotides are typically linked in a nucleic acid by phosphodiester bonds, although the term “nucleic acid” also encompasses nucleic acid analogs having other types of linkages or backbones (e.g., phosphoramide, phosphorothioate, phosphorodithioate, O-methylphosphoroamidate, morpholino, locked nucleic acid (LNA), glycerol nucleic acid (GNA), threose nucleic acid (TNA), and peptide nucleic acid (PNA) linkages or backbones, among others). The nucleic acids may be single-stranded, double-stranded, or contain portions of both single-stranded and double-stranded sequence. A nucleic acid can contain any combination of deoxyribonucleotides and ribonucleotides, as well as any combination of bases, including, for example, adenine, thymine, cytosine, guanine, uracil, and modified or non-canonical bases (including, e.g., hypoxanthine, xanthine, 7-methylguanine, 5,6-dihydrouracil, 5-methylcytosine, and 5 hydroxymethylcytosine).

As used herein, the term “pest” refers to organisms that cause damage to plants or other organisms, are present where they are not wanted, or otherwise are detrimental to humans, for example, by negatively impacting human agricultural methods or products. Pests may include, for example, invertebrates (e.g., insects, nematodes, or mollusks), microorganisms (e.g., phytopathogens, endophytes, obligate parasites, facultative parasites, or facultative saprophytes), such as bacteria, fungi, oomycetes, or viruses; or weeds.

As used herein, the term “pesticidal agent” or “pesticide” refers to an agent, composition, or substance therein, that controls or decreases the fitness (e.g., kills or inhibits the growth, reduces fecundity, proliferation, division, reproduction, or spread) of an agricultural, environmental, or domestic/household pest, such as an insect, mollusk, nematode, fungus, bacterium, weed, or virus. Pesticides are understood to encompass naturally occurring or synthetic insecticides (larvicides or adulticides), insect growth regulators, acaricides (miticides), molluscicides, nematicides, ectoparasiticides, bactericides, fungicides, or herbicides. The term “pesticidal agent” may further encompass other bioactive molecules such as antibiotics, antivirals pesticides, antifungals, antihelminthics, nutrients, and/or agents that stun or slow insect movement.

As used herein, the term “repellent” refers to an agent, composition, or substance therein, that deters pests from approaching or remaining on a plant. A repellent may, for example, decrease the number of pests on or in the vicinity of a plant, but may not necessarily kill or decrease the fitness of the pest.

As used herein, the term “peptide,” “protein,” or “polypeptide” encompasses any chain of naturally or non-naturally occurring amino acids (either D- or L-amino acids), regardless of length (e.g., at least 2, 3, 4, 5, 6, 7, 10, 12, 14, 16, 18, 20, 25, 30, 40, 50, 100, or more amino acids), the presence or absence of post-translational modifications (e.g., glycosylation or phosphorylation), or the presence of, e.g., one or more non-amino acyl groups (for example, sugar, lipid, etc.) covalently linked to the peptide, and includes, for example, natural proteins, synthetic, or recombinant polypeptides and peptides, hybrid molecules, peptoids, or peptidomimetics.

As used herein, “percent identity” between two sequences is determined by the BLAST 2.0 algorithm, which is described in Altschul et al., (1990) J. Mol. Biol. 215:403-410. Software for performing BLAST analyses is publicly available through the National Center for Biotechnology Information.

As used herein, the term “plant” refers to whole plants, plant parts, plant organs, plant tissues, seeds, plant cells, seeds, and progeny of the same. Plant cells include, without limitation, cells from seeds, suspension cultures, embryos, meristematic (e.g. meristem) regions, callus tissue, leaves, roots, shoots, gametophytes, sporophytes, pollen, and microspores. Plant parts include differentiated and undifferentiated tissues including, but not limited to the following: roots, stems, shoots, leaves, pollen, seeds, fruit, harvested produce, tumor tissue, sap (e.g., xylem sap and phloem sap), and various forms of cells and culture (e.g., single cells, protoplasts, embryos, and callus tissue).

As used herein, the term “NLPs” refers to a composition including a plurality of nature-derived lipid particles, wherein the NLPs comprise at least one phospholipid (e.g. phosphatidyl choline), at least one non-polar lipid (e.g. lemon oil), at least one surface modifier (e.g., a pegylated compound). In some embodiments, the NLP further comprises a co-solvent (e.g., DCM). In some embodiments, NLPs further comprise an excipient. In some embodiments, NLPs further comprise a heterologous functional agent. In some embodiments, the NLP encapsulates the heterologous functional agent. The NLPs may be modified in vitro or in vivo, e.g. in planta. As used herein the term “soil mobility” refers to the potential of an agent, e.g. an NLP, a heterologous functional agent, or an NLP comprising a heterologous functional agent, to move in soil from the site of application to a location in the soil at a distance (e.g., 1 mm, 5 mm, 1 cm, 5 cm, 10 cm, 15 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm, 95 cm, 1 meter, 1.5 meters, 2 meters, 2.5 meters, 3 meters, 3.5 meters, 4 meters, 4.5 meters, 5 meters, etc.) from the site of application. If a component is mobile in soil, it means that the component generally moves freely through soil to at least reach a position distant from the site of application. The site distant from the site of application can be, e.g. anywhere from about, 1 mm, 1 cm, 10 cm, 50 cm, 1 meter or 5 meter from the site of application.

As used herein “soil affinity” refers to the attraction of a component to the soil, e.g., between a positively charged heterologous functional agent and a negatively charged component in soil. Typically, affinity is the result of a state of equilibrium between association and dissociation constants, and can be quantitated with an affinity constant, where there is an equilibrium between the association and dissociation constant. An affinity may result from, e.g., electrostatic interactions, hydrogen bond formations, hydrophobic interactions, and Van der Waal's interactions, or a combination of those.

As used herein, “leachate” refers to the fraction of NLPs that does not bind to soil upon contacting of the NLP preparation with soil. For example, without being limited by theory, if an NLP preparation is mixed with a soil suspension, and 40% of the preparation does not bind to soil, the 40% is referred to as “the leachate”. Likewise, if an NLP preparation is applied to a column comprising soil, and 40% of the NLP preparation elutes from the column after application of a mobile phase, e.g., artificial rain, then the 40% is said to leach out from the column. Therefore, the eluate is the leachate.

As used herein, the term “soil” or “dirt” refers to a substrate comprising solid matter, gasses and liquids. In some embodiments, solids comprise organic matter (e.g., proteins), minerals (e.g., silicates) microorganisms, and void spaces comprising gases (e.g., oxygen) and liquids (e.g., water). The composition of soil varies depending on its position on the planet. Soil is typically negatively charged, which is attributable to negative charges on materials comprised in soil. The negative charges of soil can be quantified as its “cation-exchange capacity”.

As used herein, “cation exchange capacity” of soil is defined as the amount of positive charges in soil that can be exchanged per mass of soil. The cation exchange capacity can be determined, e.g., by displacing soil-bound cations with a concentrated solution of another cation, e.g. ammonium, and then measuring the displaced cations in solution.

As used herein “encapsulated heterologous functional agent” refers to a heterologous functional agent that is enclosed in or incorporated in another structure, e.g., into an NLP as described herein. In some embodiments, there is no contact between the encapsulated heterologous functional agent with that what surrounds the NLP, e.g. water. In some embodiments, the encapsulated functional agent is provided in an oil. In other embodiments, the encapsulated functional agent is provided in a hydrophilic liquid. In some embodiments, the encapsulated heterologous functional agent is in contact with the NLP core (e.g., a hydrophobic core). In some embodiments, the encapsulated heterologous functional agent is in contact with the phospholipid membrane. In some embodiments, the encapsulated heterologous functional agent is integrated into the phospholipid membrane.

As used herein, the term “encapsulating” refers to the process of incorporating an agent into another entity, e.g., the process of incorporating heterologous functional agent (e.g., deltamethrin) into an NLP. As used herein, “unencapsulated heterologous functional agent” refers to a heterologous agent that is free in solution, e.g., dissolved or dispersed, and able to interact directly with its surroundings, e.g., with soil.

As used herein, the term “cellular uptake” refers to uptake of a NLP or a portion or component thereof (e.g., a heterologous functional agent carried by the NLP) by a cell, such as an animal cell, a plant cell, bacterial cell, or fungal cell. For example, uptake can involve transfer of the NLP or a portion of component thereof from the extracellular environment into or across the cell membrane, the cell wall, the extracellular matrix, or into the intracellular environment of the cell). Cellular uptake of NLPs may occur via active or passive cellular mechanisms. Cellular uptake includes aspects in which the entire NLP is taken up by a cell, e.g., taken up by endocytosis. In embodiments, one or more heterologous functional agents (e.g., polynucleotides, polypeptides, small molecule chemistries, etc.) are exposed to the cytoplasm of the target cell following endocytosis and endosomal escape. In some embodiments, an NLP (e.g., an NLP comprising a charged surface modifier (e.g., a polycarboxylate) has an increased rate of endosomal escape relative to an unmodified NLP. Cellular uptake also includes aspects in which the NLP fuses with the membrane of the target cell. In some embodiments, one or more heterologous functional agents (e.g., polynucleotides, polypeptides, small molecule chemistries, etc.) are exposed to the cytoplasm of the target cell following membrane fusion. In some embodiments, an NLP comprising a surface modifier (e.g., an NLP comprising a PEGylated lipid) has an increased rate of fusion with the membrane of the target cell (e.g., is more fusogenic) relative to an NLP not comprising a surface modifier.

As used herein, the term “cell-penetrating agent” refers to an agent that alters a property (e.g., permeability) of the cell wall, extracellular matrix, or cell membrane of a cell (e.g., an animal cell, a plant cell, a bacterial cell, or a fungal cell) in a manner that promotes increased cellular uptake relative to a cell that has not been contacted with the cell-penetrating agent.

As used herein, the term “NLP” refers to a lipid structure (e.g., a micellar structure, lipid bilayer, unilamellar, multilamellar structure; e.g., a vesicular lipid structure), that is about 5-2000 nm (e.g., at least 5-1000 nm, at least 5-500 nm, at least 400-500 nm, at least 25-250 nm, at least 50-150 nm, or at least 70-120 nm) in diameter including at least one phospholipid (e.g., phosphatidic acid, PA), at least one non-polar lipid (e.g., a triglyceride), and at least one surface modifier (e.g., Atlox500L). In some embodiments, NLPs are produced by applying energy to a mixture of phospholipid, non-polar lipid and surface modifier components provided in organic and aqueous phases. In some embodiments, the surface modifier component may be added after the NLP is formed. Nonlimiting examples of a means of applying energy include one or more of sonication, vortexing, mixing, or heating a mixture of organic solutions and aqueous solutions to form the NLPs. In some embodiments, the NLPs may further be subjected to sonication, freeze/thaw treatment, and/or lipid extrusion, e.g., to reduce the size of the NLPs. In some embodiments, NLPs may be produced using a microfluidic device (such as a NanoAssemblr® IGNITE™ microfluidic instrument (Precision NanoSystems)). Several embodiments relate to an NLP composition comprising between 10% to 100% of its lipids derived from the plant source, e.g., in some embodiments, the NLPs may contain at least 10%, at least 20%, at least 30%, at least 40%, at least 50%, at least 60%, at least 70%, at least 80%, at least 90%, at least 95%, or 100% lipids derived from a plant source. Several embodiments may relate to an NLP as described herein comprising all or a fraction of the lipid species present in a lipid structure of the plant source. In some embodiments, an NLP as described herein may contain at least 10%, at least 20%, at least 30%, at least 40%, at least 50%, at least 60%, at least 70%, at least 80%, at least 90%, or 100% of the lipid species present in a lipid structure from the plant source. In some embodiments, an NLP as described herein may comprise none, a fraction, or all of the protein species present in the lipid structure from the plant source. In some embodiments, an NLP as described herein may comprise 0%, less than 1%, less than 5%, less than 10%, less than 15%, less than 20%, less than 30%, less than 40%, less than 50%, less than 60%, less than 70%, less than 80%, less than 90%, less than 100%, or 100% of the protein species present in a lipid structure from the plant source. In some embodiments, an NLP as described herein may comprise a lipid bilayer. In some embodiments, the lipid composition of the NLP may include 0%, less than 1%, or at least 1%, 2%, 5%, 10%, 15%, 20%, 25%, 30%, 40%, 50%, 60%, 70%, 80%, 90%, 95%, or more than 95% of an exogenous lipid. Nonlimiting example of exogenous lipids include charged lipids (e.g., ionizable and/or cationic lipids). In some embodiments, the exogenous lipid may be a cell-penetrating agent capable of increasing delivery of a heterologous functional agent (e.g., an agricultural or therapeutic agent) by the NLP to a cell, and/or may be capable of increasing loading (e.g., loading efficiency or loading capacity) of a heterologous functional agent (e.g., an agricultural or therapeutic agent) into the NLP. In some embodiments, an NLP as described herein may comprise an exogenous lipid selected from sterols and PEGylated lipids.

NLPs may optionally include additional agents, such as heterologous functional agents, e.g., cell-penetrating agents, pesticidal agents, fertilizing agents, plant-modifying agents, therapeutic agents, polynucleotides, polypeptides, small molecules, etc. In some embodiments, NLPs can carry or associate with one or more heterologous functional agents in a variety of ways to enable delivery of the agent to a target plant, e.g., by encapsulating the heterologous functional agent, incorporation of the heterologous functional agent in the lipid bilayer structure, or association of the heterologous functional agent (e.g., by conjugation) with the surface of the lipid bilayer structure of the NLP. Heterologous functional agents can be incorporated into the NLPs either in vivo (e.g., in planta) or in vitro (e.g., in tissue culture, in cell culture, or synthetically incorporated). In some embodiments, the heterologous functional agent is a pyrethroid. Pyrethroids are hydrophobic agents that have high affinity for soil and sediment particulate matter. The affinity of pyrethroids to soil is believed to be primarily due to their non-polar nature and lack of water solubility. When pyrethroids are dispersed in water they have a tendency to bind to natural organic matters, e.g. proteins and clay components, found in soils. Consequently, pyrethroids have a low mobility within the soil. General information about specific pyrethroid solid persistence and mobility can be found in the General and Technical Fact Sheets from the National Pesticide Telecommunications Network; the e-pesticide manual, Ver. 5. British Crop Protection Council; and Laskowski DA, “Physical and Chemical Properties of Pyrethroids,” Rev. Environ. Contam. Toxicol. 2002; 174:49-170, which is hereby incorporated by reference.

As used herein, the term “surface modifier” refers to a compound that is capable modifying one or more characteristics of the NLP. In some embodiments, an NLP as described herein may comprise one or more surface modifiers affecting the surface characteristics of the NLP (e.g., the zeta potential of the NLP). In some embodiments, the surface modifier affects the mobility of the NLP (or of a heterologous functional agent comprised in the NLP) in soil. In some embodiments, the surface modifier modifies the interaction of the NLP with any one of the components in soil as compared to an NLP not comprising a surface modifier. In some embodiments, the surface modifier increases the binding of an NLP to a plant or a plant part compared to an NLP not comprising the surface modifier. In some embodiments, the surface modifier increases the biodistribution of a heterologous functional agent comprised in the NLP upon contacting of a plant or plant part with the NLP as compared to the biodistribution of a heterologous agent comprised in an NLP not comprising the surface modifier. In some embodiments, an NLP as described herein comprises Atlox 500L as a surface modifier which alters binding of NLP (or of a heterologous functional agent comprised in the NLP) to soil. In some embodiments, the surface modifier confers charge to a NLP, e.g., renders a NLP more negatively charged or more positively charged. In some embodiments, the surface alters the zeta potential of the NLP as compared to an NLP not comprising the surface modifier. In some embodiments, the zeta potential predicts the binding characteristics of an NLP for soil. In some embodiments, the surface modifier is an amphiphilic molecule. In some embodiments, the surface modifier is a zwitterionic agent. In some embodiments the surface modifier is a cationic agent, e.g., a cationic lipid. In some embodiments, the surface modifier is an anionic polymer, e.g., a polycarboxylate. In some embodiments, the surface modifier is a lipoid compound with glycosylated moieties attached, e.g., a rhamnolipid, a sophorolipid, etc. In some embodiments, the surface modifier comprises a group (e.g., a head group) that is charged (e.g., is cationic or anionic) or that can be ionized under a given condition (e.g., pH) to produce one or more electrically charged species. Nonlimiting examples of surface modifiers affecting soil mobility of an NLP as described herein are rhamnolipids, sophorolipids, PEG2000-C18, PEG5000-C18, Atlox 500L, Atlox 4917, and Atlox CS100B.

As used herein “co-solvent” refers to an agent that helps to dissolve a heterologous functional agent. For example, DCM is a co-solvent, and helps to dissolve deltamethrin in an organic (hydrophobic) phase. In some embodiments, a co-solvent may be selected from the group consisting of a fatty acid methyl ester, a non-ionic emulsifier, propylene glycol, ethyl lactate, a non-ionic block copolymer surfactant, or a nonionic polyalkylene glycol ether. In some embodiments, the co-solvent is dichloromethane (DCM). In some embodiments, the co-solvent is isopropyl myristate (IPM). In some embodiments, the co-solvent is an emulsifier. In some embodiments, the addition of the co-solvent during NLP production enhances the solubility of the heterologous functional agent by a factor of at least 2-fold, 3-fold, 4-fold, 5-fold, 10-fold, 20-fold, 30-fold, 40-fold, 50-fold, 60-fold, 70-fold, 80-fold, 90-fold, or 100-fold fold as compared to the solubility of the heterologous functional agent in an NLP produced without the addition of the co-solvent.

As used herein, the term “stable NLP composition” (e.g., a composition including loaded or non-loaded NLPs) refers to an NLP composition that over a period of time (e.g., at least 24 hours, at least 48 hours, at least 1 week, at least 2 weeks, at least 3 weeks, at least 4 weeks, at least 30 days, at least 60 days, or at least 90 days) retains at least 5% (e.g., at least 5%, 10%, 15%, 20%, 25%, 30%, 35%, 40%, 45%, 50%, 55%, 60%, 65%, 70%, 75%, 80%, 85%, 90%, 95%, or 100%) of the initial number of NLPs (e.g., NLPs per mL of solution) relative to the number of NLPs in the NLP starting material (e.g., at the time of production or formulation) optionally at a defined temperature range (e.g., a temperature of at least 24° C. (e.g., at least 24° C., 25° C., 26° C., 27° C., 28° C., 29° C., or 30° C.), at least 20° C. (e.g., at least 20° C., 21° C., 22° C., or 23° C.), at least 4° C. (e.g., at least 5° C., 10° C., or 15° C.), at least −20° C. (e.g., at least −20° C., −15° C., −10° C., −5° C., or 0° C.), or −80° C. (e.g., at least −80° C., −70° C., −60° C., −50° C., −40° C., or −30° C.)); or retains at least 5% (e.g., at least 5%, 10%, 15%, 20%, 25%, 30%, 35%, 40%, 45%, 50%, 55%, 60%, 65%, 70%, 75%, 80%, 85%, 90%, 95%, or 100%) of its activity (e.g., cell wall penetrating activity and/or pesticidal and/or repellent activity) relative to the initial activity of the NLP (e.g., at the time of production or formulation) optionally at a defined temperature range (e.g., a temperature of at least 24° C. (e.g., at least 24° C., 25° C., 26° C., 27° C., 28° C., 29° C., or 30° C.), at least 20° C. (e.g., at least 20° C., 21° C., 22° C., or 23° C.), at least 4° C. (e.g., at least 5° C., 10° C., or 15° C.), at least −20° C. (e.g., at least −20° C., −15° C., −10° C., −5° C., or 0° C.), or −80° C. (e.g., at least −80° C., −70° C., −60° C., −50° C., −40° C., or −30° C.)).

As used herein, the term “untreated” refers to a plant, animal, fungus, or bacterium that has not been contacted with or delivered a NLP composition as described herein, including a separate plant, animal, fungus, or bacterium that has not been delivered the NLP composition, the same plant, fungus, or bacterium undergoing treatment assessed at a time point prior to delivery of the NLP composition, or the same plant, fungus, or bacterium undergoing treatment assessed at an untreated part of the plant, animal, fungus, or bacterium.

As described herein, the term “hydrophobic core” refers to the most inner part of an NLP that is hydrophobic in nature. In some embodiments, the hydrophobic core comprises one or more non-polar, non-liposome forming lipids (e.g., triglycerides). In some embodiments, a hydrophobic agent (e.g., deltamethrin) is dissolved in the hydrophobic core. In some embodiments, the hydrophobic core comprises traces of a co-solvent (e.g., DCM) used during NLP production. In some embodiments, the NLP comprises in its hydrophobic core a hydrophobic dye (e.g., Exalite 594). Several embodiments relate to an NLP having a hydrophobic core encapsulated by an outer phospholipid-comprising monolayer, wherein the fatty acid chains of the phospholipids face inwards and are in contact with the hydrophobic core. In some embodiments, the fatty acid chains are part of the hydrophobic core.

As described herein, the term “hydrophilic core” refers to the most inner part of an NLP that is polar in nature. In some embodiments, the hydrophilic core is aqueous in nature (e.g., water, or a salt solution in water). In some embodiments, the hydrophilic core comprises agents that are water soluble, e.g., a polynucleotide, a polypeptide, a hydrophilic small molecule, etc. Several embodiments relate to an NLP having a hydrophilic core encapsulated by a phospholipid bilayer, wherein the phosphorylated head groups of the phospholipids that form the inner phospholipid layer of the bilayer are in contact the hydrophilic core.

### I. NLP Composition and Characteristics

### A. NLP Composition

Several embodiments relate to an NLP composition wherein the composition comprises at least one phospholipid, at least one non-polar lipid, and at least one surface modifier, and wherein the NLP has a hydrophobic core. In some embodiments, the NLP composition further comprises a co-solvent. In some embodiments, the NLP composition further comprises one or more excipients. In some embodiments, the NLP composition further comprises one or more heterologous functional agents. In some embodiments, the heterologous functional agent is a hydrophobic agent. In some embodiments, the hydrophobic heterologous functional agent is a pesticide (e.g. deltamethrin). In some embodiments the NLP composition further comprises a dye. In some embodiments, the NLP composition comprises a lipid layer isolated from a natural source (e.g., naturally occurring phospholipids), semi-synthetic or fully synthetic lipid.

### a) Phospholipids (PL)

Several embodiments relate to an NLP composition comprising at least one phospholipid. In some embodiments, the phospholipids in the NLP form one or more phospholipid layers (e.g., a phospholipid monolayer, a phospholipid bilayer, etc.). In some embodiments, the phospholipids form a micellar structure with a hydrophilic core surrounded by a phospholipid bilayer. In some embodiments, the NLP comprises several layers of phospholipid layers akin to the layers of an onion. In some embodiments, the NLPs are sealed structure in the micron and submicron range dispersed in an aqueous solution. In some embodiments, NLPs comprise one or more bilayers (lamellae) separating the external aqueous solution from the internal phase, or the “core”. In some embodiments, the core is hydrophobic. In other embodiments, the core is hydrophilic. In some embodiments, the one or more phospholipid layers (e.g., a monolayer, a bilayer, etc.) comprises one or more amphipathic agents. Amphipathic agents comprise both polar and apolar regions. When amphipathic agents are present in an aqueous phase, they self-aggregate such that their hydrophilic moiety faces the aqueous phase, while their hydrophobic domain is “protected” from the aqueous phase. In some embodiments, an NLP may comprise a phospholipid bilayer wherein the hydrophobic domains face each other. In some embodiments, an NLP may comprise a phospholipid monolayer, wherein the hydrophobic domains face the hydrophobic core of the NLP. In some embodiments, NLPs are formed by organizing amphipathic agents, e.g., phospholipids, in a lamellar phase wherein the lamellae form closed structures and organize into vesicles.

Several embodiments relate to an NLP composition used as a carrier to facilitate movement of a heterologous functional agent through soil. In some embodiments, an NLP composition comprising two or more types of liposomes are used to facilitate movement of a heterologous functional agent through soil. In some embodiments, the liposomes can be any one or combination of vesicles selected from the group consisting of small unilamellar vesicles (SUV), large unilamellar vesicles (LUV), multilamellar vesicles (MLV), multivesicular vesicles (MVV), large multivesicular vesicles ((LMVV), also referred to, at times, by the term giant multivesicular vesicles, (“GMV”)), oligolamellar vesicles (OLV), and others.

Several embodiments relate to NLP compositions comprising at least one phospholipid, at least one of which is a liposome forming phospholipid. Without being limited by theory, the amount of phospholipids in the NLP can be determined as organic phosphorous by the modified Bartlett method (Shmeeda H, Even-Chen S, Honen R, Cohen R, Weintraub C, Barenholz Y. 2003. Enzymatic assays for quality control and pharmacokinetics of liposome formulations: comparison with nonenzymatic conventional methodologies. Methods Enzymol 367:272-92).

In some embodiments, the NLP compositions comprise at least one phospholipid selected from glycerophospholipids and sphingomyelins. The glycerophospholipids have a glycerol backbone wherein at least one, preferably two, of the hydroxyl groups at the head group is substituted by one or two hydrocarbon tails (chains), typically, an acyl, alkyl or alkenyl tails, and the third hydroxyl group is substituted by a phosphate (phosphatidic acid) or a phospho-ester such as phosphocholine group (as exemplified in phosphatidylcholine), being the polar head group of the glycerophospholipid or combination of any of the above, and/or derivatives of same and may contain a chemically reactive group (such as an amine, acid, ester, aldehyde or alcohol). Examples of glycerophospholipids include, but are not limited thereto, phosphatidylglycerols (PG) including dimyristoyl phosphatidylglycerol (DMPG); phosphatidylcholine (PC), including egg yolk phosphatidylcholine, soybean PC, sunflower PC, rapeseed PC, krill PC, canola PC, flax seed lecithin, wheat lecithin, dimyristoyl phosphatidylcholine (DMPC, Tm 24° C.), 1-palmitoyl-2-oleoylphosphatidyl choline (POPC), hydrogenated soy phosphatidylcholine (HSPC, Tm 65° C.), distearoylphosphatidylcholine (DSPC, Tm 55° C.); di-lauroyl-sn-glycero-2phosphocholine (DLPC); 1,2-dipalmitoyl-sn-glycero-3-phosphocholine (DPPC, Tm 41° C.); 1,2-dinonadecanoyl-sn-glycero-3-phosphocholine; 1,2-diarachidoyl-sn-glycero-3-phosphocholine (DBPC); 1,2-dihenarachidoyl-sn-glycero-3-phosphocholine; 1,2-dibehenoyl-sn-glycero-3-phosphocholine 1,2-ditricosanoyl-sn-glycero-3-phosphocholine 1,2-dilignoceroyl-sn-glycero-3-phosphocholine; 1-myristoyl-2-stearoyl-sn-glycero-3-phosphocholine; 1-palmitoyl-2-stearoyl-sn-glycero-3-phosphocholine (PSPC); 1-stearoyl-2-palmitoyl-sn-glycero-3-phosphocholine (SPPC); 1,2-di-oleoyl-sn-glycero-3-phosphocholine (DOPC-1.7° C.); phosphatidic acid (PA), phosphatidylinositol (PI), phosphatidylserine (PS), phosphatidylethanolamine (PE). The sphingomyelins consist of a ceramide (N-acyl sphingosine) unit having a phosphocholine moiety attached to position 1 as the polar head group. The term “sphingomyelin” or “SPM” as used herein denotes any N-acetyl sphingosine conjugated to a phosphocholine group, the later forming the polar head group of the sphingomyelin (N-acyl sphingosyl phospholcholines). The acyl chain bound to the primary amino group of the sphingosine (to form the ceramide) may be saturated or unsaturated, branched or unbranched.

In some embodiments, an NLP composition comprises a phospholipid having one or two C14 to C24 hydrocarbon tails (e.g., acyl, alkyl or alkenyl chain) with varying degrees of saturation, from being fully saturated to being fully, partially or non-hydrogenated lipids. In some embodiments, natural phospholipids may be further converted to saturated phospholipids by means of hydrogenation or further treated with enzymes to, e.g., remove partially fatty acids (e.g. using phospholipase A2) or to convert a polar head group (e.g. using phospholipase D). The saturated phospholipids are considered as natural phospholipids because the resulting saturated lipids are also occurring in nature (e.g., natural identical).

In some embodiments, the NLP composition comprises at least one phospholipid comprising a polar head group. In some embodiments, the polar head group comprises an alcohol moiety. In some embodiments, the polar head group is one comprising a serine moiety. In some embodiments, the polar head group is one comprising a choline moiety. In some embodiments, the polar head group is one comprising ethanolamine. In some embodiments, the polar head group is one comprising glycerol.

In some embodiments, an NLP composition comprises at least one phospholipid comprising a polar inositol head group. In some embodiments, the phospholipid comprising an inositol head group is selected from the group consisting of phospatidylinositol (PI), PI(4)P, PI(3)P, PI(3,4,5)P3, PI(4,5)P2, PI(3,5)P2, and PI(3,4)P2. In some embodiments, at least one phospholipid has an acidic head group. In some embodiments, the acidic head group comprises a moiety selected from the group consisting of glycerol, hydroxyl, carboxyl, amine, and phosphoric group.

In some embodiments, an NLP composition comprises at least one acidic phospholipids include natural or synthetic lipid selected from phosphatidylglycerols (PGs) such as dilauroylphosphatidylglycerol (DLPG), dimyristoylphosphatidylglycerol (DMPG), dipalmitoylphosphatidylglycerol (DPPG), distearoylphosphatidylglycerol (DSPG), dioleoylphosphatidylglycerol (DOPG), egg yolk phosphatidylglycerol (egg yolk PG), hydrogenated egg yolk phosphatidylglycerol; phosphatidylinositols (PIS) such as phosphatidylinositol, dimyristoylphosphatidylinositol, dipalmitoylphosphatidylinositol (DPPI), distearoylphosphatidylinositol (DSPI), dioleoylphosphatidylinositol (DOPI), soybean phosphatidylinositol (soybean PI), hydrogenated soybean phosphatidylinositol, phosphoinositides, sphingomyelin and phosphatidic acid. Each of these acidic phospholipids can be used alone or in combination of two or more in the NLPs of the presented disclosure.

In some embodiments, the at least one phospholipid in the NLPs is derived from lecithin. Lecithin is described in the United States Pharmacopoeia (USP) as a complex mixture of acetone-insoluble phosphatides, which consists chiefly of PC, PE, phosphatidylserine, and phosphatidylinositol, combined with various amounts of other substances such as triglycerides, fatty acids, and carbohydrates, as separated from the crude vegetable oil source.

In some embodiments, about 5%-50% (w/w) of the lipids in an NLP composition is phospholipid (e.g., about 10%-20% of the lipids in an NLP composition is phospholipid, e.g., about 10%, 12.5%, 16%, or 20% of the lipids in an NLP composition is phospholipid). In some embodiments, about 30%-75% (e.g., about 35% or about 50% phospholipid) of the lipids in an NLP composition is phospholipid. In some embodiments, about 35%-50% (e.g., about 36%, 36.5%, 37%, 37.5%, 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5%) of the lipids in an NLP composition is phospholipid.

In some embodiments, the phospholipids are selected from the group consisting of Crude lemon lipids, purified lemon phospholipids, phosphatidylethanolamine (PE), LIPOID H PS 70 (Phosphatidylserine), 14C-PA (Phosphatidic acid), LIPOID H90 (Phosphatidylcholine), Sunflower lecithin, Soybean lecithin, and De-oiled soybean lecithin.

### b) Non-Polar Lipids (NP)

Several embodiments relate to an NLP composition comprising at least one non-polar lipid. A non-polar lipid is understood to be non-amphipathic and non-liposome forming. A non-liposome forming lipid refers to a lipid that does not spontaneously form into a vesicle when brought into an aqueous medium. In some embodiments, the non-polar lipids are derived from natural sources. In some embodiments, the non-polar lipids are derived from plant sources. In some embodiments, an NLP composition comprises one or more natural/plant derived non-polar lipids obtained from vegetable sources like, e.g., seed oil (from soybeans, rape (canola), wheat germ, sunflower, flax, cotton, corn, coconut, arachis, sesame), pulp oil (palm, olive, avocado pulp), desert shrub, tobacco, bean, and carrot. In some embodiments, the non-polar lipids comprise triglycerides that typically each comprise at least one fatty acid selected from the group consisting of C6:0, C8:0, C10:0, C12:0, C14:0, C15:0, C16:0, C17:0, C18:0, C20:0, C22:0, and C24:0, saturated fatty acids are selected from C16:1 (n-7), C16:1 (n-9), C17:1 (n-7), C18:1 (n-7), C20:1 (n-7), C20:1 (n-9), C22:(n-9) and C24:1 (n-9), and mono-unsaturated fatty acids C18:2 (n-6), C18:3 (n-3), C18:3 (n-6), C18:4 (n-3), C20:2 (n-6), C20:3 (n-6), C20:4 (n-6), C20:5 (n-3), C22:2 (n-6), and C22:4 (n-6). The types of fatty acid profiles of 80 vegetable oils are described by Dubois et al., Eur. J. Lipid Sci. Technol. 109 (2007) 710-732, which is incorporated herein by reference.

In some embodiments, an NLP composition comprises a non-polar lipid comprising 40% of at least one fatty acid chain selected from the group consisting of a poly-unsaturated fatty acid; a mono-unsaturated fatty acid, and a saturated fatty acid. In some embodiments, an NLP composition comprises at least 1%, 5%, 10%, 15%, 20%, 25%, 30%, 35%, 40%, 45%, 50%, 55%, 60%, or more than 60% (w/w) oil (e.g., soy bean oil), e.g., 1%-10%, 10%-20%, 20%-30%, 30%-40%, 40%-50%, or 50%-60% (w/w) soybean oil. In some embodiments, an NLP composition comprises a molar ratio of about 35%-50% oil (e.g., soy bean oil), e.g., about 36%, 38.5%, 42.5%, or 46.5% oil. In some embodiments, an NLP composition comprises about 20%-60% oil.

In some embodiments, an NLP composition comprises one or more lipids that do not spontaneously vesiculate yet can be incorporated into vesicles. Nonlimiting examples of non-vesiculating lipids include, sterols, sphingolipids (e.g., sphingomyelin), lipoproteins. In some embodiments, the NLP composition comprises one or more sterols selected from the group consisting of β-sitosterol, β-sitostanol, stigmasterol, stigmastanol, campesterol, campestanol, ergosterol, avenasterol, brassicasterol, fucosterol, cholesterol (CHOL), cholesteryl hemisuccinate, and cholesteryl sulfate any combination of two or more of these sterols. In some embodiments, the sterol is a plant derived sterol (e.g., phytosterol). In the NLP composition comprises one or more phytosterols selected from the group consisting of β-sitosterol, β-sitostanol, stigmasterol, stigmastanol, campesterol, campestanol, ergosterol, avenasterol, brassicasterol and any combination of two or more of these sterols. In some embodiments, the NLP composition comprises one or more phytosterols selected from the group consisting of β-sitosterol, stigmasterol, and ergosterol.

In some embodiments, an NLP composition comprises one or more lipid membranes comprising a mole ratio between phospholipids and non-polar lipids between 10%:90% to 90%:10%, at times, a mole ratio of between 20%:80% to 80%:20%, at times, a mole ratio between 30%:70% to 70%:30%, at times, a mole ratio between 20%:80% to 50%:50%, at times, a mole ratio of between 20:80 to 40%:60%.

In some embodiments the non-polar lipids are selected from the group consisting of sunflower oil canola oil, soybean oil, olive oil, coconut oil, and purified lemon lipids.

### c) Surface Modifiers

Several embodiments relate to an NLP composition comprising at least one surface modifier, wherein the at least one surface modifier alters the mobility of an NLP composition through soil as compared to an NLP composition not comprising the surface modifier. In some embodiments, the surface modifier stabilizes an NLP composition. An NLP composition as described herein may comprise (e.g., be loaded with, encapsulate, be conjugated to) or be formulated with (e.g., be suspended or resuspended in a solution comprising) one or more surface modifiers. In some embodiments, the surface modifier affects the binding of any of the constituents of the NLP composition to any components present in soil. In some embodiments, one or more surface modifiers are integrated into one or more of the phospholipid layers of the NLP. In some embodiments, an NLP composition comprises at least one surface modifier selected from Table 1. In some embodiments, an NLP composition comprises at least two, three, four, five or more surface modifiers selected from Table 1.

In some embodiments, an NLP composition comprises at least 1%, 5%, 10%, 20%, 30%, 40%, 50%, 60%, 70%, 80%, 90%, or more than 90% of one or more surface modifiers. In some embodiments, an NLP composition comprises a weight/weight ratio of at least 0.1%, 1%, 5%, 10%, 15%, 20%, 25%, 30%, 35%, 40%, 45%, 50%, 55%, 60%, 65%, 70%, 75% 80%, 85%, 90%, or more than 90% of a synthetic chemical surface modifier (e.g., a pegylated compound, a polycarboxylate, etc.). In some embodiments, an NLP composition comprises a weight/weight ratio of at least 1%-10%, 10%-20%, 20%-30%, 30%-40%, 40%-50%, 50%-60%, 60%-70%, 70%-80%, or 80%-90% of one or more surface modifiers (e.g., a polycarboxylate). In some embodiments, an NLP composition comprises a weight/weight ratio of at least about 30%-75% of a polycarboxylate surface modifier. In some embodiments, the NLPs contain up to 5 mole % surface modifier. In some embodiments, an NLP composition comprises between about 0.1 mole % to 5 mole %, between about 0.5 mole % to 4 mole %, between about 1 mole % to 3 mole % of one or more surface modifiers. In some embodiments, an NLP composition comprises 25% Atlox 500L. In some embodiments, an NLP composition comprises a molar ratio of 35% Atlox 500L. In some embodiments, an NLP composition comprises a molar ratio of 50% Atlox 500L.

Several embodiments relate to an NLP composition comprising one or more surface modifiers that affect the mobility of the NLP composition in soil. In some embodiments, the surface modifier is a synthetic compound that affects the mobility of an NLP composition in soil, wherein the NLP composition optionally comprises a heterologous functional agent. In some embodiments, the surface modifier alters one or more surface characteristics of an NLP composition. In some embodiments, a surface modifier structurally alters the NLP, e.g., by adding a chemical group to the exterior surface of the NLP. In some embodiments, an NLP composition comprises a glycolipid moiety exposed at the external surface of the NLP composition. In some embodiments, an NLP composition comprises at least one glycoprotein embedded in the outer surface of the NLP composition. In some embodiments, at least a portion of the surface modifier is integrated into a lipid membrane of the NLP, e.g., a lipoid domain that is embedded into the phospholipid membrane. In some embodiments, at least a portion of the surface modifier is exposed to the outside of the NLP, facing e.g., the air, the soil, or a solution in which the NLPs are dispersed. In some embodiments, the surface modifier is an emulsifier. In some embodiments, the surface modifier is amphipathic in nature, e.g., comprises a hydrophobic part and a hydrophilic part chemically connected in one molecule. In some embodiments, the surface modifier is a surfactant. In some embodiments, the surface modifier affects the surface charge of an NLP, e.g., by making the surface charge of an NLP more or less negative in charge. In some embodiments, the surface charge of an NLP is expressed as the zeta potential of the NLP. In some embodiments, the surface charge of the NLP affects the affinity of the NLP for charged matrix. In some embodiments, the charged matrix is soil. In some embodiments, the surface charge affects the affinity of the NLP for one or more components present in soil (e.g. sillicates, clay, biological components, etc.). In some embodiments, the surface charge of the NLP affects the mobility of NLPs in soil. In some embodiments, the zeta potential predicts the retention of an NLP in soil. In some embodiments, the zeta potential predicts the mobility of an NLP in soil. In some embodiments, an NLP composition comprises at least one surface modifier selected from Table 1 that affects mobility of the NLP composition in soil. In some embodiments, an NLP composition comprises at least two, three, four, five or more surface modifiers selected from Table 1 that affect the mobility of the NLP composition in soil.

Several embodiments relate to an NLP composition comprising one or more surface modifiers that increase uptake of the NLP composition by a plant or plant part (e.g., root, leaf, plant cell, etc.). In some embodiments, the one or more surface modifiers increase the uptake of the NLP composition as a whole. In some embodiments, the one or more surface modifiers increase the uptake of a portion or component of the NLP composition, such as the uptake of a heterologous functional agent (e.g., a heterologous agricultural agent (e.g., pesticidal agent, fertilizing agent, herbicidal agent, plant-modifying agent, plant growth promoting agent, biostimulants, or plant immunity elicitors) carried by the NLP. The degree to which uptake is increased may vary depending on the plant or plant part to which the NLP composition is delivered. In some embodiments, one or more surface modifiers may increase uptake of an NLP composition by a plant or plant part by at least 1%, 2%, 5%, 10%, 15%, 20%, 30%, 40%, 50%, 60%, 70%, 80%, 90%, or 100% relative to an NLP composition lacking the one or more surface modifiers. In some embodiments, one or more surface modifiers may increase uptake of an NLP composition by a plant or plant part by at least 2×-fold, 4×-fold, 5×-fold, 10×-fold, 100×-fold, or 1000×-fold relative to an NLP composition lacking the one or more surface modifiers. In some embodiments, an NLP composition comprises at least one surface modifier selected from Table 1 that increases uptake of the NLP composition in a plant or plant part. In some embodiments, an NLP composition comprises at least two, three, four, five or more surface modifiers selected from Table 1 that increases uptake of the NLP composition in a plant or plant part.

Several embodiments relate to an NLP composition comprising one or more surface modifiers that increase uptake of the NLP composition by a cell, e.g. a plant cell. In some embodiments, the one or more surface modifiers increase the uptake of the NLP composition as a whole. In some embodiments, the one or more surface modifiers increase the uptake of a portion or component of the NLP composition, such as the uptake of a heterologous functional agent (e.g., a bactericidal agent) carried by the NLP composition. The degree to which uptake is increased may vary depending on the bacterial cell to which the NLP composition is delivered. In some embodiments, one or more surface modifiers may increase uptake of an NLP composition by a bacterial cell by at least 1%, 2%, 5%, 10%, 15%, 20%, 30%, 40%, 50%, 60%, 70%, 80%, 90%, or 100% relative to an NLP composition lacking the one or more surface modifiers. In some embodiments, an NLP composition comprises at least one surface modifier selected from Table 1 that increases uptake of the NLP composition in a bacterial cell. In some embodiments, an NLP composition comprises at least two, three, four, five or more surface modifiers selected from Table 1 that increases uptake of the NLP composition in a bacterial cell.

Several embodiments relate to an NLP composition comprising one or more surface modifiers that increase uptake of the NLP composition by a fungal cell. In some embodiments, the one or more surface modifiers increase the uptake of the NLP composition as a whole. In some embodiments, the one or more surface modifiers increase the uptake of a portion or component of the NLP composition, such as the uptake of a heterologous functional agent (e.g., a fungicidal agent) carried by the NLP composition. The degree to which uptake is increased may vary depending on the fungal cell to which the NLP composition is delivered. In some embodiments, one or more surface modifiers may increase uptake of an NLP composition by a fungal cell by at least 1%, 2%, 5%, 10%, 15%, 20%, 30%, 40%, 50%, 60%, 70%, 80%, 90%, or 100% relative to an NLP composition lacking the one or more surface modifiers. In some embodiments, an NLP composition comprises at least one surface modifier selected from Table 1 that increases uptake of the NLP composition in a fungal cell. In some embodiments, an NLP composition comprises at least two, three, four, five or more surface modifiers selected from Table 1 that increases uptake of the NLP composition in a fungal cell.

In some embodiments, a surface modifier may be an anionic agent, a cationic agent, or a zwitterionic agent. In some embodiments, a surface modifier may be a pegylated compound, a glycolipid, an anionic polymer, a polycarboxylate, a polysaccharide, or any combination thereof. In some embodiments, a surface modifier may be a polysaccharide with lipid chains. In some embodiments, a surface modifier is a pegylated surface modifier selected from the group consisting of a pegylated block copolymer (e.g., poloxamer) or a cocamide derivative. In some embodiments, a surface modifier is a pegylated compound selected from the group consisting of PEG2000-C18 and PEG5000-C18. In some embodiments, a surface modifier is a rhamnolipid. In some embodiments, a surface modifier is a sophorolipid. In some embodiments, a surface modifier is an anionic polymer. In some embodiments, a surface modifier is Atlox 500L. In some embodiments, a surface modifier is an anionic polymer. In some embodiments, a surface modifier is a styrene-acrylic copolymer. In some embodiments, a surface modifier is Atlox 4917. In some embodiments, a surface modifier is a polycarboxylate. In some embodiments, a surface modifier is Atlox CS100B. In some embodiments, a surface modifier is a polysaccharide, such as a C8-C10 alkylpolysaccharide. In some embodiments, the surface modifier is Atlox AL2575. In some embodiments, the surface modifier is an emulsifier. In some embodiments, a surface modifier is selected from the examples of surface modifiers suitable for NLPs production provided in Table 1.

TABLE 1
Surface modifiers

| Description | Class | Surface modifier (examples) |
|---|---|---|
| Rhamnolipid | glycolipid | Rhamnolipids, 95% (90% Di-Rhamnolipid) |
| Sophorolipid | glycolipid | Sophorolipid Biosurfactant SLM |
| Alkyl polysaccharide | Surfactant | Atlox AL 2575 |
| C8-C10 | (non-ionic) | |
| Fatty acid ethoxylate | Surfactant | Ninex MT-615 |
| | (non-ionic) | Toximul 8240 |
| | | Toximul 8241 |
| | | Ninex MT-603 |
| Linear Alcohol | Surfactant | Bio-soft N 411 |
| ethoxylate | (non-ionic) | |
| Cetyl trimethyl | Surfactant | Ammonyx Cetac-30 |
| ammonium chloride | (cationic) | |
| Linear isopropylamine | Surfactant | Bio-soft N91-8 |
| dodecybenzene sulfonate | (anionic) | |
| Tristyrlphenol ethoxylate | Surfactant | Stepfac TSP-PE-K |
| phosphate ester potassium | (anionic) | |
| salt | | |
| Modified styrene acrylic | Polymer | Atlox 4917, |
| co-polymer | | Atlox 500L |
| | | Step-Flow 5000 |
| Hydrophobically modified | Polymer | Atlox CS100b |
| polycarboxylate polymer | | Step-Flow 3000 |
| Non-ionic Acrylic | Polymer | Step-Flow 4000 |
| Copolymer | | |
| Nonionic comb polymer | Polymer | JEFFSPERSE ® X3202 |
| Tristyrlphenol | Polymer | Step-Flow 1500 |
| polyalkylene oxide | | |
| block copolymer | | |
| Head group modified PEG | synthetic | 1,2-distearoyl-sn-glycero-3- |
| Lipids | ethoxylated | phosphoethanolamine-N-[methoxy(polyethylene |
| | phospholipid | glycol)-2000] (ammonium salt), or 1,2-distearoyl- |
| | | sn-glycero-3-phosphoethanolamine-N- |
| | | [methoxy(polyethylene glycol)-2000] (ammonium |
| | | salt) |

In some embodiments, a surface modifier may be a lipopolymer. As used herein, the term lipopolymer refers to a lipid substance modified by inclusion of a hydrophilic polymer in its polar head group. In some embodiments, the polymer head group of the lipopolymer is water-soluble. In some embodiments, the hydrophilic polymer has a molecular weight equal or above 750 Da. There are numerous polymers which may be attached to lipids to form lipopolymers, nonlimiting examples include polyethylene glycol (PEG), polysialic acid, polylactic (also termed polylactide), polyglycolic acid (also termed polyglycolide), apolylactic-polyglycolic acid, polyvinyl alcohol, polyvinylpyrrolidone, polymethoxazoline, polyethyloxazoline, polyhydroxyethyloxazoline, polyhydroxypropyloxazoline, polyaspartamide, polyhydroxypropyl methacrylamide, polymethacrylamide, polydimethylacrylamide, polyvinylmethylether, polyhydroxyethyl acrylate, and derivatized celluloses (e.g., hydroxymethylcellulose, hydroxyethylcellulose, etc.). The polymers may be employed as homopolymers or as block or random copolymers. The lipids derivatized into lipopolymers may be neutral, negatively charged, as well as positively charged.

In some embodiments, the surface modifier is a PEGylated lipid. Polyethylene glycol (PEG) length can vary from 1 kDa to 10 kDa. In some embodiments, an NLP composition comprising one or more PEGylated lipid having a PEG length of 2 kDa. In some embodiments, an NLP composition comprises one or more the PEGylated lipids independently selected from C14-PEG2k, C18-PEG2k, and DMPE-PEG2k. In some embodiments the PEGylated lipid is a PEG5K PEGylated lipid (e.g. C14-PEG5k, C18-PEG5k or DMPE-PEG5K). In some embodiments, an NLP composition comprises a molar ratio of at least 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.5%, 4%, 4.5%, 5%, 10%, 20%, 30%, 40%, 50%, or more than 50% of one or more PEGylated lipids (e.g., C14-PEG2k, C18-PEG2k, C18-PEG5K, DMPE-PEG2k, etc.). In some embodiments, an NLP composition comprises a molar ratio of at least 0.1%-0.5%, 0.5%-1%, 1%-1.5%, 1.5%-2.5%, 2.5%-3.5%, 3.5%-5%, 5%-10%, 10%-20%, 20%-30%, 30%-40%, or 30%-50% of one or more PEGylated lipids. In some embodiments, an NLP composition comprises about 0.1%-10% (w/w) PEGylated lipid (e.g., C14-PEG2k, C18-PEG2k, DMPE-PEG2k, etc.). In some embodiments, an NLP composition comprises about 1%-3% of one or more PEGylated lipids. In some embodiments, an NLP composition comprises about 1.5% of one or more PEGylated lipids. In some embodiments, an NLP composition comprises about 2.5% of one or more PEGylated lipids. In some embodiments, an NLP composition comprising one or more PEGylated lipids has altered mobility in soil relative to an NLP composition not comprising the one or more PEGylated lipids. In some embodiments, an NLP composition comprising one or more PEGylated lipids has altered affinity for soil relative to an NLP composition not comprising the one or more PEGylated lipids.

In some embodiments, an NLP composition comprises one or more phospholipids. In some embodiments, about 5%-50% (w/w) of the lipids in an NLP composition is phospholipid (e.g., about 10%-20% of the lipids in an NLP composition is phospholipid, e.g., about 10%, 12.5%, 16%, or 20% of the lipids in an NLP composition is phospholipid). In some embodiments, about 30%-75% (e.g., about 35% or about 50% phospholipid) of the lipids in an NLP composition is phospholipid. In some embodiments, about 35%-50% (e.g., about 36%, 36.5%, 37%, 37.5%, 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5%) of the lipids in an NLP composition is phospholipid.

In some embodiments, an NLP composition comprises one or more PEGylated lipids. In some embodiments, about 5%-50% (w/w) of the lipids in an NLP composition is PEGylated lipid (e.g., about 10%-20% of the lipids in an NLP composition is PEGylated lipid, e.g., about 10%, 12.5%, 16%, or 20% of the lipids in an NLP composition is PEGylated lipid). In some embodiments, about 30%-75% (e.g., about 35% or about 50% PEGylated lipid) of the lipids in an NLP composition is PEGylated lipid. In some embodiments, about 35%-50% (e.g., about 36%, 36.5%, 37%, 37.5%, 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5%) of the lipids in an NLP composition is PEGylated lipid.

In some embodiments, an NLP composition comprising one or more PEGylated lipids has enhanced uptake relative to an NLP composition not comprising the one or more PEGylated lipids. In some embodiments, an NLP composition comprising one or more PEGylated lipids has altered stability (e.g., increased stability, decreased stability, etc.) relative to an NLP composition that not comprising the one or more PEGylated lipids. In some embodiments, an NLP composition comprising one or more PEGylated lipids has altered particle size relative to an NLP composition not comprising the one or more PEGylated lipids. In some embodiments, an NLP composition comprising one or more PEGylated lipids is less likely to be phagocytosed by a cell than an NLP composition not comprising the one or more PEGylated lipids. In some embodiments, an NLP composition comprises one or more surface modifiers comprising one or more PEG moieties having a molecular weight of the head group from about 750 Da to about 20,000 Da. In some embodiments, an NLP composition comprises one or more surface modifiers comprising one or more PEG moieties having a molecular weight of the head group from about 750 Da to about 12,000 Da. In some embodiments, an NLP composition comprises one or more surface modifiers comprising one or more PEG moieties having a molecular weight of the head group between about 1,000 Da to about 5,000 Da. In some embodiments, an NLP composition comprises one or more neutral (uncharged) lipopolymers. In some embodiments, an NLP composition comprises one or more positively charged lipopolymers. In some embodiments, an NLP composition comprises one or more negatively charged lipopolymers. In some embodiments, an NLP composition comprises one or more neutral distearoyl glycerol and the negatively charged distearoyl phosphatidylethanolamine, both covalently attached to methoxy poly(ethylene glycol) (mPEG or PEG) of Mw 750, 2000, 5000, or 12000.

In some embodiments, a surface modifier is a glycolipid. In some embodiments, one or more glycolipids is a rhamnolipid. In some embodiments, one or more glycolipids is a sophorolipid. In some embodiments, about 5%-50% (w/w) of the lipids in an NLP composition is glycolipid (e.g., about 10%-20% of the lipids in an NLP composition is glycolipid, e.g., about 10%, 12.5%, 16%, or 20% of the lipids in an NLP composition is glycolipid). In some embodiments, about 30%-75% (e.g., about 35% or about 50% glycolipids) of the lipids in an NLP composition is glycolipid. In some embodiments, about 35%-50% (e.g., about 36%, 36.5%, 37%, 37.5%, 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5%) of the lipids in an NLP composition is glycolipid.

In some embodiments, NLPs comprise any of the modifiers (SMs) recited in Table 1. In some embodiments, NLPs comprise any combination non-polar lipids (NPs), polar lipids (PLs) and surface modifiers (SM) recited in Table 2. In some embodiments, NPs, PLs and SMs are mixed at any of the ratios indicated in Table 2, and subjected to any of the methods of making as disclosed herein (e.g. the DCM method, the HHPH method, or the NanoAssemblr® IGNITE™ method) to form lipid nanoparticles, as outlined in the Examples. A person having ordinary skill in the art would know of additional methods to form lipid nanoparticles. Exemplary NLPs that can be produced by any method are recited in Table 2.

TABLE 2
Non-polar lipids (NP) polar lipis (PL) and surface
modifiers (SM) combinations used to produce NLPs

| | | | Surface | Weight |
|---|---|---|---|---|
| | Non-polar lipid | Phospholipid | modifier | ratios of |
| NLP | (NP)^{a} | (PL)^{a} | (SM) | NP:PL:SM |
| NLP018 | Crude Lemon-f | Crude Lemon-f | — | 1:1:0 |
| NLP472 | LemonNP-f | LemonPL-f | — | 1:1:0 |
| NLP485 | LemonNP-f | PS | — | 1:1:0 |
| NLP486 | LemonNP-f | PA | — | 1:1:0 |
| NLP487 | Sunflower | sunflower lecithin | — | 1:1:0 |
| NLP488 | Sunflower | soybean lecithin | — | 1:1:0 |
| NLP492 | Soybean | de-oiled soybean | — | 1:1:0 |
| NLP493 | Canola | PE | — | 1:1:0 |
| NLP494 | Coconut | PC | — | 1:1:0 |
| NLP495 | Soybean | LemonPL-f | — | 1:1:0 |
| NLP496 | Coconut | PS | — | 1:1:0 |
| NLP497 | Coconut | LemonPL-f | — | 1:1:0 |
| NLP498 | Coconut | de-oiled soybean | — | 1:1:0 |
| NLP499 | Sunflower | PC | — | 1:1:0 |
| NLP501 | Sunflower oil | PS | — | 1:1:0 |
| NLP502 | LemonNP-f | PC | — | 1:1:0 |
| NLP503 | Canola | soybean lecithin | — | 1:1:0 |
| NLP504 | LemonNP-f | sunflower lecithin | — | 1:1:0 |
| NLP505 | Canola | PS | — | 1:1:0 |
| NLP506 | Olive oil | LemonPL-f | — | 1:1:0 |
| NLP507 | Olive oil | PS | — | 1:1:0 |
| NLP508 | Soybean | soybean lecithin | Rhamnolipid | 5:4:1 |
| NLP509 | LemonNP-f | LemonPL-f | Rhamnolipid | 5:4:1 |
| NLP510 | Sunflower | PE | Rhamnolipid | 5:4:1 |
| NLP511 | Coconut | soybean lecithin | Rhamnolipid | 5:4:1 |
| NLP512 | Canola | LemonPL-f | Rhamnolipid | 5:4:1 |
| NLP513 | Canola | PS | Rhamnolipid | 5:4:1 |
| NLP514 | Coconut | PS | Rhamnolipid | 5:4:1 |
| NLP515 | LemonNP-f | de-oiled soybean | Rhamnolipid | 5:4:1 |
| NLP516 | Canola | PE | Rhamnolipid | 5:4:1 |
| NLP517 | Soybean | sunflower lecithin | Rhamnolipid | 5:4:1 |
| NLP518 | Sunflower | de-oiled soybean | Rhamnolipid | 5:4:1 |
| NLP519 | Canola | PC | Rhamnolipid | 5:4:1 |
| NLP525 | Canola | soybean lecithin | Rhamnolipid | 5:4:1 |
| NLP526 | LemonNP-f | PC | Rhamnolipid | 5:4:1 |
| NLP527 | Soybean | sunflower lecithin | Rhamnolipid | 5:4:1 |
| NLP528 | LemonNP-f | PE | Rhamnolipid | 5:4:1 |
| NLP529 | Coconut | PE | Rhamnolipid | 5:4:1 |
| NLP530 | Soybean | soybean lecithin | Rhamnolipid | 5:4:1 |
| NLP531 | Canola | LemonPL-f | Rhamnolipid | 5:4:1 |
| NLP532 | Sunflower | de-oiled soybean | Rhamnolipid | 5:4:1 |
| NLP533 | Sunflower | sunflower lecithin | Rhamnolipid | 5:4:1 |
| NLP534 | Soybean | PC | Rhamnolipid | 5:4:1 |
| NLP535 | Coconut | LemonPL-f | Rhamnolipid | 5:4:1 |
| NLP536 | Sunflower | PS | Rhamnolipid | 5:4:1 |
| NLP537 | Canola | de-oiled soybean | Rhamnolipid | 5:4:1 |
| NLP538 | LemonNP-f | sunflower lecithin | Rhamnolipid | 5:4:1 |
| NLP539 | Coconut | de-oiled soybean | Sophoro | 5:4:1 |
| | | | (SLM) | |
| NLP540 | Sunflower | PC | Sophoro | 5:4:1 |
| | | | (SLM) | |
| NLP541 | Sunflower | PA | Rhamnolipid | 5:4:1 |
| NLP542 | LemonNP-f | PA | Rhamnolipid | 5:4:1 |
| NLP543 | Sunflower | PA | Rhamnolipid | 5:4:1 |
| NLP544 | Soybean | PA | Rhamnolipid | 5:4:1 |
| NLP545 | Canola | soybean lecithin | Sophoro | 5:4:1 |
| | | | (SLM) | |
| NLP546 | Canola | PA | Sophoro | 5:4:1 |
| | | | (SLM) | |
| NLP547 | Soybean | LemonPL-f | Sophoro | 5:4:1 |
| | | | (SLM) | |
| NLP548 | Soybean | PC | Sophoro | 5:4:1 |
| | | | (SLM) | |
| NLP549 | LemonNP-f | PS | Sophoro | 5:4:1 |
| | | | (SLM) | |
| NLP550 | Canola | sunflower lecithin | Sophoro | 5:4:1 |
| | | | (SLM) | |
| NLP551 | Sunflower | sunflower lecithin | Sophoro | 5:4:1 |
| | | | (SLM) | |
| NLP552 | LemonNP-f | de-oiled soybean | Sophoro | 5:4:1 |
| | | | (SLM) | |
| NLP553 | Sunflower | PS | Sophoro | 5:4:1 |
| | | | (SLM) | |
| NLP554 | LemonNP-f | soybean lecithin | Sophoro | 5:4:1 |
| | | | (SLM) | |
| NLP555 | Soybean | PE | Sophoro | 5:4:1 |
| | | | (SLM) | |
| NLP556 | Coconut | PA | Sophoro | 5:4:1 |
| | | | (SLM) | |
| NLP557 | Coconut | PE | Sophoro | 5:4:1 |
| | | | (SLM) | |
| NLP558 | Canola | LemonPL-f | Sophoro | 5:4:1 |
| | | | (SLM) | |
| NLP574 | Sunflower | sunflower lecithin | Rhamnolipid | 5:4:1 |
| NLP575 | Sunflower | sunflower lecithin | Rhamnolipid- | 4.6:3.7:91.7 |
| | | | ABG-PJ | |
| NLP576 | Sunflower | sunflower lecithin | 18:0 PE- | 5:4:1 |
| | | | PEG5000 | |
| NLP577 | Sunflower | sunflower lecithin | 18:0 PE- | 5:4:1 |
| | | | PEG2000 | |
| NLP578 | Sunflower | sunflower lecithin | Atlox | 4.6:3.7:91.7 |
| | | | CS100B | |
| NLP579 | Sunflower | sunflower lecithin | Atlox 4917 | 4.6:3.7:91.7 |
| NLP580 | Sunflower | sunflower lecithin | Atlox 500L | 4.6:3.7:91.7 |
| NLP581 | LemonNP-f | LemonPL-f | 18:0 | 5:4:1 |
| | | | PEG2000 PE | |
| NLP582 | Soybean | PS | 18:0 | 5:4:1 |
| | | | PEG2000 PE | |
| NLP583 | Coconut | sunflower lecithin | 18:0 | 5:4:1 |
| | | | PEG2000 PE | |
| NLP584 | Soybean | PC | 18:0 | 5:4:1 |
| | | | PEG2000 PE | |
| NLP585 | Canola | PA | 18:0 | 5:4:1 |
| | | | PEG2000 PE | |
| NLP586 | Sunflower | soybean lecithin | 18:0 | 5:4:1 |
| | | | PEG2000 PE | |
| NLP587 | Sunflower | PE | 18:0 | 5:4:1 |
| | | | PEG2000 PE | |
| NLP588 | Sunflower | LemonPL-f | 18:0 | 5:4:1 |
| | | | PEG2000 PE | |
| NLP589 | Coconut | de-oiled soybean | 18:0 | 5:4:1 |
| | | | PEG2000 PE | |
| NLP590 | LemonNP-f | de-oiled soybean | 18:0 | 5:4:1 |
| | | | PEG2000 PE | |
| NLP591 | LemonNP-f | PA | 18:0 | 5:4:1 |
| | | | PEG2000 PE | |
| NLP592 | Canola | sunflower lecithin | 18:0 | 5:4:1 |
| | | | PEG2000 PE | |
| NLP593 | Canola | PC | 18:0 | 5:4:1 |
| | | | PEG2000 PE | |
| NLP594 | Coconut | soybean lecithin | 18:0 | 5:4:1 |
| | | | PEG2000 PE | |
| NLP595 | Soybean | PE | 18:0 | 5:4:1 |
| | | | PEG2000 PE | |
| NLP596 | LemonNP-f | PS | 18:0 | 5:4:1 |
| | | | PEG2000 PE | |
| NLP597 | Coconut | PE | Atlox 500L | 4.6:3.7:91.7 |
| NLP598 | Coconut | LemonPL-f | Atlox 500L | 4.6:3.7:91.7 |
| NLP599 | Canola | PE | Atlox 500L | 4.6:3.7:91.7 |
| NLP600 | Canola | sunflower lecithin | Atlox 500L | 4.6:3.7:91.7 |
| NLP601 | LemonNP-f | LemonPL-f | Atlox 500L | 4.6:3.7:91.7 |
| NLP602 | Sunflower | PC | Atlox 500L | 4.6:3.7:91.7 |
| NLP603 | Soybean | sunflower lecithin | Atlox 500L | 4.6:3.7:91.7 |
| NLP604 | Coconut | PS | Atlox 500L | 4.6:3.7:91.7 |
| NLP605 | Canola | de-oiled soybean | Atlox 500L | 4.6:3.7:91.7 |
| NLP606 | LemonNP-f | PC | Atlox 500L | 4.6:3.7:91.7 |
| NLP607 | Soybean | soybean lecithin | Atlox | 4.6:3.7:91.7 |
| | | | CS100B | |
| NLP608 | Sunflower | sunflower lecithin | Atlox | 4.6:3.7:91.7 |
| | | | CS100B | |
| NLP609 | Canola | PA | Atlox | 4.6:3.7:91.7 |
| | | | CS100B | |
| NLP610 | Coconut | PC | Atlox | 4.6:3.7:91.7 |
| | | | CS100B | |
| NLP611 | Sunflower | PA | Atlox | 4.6:3.7:91.7 |
| | | | CS100B | |
| NLP612 | Canola | PS | Atlox | 4.6:3.7:91.7 |
| | | | CS100B | |
| NLP613 | Sunflower | PE | Atlox | 4.6:3.7:91.7 |
| | | | CS100B | |
| NLP614 | Soybean | PS | Atlox | 4.6:3.7:91.7 |
| | | | CS100B | |
| NLP615 | LemonNP-f | sunflower lecithin | Atlox | 4.6:3.7:91.7 |
| | | | CS100B | |
| NLP616 | LemonNP-f | PC | Atlox | 4.6:3.7:91.7 |
| | | | CS100B | |
| NLP617 | LemonNP-f | de-oiled soybean | Atlox | 4.6:3.7:91.7 |
| | | | CS100B | |
| NLP618 | LemonNP-f | soybean lecithin | Atlox | 4.6:3.7:91.7 |
| | | | CS100B | |
| NLP619 | Sunflower | LemonPL-f | Atlox | 4.6:3.7:91.7 |
| | | | CS100B | |
| NLP620 | Coconut | soybean lecithin | Atlox | 4.6:3.7:91.7 |
| | | | CS100B | |
| NLP621 | Canola | de-oiled soybean | Atlox | 4.6:3.7:91.7 |
| | | | CS100B | |
| NLP622 | Soybean | LemonPL-f | Atlox | 4.6:3.7:91.7 |
| | | | CS100B | |
| NLP623 | Coconut | PE | Atlox | 4.6:3.7:91.7 |
| | | | CS100B | |
| NLP624 | Soybean | PA | N/A | 1:1:0 |
| NLP625 | Canola | PA | N/A | 1:1:0 |
| NLP626 | Coconut | PS | Atlox AL- | 4.6:3.7:91.7 |
| | | | 2575 | |
| NLP627 | LemonNP-f | LemonPL-f | Atlox AL- | 4.6:3.7:91.7 |
| | | | 2575 | |
| NLP628 | Coconut | PC | Atlox AL- | 4.6:3.7:91.7 |
| | | | 2575 | |
| NLP629 | LemonNP-f | PE | Atlox AL- | 4.6:3.7:91.7 |
| | | | 2575 | |
| NLP630 | Coconut | PA | Atlox AL- | 4.6:3.7:91.7 |
| | | | 2575 | |
| NLP631 | Sunflower | PS | Atlox AL- | 4.6:3.7:91.7 |
| | | | 2575 | |
| NLP632 | Sunflower | soybean lecithin | Atlox AL- | 4.6:3.7:91.7 |
| | | | 2575 | |
| NLP633 | Soybean | PA | Atlox AL- | 4.6:3.7:91.7 |
| | | | 2575 | |
| NLP634 | Canola | PC | Atlox AL- | 4.6:3.7:91.7 |
| | | | 2575 | |
| NLP635 | Canola | de-oiled soybean | Atlox AL- | 4.6:3.7:91.7 |
| | | | 2575 | |
| NLP636 | Coconut | sunflower lecithin | Atlox AL- | 4.6:3.7:91.7 |
| | | | 2575 | |
| NLP637 | Canola | LemonPL-f | Atlox AL- | 4.6:3.7:91.7 |
| | | | 2575 | |
| NLP638 | Soybean | de-oiled soybean | Atlox AL- | 4.6:3.7:91.7 |
| | | | 2575 | |
| NLP639 | Soybean | soybean lecithin | Atlox AL- | 4.6:3.7:91.7 |
| | | | 2575 | |
| NLP640 | Sunflower | PE | Atlox AL- | 4.6:3.7:91.7 |
| | | | 2575 | |
| NLP644 | Sunflower | sunflower lecithin | Atlox 500L | 28:22:50 |
| NLP645 | Sunflower | sunflower lecithin | Atlox 500L | 42:33:25 |
| NLP646 | Sunflower | sunflower lecithin | Atlox 500L | 5:4:1 |
| NLP647 | Sunflower | sunflower lecithin | Atlox | 28:22:50 |
| | | | CS100B | |
| NLP648 | Sunflower | sunflower lecithin | Atlox | 42:33:25 |
| | | | CS100B | |
| NLP649 | Sunflower | sunflower lecithin | Atlox | 5:4:1 |
| | | | CS100B | |
| NLP654 | Sunflower | sunflower lecithin | Atlox 4917 | 28:22:50 |
| NLP655 | Soybean | sunflower lecithin | Atlox 500L | 5:4:1 |
| NLP658 | Sunflower | PE | Atlox | 28:22:50 |
| | | | CS100B | |
| NLP659 | Coconut | soybean lecithin | Atlox | 28:22:50 |
| | | | CS100B | |
| NLP660 | Canola | de-oiled soybean | Atlox | 28:22:50 |
| | | | CS100B | |
| NLP663 | Sunflower | Sunflower lecithin | Atlox 500L | 4.6:3.7:91.7 |
| NLP664 | Sunflower | Sunflower lecithin | Step-flow | 4.6:3.7:91.7 |
| | | | 4000 | |
| NLP665 | Sunflower | Sunflower lecithin | NINEX ® | 4.6:3.7:91.7 |
| | | | MT-615 | |
| NLP667 | Sunflower | Sunflower lecithin | STEPFAC | 4.6:3.7:91.7 |
| | | | TSP-PE K | |
| NLP668 | Sunflower | Sunflower lecithin | TOXIMUL | 4.6:3.7:91.7 |
| | | | 8240 | |
| NLP669 | Sunflower | Sunflower lecithin | Step-flow ® | 4.6:3.7:91.7 |
| | | | 5000, | |
| | | | TOXIMUL | |
| | | | 8241, Atlox | |
| | | | 500L | |
| NLP670 | Sunflower | Sunflower lecithin | Step-flow ® | 4.6:3.7:91.7 |
| | | | 1500 | |
| NLP671 | Sunflower | Sunflower lecithin | TOXIMUL | 4.6:3.7:91.7 |
| | | | 8241 | |
| NLP672 | Sunflower | Sunflower lecithin | BIO-SOFT N- | 4.6:3.7:91.7 |
| | | | 411 | |
| NLP673 | Sunflower | Sunflower lecithin | NINEX MT- | 4.6:3.7:91.7 |
| | | | 603 | |
| NLP674 | Sunflower | Sunflower lecithin | Step-flow ® | 4.6:3.7:91.7 |
| | | | 3000 | |
| NLP675 | Sunflower | Sunflower lecithin | Step-flow ® | 4.6:3.7:91.7 |
| | | | 5000, Atlox | |
| | | | 500L | |
| NLP676 | Sunflower | Sunflower lecithin | TOXIMUL | 4.6:3.7:91.7 |
| | | | 8241, Atlox | |
| | | | 500L | |
| NLP677 | Sunflower | Sunflower lecithin | BIO-SOFT | 4.6:3.7:91.7 |
| | | | N98-1 | |
| NLP678 | Sunflower | Sunflower lecithin | Step-flow ® | 4.6:3.7:91.7 |
| | | | 5000 | |
| NLP679 | Sunflower | Sunflower lecithin | Step-flow ® | 4.6:3.7:91.7 |
| | | | 5000, | |
| | | | TOXIMUL | |
| | | | 8241 | |
| NLP680 | Sunflower | Sunflower lecithin | ZONIX 8.5% | 4.6:3.7:91.7 |
| | | | Rhamnolipid | |
| NLP683 | Genagen 4296 | Sunflower lecithin | — | 5.6:4.4:0 |
| NLP687 | Genagen 4166 | Sunflower lecithin | — | 5.6:4.4:0 |
| NLP689 | Genagen PA | Sunflower lecithin | — | 5.6:4.4:0 |
| NLP907 | Sunflower oil | Sunflower lecithin | — | 33.3:66.6 |
| NLP908 | Sunflower oil | Tween-20 | | 71.4:28.6 |
| NLP909 | Sunflower oil | Sunflower lecithin | Rhamnolipid | 29.4:58.8:11.8 |

^{a}CLL-f: crude lemon lipids from fresh lemon juice; CLL-d: crude lemon lipids from freeze-fried lemon juice; LemonPL-f: enriched phospholipids from fresh lemon juice crude lipids; LemonNP-f: enriched non-polar lipids from fresh lemon juice crude lipids; LemonPL-d: enriched phospholipids from freeze-dried lemon crude lipids; LemonNP-d: enriched non-polar lipids from freeze-fried lemon crude lipids.

### d) Co-Solvent

Several embodiments relate to an NLP composition comprising one or more co-solvents. In some embodiments, one or more co-solvents is included in an NLP composition to improve the efficiency of encapsulation of a cargo (e.g., a heterologous functional agent) compared to an NLP not comprising one or more co-solvents. In some embodiments, an NLP composition comprising one or more co-solvents have a cargo encapsulation efficiency that is at least 5%, 10%, 15%, 20%, 30%, 40%, 50%, 60%, 70%, 80%, 90%, 95%, 98%, 99%, or more than 99% higher than the cargo encapsulation efficiency of an NLP composition not comprising the one or more co-solvents. In some embodiments the cargo is a heterologous functional agent. In some embodiments the cargo is a pyrethroid. Not wishing to be bound to a particular theory, inclusion of one or more co-solvents increases the solubility of a cargo (e.g., a heterologous functional agent (e.g., a pyrethroid)). Not wishing to be bound to a particular theory, inclusion of one or more co-solvents prevents precipitation of cargo (e.g., a heterologous functional agent (e.g., a pyrethroid). In some embodiments, one or more co-solvents is a water immiscible fluid. Not wishing to be bound to a particular theory, inclusion of one or more water immiscible co-solvents prevents precipitation of a hydrophobic cargo (e.g., a hydrophobic heterologous functional agent (e.g., a pyrethroid)). In some embodiments, any of the NLP compositions of Table 2 comprises one or more water-immiscible co-solvents selected from Table 3. In some embodiments, the co-solvent is dichloromethane (DCM). In some embodiments, the co-solvent is isopropyl myristate (IPM). In some embodiments, trace amounts of a co-solvent remain after evaporation during production of an NLP composition. In some embodiments the co-solvent is water miscible. In some embodiments, the co-solvent is water immiscible. In some embodiments, the non-polar lipid phase of the NLP is represented by the co-solvent only (e.g. Genagen 4296 as in NLP683).

TABLE 3
Examples of co-solvents and excipients

| Description | Class | Co-solvents (examples) |
|---|---|---|
| water immiscible | solvents | Isopropyl myristate |
| solvents | | Ethyl lactate |
| | | Dichloromethane |
| | | Ethyl acetate |
| | | Fatty acid methyl esters |
| | | Genagen 4296 |
| | | Genagen 4166 |
| | | Genagen PA |
| water miscible | solvents | Propylene glycol |
| solvents | | Ethanol |
| | | Isopropyl alcohol |
| | | Cyclohexanone |
| | | Dimethylformamide |
| non-ionic block | Polymer | Pluronic |
| copolymer | surfactant | Tetronic |
| surfactant | | Makon L61 |
| | | Ethylan |
| non-ionic | Polymer | Biosoft, Makon, Toximul |
| polyalkylene | surfactant | Pluriol, Lotensol |
| glycol ether | | Dowfax |
| surfactant | | |

### e) Excipients

In some embodiments, an NLPs composition can further comprise one or more stabilizing molecules that increase the stability of the NLPs compared to a composition lacking the one or more stabilizing molecules (e.g., for at least one day at room temperature, for at least one week at 4° C., etc.). In some embodiments, an NLP composition that comprises one or more excipients is more stable at room temperature than an NLP composition not comprising an excipient. In some embodiments, an NLP composition that comprises one or more excipients is more stable in soil than an NLP composition not comprising an excipient. In some embodiments, an NLP composition comprises one or more excipients that prevent aggregation of the NLPs. In some embodiments, one or more excipients are added during NLP production to enhance stability of the NLPs produced. In some embodiments, one or more excipients are added after NLP production to enhance stability of the NLPs produced. In some embodiments, the one or more excipients are encapsulated within the intraliposomal internal core of an NLP (e.g., a hydrophophilic core, a hydrophobic core). In some embodiments, one or more excipients are embedded in a lipid membrane of an NLP. In some embodiments, one or more excipients are provided in a solution in which one or more NLPs are suspended. Nonlimiting examples of excipients that may be included in an NLP composition are non-ionic block copolymer surfactants and non-ionic polyalkylene glycol ether surfactants, as listed in Table 3.

### f) Heterologous Functional Agents

### 1. Functional Agents

In some embodiments, an NLP composition comprises one or more heterologous functional agents. In some embodiments, one or more heterologous functional agents are encapsulated within the intraliposomal internal core of an NLP (e.g., in the hydrophophilic core, in the hydrophobic core, etc.). In some embodiments, one or more heterologous functional agents are embedded in a lipid membrane of an NLP.

In some embodiments, one or more heterologous functional agents comprised in an NLP composition may be any of the pesticidal agents disclosed herein. In some embodiments, a pesticidal agent may be a naturally occurring or synthetic insecticide (e.g., a larvicide, an adulticide, etc.). In some embodiments, a pesticidal agent may be a naturally occurring or synthetic insect growth regulator. In some embodiments, a pesticidal agent may be a naturally occurring or synthetic acaricide (miticides). In some embodiments, a pesticidal agent may be a naturally occurring or synthetic molluscicide, nematicide, ectoparasiticide, bactericide, fungicide, or herbicide. The term “pesticidal agent” may further encompass other bioactive molecules such as antibiotics, antivirals pesticides, antifungals, antihelminthics, nutrients, and/or agents that stun or slow insect movement, fecundity, etc. In some embodiments, a heterologous functional agent may be a therapeutic agent (e.g., a cell-penetrating agent, an antifungal agent, an antibacterial agent, a virucidal agent, an anti-viral agent, an insecticidal agent, a nematicidal agent, an antiparasitic agent, an insect repellent, etc.). In some embodiments, an NLP composition as described herein may comprise one or more heterologous functional agents described in Tables 4-6.

In some embodiments, one or more heterologous functional agents comprised in an NLP composition as described herein is a pyrethroid (e.g., deltamethrin). In some embodiments, one or more heterologous functional agents comprised in an NLP composition as described herein is emamectin. In some embodiments, one or more heterologous functional agents are provided in a hydrophobic core of an NLP. In some embodiments, one or more heterologous functional agents are provided in a hydrophilic core of an NLP. In some embodiments, one or more heterologous functional agents are provided in a lipid membrane of an NLP. In some embodiments, deltamethrin is comprised in the hydrophobic core of an NLP. In some embodiments, emamectin is comprised in the hydrophobic core of an NLP.

### 2. Volatile Functional Agents.

Volatile functional agents are agents having a high vapor pressure. Examples of volatile agents used in the field of agriculture are herbicides that are typically applied as a foliar spray, fumigants which are applied to soil to kill insects, pheromones to disrupt insect mating, and essential oils to repel insects. A high vapor pressure means a high environmental exposure and potential environmental hazard, to farmers, and to off-target plants (e.g. grape vines) and off-target insects (e.g. honey bees). Spray drift is a common concern for off-target injury. It occurs when small droplets comprising the bioactive move to off-target vegetation during the process of treating the target site. Furthermore, undesired spread of e.g. a herbicide can occur when a spray solution settles on-site and then changes to a vapor phase and is carried off-site by wind. NLP encapsulation of a volatile bioactive offers a means to reduce that hazard and undesired effects on off-targets.

In some embodiments, NLP encapsulation of a volatile bioactive alters the environmental exposure to the volatile bioactive. By altering the chemistry of the components of the NLPs, NLPs can be formed of various sizes, stability, and degrees of penetrability. These factors govern the speed with which the volatile bioactive ingredient encapsulated therein is released, which in turn, affects the residual performance, speed of action, and environmental exposure of the bioactive. In some embodiments, a composition comprises a mixture of NLPs comprising one or more volatile bioactives, facilitating the controlled release of the one or more bioactives over time.

In some embodiments, NLP encapsulation of any of the volatile functional agents recited herein (e.g. a volatile insecticide, a volatile herbicide, a volatile fumigant or a volatile essential oil) facilitates their use in spray form. In some embodiments, an NLP composition comprising a volatile functional agent is a sprayable formulation.

### 2.1. Insecticides

In some embodiments, the volatile functional agent is an insecticide. In some embodiments, the volatile functional agent is an insecticide recited herein, having a high vapor pressure. In some embodiments, NLP encapsulation of any of the volatile insecticides recited herein facilitates their use in spray form. In some embodiments, an NLP composition comprising a volatile insecticide is a sprayable insecticide formulation. In some embodiments, the volatile insecticide is a pyrethroid. In some embodiments, the pyrethroid is tefluthrin.

### 2.2. Herbicides

Exemplary volatile herbicides used in the field of agriculture that can be encapsulated in any of the NLPs by any of the methods described in this application include but are not limited to Dicamba and 2,4-D. In some embodiments, the Dicamba formulations are XtendiMax, Engenia, and Tavium, or FeXapan. In some embodiments, the volatility of the herbicide is reduced by encapsulation of the herbicide in any of the NLP compositions as disclosed in this application. In some embodiments, NLP encapsulation of any of the volatile herbicides recited herein facilitates their use in spray form. In some embodiments, an NLP composition comprising a volatile herbicide is a sprayable herbicide formulation. In some embodiments, the volatile herbicide is Dicamba.

### 2.3. Fumigants

Exemplary fumigants that can be encapsulated in any of the NLPs by any of the methods described in this application include but are not limited to: 1,2-Dibromo 3-chloropropane, 1,3-Dichloropropene, aluminum phosphide, Atrazine, Azinphos methyl, Benomyl, Carbaryl (Sevin®), Carbofuran, Carbon disulfide, Chlordane, Chloropicrin, Chlorpyrifos, Dazomet (Basamid®), D-D, 1,3-Dichloropropene, Diazinon, Dichlorvos (DDVP), Dichrotophos, Dieldrin, Diquat (respirable), Endosulfan, Endrin, Epichlorohydrin, Ethyl p-nitrophenyl phenylphosphorothioate (EPN), Ethion, Ethylene dibromide (EDB), Fenamiphos, Fenthion, Fonofos (Difonate), formaldehyde, Heptachlor, iodoform, hydrogen cyanide, hydrogen disulphide, Malathion, Metam sodium, methoxychlor, methyl bromide, methyl iodide, methyl isocyanate, methyl isothiocyanate, methyl parathion, Mevinphos (Phosdrin), Naled, Paraquat, Parathion, phosphine, Picloram, Ronnel, Rotenone, sodium tetrathiocarbonate, Sulfotep (TEDP), sulfuryl fluoride, Temephos, Thiram, Trichlorophenoxyacetic acid, Warfarin, or tefluthrin. In some embodiments, the volatility of the fumigant is reduced by encapsulation of the fumigant in any of the NLP compositions as disclosed in the application. In some embodiments, NLP encapsulation of any of the fumigants recited herein facilitates their use in spray form.

### 2.4. Pheromones.

Exemplary insect pheromones that can be encapsulated in any of the NLPs by any of the methods described in this application include but are not limited to: (E)-2-Decen-1-ol; (E,E)-10,12-Tetradecadien-1-ol; (E)-2-Decenyl acetate; (E,E)-10,12-Tetradecadienyl acetate; (E)-2-Decenal; (E,E)-10,12-Tetradecadienal; (Z)-2-Decen-1-ol; (E,Z)-10,12-Tetradecadienyl acetate; (Z)-2-Decenyl acetate; (Z,E)-10,12-Tetradecadienyl acetate; (Z)-2-Decenal; (Z,Z)-10,12-Tetradecadien-1-ol; (E)-3-Decen-1-ol; (Z,Z)-10,12-Tetradecadienyl acetate; (Z)-3-Decenyl acetate; (E,Z,Z)-3,8,11-Tetradecatrienyl acetate; (Z)-3-Decen-1-ol; (E)-8-Pentadecen-1-ol; (Z)-4-Decen-1-ol (E)-8-Pentadecenyl acetate; (E)-4-Decenyl acetate; (Z)-8-Pentadecen-1-ol; (Z)-4-Decenyl acetate; (Z)-8-Pentadecenyl acetate; (Z)-4-Decenal; (Z)-9-Pentadecenyl acetate; (E)-5-Decen-1-ol; (E)-9-Pentadecenyl acetate; (E)-5-Decenyl acetate; (Z)-10-Pentadecenyl acetate; (Z)-5-Decen-1-ol; (Z)-10-Pentadecenal; (Z)-5-Decenyl acetate; (E)-12-Pentadecenyl acetate; (Z)-5-Decenal; (Z)-12-Pentadecenyl acetate; (E)-7-Decenyl acetate; (Z,Z)-6,9-Pentadecadien-1-ol; (Z)-7-Decenyl acetate; (Z,Z)-6,9-Pentadecadienyl acetate; (E)-8-Decen-1-ol; (Z,Z)-6,9-Pentadecadienal; (E,E)-2,4-Decadienal; (E,E)-8,10-Pentadecadienyl acetate; (E,Z)-2,4-Decadienal; (E,Z)-8,10-Pentadecadien-1-ol; (Z,Z)-2,4-Decadienal; (E,Z)-8,10-Pentadecadienyl acetate; (E,E)-3,5-Decadienyl acetate; (Z,E)-8,10-Pentadecadienyl acetate; (Z,E)-3,5-Decadienyl acetate; (Z,Z)-8,10-Pentadecadienyl acetate; (Z,Z)-4,7-Decadien-1-ol; (E,Z)-9,11-Pentadecadienal; (Z,Z)-4,7-Decadienyl acetate; (Z,Z)-9,11-Pentadecadienal; (E)-2-Undecenyl acetate; (Z)-3-Hexadecenyl acetate; (E)-2-Undecenal; (E)-5-Hexadecen-1-ol; (Z)-5-Undecenyl acetate; (E)-5-Hexadecenyl acetate; (Z)-7-Undecenyl acetate; (Z)-5-Hexadecen-1-ol (Z)-8-Undecenyl acetate; (Z)-5-Hexadecenyl acetate; (Z)-9-Undecenyl acetate; (E)-6-Hexadecenyl acetate; (E)-2-Dodecenal; (E)-7-Hexadecen-1-ol; (Z)-3-Dodecen-1-ol; (E)-7-Hexadecenyl acetate; (E)-3-Dodecenyl acetate; (E)-7-Hexadecenal; (Z)-3-Dodecenyl acetate; (Z)-7-Hexadecen-1-ol; (E)-4-Dodecenyl acetate; (Z)-7-Hexadecenyl acetate; (E)-5-Dodecen-1-ol; (Z)-7-Hexadecenal; (E)-5-Dodecenyl acetate; (E)-8-Hexadecenyl acetate; (Z)-5-Dodecen-1-ol; (E)-9-Hexadecen-1-ol; (Z)-5-Dodecenyl acetate; (E)-9-Hexadecenyl acetate; (Z)-5-Dodecenal; (E)-9-Hexadecenal; (E)-6-Dodecen-1-ol; (Z)-9-Hexadecen-1-ol; (Z)-6-Dodecenyl acetate; (Z)-9-Hexadecenyl acetate; (E)-6-Dodecenal; (Z)-9-Hexadecenal; (E)-7-Dodecen-1-ol; (E)-10-Hexadecen-1-ol; (E)-7-Dodecenyl acetate; (E)-10-Hexadecenal; (E)-7-Dodecenal; (Z)-10-Hexadecenyl acetate; (Z)-7-Dodecen-1-ol; (Z)-10-Hexadecenal; (Z)-7-Dodecenyl acetate; (E)-11-Hexadecen-1-ol; (Z)-7-Dodecenal; (E)-11-Hexadecenyl acetate; (E)-8-Dodecen-1-ol; (E)-11-Hexadecenal; (E)-8-Dodecenyl acetate; (Z)-11-Hexadecen-1-ol; (E)-8-Dodecenal; (Z)-11-Hexadecenyl acetate; (Z)-8-Dodecen-1-ol; (Z)-11-Hexadecenal; (Z)-8-Dodecenyl acetate; (Z)-12-Hexadecenyl acetate; (E)-9-Dodecen-1-ol; (Z)-12-Hexadecenal; (E)-9-Dodecenyl acetate; (E)-14-Hexadecenal; (E)-9-Dodecenal; (Z)-14-Hexadecenyl acetate; (Z)-9-Dodecen-1-ol; (E,E)-1,3-Hexadecadien-1-ol; (Z)-9-Dodecenyl acetate; (E,Z)-4,6-Hexadecadien-1-ol; (Z)-9-Dodecenal (E,Z)-4,6-Hexadecadienyl acetate; (E)-10-Dodecen-1-ol; (E,Z)-4,6-Hexadecadienal; (E)-10-Dodecenyl acetate; (E,Z)-6,11-Hexadecadienyl acetate; (E)-10-Dodecenal; (E,Z)-6,11-Hexadecadienal; (Z)-10-Dodecen-1-ol; (Z,Z)-7,10-Hexadecadien-1-ol; (Z)-10-Dodecenyl acetate; (Z,Z)-7,10-Hexadecadienyl acetate; (E,Z)-3,5-Dodecadienyl acetate; (Z,E)-7,11-Hexadecadien-1-ol; (Z,E)-3,5-Dodecadienyl acetate; (Z,E)-7,11-Hexadecadienyl acetate; (Z,Z)-3,6-Dodecadien-1-ol; (Z,E)-7,11-Hexadecadienal; (E,E)-4,10-Dodecadienyl acetate; (Z,Z)-7,11-Hexadecadien-1-ol; (E,E)-5,7-Dodecadien-1-ol; (Z,Z)-7,11-Hexadecadienyl acetate; (E,E)-5,7-Dodecadienyl acetate; (Z,Z)-7,11-Hexadecadienal; (E,Z)-5,7-Dodecadien-1-ol; (Z,Z)-8,10-Hexadecadienyl acetate; (E,Z)-5,7-Dodecadienyl acetate; (E,Z)-8,11-Hexadecadienal; (E,Z)-5,7-Dodecadienal; (E,E)-9,11-Hexadecadienal; (Z,E)-5,7-Dodecadien-1-ol; (E,Z)-9,11-Hexadecadienyl acetate; (Z,E)-5,7-Dodecadienyl acetate; (E,Z)-9,11-Hexadecadienal; (Z,E)-5,7-Dodecadienal; (Z,E)-9,11-Hexadecadienal; (Z,Z)-5,7-Dodecadienyl acetate; (Z,Z)-9,11-Hexadecadienal; (Z,Z)-5,7-Dodecadienal; (E,E)-10,12-Hexadecadien-1-ol; (E,E)-7,9-Dodecadienyl acetate; (E,E)-10,12-Hexadecadienyl acetate; (E,Z)-7,9-Dodecadien-1-ol; (E,E)-10,12-Hexadecadienal; (E,Z)-7,9-Dodecadienyl acetate; (E,Z)-10,12-Hexadecadien-1-ol; (E,Z)-7,9-Dodecadienal; (E,Z)-10,12-Hexadecadienyl acetate; (Z,E)-7,9-Dodecadien-1-ol; (E,Z)-10,12-Hexadecadienal; (Z,E)-7,9-Dodecadienyl acetate; (Z,E)-10,12-Hexadecadienyl acetate; (Z,Z)-7,9-Dodecadien-1-ol; (Z,E)-10,12-Hexadecadienal; (Z,Z)-7,9-Dodecadienyl acetate; (Z,Z)-10,12-Hexadecadienal; (E,E)-8,10-Dodecadien-1-01; (E,E)-11,13-Hexadecadien-1-ol; (E,E)-8,10-Dodecadienyl acetate; (E,E)-11,13-Hexadecadienyl acetate; (E,E)-8,10-Dodecadienal; (E,E)-11,13-Hexadecadienal; (E,Z)-8,10-Dodecadien-1-ol; (E,Z)-11,13-Hexadecadien-1-ol; (E,Z)-8,10-Dodecadienyl acetate; (E,Z)-11,13-Hexadecadienyl acetate; (E,Z)-8,10-Dodecadienal; (E,Z)-11,13-Hexadecadienal; (Z,E)-8,10-Dodecadien-1-ol; (Z,E)-11,13-Hexadecadien-1-ol; (Z,E)-8,10-Dodecadienyl acetate; (Z,E)-11,13-Hexadecadienyl acetate; (Z,E)-8,10-Dodecadienal; (Z,E)-11,13-Hexadecadienal; (Z,Z)-8,10-Dodecadien-1-ol; (Z,Z)-11,13-Hexadecadien-1-ol; (Z,Z)-8,10-Dodecadienyl acetate; (Z,Z)-11,13-Hexadecadienyl acetate; (Z,E,E)-3,6,8-Dodecatrien-1-ol; (Z,Z)-11,13-Hexadecadienal; (Z,Z,E)-3,6,8-Dodecatrien-1-ol; (E,E)-10,14-Hexadecadienal; (E)-2-Tridecenyl acetate; (Z,E)-11,14-Hexadecadienyl acetate; (Z)-2-Tridecenyl acetate; (E,E,Z)-4,6,10-Hexadecatrien-1-ol; (E)-3-Tridecenyl acetate; (E,E,Z)-4,6,10-Hexadecatrienyl acetate; (E)-4-Tridecenyl acetate; (E,Z,Z)-4,6,10-Hexadecatrien-1-ol; (Z)-4-Tridecenyl acetate; (E,Z,Z)-4,6,10-Hexadecatrienyl acetate; (Z)-4-Tridecenal (E,E,Z)-4,6,11-Hexadecatrienyl acetate; (E)-6-Tridecenyl acetate (E,E,Z)-4,6,11-Hexadecatrienal (Z)-7-Tridecenyl acetate (Z,Z,E)-7,11,13-Hexadecatrienal (E)-8-Tridecenyl acetate; (E,E,E)-10,12,14-Hexadecatrienyl acetate; (Z)-8-Tridecenyl acetate; (E,E,E)-10,12,14-Hexadecatrienal; (E)-9-Tridecenyl acetate; (E,E,Z)-10,12,14-Hexadecatrienyl acetate; (Z)-9-Tridecenyl acetate; (E,E,Z)-10,12,14-Hexadecatrienal; (Z)-10-Tridecenyl acetate; (E,E,Z,Z)-4,6,11,13-Hexadecatetraenal; (E)-11-Tridecenyl acetate; (E)-2-Heptadecenal; (Z)-11-Tridecenyl acetate; (Z)-2-Heptadecenal; (E,Z)-4,7-Tridecadienyl acetate; (E)-8-Heptadecen-1-ol; (Z,Z)-4,7-Tridecadien-1-ol; (E)-8-Heptadecenyl acetate; (Z,Z)-4,7-Tridecadienyl acetate; (Z)-8-Heptadecen-1-ol; (E,Z)-5,9-Tridecadienyl acetate; (Z)-9-Heptadecenal; (Z,E)-5,9-Tridecadienyl acetate; (E)-10-Heptadecenyl acetate; (Z,Z)-5,9-Tridecadienyl acetate; (Z)-11-Heptadecen-1-ol; (Z,Z)-7,11-Tridecadienyl acetate; (Z)-11-Heptadecenyl acetate; (E,Z,Z)-4,7,10-Tridecatrienyl acetate; (E,E)-4,8-Heptadecadienyl acetate; (E)-3-Tetradecen-1-ol; (Z,Z)-8,10-Heptadecadien-1-ol; (E)-3-Tetradecenyl acetate; (Z,Z)-8,11-Heptadecadienyl acetate; (Z)-3-Tetradecen-1-ol; (E)-2-Octadecenyl acetate; (Z)-3-Tetradecenyl acetate; (E)-2-Octadecenal; (E)-5-Tetradecen-1-ol; (Z)-2-Octadecenyl acetate; (E)-5-Tetradecenyl acetate; (Z)-2-Octadecenal; (E)-5-Tetradecenal; (E)-9-Octadecen-1-ol; (Z)-5-Tetradecen-1-ol; (E)-9-Octadecenyl acetate; (Z)-5-Tetradecenyl acetate; (E)-9-Octadecenal; (Z)-5-Tetradecenal; (Z)-9-Octadecen-1-ol; (E)-6-Tetradecenyl acetate; (Z)-9-Octadecenyl acetate; (Z)-6-Tetradecenyl acetate; (Z)-9-Octadecenal; (E)-7-Tetradecen-1-ol; (E)-11-Octadecen-1-ol; (E)-7-Tetradecenyl acetate; (E)-11-Octadecenal; (Z)-7-Tetradecen-1-ol; (Z)-11-Octadecen-1-ol; (Z)-7-Tetradecenyl acetate; (Z)-11-Octadecenyl acetate; (Z)-7-Tetradecenal; (Z)-11-Octadecenal; (E)-8-Tetradecenyl acetate; (E)-13-Octadecenyl acetate; (Z)-8-Tetradecen-1-ol; (E)-13-Octadecenal; (Z)-8-Tetradecenyl acetate; (Z)-13-Octadecen-1-ol; (Z)-8-Tetradecenal; (Z)-13-Octadecenyl acetate; (E)-9-Tetradecen-1-ol; (Z)-13-Octadecenal; (E)-9-Tetradecenyl acetate; (E)-14-Octadecenal; (Z)-9-Tetradecen-1-ol; (E,Z)-2,13-Octadecadien-1-ol; (Z)-9-Tetradecenyl acetate; (E,Z)-2,13-Octadecadienyl acetate; (Z)-9-Tetradecenal; (E,Z)-2,13-Octadecadienal; (E)-10-Tetradecenyl acetate; (Z,E)-2,13-Octadecadienyl acetate; (Z)-10-Tetradecenyl acetate; (Z,Z)-2,13-Octadecadien-1-ol; (E)-11-Tetradecen-1-ol; (Z,Z)-2,13-Octadecadienyl acetate; (E)-11-Tetradecenyl acetate; (E,E)-3,13-Octadecadienyl acetate; (E)-11-Tetradecenal; (E,Z)-3,13-Octadecadienyl acetate; (Z)-11-Tetradecen-1-ol; (E,Z)-3,13-Octadecadienal; (Z)-11-Tetradecenyl acetate; (Z,E)-3,13-Octadecadienyl acetate; (Z)-11-Tetradecenal; (Z,Z)-3,13-Octadecadienyl acetate; (E)-12-Tetradecenyl acetate; (Z,Z)-3,13-Octadecadienal; (Z)-12-Tetradecenyl acetate; (E,E)-5,9-Octadecadien-1-ol; (E,E)-2,4-Tetradecadienal; (E,E)-5,9-Octadecadienyl acetate; (E,E)-3,5-Tetradecadienyl acetate; (E,E)-9,12-Octadecadien-1-ol; (E,Z)-3,5-Tetradecadienyl acetate; (Z,Z)-9,12-Octadecadienyl acetate; (Z,E)-3,5-Tetradecadienyl acetate; (Z,Z)-9,12-Octadecadienal; (E,Z)-3,7-Tetradecadienyl acetate; (Z,Z)-11,13-Octadecadienal; (E,Z)-3,8-Tetradecadienyl acetate; (E,E)-11,14-Octadecadienal; (E,Z)-4,9-Tetradecadienyl acetate; (Z,Z)-13,15-Octadecadienal; (E,Z)-4,9-Tetradecadienal; (Z,Z,Z)-3,6,9-Octadecatrienyl acetate; (E,Z)-4,10-Tetradecadienyl acetate; (E,E,E)-9,12,15-Octadecatrien-1-ol; (E,E)-5,8-Tetradecadienal; (Z,Z,Z)-9,12,15-Octadecatrienyl acetate; (Z,Z)-5,8-Tetradecadien-1-ol; (Z,Z,Z)-9,12,15-Octadecatrienal; (Z,Z)-5,8-Tetradecadienyl acetate; (Z,Z)-5,8-Tetradecadienal; (E,E)-8,10-Tetradecadien-1-ol; (E,E)-8,10-Tetradecadienyl acetate; (E,E)-8,10-Tetradecadienal; (E,Z)-8,10-Tetradecadienyl acetate; (E,Z)-8,10-Tetradecadienal; (Z,E)-8,10-Tetradecadien-1-ol; (Z,E)-8,10-Tetradecadienyl acetate; (Z,Z)-8,10-Tetradecadienal; (E,E)-9,11-Tetradecadienyl acetate; (E,Z)-9,11-Tetradecadienyl acetate; (Z,E)-9,11-Tetradecadien-1-ol; (Z,E)-9,11-Tetradecadienyl acetate; (Z,E)-9,11-Tetradecadienal; (Z,Z)-9,11-Tetradecadien-1-ol; (Z,Z)-9,11-Tetradecadienyl acetate; (Z,Z)-9,11-Tetradecadienal; (E,E)-9,12-Tetradecadienyl acetate; (Z,E)-9,12-Tetradecadien-1-ol; (Z,E)-9,12-Tetradecadienyl acetate; (Z,E)-9,12-Tetradecadienal; (Z,Z)-9,12-Tetradecadien-1-ol; and (Z,Z)-9,12-Tetradecadienyl acetate. In some embodiments, the volatile is an insect repellent. In some embodiments, the volatility of the pheromones is reduced by encapsulation of the pheromone in any of the NLP compositions as disclosed in the application. In some embodiments, NLP encapsulation of any of the pheromones recited herein prolongs their efficacy through slow release of the pheromone.

### 2.4. Essential Oils

Exemplary essential oils that can be encapsulated in any of the NLPs by any of the methods described in this application include but are not limited to: cinnamon, cedar, castor, clove, geranium, lemongrass, mint, thyme, turmeric, wintergreen, rosemary, anise, cardamom, chamomile, coriander, cumin, dill, mint, parsley, lavender, basil, camphor, citronella, eucalyptus, fennel, ginger, grapefruit, lemon, mandarin, orange, pine needle, pepper, rose, sweet orange, tangerine, tea tree, tea seed, caraway, garlic, peppermint, onion, and spearmint oil. In some embodiments, the essential oils are volatile oils. In some embodiments, the volatility of the essential oil is reduced by encapsulation of the essential oil in any of the NLP compositions as disclosed in the application. In some embodiments, NLP encapsulation of any of the essential oils recited herein prolongs their efficacy through slow release of the essential oil.

### 2.5 Combinations of Volatile Bioactives.

In some embodiments, an NLP composition provided herein comprises a mixture of NLP compositions each comprising different heterologous functional agents (e.g. two different bioactives). In some embodiments, the stability of an NLP composition comprising a first functional agent (e.g. deltamethrin) differs from the stability of an NLP composition comprising a second functional agent (e.g. a herbicide). In some embodiments, one or more of the NLP compositions comprises a volatile functional agent (e.g. tefluthrin). In some embodiments, one NLP comprises two or more bioactives. In some embodiments, at least one of the bioactives is a volatile bioactive.

### g) Label

To aid in analysis and characterization, monitor the mobility of an NLP composition in soil, assess the affinity of an NLP composition for any component in soil, cellular uptake, etc., an NLP composition may comprise a detectable label. In some embodiments, the label is a fluorescent protein (e.g., green fluorescent protein). In some embodiments, the label is a protein or a poly nucleic acid conjugated to a fluorophore. In some embodiments, an NLP composition may comprise a dye (e.g., a fluorescent dye). In some embodiments, a dye may be added to an organic phase or to an aqueous phase during production of an NLP composition, depending on the chemical properties of the dye. In some embodiments, an NLP composition can be labeled with one or more of 3,3′-dihexyloxacarbocyanine iodide (DIOC6), a fluorescent lipophilic dye, PKH67 (Sigma Aldrich); Alexa Fluor® 488 (Thermo Fisher Scientific), DyLight™ 800 (Thermo Fisher), Exalite 594, Nile red, Exalite 428, Coumarin 481, Coumarin 486, DiD′ solid; DiIC18 (5) solid (1,1′-Dioctadecyl-3,3,3′,3′-Tetramethylindodicarbocyanine, 4-Chlorobenzenesulfonate Salt), DiO™ Solid; DiOΔ9,12-C18(3), ClO4 (3,3′-Dilinoleyloxacarbocyanine Perchlorate), DiI™ oil; DiIΔ9,12-C18(3), ClO4 (1,1′-Dilinoleyl-3,3,3′,3′-Tetramethylindocarbocyanine Perchlorate), DiI™ solid; DiIΔ9,12-C18(3), CBS (1,1′-Dilinoleyl-3,3,3′,3′-Tetramethylindocarbocyanine, 4-Chlorobenzenesulfonate), DiIC12(3) (1,1′-Didodecyl-3,3,3′,3′-Tetramethylindocarbocyanine Perchlorate), DiIC16(3) (1,1′-Dihexadecyl-3,3,3′,3′-Tetramethylindocarbocyanine Perchlorate), and DiR′; DiIC18(7) (1,1′-Dioctadecyl-3,3,3′,3′-Tetramethylindotricarbocyanine Iodide). In some embodiments, Exalyte 594 is added to the organic phase during production of an NLP composition. Several embodiments relate to the use of a label to quantify the total membrane content and can be used to indirectly measure the concentration of NLPs. Several embodiments relate to the use of a label (e.g., a fluorescent marker) to detect cellular uptake of an NLP composition.

Further, the production methods described herein can be supplemented with any quantitative or qualitative methods known in the art to characterize or identify the NLPs at any step of the production process. NLPs may be characterized by a variety of analysis methods to estimate NLP yield, NLP concentration, NLP purity, NLP composition, or NLP sizes. NLPs can be evaluated by a number of methods known in the art that enable visualization, quantitation, or qualitative characterization (e.g., identification of the composition) of the NLPs, such as microscopy (e.g., transmission electron microscopy), dynamic light scattering, nanoparticle tracking, spectroscopy (e.g., Fourier transform infrared analysis), or mass spectrometry (protein and lipid analysis). In certain instances, methods (e.g., mass spectroscopy) may be used to identify plant EV markers present on the NLP, such as the plant EV markers disclosed in WO2021041301A1. To aid in analysis and characterization, of the NLP fraction, the NLPs can additionally be labelled or stained. For example, the NLPs can be stained with 3,3′-dihexyloxacarbocyanine iodide (DIOC6), a fluorescent lipophilic dye, PKH67 (Sigma Aldrich); Alexa Fluor® 488 (Thermo Fisher Scientific), or DyLight™ 800 (Thermo Fisher). In the absence of sophisticated forms of nanoparticle tracking, this relatively simple approach quantifies the total membrane content and can be used to indirectly measure the concentration of NLPs (Rutter and Innes, Plant Physiol. 173 (1): 728-741, 2017; Rutter et al, Bio. Protoc. 7 (17): e2533, 2017). For more precise measurements, and to assess the size distributions of NLPs, nanoparticle tracking can be used.

### B. NLP Size

In some embodiments, an NLP as described herein has a mean diameter of about 5-50 nm, about 50-100 nm, about 100-150 nm, about 150-200 nm, about 200-250 nm, about 250-300 nm, about 300-350 nm, about 350-400 nm, about 400-450 nm, about 450-500 nm, about 500-550 nm, about 550-600 nm, about 600-650 nm, about 650-700 nm, about 700-750 nm, about 750-800 nm, about 800-850 nm, about 850-900 nm, about 900-950 nm, about 950-1000 nm, about 1000-1250 nm, about 1250-1500 nm, about 1500-1750 nm, or about 1750-2000 nm. In some embodiments, an NLP as described herein has a mean diameter of about 5-950 nm, about 5-900 nm, about 5-850 nm, about 5-800 nm, about 5-750 nm, about 5-700 nm, about 5-650 nm, about 5-600 nm, about 5-550 nm, about 5-500 nm, about 5-450 nm, about 5-400 nm, about 5-350 nm, about 5-300 nm, about 5-250 nm, about 5-200 nm, about 5-150 nm, about 5-100 nm, about 5-50 nm, or about 5-25 nm. In some embodiments, an NLP as described herein has a mean diameter of about 50-200 nm. In some embodiments, an NLP as described herein has a mean diameter of about 50-300 nm. In some embodiments, an NLP as described herein has a mean diameter of about 200-500 nm. In some embodiments, an NLP as described herein has a mean diameter of about 30-150 nm. In some embodiments, an NLP as described herein has a mean diameter of at least 5 nm, at least 50 nm, at least 100 nm, at least 150 nm, at least 200 nm, at least 250 nm, at least 300 nm, at least 350 nm, at least 400 nm, at least 450 nm, at least 500 nm, at least 550 nm, at least 600 nm, at least 650 nm, at least 700 nm, at least 750 nm, at least 800 nm, at least 850 nm, at least 900 nm, at least 950 nm, or at least 1000 nm. In some embodiments, an NLP as described herein has a mean diameter less than 1000 nm, less than 950 nm, less than 900 nm, less than 850 nm, less than 800 nm, less than 750 nm, less than 700 nm, less than 650 nm, less than 600 nm, less than 550 nm, less than 500 nm, less than 450 nm, less than 400 nm, less than 350 nm, less than 300 nm, less than 250 nm, less than 200 nm, less than 150 nm, less than 100 nm, or less than 50 nm. A variety of methods (e.g., a dynamic light scattering method) standard in the art can be used to measure the particle diameter of NLPs.

In some embodiments, an NLP has a mean surface area of 77 nm² to 3.2×10⁶ nm² (e.g., 77-100 nm², 100-1000 nm², 1000-1×10⁴ nm², 1×10⁴-1×10⁵ nm², 1×10⁵-1×10⁶ nm², or 1×10⁶-3.2×10⁶ nm²). In some embodiments, an NLP has a mean volume of 65 nm³ to 5.3×10⁸ nm³ (e.g., 65-100 nm³, 100-1000 nm³, 1000-1×10⁴ nm³, 1×10⁴-1×10⁵ nm³, 1×10⁵-1×10⁶ nm³, 1×10⁶-1×10⁷ nm³, 1×10⁷-1×10⁸ nm³, 1×10⁸-5.3×10⁸ nm³). In some embodiments, an NLP has a mean surface area of at least 77 nm², (e.g., at least 77 nm², at least 100 nm², at least 1000 nm², at least 1×10⁴ nm², at least 1×10⁵ nm², at least 1×10⁶ nm², or at least 2×10⁶ nm²). In some embodiments, an NLP may include a plant EV, or segment, portion, or extract thereof, that has a mean volume of at least 65 nm³ (e.g., at least 65 nm³, at least 100 nm³, at least 1000 nm³, at least 1×10⁴ nm³, at least 1×10⁵ nm³, at least 1×10⁶ nm³, at least 1×10⁷ nm³, at least 1×10⁸ nm³, at least 2×10⁸ nm³, at least 3×10⁸ nm³, at least 4×10⁸ nm³, or at least 5×10⁸ nm³.

In some embodiments, the size of an NLP may be determined following loading of one or more heterologous functional agents or following other modifications to the NLP. In some embodiments, an NLP comprising one or more heterologous functional agents may have a mean surface area of 77 nm² to 1.3×10⁷ nm² (e.g., 77-100 nm², 100-1000 nm², 1000-1×10⁴ nm², 1×10⁴-1×10⁵ nm², 1×10⁵-1×10⁶ nm², or 1×10⁶-1.3×10⁷ nm²).

In some embodiments, an NLP comprising a heterologous functional agent may have a mean volume of 65 nm³ to 4.2×10⁹ nm³ (e.g., 65-100 nm³, 100-1000 nm³, 1000-1×10⁴ nm³, 1×10⁴-1×10⁵ nm³, 1×10⁵-1×10⁶ nm³, 1×10⁶-1×10⁷ nm³, 1×10⁷-1×10⁸ nm³, 1×10⁸-1×10⁹ nm³, or 1×10⁹-4.2×10⁹ nm³). In some embodiments, an NLP has a mean surface area of at least 77 nm², (e.g., at least 77 nm², at least 100 nm², at least 1000 nm², at least 1×10⁴ nm², at least 1×10⁵ nm², at least 1×10⁶ nm², or at least 1×10⁷ nm²). In some embodiments, an NLP has a mean volume of at least 65 nm³ (e.g., at least 65 nm³, at least 100 nm³, at least 1000 nm³, at least 1×10⁴ nm³, at least 1×10⁵ nm³, at least 1×10⁶ nm³, at least 1×10⁷ nm³, at least 1×10⁸ nm³, at least 1×10⁹ nm³, at least 2×10⁹ nm³, at least 3×10⁹ nm³, or at least 4×10⁹ nm³).

### C. Production Methods

In some embodiments, an NLP composition as described herein may be produced by one of four methods described in Examples 1 and 2. Additional methods of preparing NLPs are available to a person having ordinary skill in the art. In some embodiments, an NLP composition as described herein may be prepared by mixing an organic phase, comprising at least one non-polar lipid and at least one phospholipid, with an aqueous phase. In some embodiments, one or more surface modifiers is added either to the organic phase or the aqueous phase, depending on the chemical properties of the surface modifier. In some embodiments, a rhamnolipid, which is a hydrophobic agent, is added to the organic phase. In some embodiments, Atlox 500L, which is a polycarboxylate, is added to the aqueous phase. In some embodiments, a co-solvent (e.g., DCM, IPM, etc.) is added to the organic phase. In some embodiments, a co-solvent is added during the production of an NLP composition to increase the solubility of an organic compound (e.g., deltamethrin). In some embodiments, the co-solvent is evaporated at the final step of NLP production. In some embodiments, an NLP composition comprises trace amounts of co-solvent. In some embodiments, an excipient is added during the production of an NLP composition to increase the stability of the NLP. In some embodiments, one or more excipients are added either to the organic phase or the aqueous phase during the production of an NLP composition, depending on the chemical properties of the excipient.

### D. Loading of Agents

Several embodiments relate to an NLP composition comprising one or more heterologous functional agents (e.g., a cell-penetrating agent, an agricultural agent (e.g., pesticidal agent, fertilizing agent, herbicidal agent, plant-modifying agent, plant growth promoting agent, biostimulants, or plant immunity elicitors), a therapeutic agent (e.g., an antifungal agent, an anti-oomycete agent, an antibacterial agent, a virucidal agent, an anti-viral agent, an insecticidal agent, a nematocidal agent, an antiparasitic agent, an insect repellent), etc.). An NLP as described herein can carry or associate with one or more heterologous functional agents by a variety of means, e.g., by encapsulating the heterologous functional agent, incorporation of the heterologous functional agent in a lipid layer (e.g., a lipid bilayer), association (e.g., by conjugation) of one or more heterologous functional agents with the surface of a lipid layer of an NLP. In some embodiments, one or more heterologous functional agents (e.g., a cell-penetrating agent, a pesticide, etc.) is included in an NLP composition, as described in Section IB herein. In some embodiments, one or more heterologous functional agents are stably associated with an NLP composition prior to and following delivery e.g., to soil, to a root of a plant, to a pest, etc. In some embodiments, one or more heterologous functional agents becomes dissociated (e.g., are released) from an NLP following delivery e.g., to soil, to a root of a plant, to a pest, etc.

In some embodiments, one or more heterologous functional agents are incorporated into an NLP during formation of the NLP, using a microfluidic device. Several embodiments are related to incorporating one or more heterologous functional agents into an NLP by providing one or more phospholipids and oil in an organic phase and one or more surface modifiers and heterologous functional agents in an aqueous phase, wherein the organic and aqueous phases are combined (e.g., in a microfluidics device), to produce an NLP composition comprising the heterologous functional agent. Several embodiments are related to incorporating one or more heterologous functional agents into an NLP by providing one or more phospholipids, oils, and surface modifiers in an organic phase and providing one or more heterologous functional agents in an aqueous phase, wherein the organic and aqueous phases are combined (e.g., in a microfluidics device), to produce an NLP composition comprising the heterologous functional agent. Several embodiments are related to incorporating one or more heterologous functional agents into an NLP by providing one or more phospholipids, oils and heterologous functional agents in an organic phase and providing one or more surface modifiers in an aqueous phase, wherein the organic and aqueous phases are combined (e.g. in a microfluidics device) to produce a NLP comprising the heterologous functional agent.

Several embodiments are related to incorporating one or more heterologous functional agents into an NLP by loading one or more heterologous functional agents into a pre-formed NLP by any methods known in the art that allow association, directly or indirectly, between the NLPs and one or more heterologous functional agents. The heterologous functional agent may be loaded onto or into (e.g., may be encapsulated by) an NLPs using, but not limited to, physical, chemical, and/or biological methods. In some embodiments, one or more heterologous functional agents may be introduced into an NLP by one or more of electroporation, sonication, passive diffusion, stirring, lipid extraction, and extrusion. However, it should be appreciated by those skilled in the art that the loading of a substance of interest into NLPs is not limited to the above-illustrated methods. Loaded NLPs can be assessed to confirm the presence or level of the loaded agent using a variety of methods, such as HPLC (e.g., to assess small molecules), immunoblotting (e.g., to assess proteins); and/or quantitative PCR (e.g., to assess nucleotides).

Several embodiments relate to an NLP composition comprising one or more heterologous functional agents conjugated to the NLP. In some embodiments, one or more heterologous functional agents are connected or joined indirectly to an NLP. In some embodiments, one or more heterologous functional agents are connected or joined directly to an NLP. In some embodiments, one or more heterologous functional agents are chemically-linked to an NLP. In some embodiments, one or more heterologous functional agents are joined (e.g., by covalent or ionic bonds) directly to a lipid structure (e.g., lipid bilayer) of an NLP.

Several embodiments relate to a method of conjugating one or more heterologous functional agents to an NLP, the method comprising incubating one or more heterologous functional agents with an appropriate cross-linking agent (e.g., N-(3-Dimethylaminopropyl)-N′-ethylcarbodiimide hydrochloride (EDC). Not to be bound by a particular theory, EDC may be utilized as a carboxyl activating agent for amide bonding with primary amines and also reacts with phosphate groups)) in a suitable solvent for a period of time sufficient to allow the one or more heterologous functional agents to attach to the cross-linking agent, incubating the one or more heterologous functional agents attached to crosslinking agent with an NLP composition. In some embodiments, a mixture one or more heterologous functional agents attached to crosslinking agent with an NLP composition is provided to a sucrose gradient (e.g., and 8, 30, 45, or 60% sucrose gradient) and subjected to centrifugation to separate the one or more free heterologous functional agents, free NLP compositions, and the heterologous functional agent conjugated to an NLP composition. In some embodiments, the heterologous functional agent conjugated NLP compositions are collected, washed, and dissolved in a suitable solution for use as described herein.

In some embodiments, a composition comprising NLPs is formulated or one or more NLP compositions are loaded to provide a composition comprising NLPs with various concentrations of one or more heterologous functional agents, depending on the particular agent or use. In some embodiments, a composition comprising NLPs is formulated or one or more NLP compositions are loaded such that a composition comprising NLPs as disclosed herein includes about 0.001, 0.01, 0.1, 1.0, 2, 3, 4, 5, 6, 7, 8, 9, 10, 15, 20, 30, 40, 50, 60, 70, 80, 90, 95 (or any range between about 0.001 and 95) or more weight % of one or more heterologous functional agents. In some embodiments, an NLP composition is loaded or an NLP composition is formulated such that the NLP composition includes about 95, 90, 80, 70, 60, 50, 40, 30, 20, 15, 10, 9, 8, 7, 6, 5, 4, 3, 2, 1.0, 0.1, 0.01, 0.001 (or any range between about 95 and 0.001) or less weight % of one or more heterologous functional agents. In some embodiments, an NLP composition can include about 0.001 to about 0.01 weight %, about 0.01 to about 0.1 weight %, about 0.1 to about 1 weight %, about 1 to about 5 weight %, or about 5 to about 10 weight %, about 10 to about 20 weight % of one or more heterologous functional agents. In some embodiments, an NLP composition can be loaded or an NLP composition is formulated with about 1, 5, 10, 50, 100, 200, 500, 1,000, 2,000 (or any range between about 1 and 2,000) or more pg/ml of one or more heterologous functional agents. In some embodiments, an NLP composition can be loaded or a NLP composition can be formulated with about 2,000, 1,000, 500, 200, 100, 50, 10, 5, 1 (or any range between about 2,000 and 1) or less pg/ml of one or more heterologous functional agents.

In some embodiments, an NLP composition is formulated or an NLP composition is loaded such that the NLP composition comprises at least 0.001 weight %, at least 0.01 weight %, at least 0.1 weight %, at least 1.0 weight %, at least 2 weight %, at least 3 weight %, at least 4 weight %, at least 5 weight %, at least 6 weight %, at least 7 weight %, at least 8 weight %, at least 9 weight %, at least 10 weight %, at least 15 weight %, at least 20 weight %, at least 30 weight %, at least 40 weight %, at least 50 weight %, at least 60 weight %, at least 70 weight %, at least 80 weight %, at least 90 weight %, or at least 95 weight % of one or more heterologous functional agents. In some embodiments, an NLP composition can be loaded or an NLP composition can be formulated with at least 1 pg/ml, at least 5 pg/ml, at least 10 pg/ml, at least 50 pg/ml, at least 100 pg/ml, at least 200 pg/ml, at least 500 pg/ml, at least 1,000 pg/ml, at least 2,000 pg/ml of one or more heterologous functional agents.

In some embodiments, an NLP composition is formulated with one or more heterologous functional agents by suspending (e.g., by vigorous mixing) the NLP composition in a solution comprising or consisting essentially of one or more heterologous functional agents. In some embodiments, one or more heterologous functional agents (e.g., an antifungal agent, an anti-oomycete agent, an antibacterial agent, an insecticidal agent, a molluscicidal agent, a nematocidal agent, a herbicidal agent, a virucidal agent, a peptide, a polypeptide, a nucleic acid, a polynucleotide, etc.) may comprise less than 1% or at least 1%, 5%, 10%, 20%, 30%, 40%, 50%, 60%, 70%, 80%, 90%, or 100% of a solution in which one or more NLP compositions are suspended.

### E. Production of NLP Compositions Using Microfluidics

In some embodiments, an NLP composition is produced by a process which comprises microfluidics. In some embodiments, an NLP composition is produced by mixing a lipid solution and an aqueous phase in a microfluidics device at any suitable ratio. In some embodiments, an NLP composition is produced by mixing a lipid solution and an aqueous phase in a microfluidics device at a 1:3 volumetric ratio. In some embodiments, an NLP composition is produced by mixing a lipid solution and an aqueous phase in a microfluidics device at a 1:1, 1:2, 1:3, 1:4, or 1:5 volumetric ratio.

In some embodiments, one or more lipids comprised in an NLP composition are extracted from a plurality of lipid sources (e.g., extracting lipids using the Bligh-Dyer method (Bligh and Dyer, J Biolchem Physiol, 37:911-917, 1959)). In some embodiments, one or more lipids comprised in an NLP composition are extracted from a plant source (e.g., soybean, citrus (e.g., lemon, orange, grapefruit, etc.), avocado, tomato, corn, etc.). In some embodiments, one or more extracted lipids may be provided as a stock solution (e.g., a solution in chloroform methanol). In some embodiments one or more extracted lipids are processed to produce a lipid film. In some embodiments, a lipid film is produced by evaporation of solvent with a stream of inert gas (e.g., nitrogen). In some embodiments, a lipid phase used during NLP production may comprise one or more phospholipids. In some embodiments, a lipid phase used during NLP production may comprise one or more non-polar lipids. In some embodiments, a lipid phase used during NLP production may comprise one or more phospholipids and one or more non-polar lipids. In some embodiments, a lipid phase used during NLP production may comprise one or more hydrophobic heterologous functional agents. In some embodiments, a lipid phase used during NLP production may comprise one or more hydrophobic heterologous functional agents selected from the group consisting of an antifungal agent, an antibacterial agent, an insecticidal agent, a molluscicidal agent, a nematocidal agent, a herbicidal agent, a virucidal agent, a peptide, a polypeptide, a nucleic acid, and a polynucleotide, or any combination thereof. In some embodiments, a lipid phase used during NLP production may comprise one or more proteins. In some embodiments, a lipid phase used during NLP production may comprise one or more ribonucleoproteins. In some embodiments, a lipid phase used during NLP production may comprise one or more surface modifiers. In some embodiments, a lipid phase used during NLP production may comprise one or more co-solvents. In some embodiments, a lipid phase used during NLP production may comprise one or more excipients.

In some embodiments, an aqueous phase used during NLP production may be a citrate buffer (e.g., a citrate buffer having a pH of about 3.2). In some embodiments, an aqueous phase used during NLP production may be de-ionized water. In some embodiments, an aqueous phase used during NLP production may be phosphate-buffered saline (PBS). In some embodiments, an aqueous phase used during NLP production may comprise one or more hydrophilic heterologous functional agents. In some embodiments, an aqueous phase used during NLP production may comprise one or more hydrophilic heterologous functional agents selected from the group consisting of an antifungal agent, an antibacterial agent, an insecticidal agent, a molluscicidal agent, a nematocidal agent, an herbicidal agent, a virucidal agent, a peptide, a polypeptide, a nucleic acid, and a polynucleotide, or any combination thereof. In some embodiments, an aqueous phase used during NLP production may comprise one or more proteins. In some embodiments, an aqueous phase used during NLP production may comprise one or more ribonucleoproteins. In some embodiments, an aqueous phase used during NLP production may comprise one or more nucleic acids. In some embodiments, an aqueous phase used during NLP production may comprise one or more cationic molecules. In some embodiments, an aqueous phase used during NLP production may comprise one or more surface modifiers. In some embodiments, an aqueous phase used during NLP production may comprise one or more co-solvents. In some embodiments, an aqueous phase used during NLP production may comprise one or more excipients.

In some embodiments, an NLP composition may comprise at least one phospholipid. In some embodiments, an NLP composition may comprise one or more phospholipids selected from the group consisting of phosphatidylcholine, phosphatidylethanolamine, phosphatidylinositol, phosphatidic acid, phosphatidyl serine, and 1,2-dimyristoyl-sn-glycero-3-phosphate or any combination thereof. In some embodiments, an NLP composition may comprise at least one phospholipid selected from the group consisting of soybean lecithin and sunflower lecithin. In some embodiments, an NLP composition may comprise at least one non-polar lipid. In some embodiments, an NLP composition may comprise at least one non-polar lipid comprising 40% of at least one fatty acid chain selected from the group consisting of a poly-unsaturated fatty acid, mono-unsaturated fatty acid and saturated fatty acid or any combination thereof. In some embodiments, an NLP composition may comprise one or more phospholipids and one or more non-polar lipids. In some embodiments, an NLP composition may comprise at least 0.5%, 1%, 5%, 10%, 15%, 20%, 25%, 30%, 35%, 40%, 45%, 50%, 55%, 60%, 65%, 70%, 75%, 80%, 85%, 90%, or more than 90% phospholipid (w/w) of total lipids in the NLP composition. In some embodiments, an NLP composition may comprise at least 0.5%, 1%, 5%, 10%, 15%, 20%, 25%, 30%, 35%, 40%, 45%, 50%, 55%, 60%, 65%, 70%, 75%, 80%, 85%, 90%, or more than 90% non-polar lipid (w/w) of total lipids in the NLP composition. In some embodiments, an NLP composition may comprise at least 0.5%, 1%, 5%, 10%, 15%, 20%, 25%, 30%, 35%, 40%, 45%, 50%, 55%, 60%, 65%, 70%, 75%, 80%, 85%, 90%, or more than 90% phospholipid and non-polar lipid (w/w) of total lipids in the NLP composition. In some embodiments, an NLP composition may comprise one or more non-polar lipids at an amount of 25% to 40% (w/w) of total lipids in the preparation.

In some embodiments, an NLP composition comprises one or more surface modifiers. In some embodiments, an NLP composition comprises one or more surface modifiers selected from a group consisting of a pegylated moiety, pegylated block copolymers (e.g., as a poloxamer), cocamide derivatives, glycolipids, polysacharides, and polysacharides with lipid chains, or any combination thereof. In some embodiments one or more surface modifiers may comprise about 1%, 5%, 10%, 20%, 30%, 40%, 50%, 60%, 70%, 80%, 90%, or more than 90% (w/w) of total lipids and sterols in an NLP composition.

In some embodiments, an NLP composition comprises one or more co-solvents. In some embodiments, the co-solvent is an organic solvent. In some embodiments, the co-solvent is DCM. In some embodiments, the co-solvent is IPM. In some embodiments, trace amounts of the co-solvent remain in an NLP composition after evaporation of the co-solvent. In some embodiments, co-solvent comprises between 1-10% (w/w) of the total NLP weight. In some instances, one or more co-solvents provided in an NLP composition is dimethylformamide: methanol (DMF: MeOH). In some embodiments, an NLP composition comprises one or more co-solvents selected from a group consisting of acetonitrile, acetone, ethanol, methanol, dimethylformamide, tetrahydrofuran, 1-buthanol, dimethyl sulfoxide, acetonitrile: ethanol, acetonitrile: methanol, acetone: methanol, methyl tert-butyl ethenpropanol, tetrahydrofura methanol, dimethyl sulfoxide: methanol, and dimethylformamide: methanol, or any combination thereof.

In some embodiments, an NLP composition may comprise one or more excipients in an organic phase. In some embodiments, one or more excipients may be included in an NLP composition to stabilize the NLP composition.

### F. Zeta Potential

The NLP composition comprising a phospholipid, a non-polar lipid, and a surface modifier may have, e.g., a zeta potential of less than 0 mV, less than −5 mV, less than −10 mV, less than −20 mV, less than −30 mV, less than −40 mV, less than −50 mV, less than −60 mV, less than-70 mV, less than −80 mV, less than −90 mV or less than −100 mV when in the absence of cargo. In some embodiments, the NLP composition comprising a phospholipid, a non-polar lipid, and a surface modifier may have, e.g., a zeta potential of less than 0 mV, less than −5 mV, less than −10 mV, less than −20 mV, less than −30 mV, less than −40 mV, less than −50 mV, less than −60 mV, less than −70 mV, less than −80 mV, less than −90 mV or less than −100 mV when in the presence of cargo. In some embodiments, the zeta potential of the NLP comprising a phospholipid, a non-polar lipid, a surface modifier and a cargo (e.g. a heterologous functional agent) ranges between −10 mV and −60 mV, between −20 mV and −50 mV, or between −30 mV and −50 mV.

The zeta potential of an NLP composition may be measured using any method known in the art. Zeta potentials are generally measured indirectly, e.g., calculated using theoretical models from the data obtained using methods and techniques known in the art, e.g., electrophoretic mobility or dynamic electrophoretic mobility. Electrophoretic mobility is typically measured using microelectrophoresis, electrophoretic light scattering, or tunable resistive pulse sensing. Electrophoretic light scattering is based on dynamic light scattering. Typically, zeta potentials are accessible from dynamic light scattering (DLS) measurements, also known as photon correlation spectroscopy or quasi-elastic light scattering.

### G. Formulations

i. Agricultural Formulations

In some embodiments, an NLP composition as described herein can be formulated with other substances to allow ease of application, handling, transportation, storage, effective activity, etc. In some embodiments, an NLP composition can be formulated into, for example, baits, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra-low volume solutions. In some embodiments, an NLP composition as described herein may be formulated as a formulation type described in “Catalogue of Pesticide Formulation Types and International Coding System” Technical Monograph n° 2, 5th Edition by CropLife International (2002), which is incorporated herein in its entirety.

In some embodiments, an NLP composition as described herein can be formulated as an aqueous suspension or emulsion. In some embodiments, an NLP composition as described herein can be formulated as an aqueous suspension or emulsion prepared from concentrated formulations. In some embodiments, a concentrated NLP formulation may be water-soluble, water-suspendable, or emulsifiable. In some embodiments, a concentrated NLP formulation may be a solid, such as a wettable powder or water dispersible granules, or a liquid, such as an emulsifiable concentrate or aqueous suspension. In some embodiments, a concentrated NLP formulation may be a wettable powder, which may be compacted to form water dispersible granules, comprising an intimate mixture of one or more NLP compositions, one or more carriers, and optionally, one or more surfactants. In some embodiments, an NLP composition as described herein may be formulated with one or more carriers selected from the group consisting of attapulgite clay, montmorillonite clay, diatomaceous earth, and purified silicate, or any combination thereof. In some embodiments, an NLP composition as described herein may be formulated with one or more surfactants, including from about 0.5% to about 10% of the formulation (e.g., a wettable powder) comprising one or more of sulfonated lignin, condensed naphthalenesulfonate, naphthalenesulfonate, alkylbenzenesulfonate, alkyl sulfate, and non-ionic surfactant (e.g., ethylene oxide adducts of alkyl phenols).

In some embodiments, an NLP composition as described herein can be formulated as an emulsifiable concentrate. In some embodiments, an emulsifiable concentrate comprises one or more NLP compositions as described herein at a concentration of from about 50 to about 500 grams per liter of liquid dissolved in a carrier (e.g., an organic solvent, a water miscible solvent, a mixture of water-immiscible organic solvent and emulsifiers, etc.). In some embodiments, an emulsifiable concentrate comprises one or more NLP compositions dissolved in an organic solvent. In some embodiments, an emulsifiable concentrate comprises one or more NLP compositions dissolved in an organic solvent selected from an aromatic solvent (e.g., xylene, petroleum fractions (e.g., high-boiling naphthalenic and olefinic portions of petroleum such as heavy aromatic naphtha), a terpenic solvent (e.g., rosin derivatives), aliphatic ketones such as cyclohexanone, and complex alcohols such as 2-ethoxyethanol. In some embodiments, an emulsifiable concentrate comprises one or more NLP compositions and one or more suitable emulsifiers, such as anionic and non-ionic surfactants.

In some embodiments, an NLP composition as described herein can be formulated as an aqueous suspension. In some embodiments, an aqueous suspension comprises one or more water-insoluble NLP compositions dispersed in an aqueous carrier at a concentration in the range from about 5% to about 50% by weight. In some embodiments, an aqueous suspension is prepared by finely grinding a dry formulation of one or more NLP compositions and vigorously mixing with an aqueous carrier (e.g., water) and, optionally, one or more surfactants. In some embodiments, one or more NLP compositions may be formulated in an aqueous carrier comprising one or more of an inorganic salt, synthetic gum, natural gum, etc., which may be added to increase the density and viscosity of the aqueous carrier.

In some embodiments, an NLP composition as described herein can be formulated as a granular composition. In some embodiments, a granular composition comprises from about 0.5% to about 10% by weight of one or more NLP compositions dispersed in a carrier, such as clay, starch, silicate, etc. In some embodiments, a granular composition is prepared by dispersing one or more NLP compositions in a suitable solvent and applying it to a granular carrier which has been pre-formed to the appropriate particle size, in the range of from about 0.5 to about 3 mm. In some embodiments, a granular composition is prepared by making a dough or paste of the carrier and one or more NLP compositions and crushing and drying to obtain the desired granular particle size.

In some embodiments, an NLP composition as described herein can be formulated as a powder. In some embodiments, a powder is formulated by mixing one or more NLP compositions as described herein provided in powdered form with a suitable dusty agricultural carrier, such as kaolin clay, ground volcanic rock, and the like. In some embodiments, a powder formulation of one or more NLP compositions as described herein comprises a suitable dusty agricultural carrier at a concentration from about 1% to about 10%. In some embodiments, a powder formulation of one or more NLP compositions can be applied as a seed dressing or as a foliage application with a dust blower machine.

In some embodiments, an NLP composition as described herein can be formulated in an organic solvent (e.g., petroleum oil, such as the spray oils, which are widely used in agricultural chemistry).

In some embodiments, an NLP composition as described herein can be formulated to be applied in the form of an aerosol composition. In some embodiments, one or more NLP compositions are dissolved or dispersed in a carrier and packaged in a container comprising a pressure-generating propellant mixture. In some embodiments, an NLP composition formulated as an aerosol composition is packaged in a container from which the mixture is dispensed through an atomizing valve.

In some embodiments, an NLP composition as described herein can be formulated as an oil-in-water emulsion. In some embodiments, an NLP composition as described herein can be formulated as an oil-in-water emulsion comprising oily globules which are each provided with a lamellar liquid crystal coating dispersed in an aqueous phase, wherein each oily globule comprises at least one heterologous active agent, and is individually coated with a monolamellar or oligolamellar layer including: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in U.S. patent publication 20070027034 published Feb. 1, 2007. For ease of use, this embodiment will be referred to as “OIWE.”

In some embodiments, an NLP composition as described herein can be formulated with one or more of wetters, spreaders, stickers, penetrants, buffers, sequestering agents, drift reduction agents, compatibility agents, anti-foam agents, cleaning agents, and emulsifiers.

As used herein, the term “wetting agent” or “wetter” refers to a substance that when added to a liquid increases the spreading or penetration power of a liquid by reducing the interfacial tension between the liquid and the surface on which it is spreading. Not wishing to be bound by any particular theory, a wetting agents may be used in a formulation (e.g., an agricultural formulation) for two main functions: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Nonlimiting examples of wetting agents include sodium lauryl sulfate, sodium dioctyl sulfosuccinate, alkyl phenol ethoxylates, and aliphatic alcohol ethoxylates.

As used herein, the term “dispersing agent” refers to a substance which adsorbs onto the surface of particles and helps to preserve the state of dispersion of the particles and prevents them from reaggregating. Not wishing to be bound by any particular theory, dispersing agents have the ability to adsorb strongly onto a particle surface and provide a charged or steric barrier to reaggregation of particles. In some embodiments, a dispersing agent may be used in a formulation (e.g., an agricultural formulation) of NLP compositions as described herein to facilitate dispersion and suspension during manufacture, and/or to ensure the particles redisperse into water in a spray tank. In some embodiments, a dispersing agent may be used in wettable powders, suspension concentrates and water-dispersible granules. In some embodiments, one or more surfactants may be used as a dispersing agent. In some embodiments, an anionic surfactant, a non-ionic surfactant, or mixtures of anionic surfactants and non-ionic surfactants may be used as a dispersing agent. In some embodiments, one or more dispersing agents selected from the group consisting of sodium lignosulfonates, polyelectrolytes (e.g., sodium naphthalene sulfonate formaldehyde condensates), tristyrylphenol ethoxylate phosphate esters, alkylarylethylene oxide condensates, aliphatic alcohol ethoxylates, alkyl ethoxylates, EO-PO (ethylene oxide-propylene oxide) block copolymers, and graft copolymers or any combination thereof and optionally combined with anionics may be used in a formulation (e.g., an agricultural formulation) comprising one or more NLP compositions as described herein. In some embodiments, one or more high molecular weight polymeric surfactants may be used as a dispersing agent. In some embodiments, a high molecular weight polymeric surfactant has a long hydrophobic ‘backbone’ and a large number of ethylene oxide chains forming the ‘teeth’ of a ‘comb’ surfactant. Not wishing to be bound by any particular theory, a high molecular weight polymer can provide long-term stability to suspension concentrates because the hydrophobic backbones have many anchoring points onto the particle surfaces.

As used herein, the term “emulsifying agent” or “emulsifier” refers to a substance which stabilizes a suspension of droplets of one liquid phase in another liquid phase. In some embodiments, an emulsifying agent may be used in a formulation (e.g., an agricultural formulation) of NLP compositions as described herein to prevent two liquids from separating into two immiscible liquid phases. In some embodiments, one or more emulsifiers selected from the group consisting of alkylphenol, aliphatic alcohol (e.g., an aliphatic alcohol with twelve or more ethylene oxide units), and oil-soluble calcium salt of dodecylbenzenesulfonic acid, or any combination thereof. In some embodiments, a small amount of an EO-PO block copolymer surfactant is provided with an emulsifying agent in a formulation (e.g., an agricultural formulation) of NLP compositions as described herein to improve emulsion stability. Several embodiments relate to a formulation (e.g., an agricultural formulation) of NLP compositions as described herein with range of hydrophile-lipophile balance (“HLB”) values from 8 to 18.

In some embodiments, a formulation (e.g., an agricultural formulation) of NLP compositions as described herein comprises a surfactant which will form micelles in water at concentrations above the critical micelle concentration as a solubilizing agent. Not wishing to be bound by any particular theory, micelles in a formulation (e.g., an agricultural formulation) of NLP compositions are able to dissolve or solubilize water-insoluble materials inside the hydrophobic portions of the NLP composition. In some embodiments, a formulation (e.g., an agricultural formulation) of NLP compositions as described herein comprises one or more surfactants selected from the group consisting of a non-ionic surfactant, sorbitan monooleates, sorbitan monooleate ethoxylates, and methyl oleate esters or any combination thereof.

In some embodiments, a formulation (e.g., an agricultural formulation) of NLP compositions as described herein comprises a surfactant which, either alone or with other excipients, such as mineral or vegetable oils, improves the biological activity of the NLP composition on the target. The types of surfactants used for enhancement of the biological activity of an NLP composition depends generally on the nature and mode of action of the NLP composition. In some embodiments, a formulation (e.g., an agricultural formulation) of NLP compositions as described herein comprises one or more surfactants selected from the group consisting of non-ionic surfactants (e.g., alkyl ethoxylates), linear aliphatic alcohol ethoxylates, and aliphatic amine ethoxylates, or any combination thereof.

In some embodiments, a formulation (e.g., an agricultural formulation) of NLP compositions as described herein comprises a carrier or diluent in an amount necessary to adjust the concentration, strength, and/or biological activity. In some embodiments, one or more materials with high absorptive capacities are provided as a carrier in a formulation (e.g., an agricultural formulation) of NLP compositions as described herein. In some embodiments, one or more materials with low absorptive capacities are provided as a diluent in a formulation (e.g., an agricultural formulation) of NLP compositions as described herein. In some embodiments, one or more carriers and/or diluents are provided in the formulation of dust, wettable powder, granule, and water-dispersible granule formulations of NLP compositions as described herein.

Several embodiments relate to use of one or more organic solvents in the formulation of one or more NLP compositions as an emulsifiable concentrate, an oil-in-water emulsion, a suspoemulsion, an ultra-low volume NLP formulation, and a granular NLP formulation. In some embodiments, a formulation (e.g., an agricultural formulation) of NLP compositions as described herein comprises a mixture of organic solvents. In some embodiments, a formulation (e.g., an agricultural formulation) of NLP compositions as described herein comprises an aliphatic paraffinic oil, such as kerosene or refined paraffin. In some embodiments, a formulation (e.g., an agricultural formulation) of NLP compositions as described herein comprises an aromatic solvent, such as xylene and higher molecular weight fractions of C9 and C10 aromatic solvents. In some embodiments, a formulation (e.g., an agricultural formulation) of NLP compositions as described herein comprises a mixture of an aliphatic paraffinic oil and an aromatic solvent. In some embodiments, a formulation (e.g., an agricultural formulation) of NLP compositions as described herein comprises one or more cosolvents. In some embodiments, a formulation (e.g., an agricultural formulation) of NLP compositions as described herein comprises one or more chlorinated hydrocarbons as cosolvents to prevent crystallization of NLP compositions when formulated as an emulsion in water. In some embodiments, a formulation (e.g., an agricultural formulation) of NLP compositions as described herein comprises one or more alcohols as cosolvents. In some embodiments, a formulation (e.g., an agricultural formulation) of NLP compositions as described herein comprises one or more solvents selected from the group consisting of vegetable oil, seed oil, esters of vegetable oil and esters of seed oil or any combination thereof.

Several embodiments relate to use of one or more thickeners, gelling agents, and/or anti-settling agents in the formulation of one or more NLP compositions as suspension concentrates, emulsions, or suspoemulsions to modify the rheology or flow properties of the liquid formulation and to prevent separation and settling of dispersed NLP compositions. In some embodiments, a formulation (e.g., an agricultural formulation) of NLP compositions as described herein comprises one or more water-insoluble particulates (e.g., clays, silicas, montmorillonite, bentonite, magnesium aluminum silicate, attapulgite, etc.) as a thickening, gelling, and/or anti-settling agent. In some embodiments, a formulation (e.g., an agricultural formulation) of NLP compositions as described herein comprises one or more water-soluble polymers (e.g., a polysaccharide) as a thickening, gelling, and/or anti-settling agent. In some embodiments, a formulation (e.g., an agricultural formulation) of NLP compositions as described herein comprises one or more polysaccharides extracted from seeds or seaweeds. In some embodiments, a formulation (e.g., an agricultural formulation) of NLP compositions as described herein comprises one or more cellulose derivatives. In some embodiments, a formulation (e.g., an agricultural formulation) of NLP compositions as described herein comprises one or more cellulose derivatives selected from the group consisting of xanthan gum, guar gum, locust bean gum, carrageenam, alginates, methyl cellulose, sodium carboxymethyl cellulose (SCMC), hydroxyethyl cellulose (HEC). In some embodiments, a formulation (e.g., an agricultural formulation) of NLP compositions as described herein comprises one or more anti-settling agents selected from the group consisting of modified starches, polyacrylates, polyvinyl alcohol, and polyethylene oxide.

Microorganisms can cause spoilage or degradation of NLP compositions as described herein. In some embodiments, one or more preservation agents are used to eliminate or reduce the effect of microorganisms on NLP compositions. In some embodiments, a formulation (e.g., an agricultural formulation) of NLP compositions as described herein comprises one or more antimicrobial agents. In some embodiments, a formulation (e.g., an agricultural formulation) of NLP compositions as described herein comprises one or more of propionic acid, sodium salt of propionic acid, sorbic acid, sodium salts of sorbic acid, potassium salts of sorbic acid, benzoic acid, sodium salts of benzoic acid, p-hydroxybenzoic acid sodium salt, methyl p-hydroxybenzoate, and 1,2-benzisothiazolin-3-one (BIT).

The presence of surfactant in water-based formulations of NLP compositions can cause foaming during mixing operations in production and in application through a spray tank. In order to reduce the tendency to foam, anti-foam agents may be added either during the production stage or before filling into bottles. Generally, there are two types of anti-foam agents, namely silicones and non-silicones. Silicones are usually aqueous emulsions of dimethyl polysiloxane, while the non-silicone anti-foam agents are water-insoluble oils, such as octanol and nonanol, or silica. In both cases, the function of the anti-foam agent is to displace the surfactant from the air-water interface.

Several embodiments relate to use of one or more “Green” agents (e.g., adjuvants, surfactants, solvents) that reduce the overall environmental footprint of crop protection formulations. Green agents are biodegradable and generally derived from natural and/or sustainable sources, e.g., plant and animal sources. In some embodiments, a formulation (e.g., an agricultural formulation) of NLP compositions as described herein comprises one or more green agents selected from the group consisting of vegetable oils, esters of vegetable oils, seed oils, esters of seed oils, and alkoxylated alkyl polyglucosides.

In some embodiments, an NLP composition as described herein can be freeze-dried or lyophilized. See, e.g., U.S. Pat. No. 4,311,712 incorporated by reference herein. In some embodiments, freeze-dried or lyophilized NLP compositions can be reconstituted with water or another liquid. In some embodiments, freeze-dried or lyophilized NLP compositions can be reconstituted with a solution comprising one or more heterologous functional agents, agriculturally acceptable carriers, solvents, co-solvents, dispersing agents, emulsifiers, and/or other materials in accordance with the formulations described herein.

In some embodiments, an NLP composition as described herein can be formulated with carriers or delivery vehicles that protect the NLP composition against UV and/or acidic conditions. In some embodiments, an NLP composition as described herein can be formulated with delivery vehicle containing a pH buffer. In some embodiments, an NLP composition as described herein can be formulated to have a pH in the range of about 4.5 to about 9.0, including for example pH ranges of about any one of 5.0 to about 8.0, about 6.5 to about 7.5, or about 6.5 to about 7.0. In some embodiments, an NLP composition as described herein can be formulated as described in “Chemistry and Technology of Agrochemical Formulations” edited by D. A. Knowles, copyright 1998 by Kluwer Academic Publishers, which is incorporated herein by reference. In some embodiments, an NLP composition as described herein can be formulated as described in “Insecticides in Agriculture and Environment—Retrospects and Prospects” by A. S. Perry, I. Yamamoto, I. Ishaaya, and R. Perry, copyright 1998 by Springer-Verlag, which is incorporated herein by reference.

ii. Pharmaceutical Formulations

Several embodiments relate to pharmaceutical formulations of one or more NLP compositions as described herein. NLP compositions as described herein may be formulated according to conventional pharmaceutical practice. In some embodiments, an NLP composition as described herein can be formulated into a pharmaceutical composition suitable for administration to an animal (e.g., a human). In some embodiments, a pharmaceutical formulation of one or more NLP compositions as described herein may be administered to an animal (e.g., human) with a pharmaceutically acceptable diluent, carrier, and/or excipient. Depending on the mode of administration and the dosage, an NLP composition as described herein can be formulated into suitable pharmaceutical compositions to permit facile delivery. In some embodiments, an effective amount of one or more NLP compositions as described herein may be formulated as a single dose in a unit dose form as needed. The concentration of NLPs in a pharmaceutical formulation can vary depending upon a number of factors, including the dosage of the heterologous active agent comprised in the NLP to be administered and the route of administration.

In some embodiments, NLP compositions as described herein can be formulated with one or more excipients and/or carriers. In some embodiments, an NLP composition may be formulated with a pharmaceutical carrier suitable for oral administration, intravenous administration (e.g., injection or infusion), or subcutaneous administration to an animal. In some embodiments, an NLP composition may be formulated with a pharmaceutical carrier as described in Remington: The Science and Practice of Pharmacy, 22nd ed., (2012) or ASHP Handbook on Injectable Drugs, 18th ed., (2014), both of which are incorporated by reference. Pharmaceutically acceptable carriers and excipients suitable for use in pharmaceutical formulations of NLP compositions are nontoxic to recipients at the dosages and concentrations employed. In some embodiments, an NLP composition may be formulated with one or more of a pharmaceutically acceptable buffer (e.g., phosphate buffer, citrate buffer, HEPES, TAE, etc.), antioxidant (e.g., ascorbic acid, methionine, etc.), preservative (e.g., hexamethonium chloride, octadecyldimethylbenzyl ammonium chloride, resorcinol, benzalkonium chloride, etc.), protein (e.g., serum albumin, gelatin, dextran, immunoglobulins, etc.), hydrophilic polymer (e.g., polyvinylpyrrolidone, etc.), amino acid (e.g., glycine, glutamine, histidine, lysine, etc.) and carbohydrate (e.g., glucose, mannose, sucrose, sorbitol, etc.).

In some embodiments, NLP compositions as described herein can be formulated with one or more excipients selected from the group consisting of inert diluents, fillers (e.g., sucrose, sorbitol, sugar, mannitol, microcrystalline cellulose, starches (e.g., potato starch), calcium carbonate, sodium chloride, lactose, calcium phosphate, calcium sulfate, sodium phosphate, etc.); granulating agents, disintegrating agents (e.g., cellulose derivatives (e.g., microcrystalline cellulose), starches (e.g., potato starch), croscarmellose sodium, alginates, alginic acid), binding agents (e.g., sucrose, glucose, sorbitol, acacia, alginic acid, sodium alginate, gelatin, starch, pregelatinized starch, microcrystalline cellulose, magnesium aluminum silicate, carboxymethylcellulose sodium, methylcellulose, hydroxypropyl methylcellulose, ethylcellulose, polyvinylpyrrolidone, polyethylene glycol, etc.), lubricating agents, glidants, antiadhesives (e.g., magnesium stearate, zinc stearate, stearic acid, silicas, hydrogenated vegetable oils, or talc), colorants, flavoring agents, plasticizers, humectants, and buffering agents or any combination thereof.

For oral administration to an animal, an NLP composition can be prepared in the form of an oral formulation. Formulations for oral use can include tablets, caplets, capsules, syrups, or oral liquid dosage forms containing one or more NLP compositions) in a mixture with non-toxic pharmaceutically acceptable excipients. In some embodiments an NLP composition as described herein can be formulated for oral delivery (e.g., in unit dosage form as chewable tablets, non-chewable tablets, caplets, capsules (e.g., as hard gelatin capsules wherein the active ingredient is mixed with an inert solid diluent, or as soft gelatin capsules wherein NLP compositions are mixed with water or an oil medium). In some embodiments an NLP composition as described herein can be formulated as an immediate-release, extended release or delayed-release formulation.

For parenteral administration to an animal, an NLP composition may be formulated in the form of liquid solutions or suspensions and administered by a parenteral route (e.g., subcutaneous, intravenous, or intramuscular). In some embodiments an NLP composition as described herein can be formulated for injection or infusion. Pharmaceutical formulations of NLP compositions for parenteral administration can be formulated using a sterile solution or any pharmaceutically acceptable liquid as a vehicle. In some embodiments a pharmaceutical formulation of NLP compositions suitable for parenteral administrate comprise one or more pharmaceutically acceptable vehicles selected from the group consisting of sterile water, physiological saline, and cell culture media (e.g., Dulbecco's Modified Eagle Medium (DMEM), a-Modified Eagles Medium (a-MEM), F-12 medium). Formulation methods are known in the art, see e.g., Gibson (ed.) Pharmaceutical Preformulation and Formulation (2nd ed.) Taylor & Francis Group, CRC Press (2009).

### II. Heterologous Functional Agents

Several embodiments relate to an NLP composition comprising one or more heterologous functional agents, such as a heterologous agricultural agent (e.g., a pesticidal agent, fertilizing agent, herbicidal agent, plant-modifying agent, etc.) or a heterologous therapeutic agent (e.g., an antifungal agent, an anti-oomycete agent, an antibacterial agent, a virucidal agent, an anti-viral agent, an insecticidal agent, a nematocidal agent, an antiparasitic agent, an insect repellent, etc.). In some embodiments of an NLP composition as described herein, an NLP may encapsulate the heterologous functional agent. In some embodiments of an NLP composition as described herein, the heterologous functional agent can be embedded on or conjugated to the surface of the NLP. In some embodiments, an NLP composition may include two or more (e.g., 2, 3, 4, 5, 6, 7, 8, 9, 10, or more than 10) different heterologous functional agents. Heterologous functional agents may be added at any step during the manufacturing process effective to introduce the agent into the NLP composition.

In some embodiments, a heterologous functional agent (e.g., a heterologous agricultural agent (e.g., pesticidal agent, fertilizing agent, herbicidal agent, plant-modifying agent, a heterologous nucleic acid, a heterologous polypeptide, a heterologous small molecule, etc.) or a heterologous therapeutic agent (e.g., an antifungal agent, an anti-oomycete agent, an antibacterial agent, a virucidal agent, an anti-viral agent, a nematicidal agent, an antiparasitic agent, an insect repellent, etc.)) can be modified. For example, the modification can be a chemical modification, e.g., conjugation to a marker, e.g., fluorescent marker or a radioactive marker. In some embodiments, the modification can include conjugation or operational linkage of a heterologous functional agent to a moiety that enhances the stability, delivery, targeting, bioavailability, or half-life of the agent, e.g., a lipid, a glycan, a polymer (e.g., PEG), or a cation moiety.

Examples of heterologous functional agents that can be loaded into the NLP compositions as described herein are outlined below.

### A. Heterologous Agricultural Agents

An NLP composition as described herein can include one or more heterologous agricultural agents. Nonlimiting examples of heterologous agricultural agents include antifungal agents, antibacterial agents, insecticidal agents, molluscicidal agents, nematicidal agents, herbidical agents, virucidal agents, peptides, polypeptides, nucleic acids, polynucleotides, and ribonucleoproteins.

For example, in some instances, an NLP composition may include one or more pesticidal agents. Nonlimiting examples of pesticidal agents include antifungal agents, antibacterial agents, insecticidal agents, molluscicidal agents, nematicidal agents, virucidal agents. In some embodiments, the pesticidal agent can be a chemical agent, such as those well known in the art (e.g., deltamethrin). In some embodiments, the pesticidal agent can be a peptide, a polypeptide, a nucleic acid, a polynucleotide, or a small molecule. In some embodiments, the pesticidal agent may be an agent that can decrease the fitness of a variety of plant pests or can be one that targets one or more specific target plant pests (e.g., a specific species or genus of plant pests).

In some instances, an NLP composition may include one or more heterologous fertilizing agents. Nonlimiting examples of heterologous fertilizing agents include plant nutrients and plant growth regulators, such as those well known in the art. In some embodiments, the fertilizing agent can be a mineral, a peptide, a polypeptide, a nucleic acid, or a polynucleotide that can increase the fitness of a plant or plant microorganism (e.g. a plant symbiont). In some embodiments, the fertilizing agent may be an agent that can increase the fitness of a variety of plants or plant microorganisms or can be one that targets one or more specific target plants or plant microorganisms (e.g., a specific species or genera of plants or plant microorganisms).

In some embodiments, an NLP composition may include one or more heterologous plant-modifying agents. In some instances, the plant-modifying agent can include a peptide or a nucleic acid.

### B. Heterologous Therapeutic Agents

An NLP composition as described herein can include one or more heterologous therapeutic agents (e.g., an agent that affects an animal (e.g., a mammal, e.g., a human), an animal pathogen, or a pathogen vector thereof). Nonlimiting examples of heterologous therapeutic agents include a therapeutic peptide, a therapeutic nucleic acid (e.g., a therapeutic RNA), a therapeutic small molecule, and a pathogen control agent (e.g., antifungal agent, an antibacterial agent, a virucidal agent, an anti-viral agent, an insecticidal agent, a nematicidal agent, an antiparasitic agent, an insect repellent, etc.). In some embodiments, an NLP composition loaded a heterologous therapeutic agent can be formulated with a pharmaceutically acceptable carrier for delivery to an animal, an animal pathogen, or a pathogen vector thereof.

### C. Antibacterial Agents

In some embodiments, an NLP composition as described herein can include an antibacterial agent. In some embodiments, an NLP composition includes two or more (e.g., 2, 3, 4, 5, 6, 7, 8, 9, 10, or more than 10) different antibacterial agents. In some embodiments, an NLP composition as described herein can include an antibacterial agent that decreases the fitness of (e.g., decrease growth or kill) a bacterial pathogen (e.g., a bacterial plant pathogen, a bacterial animal pathogen). In some embodiments, a targeted bacteria or plant or animal infected with the target bacteria can be contacted with an NLP composition comprising an antibiotic as described herein in an amount and for a time sufficient to: (a) reach a target level (e.g., a predetermined or threshold level) of antibiotic concentration inside or on the target bacteria; and (b) decrease fitness of the target bacteria. An antibacterial agent may be loaded in an NLP composition according to any of the methods described herein, and in certain instances, may be associated with the surface of an NLP.

As used herein, the term “antibacterial agent” refers to any material that kills or inhibits the growth, proliferation, division, reproduction, or spread of bacteria, such as phytopathogenic bacteria, and includes bactericidal (e.g., disinfectant compounds, antiseptic compounds, antibiotics, etc.) and bacteriostatic agents (e.g., growth or reproduction inhibiting compounds or antibiotics). Bactericidal agents kill bacteria, while bacteriostatic agents only slow their growth or reproduction. Bactericides can include disinfectants, antiseptics, or antibiotics. Nonlimiting examples of disinfectants include active chlorine (e.g., hypochlorites (e.g., sodium hypochlorite), chloramines, dichloroisocyanurate and trichloroisocyanurate, wet chlorine, chlorine dioxide, active oxygen, peroxide (e.g., peracetic acid, potassium persulfate, sodium perborate, sodium percarbonate, urea perhydrate, etc.), iodine, iodpovidone, povidone-iodine, Betadine, Lugol's solution, iodine tincture, iodinated nonionic surfactants, concentrated alcohols (e.g., ethanol, 1-propanol (called also n-propanol), 2-propanol (called also isopropanol), 2-phenoxyethanol, 1-phenoxypropanol, 2-phenoxypropanol, etc.), phenolic substances (such as phenol (also called carbolic acid), cresols (called Lysole in combination with liquid potassium soaps), halogenated (chlorinated, brominated) phenols, such as hexachlorophene, triclosan, trichlorophenol, tribromophenol, pentachlorophenol, Dibromol and salts thereof), cationic surfactants, such as some quaternary ammonium cations (such as benzalkonium chloride, cetyl trimethylammonium bromide or chloride, didecyldimethylammonium chloride, cetylpyridinium chloride, benzethonium chloride) and others, non-quaternary compounds, such as chlorhexidine, glucoprotamine, octenidine dihydrochloride etc.), strong oxidizers, such as ozone and permanganate solutions; heavy metals and their salts, such as colloidal silver, silver nitrate, mercury chloride, phenylmercury salts, copper sulfate, copper oxide-chloride, copper hydroxide, copper octanoate, copper oxychloride sulfate, and copper sulfate pentahydrate. Concentrated strong acids (e.g., phosphoric acid, nitric acid, sulfuric acid, amidosulfuric acid, toluenesulfonic acid, etc.) and alkalis (e.g., sodium hydroxide, potassium hydroxide, calcium hydroxide, etc.) may also be used as disinfectants.

As used herein the term “antiseptic” refers to an antibacterial or germicidal agent that can under proper conditions (e.g., concentration, pH, temperature, etc.) be applied to an animal (e.g., skin, mucosas, wounds, etc.). Nonlimiting examples of antiseptics include diluted chlorine preparations (e.g., Daquin's solution, 0.5% sodium or potassium hypochlorite solution, pH-adjusted to pH 7-8, 0.5-1% solution of sodium benzenesulfochloramide (chloramine B), etc.), iodine preparations (e.g., iodopovidone in various galenics (ointment, solutions, wound plasters)), Lugol's solution, peroxides, urea perhydrate solutions, pH-buffered 0.1-0.25% peracetic acid solutions, alcohols with or without antiseptic additives, weak organic acids (e.g., sorbic acid, benzoic acid, lactic acid, salicylic acid), phenolic compounds (e.g., hexachlorophene, triclosan, Dibromol etc.), cation-active compounds (e.g., 0.05-0.5% benzalkonium, 0.5-4% chlorhexidine, 0.1-2% octenidine solutions).

Several embodiments relate to an NLP composition as described herein comprising one or more antibiotics. Antibiotics are commonly classified based on their mechanism of action, chemical structure, or spectrum of activity. Antibiotics may target any bacterial function or growth processes and may be either bacteriostatic or bactericidal. Antibiotics also vary in their level of target specificity (e.g., narrow- or broad-spectrum). In some instances, an antibiotic is a narrow-spectrum antibiotic, and thus targets specific types of bacteria, such as gram-negative or gram-positive bacteria. Alternatively, an antibiotic may be a broad-spectrum antibiotic that targets a wide range of bacteria.

Any antibiotic known in the art may be comprised in an NLP composition as described herein and/or formulated with an NLP composition. In some embodiments, an NLP composition as described herein may comprise one or more bactericidal antibiotics. Nonlimiting examples of bactericidal antibiotics include: antibiotics that target the bacterial cell wall (e.g., penicillins, cephalosporins); antibiotics that target the cell membrane (e.g., polymyxins); antibiotics that inhibit essential bacterial enzymes (e.g., rifamycins, lipiarmycins, quinolones, sulfonamides); aminoglycosides (e.g., kasugamycin). In some embodiments, an NLP composition as described herein may comprise one or more bacteriostatic antibiotics. Nonlimiting examples of bacteriostatic antibiotics include antibiotics that target protein synthesis (e.g., macrolides, lincosamides, tetracyclines). Additional classes of antibiotics that may be comprised in an NLP composition include, but are not limited to, cyclic lipopeptides (such as daptomycin), glycylcyclines (such as tigecycline), oxazolidinones (such as linezolid), and lipiarmycins (such as fidaxomicin). In some embodiments, an NLP composition as described herein may comprise one or more antibiotics selected from the group consisting of rifampicin, ciprofloxacin, doxycycline, ampicillin, and polymyxin B. In some embodiments, an NLP composition as described herein may comprise one or more antibiotics described in Table 4. One skilled in the art will appreciate that a suitable concentration of an antibiotic in an NLP composition or a formulation comprising one or more NLP compositions depends on factors such as efficacy, stability of the antibiotic, number of distinct antibiotics, the formulation, and methods of application of the composition.

TABLE 4
Examples of antibiotics

| Antibiotics | Action |
|---|---|
| Penicillins, cephalosporins, vancomycin | Cell wall synthesis |
| Polymixin, gramicidin | Membrane active agent, |
| | disrupt cell membrane |
| Tetracyclines, macrolides, chloramphenicol, | Inhibit protein synthesis |
| clindamycin, spectinomycin | |
| Sulfonamides | Inhibit folate-dependent |
| | pathways |
| Ciprofloxacin | Inhibit DNA-gyrase |
| Isoniazid, rifampicin, pyrazinamide, | Antimycobacterial agents |
| ethambutol, (myambutol)l, streptomycin | |

Several embodiments relate to an NLP composition comprising an antibiotic that can be administered to an animal (e.g., a human) in an amount and for a time sufficient to: reach a target level (e.g., a predetermined or threshold level) of antibiotic concentration inside or on the animal; and/or treat or prevent a bacterial infection in the animal. Non-limiting examples of antibacterial agents suitable for the treatment of animals that may be comprised in an NLP composition as described herein and/or formulated with an NLP composition include: penicillins (amoxicillin, ampicillin, bacampicillin, carbenicillin, cloxacillin, dicloxacillin, flucloxacillin, mezlocillin, nafcillin, oxacillin, penicillin g, crysticillin 300 A. S., pentids, permapen, pfizerpen, pfizerpen-AS, wycillin, penicillin V, piperacillin, pivampicillin, pivmecillinam, ticarcillin), cephalosporins (cefacetrile (cephacetrile), cefadroxil (cefadroxyl), cefalexin (cephalexin), cefaloglycin (cephaloglycin), cefalonium (cephalonium), cefaloridine (cephaloradine), cefalotin (cephalothin), cefapirin (cephapirin), cefatrizine, cefazaflur, cefazedone, cefazolin (cephazolin), cefradine (cephradine), cefroxadine, ceftezole, cefaclor, cefamandole, cefmetazole, cefonicid, cefotetan, cefoxitin, cefprozil (cefproxil), cefuroxime, cefuzonam, cefcapene, cefdaloxime, cefdinir, cefditoren, cefetamet, cefixime, cefmenoxime, cefodizime, cefotaxime, cefpimizole, cefpodoxime, cefteram, ceftibuten, ceftiofur, ceftiolene, ceftizoxime, ceftriaxone, cefoperazone, ceftazidime, cefclidine, cefepime, cefluprenam, cefoselis, cefozopran, cefpirome, cefquinome, ceftobiprole, ceftaroline, cefaclomezine, cefaloram, cefaparole, cefcanel, cefedrolor, cefempidone, cefetrizole, cefivitril, cefmatilen, cefmepidium, cefovecin, cefoxazole, cefrotil, cefsumide, cefuracetime, ceftioxide, combinations, ceftazidime/avibactam, ceftolozane/tazobactam), monobactams (aztreonam), carbapenems (imipenem, imipenem/cilastatin .doripenem, ertapenem, meropenem, meropenem/vaborbactam), macrolide (azithromycin, erythromycin, clarithromycin, dirithromycin, roxithromycin, telithromycin), lincosamides (clindamycin, lincomycin), streptogramins (pristinamycin, quinupristin/dalfopristin), aminoglycoside (amikacin, gentamicin, kanamycin, neomycin, netilmicin, paromomycin, streptomycin, tobramycin), quinolone (flumequine, nalidixic acid, oxolinic acid, piromidic acid, pipemidic acid, rosoxacin, second generation, ciprofloxacin, enoxacin, lomefloxacin, nadifloxacin, norfloxacin, ofloxacin, pefloxacin, rufloxacin, balofloxacin, gatifloxacin, grepafloxacin, levofloxacin, moxifloxacin, pazufloxacin, sparfloxacin, temafloxacin, tosufloxacin, besifloxacin, delafloxacin, clinafloxacin, gemifloxacin, prulifloxacin, sitafloxacin, trovafloxacin), sulfonamides (sulfamethizole, sulfamethoxazole, sulfisoxazole, trimethoprim-sulfamethoxazole), tetracycline (demeclocycline, doxycycline, minocycline, oxytetracycline, tetracycline, tigecycline), other (lipopeptides, fluoroquinolone, lipoglycopeptides, cephalosporin, macrocyclics, chloramphenicol, metronidazole, tinidazole, nitrofurantoin, glycopeptides, vancomycin, teicoplanin, lipoglycopeptides, telavancin, oxazolidinones, linezolid, cycloserine 2, rifamycins, rifampin, rifabutin, rifapentine, rifalazil, polypeptides, bacitracin, polymyxin B, tuberactinomycins, viomycin, capreomycin). One skilled in the art will appreciate that a suitable concentration of each antibiotic in the composition depends on factors such as efficacy, stability of the antibiotic, number of distinct antibiotics, the formulation, and methods of application of the composition.

### D. Antifungal Agents

Several embodiments relate to an NLP composition as described herein comprising one or more antifungal agents. In some instances, an NLP composition can include two or more (e.g., 2, 3, 4, 5, 6, 7, 8, 9, 10, or more than 10) different antifungal agents. Several embodiments relate to a method of decreasing the fitness (e.g., decrease growth or kill) of a fungus (e.g., a fungal plant pathogen) by contacting the fungus or a plant or animal infested with the fungus with an NLP composition comprising an antifungal agent, in an amount and for a time sufficient to: (a) reach a target level (e.g., a predetermined or threshold level) of antifungal agent concentration inside or on the targeted fungus; and (b) decrease fitness of the target fungus. Antifungal agent may be loaded/incorporated into an NLP composition as described herein and/or formulated with an NLP composition by any of the methods described herein.

As used herein, the term “fungicide” or “antifungal agent” refers to a substance that kills or inhibits the growth, proliferation, division, reproduction, or spread of fungi, such as phytopathogenic fungi or animal pathogenic fungi. Non-limiting examples of antifungal agents that may be comprised in an NLP composition as described herein and/or formulated with an NLP composition include: azoxystrobin, mancozeb, prothioconazole, folpet, tebuconazole, difenoconazole, captan, bupirimate, orfosetyl-AI, strobilurins, azoxystrobin, dimoxystrobin, enestroburin, fluoxastrobin, kresoxim-methyl, metominostrobin, picoxystrobin, pyraclostrobin, trifloxystrobin, orysastrobin, carboxamides, carboxanilides, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M (mefenoxam), methfuroxam, metsulfovax, ofurace, oxadixyl, oxycarboxin, penthiopyrad, pyracarbolid, salicylanilide, tecloftalam, thifluzamide, tiadinil, N-biphenylamides, bixafen, boscalid, carboxylic acid morpholides, dimethomorph, flumorph, benzamides, flumetover, fluopicolid (picobenzamid), zoxamid, carboxamides, carpropamid, diclocymet, mandipropamid, silthiofam, azoles, triazoles, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, Imidazoles, cyazofamid, imazalil, pefurazoate, prochloraz, triflumizole, benzimidazoles, benomyl, carbendazim, fuberidazole, thiabendazole, ethaboxam, etridiazole, hymexazol, nitrogen-containing heterocyclyl compounds, pyridines, fuazinam, pyrifenox, pyrimidines, cyprodinil, ferimzone, fenarimol, mepanipyrim, nuarimol, pyrimethanil, piperazines, triforine, pyrroles, fludioxonil, fenpiclonil, morpholines, aldimorph, dodemorph, fenpropimorph, tridemorph, dicarboximides, iprodione, procymidone, vinclozolin, acibenzolar-S-methyl, anilazine, captan, captafol, dazomet, diclomezin, fenoxanil, folpet, fenpropidin, famoxadon, fenamidon, octhilinone, probenazole, proquinazid, pyroquilon, quinoxyfen, tricyclazole, carbamates, dithiocarbamates, ferbam, mancozeb, maneb, metiram, metam, propineb, thiram, zineb, ziram, diethofencarb, flubenthiavalicarb, iprovalicarb, propamocarb, guanidines, dodine, iminoctadine, guazatine, kasugamycin, polyoxins, streptomycin, validamycin A, organometallic compounds, fentin salts, sulfur-containing heterocyclyl compounds, isoprothiolane, dithianone, organophosphorous compounds, edifenphos, fosetyl, fosetyl-aluminum, iprobenfos, pyrazophos, tolclofos-methyl, Organochlorine compounds, thiophanate-methyl, chlorothalonil, dichlofluanid, tolylfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon, N-2-cyanophenyl-3,4-dichloroisothiazol-5-carboxamide (isotianil), N-(3′,4′,5′-trifluorobiphenyl-2-yl)-3-difluoromethyl-1-methylpyrazole-4-carboxamide, 3-[5-(4-chlorophenyl)-2,3-dimethylisoxazolidin-3-yl]-pyridine, N-(3′,4′-dichloro-4-fluorobiphenyl-2-yl)-3-difluoromethyl-1-methylpyrazol-e-4-carboxamide, 5-chloro-7-(4-methylpiperidin-1-yl)-6-(2,4,6-trifluorophenyl)-[1,2,4]tria-zolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazo-le-1-sulfonamide, methyl-(2-chloro-5-[1-(3-methylbenzyloxyimino)-ethyl]benzyl)carbamate, methyl-(2-chloro-5-[1-(6-methylpyridin-2-ylmethoxy-imino)ethyl]benzyl)carbamate, methyl 3-(4-chlorophenyl)-3-(2-isopropoxycarbonylamino-3-methylbutyryl-amino)propionate, 4-fluorophenyl N-(1-(1-(4-cyanophenyl)ethanesulfonyl)but-2-yl)carbamate, N-(2-(4-[3-(4-chlorophenyl)prop-2-ynyloxy]-3-methoxyphenyl)ethyl)-2-metha-nesulfonylamino-3-methylbutyramide, N-(2-(4-[3-(4-chlorophenyl)prop-2-ynyloxy]-3-methoxyphenyl)ethyl)-2-ethan-esulfonylamino-3-methylbutyramide, N-(4′-bromobiphenyl-2-yl)-4-difluoromethyl-2-methylthiazol-5-carboxamide, N-(4′-trifluoromethylbiphenyl-2-yl)-4-difluoromethyl-2-methylthiazol-5-carboxamide, N-(4′-chloro-3′-fluorobiphenyl-2-yl)-4-difluoromethyl-2-methylt-hiazol-5-carboxamide, methyl 2-(ortho-((2,5-dimethylphenyloxy-methylene)phenyl)-3-methoxyacrylate or oxathiapiprolin. One skilled in the art will appreciate that a suitable concentration of each antifungal in an NLP composition or a formulation comprising one or more NLP compositions depends on factors such as efficacy, stability of the antifungal, number of distinct antifungals, the formulation, and methods of application of the composition.

Several embodiments relate to an NLP composition comprising an antifungal agent that can be administered to an animal (e.g., a human) in an amount and for a time sufficient to: reach a target level (e.g., a predetermined or threshold level) of antifungal concentration inside or on the animal; and/or treat or prevent a fungal infection in the animal. Non-limiting examples of antifungal agents suitable for the treatment of animals that may be comprised in an NLP composition as described herein and/or formulated with an NLP composition include: allylamines (amorolfin, butenafine, naftifine, terbinafine), imidazoles ((bifonazole, butoconazole, clotrimazole, econazole, fenticonazole, ketoconazole, isoconazole, luliconazole, miconazole, omoconazole, oxiconazole, sertaconazole, sulconazole, tioconazole, terconazole); triazoles (albaconazole, efinaconazole, fluconazole, isavuconazole, itraconazole, posaconazole, ravuconazole, terconazole, voriconazole), thiazoles (abafungin), polyenes (amphotericin b, nystatin, natamycin, trichomycin), echinocandins (anidulafungin, caspofungin, micafungin), tolnaftate, flucytosine, butenafine, griseofulvin, ciclopirox, selenium sulfide, and tavaborole. One skilled in the art will appreciate that a suitable concentration of each antifungal in the NLP composition depends on factors such as efficacy, stability of the antifungal, number of distinct antifungals, the formulation, and methods of application of the NLP composition.

### E. Insecticidal Agents

Several embodiments relate to an NLP composition as described herein comprising one or more insecticidal agents. In some instances, an NLP composition includes two or more (e.g., 2, 3, 4, 5, 6, 7, 8, 9, 10, or more than 10) different insecticidal agents. Several embodiments relate to a method of decreasing the fitness (e.g., decrease growth or kill) of a targeted insect by contacting the targeted insect or a plant or animal infested with or parasitized by the targeted insect with an NLP composition including an insecticidal agent, in an amount and for a time sufficient to: (a) reach a target level (e.g., a predetermined or threshold level) of insecticidal agent concentration inside or on the target insect; and (b) decrease fitness of the target insect. Insecticidal agents may be loaded/incorporated into an NLP composition as described herein and/or formulated with an NLP composition by any of the methods described herein.

As used herein, the term “insecticide” or “insecticidal agent” refers to a substance that decreases the fitness (e.g., kills, inhibits the growth, inhibits proliferation, inhibits reproduction, inhibits spread, inhibits feeding, reduces fecundity, etc.) of an insect, such as an agricultural insect pest (e.g., corn root worm, stink bug, canola flea beetle, THRIPS, fall army worm, etc.), an insect vector of an animal pathogen, or a parasitic insect. Non-limiting examples of insecticides that may be comprised in an NLP composition as described herein and/or formulated with an NLP composition are described in Tables 5A and 5B. Additional non-limiting examples of insecticides are flupyradifuron, spirotetramat, spiromesifen, fluopyram, imidacloprid, flubendiamide, permethrin, thiacloprid, fluopyram, sulfoxaflor, spinetoram, chlorpyrifos, spinosad, cyantraniliprole, indoxacarb, chlorantraniliprole, cypermethrin, emamectin benzoate, pymetrozine, thiamethoxam, lamda cyhalothrin, and cyclaniliprole.

Additional non-limiting examples of suitable insecticides that may be comprised in an NLP composition as described herein and/or formulated with an NLP composition include biologic insecticides, such as: inhibitory RNAs targeting an essential insect gene; hormones, such as ecdysteroidal and juvenile hormone; pheromones, such as codlemone; insecticidal proteins (e.g., Bacillus thuringiensis (Bt) crystalline proteins (Cry) (e.g., CrylAb, CrylFa, Cry2Ab, etc.), vegetative insecticidal proteins (Vip) (e.g., Vip1, Vip2, Vip3 (e.g., Vip3Aa), Vip4, etc.), IPD083Aa, IPD083Cb, etc.); insecticidal plant extracts, such as neem oil and azadirachtin; insecticidal bacteria, such as Bacillus species (e.g., Bacillus thuringiensis), Beauveria species, Metarrhizium species, Saccharopolyspora species, Paecilomyces species, and Verticillium species. In some embodiments, an NLP composition as described herein may include or be formulated with one or more insecticidal active compounds having unknown or non-specified mechanisms of action such as fumigants (e.g., aluminum phosphide, methyl bromide, sulphuryl fluoride, etc.) and selective feeding inhibitors (e.g., cryolite, flonicamid, pymetrozine, etc.). One skilled in the art will appreciate that a suitable concentration of each insecticidal agent in an NLP composition depends on factors such as efficacy, stability of the insecticide, number of distinct insecticides, the formulation, and methods of application of the NLP composition.

TABLE 5A
Examples of insecticides

| Class | Compounds |
|---|---|
| chloronicotinyls/ | acetamiprid, clothianidin, dinotefuran, imidacloprid, nitenpyram, |
| neonicotinoids | nithiazine, thiacloprid, thiamethoxam, imidaclothiz, (2E)-1-[(2- |
| | chloro-1,3-thiazol-5-yl)methyl]-3,5-dimethyl-N-nitro-1,3,5-tri-azinan- |
| | 2-imine, acetylcholinesterase (AChE) inhibitors (such as |
| | carbamates and organophosphates) |
| carbamates | alanycarb, aldicarb, aldoxycarb, allyxycarb, aminocarb, bendiocarb, |
| | benfuracarb, bufencarb, butacarb, butocarboxim, butoxycarboxim, |
| | carbaryl, carbofuran, carbosulfan, chloethocarb, dimetilan, |
| | ethiofencarb, fenobucarb, fenothiocarb, formetanate, furathiocarb, |
| | isoprocarb, metam-sodium, methiocarb, methomyl, metolcarb, |
| | oxamyl, phosphocarb, pirimicarb, promecarb, propoxur, thiodicarb, |
| | thiofanox, triazamate, trimethacarb, XMC, xylylcarb |
| organophosphates | acephate, azamethiphos, azinphos (-methyl, -ethyl), bromophos- |
| | ethyl, bromfenvinfos (-methyl), butathiofos, cadusafos, |
| | carbophenothion, chlorethoxyfos, chlorfenvinphos, chlormephos, |
| | chlorpyrifos (-methyl/-ethyl), coumaphos, cyanofenphos, |
| | cyanophos, demeton-S-methyl, demeton-S-methylsulphon, dialifos, |
| | diazinon, dichlofenthion, dichlorvos/DDVP, dicrotophos, |
| | dimethoate, dimethylvinphos, dioxabenzofos, disulfoton, EPN, |
| | ethion, ethoprophos, etrimfos, famphur, fenamiphos, fenitrothion, |
| | fensulfothion, fenthion, flupyrazofos, fonofos, formothion, |
| | fosmethilan, fosthiazate, heptenophos, iodofenphos, iprobenfos, |
| | isazofos, isofenphos, isopropyl O-salicylate, isoxathion, malathion, |
| | mecarbam, methacrifos, methamidophos, methidathion, |
| | mevinphos, monocrotophos, naled, omethoate, oxydemeton- |
| | methyl, parathion (-methyl/-ethyl), phenthoate, phorate, phosalone, |
| | phosmet, phosphamidon, phosphocarb, phoxim, pirimiphos |
| | (-methyl/-ethyl), profenofos, propaphos, propetamphos, prothiofos, |
| | prothoate, pyraclofos, pyridaphenthion, pyridathion, quinalphos, |
| | sebufos, sulfotep, sulprofos, tebupirimfos, temephos, terbufos, |
| | tetrachlorvinphos, thiometon, triazophos, triclorfon, vamidothion |
| pyrethroids | acrinathrin, allethrin (d-cis-trans, d-trans), cypermethrin (alpha-, |
| | beta-, theta-, zeta-), permethrin (cis-, trans-), beta-cyfluthrin, |
| | bifenthrin, bioallethrin, bioallethrin-S-cyclopentyl-isomer, |
| | bioethanomethrin, biopermethrin, bioresmethrin, chlovaporthrin, |
| | cis-cypermethrin, cis-resmethrin, cis-permethrin, clocythrin, |
| | cycloprothrin, cyfluthrin, cyhalothrin, cyphenothrin, DDT, |
| | deltamethrin, empenthrin (1R-isomer), esfenvalerate, etofenprox, |
| | fenfluthrin, fenpropathrin, fenpyrithrin, fenvalerate, flubrocythrinate, |
| | flucythrinate, flufenprox, flumethrin, fluvalinate, fubfenprox, gamma- |
| | cyhalothrin, imiprothrin, kadethrin, lambda, cyhalothrin, |
| | metofluthrin, phenothrin (1R-trans isomer), prallethrin, profluthrin, |
| | protrifenbute, pyresmethrin, resmethrin, RU 15525, silafluofen, tau- |
| | fluvalinate, tefluthrin, terallethrin, tetramethrin (1R-isomer), |
| | tralocythrin, tralomethrin, transfluthrin, ZXI 8901, pyrethrins |
| | (pyrethrum) |
| oxadiazines | indoxacarb, acetylcholine receptor modulators (such as spinosyns) |
| spinosyns | spinosad |
| cyclodiene | camphechlor, chlordane, endosulfan, gamma-HCH, HCH, |
| | heptachlor, |
| organochlorines | lindane, methoxychlor |
| fiproles | acetoprole, ethiprole, vaniliprole, fipronil |
| mectins | abamectin, avermectin, emamectin, emamectin-benzoate, |
| | fenoxycarb, hydroprene, kinoprene, methoprene, ivermectin, |
| | lepimectin, epofenonane, pyriproxifen, milbemectin, milbemycin, |
| | triprene |
| diacylhydrazines | chromafenozide, halofenozide, methoxyfenozide, tebufenozide |
| benzoylureas | bistrifluoron, chlorfluazuron, diflubenzuron, fluazuron, flucycloxuron, |
| | flufenoxuron, hexaflumuron, lufenuron, novaluron, noviflumuron, |
| | penfluoron, teflubenzuron, triflumuron |
| organotins | azocyclotin, cyhexatin, fenbutatin oxide |
| pyrroles | chlorfenapyr |
| dinitrophenols | binapacyrl, dinobuton, dinocap, DNOC |
| METIs | fenazaquin, fenpyroximate, pyrimidifen, pyridaben, tebufenpyrad, |
| | tolfenpyrad, rotenone, acequinocyl, fluacrypyrim, microbial |
| | disrupters of the intestinal membrane of insects (such as Bacillus |
| | thuringiensis strains), inhibitors of lipid synthesis (such as tetronic |
| | acids and tetramic acids) |
| tetronic acids | spirodiclofen, spiromesifen, spirotetramat |
| tetramic acids | cis-3-(2,5-dimethylphenyl)-8-methoxy-2-oxo-1-azaspiro[4.5]dec-3- |
| | en-4-yl ethyl carbonate (alias: carbonic acid, 3-(2,5- |
| | dimethylphenyl)-8-methoxy-2-oxo-1-azaspiro[4.5]dec-3-en-4-yl |
| | ethyl ester; CAS Reg. No.: 382608-10-8), carboxamides (such as |
| | flonicamid), octopaminergic agonists (such as amitraz), inhibitors of |
| | the magnesium-stimulated ATPase (such as propargite), ryanodin |
| | receptor agonists (such as phthalamides or rynaxapyr) |
| phthalamides | N2-[1,1-dimethyl-2-(methylsulphonyl)ethyl]-3-iodo-N1-[2-methyl--4- |
| | [1,2,2,2-tetrafluoro-1-(trifluoromethyl)ethyl]phenyl]-1,2-benzenedi- |
| | carboxamide (i.e., flubendiamide; CAS reg. No.: 272451-65-7) |

TABLE 5B
Additional Insecticides

| Compound | Chemical Class | Major Uses/targeted insect |
|---|---|---|
| Acynonapyr | Complex 1 acaricides | Miticide |
| Afidopyropen | Pyropene | Sucking pests |
| Benzpyrimoxan | Benzyloxy pyrimidine | Hoppers |
| Broflanilide | meta-Diamide | Leps, bugs, soil pests |
| Cyclobutrifluram | SDHI | Nematicide |
| Cyetpyrafen | Complex II acaricide | Miticide |
| Cyhalodiamide | 1,2-Diamide | Leps, bugs |
| Cyproflanilide | meta-Diamide | Leps, bugs, soil pests |
| Dichloromezotiaz | Mesoisonic (neonic) | Hoppers |
| Dimpropyridaz | Pyrazole carboxamide | Sucking pests |
| Fluazaindolizine | Sulfonamide | Nematicide |
| Fluhexafon | Trifluoropropylsulfon | Ectoparasite control |
| Flupentiofenox | Trifluorethylsulfoxide | Miticide |
| Flupyrimin | Neonicotinoid | Sucking pests |
| Fluxametamide | Isoxazoline | Leps, bugs |
| Nicofluprole | Phenylpyrazole | Parasite control |
| Oxazosulfyl | Ethlysulfonylpyridines | Rice pests |
| Plinazolin | Isoxazoline | Leps, bugs |
| Spidoxamat | Ketoenole | Sucking pests |
| Spiropidion | Ketoenole | Sucking pests |
| Tetraniliprole | 1,2-Diamide | Leps, bugs |
| Tioxazafen | Oxadiazine | Nematicide |
| Triflumezopyrim | Mesoionic (neonic) | Hoppers |

### F. Nematicides

Several embodiments relate to an NLP composition as described herein comprising one or more nematicides. In some instances, an NLP composition can include two or more (e.g., 2, 3, 4, 5, 6, 7, 8, 9, 10, or more than 10) different nematicides. Several embodiments relate to a method of decreasing the fitness (e.g., decrease growth or kill) of a targeted nematode by contacting the targeted nematode or a plant or animal infested with or parasitized by the targeted nematode with an NLP composition comprising one or more nematicides, in an amount and for a time sufficient to: (a) reach a target level (e.g., a predetermined or threshold level) of nematicide concentration inside or on the targeted nematode; and (b) decrease fitness of the targeted nematode. Nematicides may be loaded/incorporated into an NLP composition as described herein and/or formulated with an NLP composition by any of the methods described herein.

As used herein, the term “nematicide” or “nematocidal agent” refers to a substance that decreases the fitness (e.g., kills, inhibits growth, inhibits proliferation, inhibits reproduction, inhibits spread, inhibits feeding, etc.) of a nematode, such as an agricultural nematode pest or a parasitic nematode. Non-limiting examples of nematicides that may be comprised in an NLP composition as described herein and/or formulated with an NLP composition are described in Table 6. One skilled in the art will appreciate that a suitable concentration of each nematicide in an NLP composition depends on factors such as efficacy, stability of the nematicide, number of distinct nematicides, the formulation, and methods of application of the NLP composition.

TABLE 6
Examples of nematicides

| | |
|---|---|
| FUMIGANTS | D-D, 1,3-Dichloropropene, Ethylene Dibromide, 1,2-Dibromo-3- |
| | Chloropropane, Methyl Bromide, Chloropicrin, Metam Sodium, Dazomet, |
| | Methyl Isothiocyanate (MITC), Sodium Tetrathiocarbonate, Chloropicrin, |
| CARBAMATES | Aldicarb, Aldoxycarb, Carbofuran, Oxamyl, Cleothocarb |
| ORGANOPHOSPHATES | Ethoprophos, Fenamiphos, Cadusafos, Fosthiazate, Fensulfothion, |
| | Thionazin, Isazofos, |
| BIOCHEMICALS | DITERA ®, CLANDOSAN ®, SINCOCIN ® |

### G. Antiparasitic Agents

Several embodiments relate to an NLP composition as described herein comprising one or more antiparasitic agents. In some instances, an NLP composition includes two or more (e.g., 2, 3, 4, 5, 6, 7, 8, 9, 10, or more than 10) different antiparasitic agents. In some embodiments, an animal is contacted with an NLP composition comprising one or more antiparasitic agents in an amount and for a time sufficient to: (a) reach a target level (e.g., a predetermined or threshold level) of antiparasitic agent concentration inside or on the parasite (e.g., a parasitic nematode, a parasitic insect, a protozoan) or animal infected therewith; and (b) decrease fitness of the parasite. This can be useful in the treatment or prevention of parasites in animals. An antiparasitic agent may be formulated with a NLP composition by any of the methods described herein, and in certain instances, may be associated or encapsulated by an NLP.

As used herein, the term “antiparasitic” or “antiparasitic agent” refers to a substance that kills or inhibits the growth, proliferation, reproduction, or spread of a parasite, such as parasitic protozoa, a parasitic nematode, or a parasitic insect. Non-limiting examples of antiparasitic agents that may be comprised in an NLP composition as described herein and/or formulated with an NLP composition include antihelminthics (bephenium, diethylcarbamazine, ivermectin, niclosamide, piperazine, praziquantel, pyrantel, pyrvinium, benzimidazoles, albendazole, flubendazole, mebendazole, thiabendazole, levamisole, nitazoxanide, monopantel, emodepside, spiroindoles), scabicides (benzyl benzoate, benzyl benzoate/disulfiram, lindane, malathion, permethrin), pediculicides (piperonyl butoxide/pyrethrins, spinosad, moxidectin), scabicides (crotamiton), anticestodes (niclosamide, pranziquantel, albendazole), antiamoebics (rifampin, anlphotericin B); or antiprotozoals (melarsoprol, eflorn ithine, metronidazole, tinidazole, miltefosine, artemisinin). In certain instances, an NLP composition comprising an antiparasitic agent may be use for treating or preventing infections in livestock animals. In some embodiments, an NLP composition as described herein may comprise or be formulated with one or more of levamisole, fenbendazole, oxfendazole, albendazole, moxidectin, eprinomectin, doramectin, ivermectin, and clorsulon. One skilled in the art will appreciate that a suitable concentration of each antiparasitic in an NLP composition depends on factors such as efficacy, stability of the antiparasitic, number of distinct antiparasitics, the formulation, and methods of application of the NLP composition.

### H. Molluscicides

Several embodiments relate to an NLP composition as described herein comprising one or more molluscicides. In some instances, an NLP composition includes two or more (e.g., 2, 3, 4, 5, 6, 7, 8, 9, 10, or more than 10) different molluscicides. Several embodiments relate to a method of decreasing the fitness (e.g., decrease growth or kill) of a targeted mollusk by contacting the targeted mollusk with or a plant infested with the targeted mollusk with an NLP composition comprising a molluscicide, in an amount and for a time sufficient to: (a) reach a target level (e.g., a predetermined or threshold level) of molluscicide concentration inside or on the target mollusk; and (b) decrease fitness of the target mollusk. Molluscicides may be loaded/incorporated into an NLP composition as described herein and/or formulated with an NLP composition by any of the methods described herein.

As used herein, the term “molluscicide” or “molluscicidal agent” refers to a substance that decreases the fitness (e.g., kills, inhibits the growth, inhibits proliferation, inhibits reproduction, inhibits spread, inhibits feeding, etc.) of a mollusk, such as agricultural mollusk pests. Non-limiting examples of molluscicides that may be comprised in an NLP composition as described herein and/or formulated with an NLP composition include metal salts, such as iron(II) phosphate, aluminium sulfate, and ferric sodium; EDTA; metaldehyde; methiocarb; and acetylcholinesterase inhibitors. One skilled in the art will appreciate that a suitable concentration of each molluscicide in an NLP composition depends on factors such as efficacy, stability of the molluscicide, number of distinct molluscicides, the formulation, and methods of application of the NLP composition.

### I. Antiviral Agents

Several embodiments relate to an NLP composition as described herein further comprising one or more antiviral agents. In some instances, an NLP composition include two or more (e.g., 2, 3, 4, 5, 6, 7, 8, 9, 10, or more than 10) different antiviral agents. Several embodiments relate to a method of treating a viral infection (e.g., decrease growth or kill) by contacting the virus or a plant or animal infected with the virus with an NLP composition including an antiviral agent, in an amount and for a time sufficient to: (a) reach a target level (e.g., a predetermined or threshold level) of antiviral agent concentration; and (b) decrease or eliminate the target virus. In some embodiments, an NLP composition including an antiviral agent can be administered to an animal in an amount and for a time sufficient to reach a target level (e.g., a predetermined or threshold level) of antiviral concentration inside or on the animal; and/or to treat or prevent a viral infection in the animal. Antiviral agents may be loaded/incorporated into an NLP composition as described herein and/or formulated with an NLP composition by any of the methods described herein.

As used herein, the term “viricide” or “antiviral” or “antiviral agent” refers to any substance that deactivates a virus, destroys a virus, or otherwise interferes with or inhibits any stage of the viral life cycle (e.g., prevents infection (e.g., attachments to the host cell), uncoating, integration, transcription, translation, replication, assembly, or release of viruses). In some embodiments, the virus is a viral plant pathogen. A number of agents can be employed as a viricide, including chemicals and biological agents (e.g., biomimetics, nucleic acids (e.g., dsRNA, morpholinos, etc.). Non-limiting examples of antivirals that may be comprised in an NLP composition as described herein and/or formulated with an NLP composition include abacavir, acyclovir (aciclovir), adefovir, amantadine, amprenavir (agenerase), ampligen, arbidol, atazanavir, atripla, balavir, cidofovir, combivir, dolutegravir, darunavir, delavirdine, didanosine, docosanol, edoxudine, efavirenz, emtricitabine, enfuvirtide, entecavir, ecoliever, famciclovir, fomivirsen, fosamprenavir, foscarnet, fosfonet, fusion inhibitor, ganciclovir, ibacitabine, imunovir, idoxuridine, imiquimod, indinavir, inosine, integrase inhibitor, interferon type III, interferon type II, interferon type I, interferon, lamivudine, lopinavir, loviride, maraviroc, moroxydine, methisazone, nelfinavir, nevirapine, nexavir, nitazoxanide, nucleoside analogues, norvir, oseltamivir (tamiflu), peginterferon alfa-2a, penciclovir, peramivir, pleconaril, podophyllotoxin, raltegravir, ribavirin, rimantadine, ritonavir, pyramidine, saquinavir, sofosbuvir, stavudine, synergistic enhancer (antiretroviral), telaprevir, tenofovir, tenofovir disoproxil, tipranavir, trifluridine, trizivir, tromantadine, truvada, valaciclovir (valtrex), valganciclovir, vicriviroc, vidarabine, viramidine, zalcitabine, zanamivir (relenza), and zidovudine. One skilled in the art will appreciate that a suitable concentration of each antiviral in an NLP composition depends on factors such as efficacy, stability of the virucide, number of distinct virucides, the formulation, and methods of application of the NLP composition.

### J. Herbicides

Several embodiments relate to an NLP composition as described herein comprising one or more herbicidal agents. In some instances, an NLP composition includes two or more (e.g., 1, 2, 3, 4, 5, 6, 7, 8, 9, 10, or more than 10) different herbicidal agents. Several embodiments relate to a method of decreasing the fitness of a plant (e.g., a weed) by contacting the plant with an NLP composition comprising an herbicidal agent, in an amount and for a time sufficient to: (a) reach a target level (e.g., a predetermined or threshold level) of herbicide concentration on the plant and (b) decrease the fitness of the plant. Herbicidal agents may be loaded or incorporated into an NLP composition as described herein and/or formulated with an NLP composition by any of the methods described herein.

As used herein, the term “herbicide” or “herbicidal agent” refers to a substance that decrease the fitness (e.g., kills, inhibits the growth, inhibits proliferation, inhibits reproduction, inhibits spread, etc.) of a plant. Non-limiting examples of herbicides that may be comprised in an NLP composition as described herein and/or formulated with an NLP composition include: glufosinate; propaquizafop; metamitron; metazachlor; pendimethalin; flufenacet; diflufenican; clomazone; nicosulfuron; mesotrione; pinoxaden; sulcotrione; prosulfocarb; sulfentrazone; bifenox; quinmerac; triallate; terbuthylazine; atrazine; oxyfluorfen; diuron; trifluralin; chlorotoluron; benzoic acid herbicides, such as dicamba esters; phenoxyalkanoic acid herbicides, such as 2,4-D, MCPA and 2,4-DB esters; aryloxyphenoxypropionic acid herbicides, such as clodinafop, cyhalofop, fenoxaprop, fluazifop, haloxyfop, and quizalofop esters; pyridinecarboxylic acid herbicides, such as aminopyralid, picloram, and clopyralid esters; pyrimidinecarboxylic acid herbicides, such as aminocyclopyrachlor esters; pyridyloxyalkanoic acid herbicides, such as fluoroxypyr and triclopyr esters; hydroxybenzonitrile herbicides, such as bromoxynil and ioxynil esters; esters of the arylpyridine carboxylic acids; and arylpyrimidine carboxylic acids of the generic structures disclosed in U.S. Pat. Nos. 7,314,849, 7,300,907, and 7,642,220, each of which is incorporated by reference herein in its entirety. In certain embodiments, an NLP composition as described herein comprises one or more herbicides selected from the group consisting of: 2,4-D, 2,4-DB, acetochlor, acifluorfen, alachlor, ametryn, amitrole, asulam, atrazine, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate, DCPA, desmedipham, dichlobenil, diclofop, diclosulam, diethatyl, difenzoquat, diflufenzopyr, dimethenamid-p, diquat, DSMA, endothall, EPTC, ethalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glufosinate, glyphosate, halosulfuron, haloxyfop, hexazinone, imazamethabenz, imazamox, imazapic, imazaquin, imazethapyr, isoxaben, isoxaflutole, lactofen, linuron, MCPA, MCPB, mesotrione, methazole, metolachlor-s, metribuzin, metsulfuron, molinate, MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triclopyr, triflusulfu ron, and vernolate. In certain embodiments, an NLP composition as described herein comprises one or more nucleic acids (e.g., siRNA, miRNA, dsRNA, RNA/DNA hybrid, etc.) that induces silencing or reduces expression of an essential plant gene. One skilled in the art will appreciate that a suitable concentration of each herbicide in an NLP composition depends on factors such as efficacy, stability of the herbicide, number of distinct herbicides, the formulation, and methods of application of the NLP composition.

In cases where an herbicide is included in the NLP, or compositions thereof, the methods may be further used to decrease the fitness of or kill weeds. In such instances, the method may be effective to decrease the fitness of the weed by about 2%, 5%, 10%, 20%, 30%, 40%, 50%, 60%, 70%, 80%, 90%, 100%, or more in comparison to an untreated weed (e.g., a weed to which the NLP composition has not been administered). For example, the method may be effective to kill the weed, thereby decreasing a population of the weed by about 2%, 5%, 10%, 20%, 30%, 40%, 50%, 60%, 70%, 80%, 90%, 100%, or more in comparison to an untreated weed. In some instances, the method substantially eliminates the weed. Examples of weeds that can be treated with NLPs in accordance with the present compositions and methods are described in WO2021041301A1, which is incorporated by reference in its entirety herein.

### K. Repellents

Several embodiments relate to an NLP composition as described herein comprising one or more repellents. In some instances, an NLP composition include two or more (e.g., 2, 3, 4, 5, 6, 7, 8, 9, 10, or more than 10) different repellents. Several embodiments relate to a method of repelling a targeted pest by contacting the targeted pest, an environment where the targeted pest occupies, a plant or an animal with an NLP composition or formulation including a repellent, in an amount and for a time sufficient to: (a) reach a target level (e.g., a predetermined or threshold level) of repellent concentration; and (b) decrease the levels of the pest on the plant, animal or in the environment relative to an untreated plant, animal or environment. Repellents may be loaded/incorporated into an NLP composition as described herein and/or formulated with an NLP composition by any of the methods described herein.

As used herein, the term “repellent” refers to any substance that acts to repel or discourage entry of a pest (e.g., insects, nematodes, mollusks, endophytes, fungi, weeds, etc.). In some instances, the repellent is an insect repellent. Non-limiting examples of repellants that may be comprised in an NLP composition as described herein and/or formulated with an NLP composition include: benzil; benzyl benzoate; 2,3,4,5-bis(butyl-2-ene)tetrahydrofurfural (MGK Repellent 11); butoxypolypropylene glycol; N-butylacetanilide; normal-butyl-6, 6-dimethyl-5, 6-dihydro-1,4-pyrone-2-carboxylate (Indalone); dibutyl adipate; dibutyl phthalate; di-normal-butyl succinate (Tabatrex); N,N-diethyl-meta-toluamide (DEET); dimethyl carbate (endo,endo)-dimethyl bicyclo[2.2.1]hept-5-ene-2,3-dicarboxylate); dimethyl phthalate; 2-ethyl-2-butyl-1,3-propanediol; 2-ethyl-1,3-hexanediol (Rutgers 612); di-normal-propyl isocinchomeronate (MGK Repellent 326); 2-phenylcyclohexanol; p-methane-3,8-diol, and normal-propyl N,N-diethylsuccinamate, citronella oil, dimethyl phthalate, normal-butylmesityl oxide oxalate and 2-ethyl hexanediol-1,3 (See, Kirk-Othmer Encyclopedia of Chemical Technology, 2nd Ed., Vol. 11:724-728; and The Condensed Chemical Dictionary, 8th Ed., p 756).

An insect repellent that may be comprised in an NLP composition as described herein and/or formulated with an NLP composition may be a synthetic or non-synthetic insect repellent. Examples of synthetic insect repellents include methyl anthranilate and other anthranilate-based insect repellents, benzaldehyde, DEET (N,N-diethyl-m-toluamide), dimethyl carbate, dimethyl phthalate, icaridin (e.g., picaridin, Bayrepel, and KBR 3023), indalone (e.g., as used in a “6-2-2” mixture (60% Dimethyl phthalate, 20% Indalone, 20% Ethylhexanediol), IR3535 (3-[N-Butyl-N-acetyl]-aminopropionic acid, ethyl ester), metofluthrin, permethrin, SS220, ortricyclodecenyl allyl ether. Examples of natural insect repellents include beautyberry (Callicarpa) leaves, birch tree bark, bog myrtle (Myrica Gale), catnip oil (e.g., nepetalactone), citronella oil, essential oil of the lemon eucalyptus (Corymbia citriodora), p-menthane-3,8-diol (PMD), neem oil, lemongrass, tea tree oil from the leaves of Melaleuca alternifolia, tobacco, or extracts thereof.

### L. Fertilizing Agents

Several embodiments relate to an NLP composition as described herein comprising one or more heterologous fertilizing agents. In some instances, the heterologous fertilizing agent is associated with a formula comprising the NLPs. In some embodiments, an NLP may encapsulate the heterologous fertilizing agent. In some embodiments, the heterologous fertilizing agent can be embedded on or conjugated to the surface of the NLP.

As used herein, the term “heterologous fertilizing agent” refers to a substance that can increase the fitness of a plant or plant microorganism (e.g. a plant symbiont) t. A heterologous fertilizing agent includes any material of natural or synthetic origin that is applied to soils or to plant tissues to increase the fitness of plants and plant microorganisms. A heterologous fertilizing agent may stimulate soil microbial population growth and activities. Increased soil microbial population (e.g., plant symbionts) may have significant beneficial effects on the physical and chemical properties of the soil, as well as increasing disease and pest resistance. In some instances, the heterologous fertilizing agent can be modified. For example, the modification can be a chemical modification, e.g., conjugation to a marker, e.g., fluorescent marker or a radioactive marker. In other examples, the modification can include conjugation or operational linkage to a moiety that enhances the stability, delivery, targeting, bioavailability, or half-life of the agent, e.g., a lipid, a glycan, a polymer (e.g., PEG), a cation moiety.

Non-limiting examples of heterologous fertilizing agents that may be comprised in an NLP composition as described herein and/or formulated with an NLP composition include plant nutrients and plant growth regulators. In some embodiments, a heterologous fertilizing agent can be a peptide, a polypeptide, a nucleic acid, or a polynucleotide that can increase the fitness of a plant or a plant microorganism (e.g. a plant symbiont). In some embodiments, a heterologous fertilizing agent can be a plant nutrient selected from a macronutrient, micronutrient, or a combination thereof. Nonlimiting examples of macronutrients include nitrogen, phosphorus, potassium, calcium, magnesium, and sulfur. Nonlimiting examples of micronutrients include copper, iron, manganese, molybdenum, zinc, boron, silicon, cobalt, and vanadium. In some embodiments, a heterologous fertilizing agent can be a nitrogen fertilizer including, but not limited to urea, ammonium nitrate, ammonium sulfate, non-pressure nitrogen solutions, aqua ammonia, anhydrous ammonia, ammonium thiosulfate, sulfur-coated urea, urea-formaldehydes, IBDU, polymer-coated urea, calcium nitrate, ureaform, and methylene urea. In some embodiments, a heterologous fertilizing agent can be a phosphorous fertilizer, such as diammonium phosphate, monoammonium phosphate, ammonium polyphosphate, concentrated superphosphate and triple superphosphate. In some embodiments, a heterologous fertilizing agent can be a potassium fertilizer such as potassium chloride, potassium sulfate, potassium-magnesium sulfate, and potassium nitrate. Such heterologous fertilizing agents can exist as free salts or ions within an NLP composition or in a formulation of NLP compositions.

In some embodiments, a heterologous fertilizing agent can be classified as an organic fertilizer or inorganic fertilizer. In some embodiments, an inorganic fertilizer is derived or manufactured from non-living materials. Nonlimiting examples of heterologous inorganic fertilizing agents include ammonium nitrate, ammonium sulfate, urea, potassium chloride, potash, ammonium phosphate, anhydrous ammonia, and other phosphate salts. Organic fertilizers include fertilizers having a molecular skeleton with a carbon backbone. In some embodiments, an organic fertilizer is derived or manufactured from living matter. Nonlimiting examples of heterologous organic fertilizing agents include animal manures, compost, bonemeal, feather meal, and blood meal. One skilled in the art will appreciate that the exact amount of a given element in a fertilizing agent may be calculated and administered to the plant or soil.

Several embodiments relate to methods and compositions for altering the mobility of a plant nutrient through the soil by providing the plant nutrient in an NLP composition as described herein. In some embodiments, a plant is contacted by an NLP composition comprising one or more plant nutrients in an amount and for a time sufficient to: (a) reach a target level (e.g., a predetermined or threshold level) of plant nutrient concentration inside or on the plant, and (b) increase the fitness of the plant relative to an untreated plant. In some embodiments, a plant microorganism (e.g., a bacteria or fungal endosymbiont) is contacted by an NLP composition comprising one or more plant nutrients in an amount and for a time sufficient to: (a) reach a target level (e.g., a predetermined or threshold level) of plant nutrient concentration inside or on the, and (b) increase the fitness of the plant microorganism relative to an untreated plant microorganism. In some embodiments, an NLP composition comprising one or more plant nutrients is applied to soil and moves through soil to contact a plant or plant microorganism.

Non-limiting examples of plant growth regulators that may be comprised in an NLP composition as described herein and/or formulated with an NLP composition include auxins, cytokinins, gibberellins (e.g., gibberellic acid), abscisic acid, amidochlor, ancymidol, 6-benzylaminopurine, brassinolide, butralin, chlormequat (e.g., chlormequat chloride), choline chloride, cyclanilide, daminozide, dikegulac, dimethipin, 2,6-dimethylpuridine, ethephon, flumetralin, flurprimidol, fluthiacet, forchlorfenuron, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole. Other plant growth regulators that can be incorporated in an NLP compositions are described in US 2012/0108431, which is incorporated by reference in its entirety.

### M. Plant-Modifying Agents

Several embodiments relate to an NLP composition as described herein comprising one or more heterologous plant-modifying agents. In some instances, an NLP composition includes two or more (e.g., 2, 3, 4, 5, 6, 7, 8, 9, 10, or more than 10) different plant-modifying agents. In some instances, the heterologous plant-modifying agent is associated with a formula comprising the NLPs. In some embodiments, an NLP may encapsulate the heterologous plant-modifying agent. In some embodiments, the heterologous plant-modifying agent can be embedded on or conjugated to the surface of the NLP.

As used herein, the term “plant-modifying agent” refers to a substance that alters a phenotype of a plant provided with the plant-modifying agent compared to a plant not receiving the plant-modifying agent. In some instances, the plant-modifying agent is a peptide. In some instances, the plant-modifying agent is a nucleic acid. In some instances, the plant-modifying agent modifies a phenotype of a variety of plants or can be one that targets one or more specific plants (e.g., a specific species or genera of plants). In some instances, the heterologous plant-modifying agent (e.g., an agent including a nucleic acid molecule or peptide) can be modified. For example, the modification can be a chemical modification, e.g., conjugation to a marker, e.g., fluorescent marker or a radioactive marker. In some embodiments, the modification can include conjugation or operational linkage to a moiety that enhances the stability, delivery, targeting, bioavailability, or half-life of the plant-modifying agent, e.g., a lipid, a glycan, a polymer (e.g., PEG), a cation moiety. Nonlimiting examples of heterologous plant-modifying agents (e.g., peptides, nucleic acids) that can be used are in the presently disclosed NLP compositions and methods.

### N. Polypeptides

Several embodiments relate to an NLP composition as described herein comprising one or more heterologous polypeptides. In some instances, an NLP composition includes two or more (e.g., 2, 3, 4, 5, 6, 7, 8, 9, 10, or more than 10) heterologous polypeptides. In some instances, an NLP composition as described herein includes a polypeptide or functional fragments or derivative thereof that modifies a plant characteristic (e.g., increases the fitness of the plant, provides insect resistance, increases herbicide tolerance, etc.). In some instances, a heterologous polypeptide (or functional fragments or derivative thereof) is associated with a formula comprising the NLPs. In some embodiments, an NLP may encapsulate the heterologous polypeptide (or functional fragments or derivative thereof). In some embodiments, the heterologous polypeptide (or functional fragments or derivative thereof) can be embedded on or conjugated to the surface of the NLP. Several embodiments relate to a method of modifying a characteristic of a plant by contacting the plant with an NLP composition including a heterologous polypeptide, in an amount and for a time sufficient to: (a) reach a target level (e.g., a predetermined or threshold level) of polypeptide concentration; and (b) modify the plant (e.g., increase the fitness of the plant). One skilled in the art will appreciate that a suitable concentration of each heterologous polypeptide (or functional fragments or derivative thereof) in an NLP composition depends on factors such as efficacy, stability of the polypeptide, number of distinct polypeptides, the formulation, and methods of application of the NLP composition. In some instances, each polypeptide in a liquid formulation of NLP compositions is from about 0.1 ng/ml to about 100 mg/ml. In some instances, each polypeptide in a solid formulation of NLP compositions is from about 0.1 ng/g to about 100 mg/g.

Non-limiting examples of heterologous polypeptide (or functional fragments or derivative thereof) that may be comprised in an NLP composition as described herein and/or formulated with an NLP composition include an enzyme (e.g., a metabolic recombinase, a helicase, an integrase, a RNAse, a DNAse, or an ubiquitination protein), a pore-forming protein, a signaling ligand, a cell penetrating peptide, a transcription factor, a receptor, an antibody, a nanobody, a gene editing protein (e.g., CRISPR Associated Protein (Cas), TALEN, zinc fingers, meganucleases, etc.), riboprotein, a protein aptamer, an insecticidal protein, and a chaperone. Polypeptides that may be comprised in an NLP composition as described herein and/or formulated with an NLP composition may include naturally occurring polypeptides or recombinantly produced polypeptides, functional fragments and variants thereof. In some instances, the polypeptide may be a functional fragments or variants of a naturally occurring polypeptide (e.g., an enzymatically active fragment or variant thereof).

In some embodiments, an NLP composition comprises one or more antibodies and/or antigen binding fragment thereof. In some embodiments, a heterologous functional agent comprised in an NLP composition as described herein may be an antibody that blocks or potentiates activity and/or function of a plant. In some embodiments, an antibody or a functional fragment thereof comprised in an NLP composition may act as an antagonist or agonist of a polypeptide (e.g., enzyme or cell receptor) in a plant.

### O. Nucleic Acids

Several embodiments relate to an NLP composition as described herein comprising one or more heterologous nucleic acids. In some instances, an NLP composition includes two or more (e.g., 2, 3, 4, 5, 6, 7, 8, 9, 10, or more than 10) different heterologous nucleic acids. Non-limiting examples of nucleic acids that may be loaded/incorporated into an NLP composition as described herein and/or formulated with an NLP composition by any of the methods described herein include: deoxyribose nucleic acids (DNA), cDNA, such as plasmids, expression cassettes, protein coding sequence, expression elements, editing templates, etc.; ribose nucleic acids (RNA), such as mRNA, guide RNA (gRNA), inhibitory RNA molecules (e.g., siRNA, shRNA, microRNA (miRNA), etc.); DNA/RNA hybrid molecules, such as hybrid DNA/RNA guide molecules; peptide nucleic acids (PNA); and precursors or derivatives (e.g., phosphorothioate-based molecules such as deoxyribonucleic guanidine (DNG) and ribonucleic guanidine (RNG)) of any of the foregoing. Nucleic acids that may be loaded/incorporated into an NLP composition as described herein and/or formulated with an NLP composition by any of the methods described herein may be single stranded, double stranded, partially double stranded, partially single stranded, circular, linear, and/or may comprise one or more noncanonical, modified or synthetic nucleotides. In some embodiments, a nucleic acid comprised in an NLP composition and/or formulated with an NLP composition as described herein may be chemically modified (e.g., 2′-fluoro, 2′-o-methyl, 2′-deoxy, unlocked nucleic acid, 2′-hydroxy, phosphorothioate, 2′-thiouridine, 4′-thiouridine, 2′-deoxyuridine, etc.). In some embodiments, a nucleic acid comprised in an NLP composition and/or formulated with an NLP composition as described herein comprises a physiologically labile linker that undergoes a chemical transformation (e.g., cleavage) when present in certain physiological conditions, (e.g., disulfide bond cleaved in the reducing environment of the cell cytoplasm). In some embodiments, a nucleic acid comprised in an NLP composition and/or formulated with an NLP composition as described herein is linked to a polymer via a physiologically labile bond or linker.

An NLP composition as described herein may comprise and/or be formulated with any number or type of heterologous nucleic acids. In some embodiments, an NLP composition as described herein may comprise and/or be formulated with one or more nucleic acids selected from the group consisting of a plasmid, a DNA molecule encoding an RNA, a DNA molecule encoding a polypeptide, an expression element, an expression vector, an mRNA, an siRNA, tRNA, a Dicer substrate small interfering RNA (dsiRNA), an antisense RNA, a short interfering RNA (siRNA), a siRNA precursor (e.g., one or more strands of RNA that hybridize inter- or intra-molecularly to form at least partially double-stranded RNA), a short hairpin RNA (shRNA), a microRNA (miRNA), a miRNA precursor, an asymmetric interfering RNA (aiRNA), a peptide nucleic acid (PNA), a morpholino, a locked nucleic acid (LNA), a piwi-interacting RNA (piRNA), a ribozyme, a deoxyribozymes (DNAzyme), a DNA aptamer, an RNA aptamer, a DNA/RNA hybrid aptamer, a circular RNA (circRNA), a guide RNA (gRNA), a tracrRNA, a CRISPR RNA (crRNA), a single guide RNA (sgRNA), and a precursor of any of the foregoing. One skilled in the art will appreciate that a suitable concentration of each nucleic acid in an NLP composition depends on factors such as efficacy, stability of the nucleic acid, number of nucleic acids, types of nucleic acids, the formulation, and methods of application of the NLP composition. Several embodiments relate to a method of providing to a plant, animal, plant cell or animal cell an NLP composition comprising one or more nucleic acids by contacted the plant, animal, plant cell or animal cell with the NLP composition in an amount and for a time sufficient to: (a) reach a target level (e.g., a predetermined or threshold level) of nucleic acid concentration; and (b) modify a characteristic of the plant, animal, plant cell or animal cell (e.g., increase the fitness).

Several embodiments relate to a method of decreasing the level expression of a targeted gene and/or decreases the level of a protein in a plant by proving to a surface of the plant (e.g., leaf, root, seed, etc.) an effective amount of an NLP composition comprising an inhibitory RNA (RNAi) molecule. Examples of RNAi molecules include, but are not limited to: short interfering RNAs (siRNAs), double-strand RNAs (dsRNA), short hairpin RNAs (shRNA), meroduplexes, dicer substrates, and microRNA.

Several embodiments relate to a method of increasing the level of a protein in a plant by proving to a surface of the plant (e.g., leaf, root, seed, etc.) an effective amount of an NLP composition comprising a nucleic acid molecule that encodes the protein. In some embodiments, an NLP composition comprising an mRNA, a modified mRNA, or a DNA molecule that increases expression of an enzyme (e.g., a metabolic recombinase, a helicase, an integrase, a RNAse, a DNAse, or an ubiquitination protein), a pore-forming protein, a signaling ligand, a cell penetrating peptide, a transcription factor, a receptor, an antibody, a nanobody, a gene editing protein (e.g., a CRISPR associated protein (e.g., Cas9, Cas12a, C1C2, etc), TALEN, zinc finger, etc.), riboprotein, a protein aptamer, or a chaperone is provided to a plant.

### P. Gene Editing

Several embodiments relate to an NLP composition as described herein comprising one or more components of a gene editing system. In some embodiments, an NLP composition as described herein comprises one or more zinc finger nucleases (ZFNs). In some embodiments, an NLP composition as described herein comprises one or more Transcription Activator-Like Effector-based Nucleases (TALEN). In some embodiments, an NLP composition as described herein comprises one or more components of a clustered regulatory interspaced short palindromic repeat (CRISPR) system. In some embodiments, an NLP composition as described herein comprises one or more components of a CRISPR gene editing system selected from the group consisting of a CRISPR associated (Cas) protein (e.g., Cas9, Cas12a (also known as Cpf1), C2C1, C2C3, MAD7, etc.), a CRISPR RNA (crRNA), a trans-activating crRNA (tracrRNA), a chimeric single guide RNA (sgRNA), prime editing guide RNA (pegRNA), and a donor template (e.g., a single-stranded DNA template or a double-stranded DNA template comprising a desired nucleotide sequence to be inserted or knocked-in at a double-stranded break). Non-limiting examples of CRISPR associated proteins that may be comprised in an NLP composition as described herein and/or formulated with an NLP composition include: Cas9 (e.g., a wild type Cas9, a nickase Cas9 (e.g., Cas9 D10A), a dead (catalytically inactive) Cas9 (dCas9), eSpCas9, etc.); Cas12a (e.g., AsCas12a (from Acidaminococcus sp.) LbCas12a (from Lachnospiraceae sp.); CasX (Cas12e); Cas13a; Cas14; C2C1; C2C3; Caso; a dCas9 conjugated with an effector (e.g., a KRAB domain, SID4X, etc.) to repress expression of a target gene (CRISPRi); a dCas9 conjugated with an effector (e.g., VP64, p65 activation domain (p65D), etc.) to activate expression of a target gene (CRISPRa); or a nucleic acid encoding any of the foregoing.

### III. Methods of Use

The NLP compositions described herein are useful in a variety of agricultural or therapeutic methods. Examples of methods of using NLP compositions are described further below.

### A. Delivery to a Plant

Several embodiments relate to methods of delivering an NLP composition and/or a formulation comprising one or more NLP compositions to a plant, e.g., by contacting the plant, a part, or an environment where the plant resides (e.g., soil), with the NLP composition and/or the formulation comprising the NLP composition. In some embodiments, an NLP composition as described herein comprise one or more heterologous functional agents selected from the group consisting of pesticidal agents, antibacterial agents, antifungal agents, nematicides, molluscicides, virucides, herbicides, pest control agents (e.g., repellents), fertilizing agents, and plant-modifying agents.

Several embodiments relate to a method of increasing the fitness of a plant, the method including delivering to the plant an effective amount of one or more NLP compositions as described herein to increase the fitness of the plant relative to an untreated plant (e.g., a plant that has not been delivered the NLP composition). An increase in the fitness of the plant as a consequence of delivery of an NLP composition can manifest in a number of ways, e.g., improved yield (e.g., increased biomass, grain yield, seed yield, fruit yield, protein content, carbohydrate content, oil content, leaf area, etc.), improved vigor of the plant (e.g., improved tolerance of abiotic or biotic stress, improved resistance to pests, improved germination rate, etc.), or improved quality of the harvested product from the plant by a measurable amount over the fitness of a plant without the application of the NLP compositions or compared with application of conventional agricultural agents. In some embodiments, delivering an effective amount of one or more NLP compositions as described herein to a plant can increase yield by at least about 0.5%, about 1%, about 2%, about 3%, about 4%, about 5%, about 10%, about 20%, about 30%, about 40%, about 50%, about 60%, about 70%, about 80%, about 90%, about 100%, or more than 100%. Yield can be expressed in terms of an amount by weight or volume of the plant or a product of the plant on some basis. An increase in the fitness of a plant as a consequence of delivery of a NLP composition can also be measured by other methods, such as an increase or improvement of the vigor rating, the stand (the number of plants per unit of area), plant height, stalk circumference, stalk length, leaf number, leaf size, plant canopy, visual appearance (such as greener leaf color), root rating, emergence, protein content, increased tillering, bigger leaves, more leaves, less dead basal leaves, stronger tillers, less fertilizer needed, less seeds needed, more productive tillers, earlier flowering, early grain or seed maturity, less plant verse (lodging), increased shoot growth, earlier germination, or any combination of these factors, by a measurable or noticeable amount over the same factor of the plant produced under the same conditions, but without the administration of the instant compositions or with application of conventional agricultural agents. In some embodiments, delivering an effective amount of one or more NLP compositions as described herein to a plant introduces or increases a beneficial trait in the plant (e.g., by about 1%, 2%, 5%, 10%, 20%, 30%, 40%, 50%, 60%, 70%, 80%, 90%, 100%, or more than 100%) relative to an untreated plant. In some instances, the increase in plant fitness is an increase (e.g., by about 1%, 2%, 5%, 10%, 20%, 30%, 40%, 50%, 60%, 70%, 80%, 90%, 100%, or more than 100%) in disease resistance, drought tolerance, heat tolerance, cold tolerance, salt tolerance, metal tolerance, herbicide tolerance, chemical tolerance, water use efficiency, nitrogen utilization, resistance to nitrogen stress, nitrogen fixation, pest resistance, herbivore resistance, pathogen resistance, yield, yield underwater-limited conditions, vigor, growth, photosynthetic capability, nutrition, protein content, carbohydrate content, oil content, biomass, shoot length, root length, root architecture, seed weight, or amount of harvestable produce.

Several embodiments relate a method of increasing the fitness of a plant, the method including contacting one or more of a seed, protoplast, embryo, leaf, root, stem, tissue (e.g., meristematic or meristem tissue), of the plant with an effective amount of a NLP composition as disclosed herein, wherein the method increases the fitness of the plant (e.g., by about 1%, 2%, 5%, 10%, 20%, 30%, 40%, 50%, 60%, 70%, 80%, 90%, 100%, or more than 100%) relative to an untreated plant.

Several embodiments relate a method of decreasing the fitness of a plant (e.g., a weed) or a plant part (e.g., reproductive tissue), the method including contacting one or more of a seed, protoplast, embryo, leaf, root, stem, tissue (e.g., meristematic tissue, reproductive tissue), of the plant with an effective amount of an NLP composition comprising one or more herbicides. In cases where an herbicide is included in an NLP compositions, the methods may be further used to decrease the fitness of or kill weeds. In cases where an herbicide is included in an NLP composition provided to a reproductive tissue of a plant, the methods may be further used to prevent pollen production. In some embodiments, the method may be effective to decrease the fitness of the weed by about 2%, 5%, 10%, 20%, 30%, 40%, 50%, 60%, 70%, 80%, 90%, 100%, or more in comparison to an untreated weed (e.g., a weed to which the NLP composition has not been administered). For example, the method may be effective to kill the weed, thereby decreasing a population of the weed by about 2%, 5%, 10%, 20%, 30%, 40%, 50%, 60%, 70%, 80%, 90%, 100%, or more in comparison to an untreated weed. In some instances, the method substantially eliminates the weed. Examples of weeds that can be treated in accordance with the present methods are further described herein. In cases where an herbicide is included in an NLP composition provided to a reproductive tissue of a plant, the methods may be further used to prevent pollen production or germination. In some embodiments, the method may be effective to decrease pollen production by about 2%, 5%, 10%, 20%, 30%, 40%, 50%, 60%, 70%, 80%, 90%, 100%, or more in comparison to an untreated plant (a plant to which the NLP composition has not been administered).

Plant cell uptake of the NLPs can be measured by a variety of methods known in the art. For example, the NLPs, or a component thereof, can be labelled with a marker (e.g., a fluorescent marker) that can be detected in isolated cells to confirm uptake. For example, cell uptake can be detected based on fluorescence intensity in the cell, which can be determined e.g. microscopically, e.g. with a confocal microscope. Uptake can also be determined with measures of fitness, e.g., fitness the plant comprising the treated cell. For instance, efficacy of the present compositions and methods can be determined by comparing fitness changes in plants treated with NLPs comprising a heterologous functional agent, e.g. a herbicidal agent, relative to treatment of plants treated with NLPs not comprising the herbidical agent.

i. Plants

A variety of plants can be contacted with one or more NLP compositions as described herein. An NLP composition as described herein can be provided to a plant according to any method known in the art. In some embodiments, an NLP composition as described herein can be provided to whole plants, plant parts, including, but not limited to, shoot vegetative organs/structures (e.g., leaves, stems and tubers), roots, flowers and floral organs/structures (e.g., bracts, sepals, petals, stamens, carpels, anthers and ovules), seed (including embryo, endosperm, cotyledons, and seed coat) and fruit (the mature ovary), plant tissue (e.g., meristematic tissue, vascular tissue, ground tissue, and the like) and cells (e.g., guard cells, egg cells, and the like), and progeny of same. The class of plants that can be treated in a method or by a NLP composition disclosed herein includes the class of higher and lower plants, including angiosperms (monocotyledonous and dicotyledonous plants), gymnosperms, ferns, horsetails, psilophytes, lycophytes, bryophytes, and algae (e.g., multicellular or unicellular algae). Plants that can be treated in accordance with the present methods further include any vascular plant, for example monocotyledons or dicotyledons or gymnosperms, including, but not limited to alfalfa, apple, Arabidopsis, banana, barley, canola, castor bean, chrysanthemum, clover, cocoa, coffee, cotton, cottonseed, corn, crambe, cranberry, crucifers, cucumber, dendrobium, dioscorea, eucalyptus, fescue, flax, gladiolus, liliacea, linseed, millet, muskmelon, mustard, oat, oil palm, canola or oilseed rape, papaya, peanut, pineapple, ornamental plants, Phaseolus, potato, rapeseed, rice, rye, ryegrass, safflower, sesame, sorghum, soybean, sugarbeet, sugarcane, sunflower, strawberry, tobacco, tomato, turfgrass, wheat, and vegetable crops such as lettuce, celery, broccoli, cauliflower, cucurbits; fruit and nut trees, such as apple, pear, peach, orange, grapefruit, lemon, lime, almond, pecan, walnut, hazel; vines, such as grapes (e.g., a vineyard), kiwi, hops; cannabis, fruit shrubs and brambles, such as raspberry, blackberry, gooseberry; forest trees, such as ash, pine, fir, maple, oak, chestnut, popular; with alfalfa, canola, castor bean, corn, cotton, crambe, flax, linseed, mustard, oil palm, oilseed rape, peanut, potato, rice, safflower, sesame, soybean, sugarbeet, sunflower, tobacco, tomato, and wheat.

Several embodiments relate to methods of providing one or more NLP compositions as described herein to a crop plant. Crop plants include, for example, plants grown for forage, plants grown for oil (e.g., oilseed), plants grown for grain (e.g., wheat, millet, barely, rye, etc.), plants grown for fruit, vegetables, plants grown for fiber, spice crop, plants grown for nuts, plants grown for wood, etc. In certain instances, the crop plant that is treated in the method is a soybean plant. In other certain instances, the crop plant is wheat. In certain instances, the crop plant is corn. In certain instances, the crop plant is cotton. In certain instances, the crop plant is alfalfa. In certain instances, the crop plant is sugarbeet. In certain instances, the crop plant is rice. In certain instances, the crop plant is potato. In certain instances, the crop plant is tomato.

Examples of such crop plants include, but are not limited to, monocotyledonous and dicotyledonous plants including, but not limited to, fodder or forage legumes, ornamental plants, food crops, trees, or shrubs selected from Acer spp., Allium spp., Amaranthus spp., Ananas comosus, Apium graveolens, Arachis spp, Asparagus officinalis, Beta vulgaris, Brassica spp. (e.g., Brassica napus, Brassica rapa ssp. (canola, oilseed rape, turnip rape), Camellia sinensis, Canna indica, Cannabis sativa, Capsicum spp., Castanea spp., Cichorium endivia, Citrullus lanatus, Citrus spp., Cocos spp., Coffea spp., Coriandrum sativum, Corylus spp., Crataegus spp., Cucurbita spp., Cucumis spp., Daucus carota, Fagus spp., Ficus carica, Fragaria spp., Ginkgo biloba, Glycine spp. (e.g., Glycine max, Soja hispida or Soja max), Gossypium hirsutum, Helianthus spp. (e.g., Helianthus annuus), Hibiscus spp., Hordeum spp. (e.g., Hordeum vuigare), Ipomoea batatas, Juglans spp., Lactuca sativa, Linum usitatissimum, Litchi chinensis, Lotus spp., Luffa acutangula, Lupinus spp., Lycopersicon spp. (e.g., Lycopersicon esculenturn, Lycopersicon lycopersicum, Lycopersicon pyriforme), Malus spp., Medicago sativa, Mentha spp., Miscanthus sinensis, Morns nigra, Musa spp., Nicotiana spp., Olea spp., Oryza spp. (e.g., Oryza sativa, Oryza lati folia), Panicum miliaceum, Panicum virgatum, Passiflora edulis, Petroselinum crispum, Phaseolus spp., Pinus spp., Pistacia vera, Pisum spp., Poa spp., Populus spp., Prunus spp., Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis spp., Solanum spp. (e.g., Solanum tuberosum, Solarium integrifolium or Solarium lycopersicum), Sorghum bicolor, Sorghum halepense, Spinacia spp., Tamarindus indica, Theobroma cacao, Trifolium spp., Triticosecale rimpaui, Triticum spp. (e.g., Triticum aestivum, Triticum durum, Triticum turgidum, Triticum hybernum, Triticum macha, Triticum sativum or Triticum vuigare), Vaccinium spp., Vicia spp., Vigna spp., Viola odorata, Vitis spp., and Zea mays. In certain embodiments, the crop plant is rice, oilseed rape, canola, soybean, corn (maize), cotton, sugarcane, alfalfa, sorghum, or wheat.

In certain instance, the compositions and methods can be used to treat post-harvest plants or plant parts, food, or feed products. In some instances, the food or feed product is a non-plant food or feed product (e.g., a product edible for humans, veterinary animals, or livestock (e.g., mushrooms)).

Several embodiments relate to a methods and compositions for decreasing the fitness of or killing weeds. In some embodiments an NLP composition comprising one or more herbicidal agents is used to decrease the fitness of or kill weeds. In some embodiments, an NLP composition comprising one or more herbicidal agents decreases the fitness of a weed by about 2%, 5%, 10%, 20%, 30%, 40%, 50%, 60%, 70%, 80%, 90%, 100%, or more in comparison to an untreated weed (e.g., a weed to which the NLP composition has not been administered). In some embodiments, an NLP composition comprising one or more herbicidal agents is used to decrease the population of a weed in a treated area by about 2%, 5%, 10%, 20%, 30%, 40%, 50%, 60%, 70%, 80%, 90%, or more in comparison to an untreated area. In some embodiments an NLP composition comprising one or more herbicidal agents is applied to control monocotyledonous weeds (e.g., Agrostis, Alopecurus, Avena, Bromus, Cyperus, Digitaria, Echinochloa, Lolium, Monochoria, Rottboellia, Sagittaria, Scirpus, Setaria, Sida or Sorghum) or dicotyledonous weeds (e.g., Abutilon, Amaranthus, Chenopodium, Chrysanthemum, Conyza, Galium, Ipomoea, Nasturtium, Sinapis, Solanum, Stellaria, Veronica, Viola or Xanthium). In some embodiments an NLP composition comprising one or more herbicidal agents is applied to control Lolium rigidum, Amaramthus palmeri, Abutilon theopratsi, Sorghum halepense, Conyza Canadensis, Setaria verticillata, Capsella pastoris, and Cyperus rotundas.

A plant or plant part that may be contacted with an NLP composition as described herein includes plants of any stage of plant development. In certain instances, the delivery can occur during the stages of germination, seedling growth, vegetative growth, and reproductive growth. In certain instances, delivery to the plant occurs during vegetative and reproductive growth stages. Alternatively, the delivery can occur to a seed. The stages of vegetative and reproductive growth are also referred to herein as “adult” or “mature” plants.

### B. Delivery to a Plant Pest

Several embodiments relate to methods and compositions for controlling a plant pest. In some embodiments, a plant pest is contacted with an NLP composition comprising a heterologous functional agent, such as a pesticidal agent (e.g., antibacterial agents, antifungal agents, nematicides, molluscicides, virucides, herbicides, etc.) or a pest control agent (e.g., repellents). Several embodiments relate to methods and compositions for decreasing the fitness of a pest, e.g., to prevent or treat a pest infestation as a consequence of delivery of an NLP composition.

Several embodiments relate to methods and compositions for decreasing a fungal infection in a plant having a fungal infection. In some embodiments a plant is contacted with an NLP composition comprising one or more antifungal agents. In some instances, the antifungal agent is a nucleic acid that inhibits expression of a gene (e.g., del1 and del2 (e.g., dcH/2) in a fungus that causes the fungal infection. In some instances, the fungal infection is caused by a fungus belonging to a Sclerotinia spp. (e.g., Sclerotinia sclerotiorum), a Botrytis spp. (e.g., Botrytis cinerea), an Aspergillus spp., a Fusarium spp., or a Penicillium spp. In some embodiments, an NLP composition comprising one or more antifungal agents is applied to prevent of treat a fungal disease selected from the group consisting of: White rust (Albugo candida), downy mildew, powdery mildew, Clubroot (Plasmodiophora brassicae), Pythium species, Sclerotinia rot (e.g., S. sclerotiorum, S. minor), Sclerotium rot (e.g., Sclerotium rolfsii, S. cepivorum), Fusarium wilts and rots (various Fusarium species including F. solani and F. oxysporum), Botrytis rots (e.g., Botrytis cinerea), Anthracnose, Rhizoctonia rots (Rhizoctonia solani), Pythium, Rhizoctonia, Phytophthora, Fusarium, Aphanomyces, Pythium sulcatum, Alternaria solani, leaf rust, Fusarium head blight, Septoria leaf blotch, stripe rust, spot blotch, and tan spot. In some instances, the method decreases or substantially eliminates the fungal infection.

Several embodiments relate to methods and compositions for decreasing a bacterial infection in a plant having a bacterial infection. In some embodiments, a plant is contacted with an NLP composition comprising one or more antibacterial agents. In some instances, the antibacterial agent is streptomycin. In some instances, the bacterial infection is caused by a bacterium belonging to a Pseudomonas spp. (e.g., Pseudomonas syringae). In some instances, the antibacterial agent is Oxytetracycline (OTC). In some instances, the bacterial infection causes Huanglongbing. In some instances, the antibacterial agent is selected from the group consisting of: amoxicillin, enrofloxacin, chloramphenicol, penicillin, oxytetracycline, quinolone, sulfonamides, sulphamethazine, sulfadimidine, sulfamethoxazole, and tetracycline. In some embodiments, an NLP composition comprising one or more antibacterial agents is applied to prevent or treat a bacterial disease caused by a bacterial pathogen selected from the group consisting of: Actinobacteria, Agrobacterium (e.g., Agrobacterium tumefaciens), Burkholderiaceae, Candidatus Liberibacter asiaticus, Clavibacter (e.g., Clavibacter michiganensis, Clavibacter sepedonicus), Corynebacterium, Dickeya (e.g., Dickeya dadantii, Dickeya solani), Erwinia (e.g., Erwinia amylovora, E. carotovora), Enterobacteriaceae, Microbacteriaceae, Pectobacterium (e.g., Pectobacterium carotovorum, Pectobacterium atrosepticum), Pseudomonas (e.g., Pseudomonas syringae, Pseudomonas savastanoi), Proteobacteria, Rhizobiaceae, Ralstonia solanacearum, Streptomyces, Xanthomonas (e.g., Xanthomonas axonopodis, Xanthomonas campestris, Xanthomonas oryzae), and Xylella (e.g., Xylella fastidiosa). In some instances, the method decreases or substantially eliminates the bacterial infection.

Several embodiments relate to methods and compositions for decreasing the fitness of an insect plant pest. In some embodiments, an insect plant pest is contacted with an NLP composition comprising one or more insecticidal agents. In some embodiments, the plant is contacted with the NLP, which then delivers the insecticide to the insect pest, e.g. upon ingestion of the plant by the insect pest. In some instances, the insecticidal agent is a peptide nucleic acid. In some instances, the insecticidal agent is an insecticidal peptide. In some instances, the insect plant pest is an aphid. In some instances, the insect plant pest is a lepidopteran (e.g., Spodoptera frugiperda). In some instances, the insect plant pest is an arachnid, e.g., a mite. In some embodiments, an NLP composition comprising one or more insecticidal agents is provided to an insect pest selected from the group consisting of: asian citrus psyllid, asian loghorn beetle, emerald ash borer, grasshopper, false codling moth, fall army worm, stinkbug, cotton bollworm, tobacco whitefly, diamondback moth, red flour beetle, green peach aphid, cotton aphid, taro caterpillar, thrips, flea beetle, Colorado potato beetle, corn rootworm, tomato hornworn, weevils, and brown planthopper. In some instances, the method decreases the fitness of the insect plant pest relative to an untreated insect plant pest

Several embodiments relate to methods and compositions for decreasing the fitness of a nematode plant pest. In some embodiments, the nematode plant pest is contacted with an NLP composition comprising a nematicidal agent. In some embodiments, a plant at risk of or having a nematode infestation is contacted with the NLP composition comprising a nematicidal agent. In some instances, the nematicidal agent is a neuropeptide (e.g., Mi-NLP-15b). In some instances, the nematode plant pest is a root-knot nematode. In some embodiments, an NLP composition comprising one or more nematicidal agents is provided to a nematode pest selected from the group consisting of: root-knot nematodes (e.g., Meloidogyne spp.), cyst nematodes (e.g., Heterodera and Globodera spp.), root lesion nematodes (e.g., Pratylenchus spp.), Radopholus similis, Ditylenchus dipsaci, pine wilt nematode (e.g., Bursaphelenchus xylophilus), reniform nematode (e.g., Rotylenchulus reniformis), Xiphinema index, Nacobbus aberrans, and Aphelenchoides besseyi. In some instances, the method decreases the fitness of the nematode plant pest relative to an untreated nematode plant pest.

Several embodiments relate to methods and compositions for decreasing the fitness of a weed. In some embodiments, the weed is contacted with an NLP composition comprising an herbicidal agent (e.g. Glufosinate). In some instances, the weed is an Indian goosegrass. In some instances, an NLP composition comprises an agent (e.g., an RNAi agent targeting 5-enolpyruvylshikimate-3-phosphate (EPSP) synthase) that increases the sensitivity of a weed to an herbicide relative to an untreated weed. In some embodiments, an NLP composition comprising one or more herbicidal agents (and/or an agent that increases the sensitivity of a weed to an herbicide) is provided to a weed selected from the group consisting of: dandelion, yellow nutsedge, field horsetail, horsenettle, kochia, thistle, marestail, morningglories, prairie cupgrass, pokeweed, powell amaranth, quackgrass, ragweed, nutsedge, wild buckwheat, dayflower species, pigweed (Palmer amaranth), waterhemp, vetch, and volunteer plants.

Several embodiments relate to methods and compositions for decreasing the fitness of a mollusk. In some embodiments, the mollusk is contacted with an NLP composition comprising an active agent that decreases the fitness of a mollusk. In some embodiments, an NLP composition as described herein is delivered to a mollusk by contacting the mollusk with the NLP composition. In some embodiments, an NLP composition as described herein is delivered to a plant at risk of or having a mollusk infestation. In some embodiments, an NLP composition comprising one or more active agents that decrease the fitness of a mollusk is provided to a mollusk selected from the group consisting of: Achatinidae, Agriolimacidae, Ampullariidae, Arionidae, Bradybaenidae, Helicidae, Hydromiidae, Lymnaeidae, Milacidae, Urocyclidae, and Veronicellidae.

Several embodiments relate to methods and compositions effective to decrease the ability of a pest to carry or transmit a plant pathogen (e.g., plant virus (e.g., TYLCV) or a plant bacterium (e.g., Agrobacterium spp.)) in comparison to a pest to which the NLP composition has not been administered. Methods and compositions provided herein may be effective to decrease the pest's ability to carry or transmit a plant pathogen (e.g., a plant virus (e.g., TYLCV) or plant bacterium (e.g., Agrobacterium spp.)) by about 2%, 5%, 10%, 20%, 30%, 40%, 50%, 60%, 70%, 80%, 90%, 100%, or greater than 100% relative to a reference level (e.g., a level found in a pest that does not receive a NLP composition).

### C. Delivery to a Plant Microorganism

Several embodiments relate to methods and compositions for increasing the fitness of plant microorganism, e.g., a symbiont that is beneficial to the fitness of a plant (e.g., a bacterial endosymbiont, a fungal endosymbiont, an insect pollinator, etc.). In some embodiments, a plant or plant symbiont is contacted with an NLP composition comprising a heterologous functional agent that increases the fitness of the microorganism (e.g., fertilizing agent, nutritional supplement, etc.) relative to an untreated microorganism (e.g., a microbial symbiont that has not been delivered the NLP composition). In one aspect, an endosymbiont is contacted with an NLP composition as described herein comprising a heterologous functional agent that increases the fitness of the symbiont relative to an untreated endosymbiont. In some instances, the methods or compositions provided herein may be effective to increase the symbiont's resistance to parasites or pathogens (e.g., fungal, bacterial, or viral pathogens; or parasitic mites (e.g., Varroa destructor mite in honeybees)) in comparison to a symbiont organism to which the NLP composition has not been administered. In some instances, the methods or compositions provided herein may be effective to increase the symbiont's resistance to a pathogen or parasite (e.g., fungal, bacterial, or viral pathogens; or parasitic mites (e.g., Varroa destructor mite in honeybees)) by about 2%, 5%, 10%, 20%, 30%, 40%, 50%, 60%, 70%, 80%, 90%, 100%, or greater than 100% relative to a reference level (e.g., a level found in a symbiont that does not receive a NLP composition). In some embodiments, a plant symbiont treated with an NLP composition as described herein may be an endosymbiotic fungus, such as a fungus of the genus Aspergillaceae, Ceratobasidiaceae, Coniochaetaceae, Cordycipitaceae, Corticiaceae, Cystofilobasidiaceae, Davidiellaceae, Debaryomycetaceae, Dothioraceae, Erysiphaceae, Filobasidiaceae, Glomerellaceae, Hydnaceae, Hypocreaceae, Leptosphaeriaceae, Montagnulaceae, Mortierellaceae, Mycosphaerellaceae, Nectriaceae, Orbiliaceae, Phaeosphaeriaceae, Pleosporaceae, Pseudeurotiaceae, Rhizopodaceae, Sclerotiniaceae, Stereaceae, or Trichocomacea. In some embodiments, a plant symbiont treated with an NLP composition as described herein may be an endosymbiotic bacteria, such as a bacteria of the genus Acetobacteraceae, Acidobacteriaceae, Acidothermaceae, Aerococcaceae, Alcaligenaceae, Alicyclobacillaceae, Alteromonadaceae, Anaerolineaceae, Aurantimonadaceae, Bacillaceae, Bacteriovoracaceae, Bdellovibrionaceae, Bradyrhizobiaceae, Brevibacteriaceae, Brucellaceae, Burkholderiaceae, Carboxydocellaceae, Caulobacteraceae, Cellulomonadaceae, Chitinophagaceae, Chromatiaceae, Chthoniobacteraceae, Chthonomonadaceae, Clostridiaceae, Comamonadaceae, Corynebacteriaceae, Coxiellaceae, Cryomorphaceae, Cyclobacteriaceae, Cytophagaceae, Deinococcaceae, Dermabacteraceae, Dermacoccaceae, Enterobacteriaceae, Enterococcaceae, Erythrobacteraceae, Fibrobacteraceae, Flammeovirgaceae, Flavobacteriaceae, Frankiaceae, Fusobacteriaceae, Gaiellaceae, Gemmatimonadaceae, Geodermatophilaceae, Glycornycetaceae, Haliangiaceae, Halomonadaceae, Holosporaceae, Hyphomicrobiaceae, lamiaceae, Intrasporangiaceae, Kineosporiaceae, Koribacteraceae, Lachnospiraceae, Lactobacillus, Legionellaceae, Leptospiraceae, Leuconostocaceae, Methylobacteriaceae, Methylocystaceae, Methylophilaceae, Microbacteriaceae, Micrococcaceae, Micromonosporaceae, Moraxellaceae, Mycobacteriaceae, Mycoplasmataceae, Myxococcaceae, Nakamurellaceae, Neisseriaceae, Nitrosomonadaceae, Nocardiaceae, Nocardioidaceae, Oceanospirillaceae, Opitutaceae, Oxalobacteraceae, Paenibacillaceae, Parachlamydiaceae, Pasteurellaceae, Patulibacteraceae, Peptostreptococcaceae, Phyllobacteriaceae, Piscirickettsiaceae, Planctomycetaceae, Planococcaceae, Polyangiaceae, Porphyromonadaceae, Prevotellaceae, Promicromonosporaceae, Pseudomonadaceae, Pseudonocardiaceae, Rhizobiaceae, Rhodobacteraceae, Rhodospirillaceae, Roseiflexaceae, Rubrobacteriaceae, Sandaracinaceae, Sanguibacteraceae, Saprospiraceae, Segniliparaceae, Shewanellaceae, Sinobacteraceae, Solibacteraceae, Solimonadaceae, Solirubrobacteraceae, Sphingobacteriaceae, Sphingomonadaceae, Spiroplasmataceae, Sporichthyaceae, Sporolactobacilloae, Staphylococcaceae, Streptococcaceae, Streptomycetaceae, Syntrophobacteraceae, Veillonellaceae, Verrucomicrobiaceae, Weeksellaceae, Xanthobacteraceae, or Xanthomonadaceae.

Several embodiments relate to methods and compositions for increasing the fitness of an insect (e.g., an insect symbiont of a plant) that is beneficial to a plant. In some embodiments, a beneficial insect is contacted with an NLP composition comprising a heterologous functional agent that increases the fitness of the beneficial insect compared to an untreated insect. For example, the host may include insects that are used in agricultural applications, including insects that aid in the pollination of crops, spreading seeds, or pest control. In some instances, the insect is a plant pollinator. For example, the insect may be of the genus Hymenoptera or Diptera. In some instances, the insect of the genus Hymenoptera is a bee. In other instances, the insect of the genus Diptera is a fly.

### D. Delivery to an Animal Pathogen

Several embodiments relate to methods and compositions for controlling an animal (e.g., human) pathogen. In some embodiments, an animal pathogen is contacted with an NLP composition comprising a heterologous functional agent (e.g., antibacterial agent, antifungal agent, insecticide, nematicide, antiparasitic agent, antiviral agent, etc.). As used herein the term “pathogen” refers to an organism, such as a microorganism or an invertebrate, which causes disease or disease symptoms in an animal host by, e.g., (i) directly infecting the animal, (ii) by producing agents that causes disease or disease symptoms in an animal (e.g., bacteria that produce pathogenic toxins and the like), and/or (iii) that elicit an immune (e.g., inflammatory response) in animals (e.g., biting insects, e.g., bedbugs). Nonlimiting examples of pathogens that may be controlled by application of an NLP composition comprising a heterologous functional agent includes bacteria (e.g., Streptococcus spp., Pneumococcus spp., Pseudomonas spp., Shigella spp, Salmonella spp., Campylobacter spp., or an Escherichia spp), fungi (Saccharomyces spp, or a Candida spp), parasitic insects (e.g., Cimex spp), parasitic nematodes (e.g., Heligmosomoides spp), parasitic protozoa (e.g., Trichomoniasis spp) protozoa, fungi, nematodes, insects, viroids and viruses. In some embodiments, an NLP composition comprising a heterologous functional agent can be useful for decreasing the fitness of an animal pathogen, e.g., to prevent or treat a pathogen infection or control the spread of a pathogen as a consequence of delivery of the NLP composition. In some embodiments, the method includes delivering an NLP composition to at least one habitat where the pathogen grows, lives, reproduces, feeds, or infests. In some instances, the NLP composition is delivered as a pathogen comestible composition for ingestion by the pathogen. Pathogen fitness may be evaluated using any standard methods in the art. In some instances, pest fitness may be evaluated by assessing an individual pathogen. Alternatively, pest fitness may be evaluated by assessing a pathogen population. For example, a decrease in pathogen fitness may manifest as a decrease in successful competition against other pathogens, thereby leading to a decrease in the size of the pathogen population. The NLP compositions and related methods described herein are useful to decrease the fitness of an animal pathogen and thereby treat or prevent infections in animals.

Several embodiments relate to methods and compositions for preventing or treating a fungal infection in an animal. In some embodiments, an NLP composition comprising one or more antifungal agents is provided to a fungus or an animal at risk of having a fungal infection. NLP compositions as described herein and related methods are suitable for treatment or prevention of fungal infections in animals, including infections caused by fungi belonging to Ascomycota (Fusarium oxysporum, Pneumocystis jirovecii, Aspergillus spp., Coccidioides immitis/posadasii, Candida albicans), Basidiomycota (Filobasidiella neoformans, Trichosporon), Chytridiomycota, Microsporidia (Encephalitozoon cuniculi, Enterocytozoon bieneusi), Mucoromycotina (Mucor circinelloides, Rhizopus oryzae, Lichtheimia corymbifera) or Zygomycota.

Several embodiments relate to methods and compositions for preventing or treating a pathogenic bacterial infection in an animal. In some embodiments, an NLP composition comprising one or more bactericidal and/or bacteriostatic agents is provided to pathogenic bacteria or an animal at risk of having a pathogenic bacterial infection. NLP compositions as described herein and related methods are suitable for treatment or prevention of pathogenic bacterial infections in animals, including infections caused by bacteria belonging to Bacillales (B. anthracis, B. cereus, S. aureus, L. monocytogenes), Lactobacillies (S. pneumoniae, S. pyogenes), Clostridiales (C. botulinum, C. difficile, C. perfringens, C. tetani), Spirochaetales (Borrelia burgdorferi, Treponema pallidum), Chlamydiales (Chlamydia trachomatis, Chlamydophila psittaci), Actinomycetales (C. diphtheriae, Mycobacterium tuberculosis, M. avium), Rickettsiales (R. prowazekii, R. rickettsii, R. typhi, A. phagocytophilum, E. chaffeensis), Rhizobiales (Brucella melitensis), Burkholderiales (Bordetella pertussis, Burkholderia mallei, B. pseudomallei), Neisseriales (Neisseria gonorrhoeae, N. meningitidis), Campylobacterales (Campylobacter jejuni, Helicobacter pylori), Legionellales (Legionella pneumophila), Pseudomonadales (A. baumannii, Moraxella catarrhalis, P. aeruginosa), Aeromonadales (Aeromonas sp.), Vibrionales (Vibrio cholerae, V. parahaemolyticus), Thiotrichales, Pasteurellales (Haemophilus influenzae), and Enterobacteriales (Klebsiella pneumoniae, Proteus mirabilis, Yersinia pestis, Y. enterocolitica, Shigella flexneri, Salmonella enterica, E. coli).

Several embodiments relate to methods and compositions for decreasing the fitness of a parasitic insect, e.g., to prevent or treat a parasitic insect infection in an animal. In some embodiments, an NLP composition comprising one or more insecticidal agents is provided to a parasitic insect or an animal host of the parasitic insect. NLP compositions as described herein and related methods are suitable for preventing or treating infection in animals by a parasitic insect, including infections by insects belonging to Phthiraptera: Anoplura (Sucking lice), Ischnocera (Chewing lice), Amblycera (Chewing lice). Siphonaptera: Pulicidae (Cat fleas), Ceratophyllidae (Chicken-fleas). Diptera: Culicidae (Mosquitoes), Ceratopogonidae (Midges), Psychodidae (Sandflies), Simuliidae (Blackflies), Tabanidae (Horse-flies), Muscidae (House-flies, etc.), Calliphoridae (Blowflies), Glossinidae (Tsetse-flies), Oestridae (Bot-flies), Hippoboscidae (Louse-flies). Hemiptera: Reduviidae (Assassin-bugs), Cimicidae (Bed-bugs). Arachnida: Sarcoptidae (Sarcoptic mites), Psoroptidae (Psoroptic mites), Cytoditidae (Air-sac mites), Laminosioptes (Cyst-mites), Analgidae (Feather-mites), Acaridae (Grain-mites), Demodicidae (Hair-follicle mites), Cheyletiellidae (Fur-mites), Trombiculidae (Trombiculids), Dermanyssidae (Bird mites), Macronyssidae (Bird mites), Argasidae (Soft-ticks), Ixodidae (Hard-ticks).

Several embodiments relate to methods and compositions for decreasing the fitness of a parasitic protozoa, e.g., to prevent or treat a parasitic protozoa infection in an animal. In some embodiments, an NLP composition comprising one or more heterologous functional agents is provided to a parasitic protozoa or an animal host of the parasitic protozoa. NLP compositions as described herein and related methods are suitable for preventing or treating infection by parasitic protozoa in animals, including protozoa belonging to Euglenozoa (Trypanosoma cruzi, Trypanosoma brucei, Leishmania spp.), Heterolobosea (Naegleria fowleri), Diplomonadida (Giardia intestinalis), Amoebozoa (Acanthamoeba castellanii, Balamuthia mandrillaris, Entamoeba histolytica), Blastocystis (Blastocystis hominis), Apicomplexa (Babesia microti, Cryptosporidium parvum, Cyclospora cayetanensis, Plasmodium spp., Toxoplasma gondii).

Several embodiments relate to methods and compositions for decreasing the fitness of a parasitic nematode, e.g., to prevent or treat a parasitic nematode infection in an animal. In some embodiments, an NLP composition comprising one or more heterologous functional agents is provided to a parasitic nematode or an animal host of the parasitic nematode. The NLP compositions and related methods are suitable for preventing or treating infection by parasitic nematodes in animals, including nematodes belonging to Nematoda (roundworms): Angiostrongylus cantonensis (rat lungworm), Ascaris lumbricoides (human roundworm), Baylisascaris procyonis (raccoon roundworm), Trichuris trichiura (human whipworm), Trichinella spiralis, Strongyloides stercoralis, Wuchereria bancrofti, Brugia malayi, Ancylostoma duodenale and Necator americanus (human hookworms), Cestoda (tapeworms): Echinococcus granulosus, Echinococcus multilocularis, Taenia solium (pork tapeworm).

Several embodiments relate to methods and compositions for preventing or treating a viral infection in an animal. In some embodiments, an NLP composition comprising one or more antiviral agents is provided to a virus or an animal at risk of or having a viral infection. NLP compositions as described herein and related methods are suitable for preventing or treating a viral infection in animals, including infections by viruses belonging to DNA viruses: Parvoviridae, Papillomaviridae, Polyomaviridae, Poxviridae, Herpesviridae; Single-stranded negative strand RNA viruses: Arenaviridae, Paramyxoviridae (Rubulavirus, Respirovirus, Pneumovirus, Moribillivirus), Filoviridae (Marburgvirus, Ebolavirus), Bornaoviridae, Rhabdoviridae, Orthomyxoviridae, Bunyaviridae, Nairovirus, Hantaviruses, Orthobunyavirus, Phlebovirus. Single-stranded positive strand RNA viruses: Astroviridae, Coronaviridae, Caliciviridae, Togaviridae (Rubivirus, Alphavirus), Flaviviridae (Hepacivirus, Flavivirus), Picornaviridae (Hepatovirus, Rhinovirus, Enterovirus); or dsRNA and Retro-transcribed Viruses: Reoviridae (Rotavirus, Coltivirus, Seadornavirus), Retroviridae (Deltaretrovirus, Lentivirus), Hepadnaviridae (Orthohepadnavirus).

### E. Delivery to a Pathogen Vector

Several embodiments relate to methods and compositions for decreasing the fitness of a pathogen vector. In some embodiments, an NLP composition comprising one or more heterologous functional agents to a pathogen vector. As used herein, the term “vector” refers to an organism (e.g., an insect) that can carry or transmit an animal pathogen from a reservoir to an animal. Examples of vectors include insects, such as those with piercing-sucking mouthparts, as found in Hemiptera and some Hymenoptera and Diptera such as mosquitoes, bees, wasps, midges, lice, tsetse fly, fleas and ants, as well as members of the Arachnidae such as ticks and mites. In some instances, the vector of the animal pathogen may be treated with an NLP composition comprising a heterologous therapeutic agent (e.g., antibacterial agent, antifungal agent, insecticide, nematicide, antiparasitic agent, antiviral agent, or a repellent). In some embodiments, an NLP composition comprising a heterologous functional agent is provided to decrease the fitness of a pathogen vector, e.g., to control the spread of a pathogen. For example, provided herein is a method of decreasing the fitness of an animal pathogen vector, the method including delivering to the vector an effective amount of an NLP composition as described herein, wherein the method decreases the fitness of the vector relative to an untreated vector.

### F. Delivery to an Animal

Several embodiments relate to methods and compositions for delivering an NLP composition to an animal cell, tissue or subject (e.g., a mammal, e.g., a human), e.g., by contacting the animal cell, tissue, subject, or a part thereof, with the NLP composition. In some instances, animals may be treated with an NLP composition comprising a heterologous functional agent, e.g., a heterologous therapeutic agent (e.g., a therapeutic protein or peptide nucleic acid, or small molecule, an antibacterial agent, antifungal agent, insecticide, nematicide, antiparasitic agent, antiviral agent, or a repellent). In one aspect, provided herein is a method of increasing the fitness of an animal (e.g., a human), the method including delivering to the animal an NLP composition as described herein (e.g., in an effective amount and duration) to increase the fitness of the animal relative to an untreated animal (e.g., an animal that has not been delivered the NLP composition). An increase in the fitness of the animal as a consequence of delivery of an NLP composition can be determined by any method of assessing animal fitness (e.g., fitness of a mammal, e.g., fitness (e.g., health) of a human).

### G. Application Methods

A plant described herein can be contacted with an effective amount of an NLP composition in any suitable manner that permits delivering or administering the composition to the plant. An NLP composition may be delivered either alone or in combination with other active (e.g., fertilizing agents) or inactive substances and may be applied by, for example, spraying, injection (e.g., microinjection), dipping, providing to the soil, etc. An NLP composition may be provided in the form of concentrated liquids, gels, solutions, suspensions, sprays, powders, pellets, briquettes, bricks and the like, formulated to deliver an effective concentration of the NLP composition. Amounts and locations for application of NLP compositions as described herein are generally determined by the habitat of the plant, the lifecycle stage at which the plant can be targeted by the NLP composition, the site where the application is to be made, and the physical and functional characteristics of the NLP composition.

In some instances, an NLP composition is sprayed directly onto a plant e.g., crops, by e.g., backpack spraying, aerial spraying, crop spraying/dusting etc. In instances where the NLP composition is delivered to a plant, the plant receiving the NLP composition may be at any stage of plant growth. For example, formulated NLP compositions can be applied as a seed-coating or root treatment in early stages of plant growth or as a total plant treatment at later stages of the crop cycle. In some instances, the NLP composition may be applied as a topical agent to a plant. In some instances, the NLP composition may be applied in the soil in which a plant grows. In some instances, the NLP composition may be applied in the water that is used to water the plant. In some instances, the NLP composition may be applied as a systemic agent that is absorbed and distributed through the tissues of a plant.

In some embodiments, delayed or continuous release of an NLP composition can be accomplished by coating the NLP composition with a dissolvable or biodegradable coating layer, such as gelatin, which coating dissolves or erodes in the environment of use, to then make the NLP composition available, or by dispersing the agent in a dissolvable or erodable matrix. Such continuous release and/or dispensing devices may be advantageously employed to consistently maintain an effective concentration of one or more of the NLP compositions described herein.

In some embodiments, an NLP composition is delivered to a part of the plant, e.g., a leaf, seed, pollen, root, fruit, shoot, or flower, or a tissue, cell, or protoplast thereof. In some instances, the NLP composition is delivered to a cell of the plant. In some instances, the NLP composition is delivered to a protoplast of the plant. In some instances, the NLP composition is delivered to a tissue of the plant. For example, the composition may be delivered to meristematic tissue of the plant (e.g., apical meristem, lateral meristem, or intercalary meristem). In some instances, the composition is delivered to reproductive tissue of the plant (e.g., pollen, egg, ovary, etc.). In some instances, the composition is delivered to a plant embryo. In some instances, the composition is delivered to a seed.

In some instances, an NLP composition may be recommended for field application as an amount of NLPs per hectare (g/ha or kg/ha) or the amount of active ingredient (e.g., NLP with a heterologous functional agent) per hectare (g/ha or kg/ha). In some instances, a lower amount of heterologous functional agent comprised in an NLP composition may be required to be applied to soil, plant media, seeds plant tissue, or plants to achieve the same results as where the heterologous functional agent is not comprised in an NLP composition. For example, the amount of heterologous functional agent comprised in an NLP composition may be applied at levels about 2, 3, 4, 5, 6, 7, 8, 9, 10, 15, 20, 30, 50, or 100-fold (or any range between about 2 and about 100-fold, for example about 2- to 10-fold; about 5- to 15-fold, about 10- to 20-fold; about 10- to 50-fold) less than the same heterologous functional agent applied in a non-NLP composition, e.g., direct application of the same heterologous functional agent without NLPs. NLP compositions as described herein can be applied at a variety of amounts per hectare, for example at about 0.0001, 0.001, 0.005, 0.01, 0.1, 1, 2, 10, 100, 1,000, 2,000, 5,000 (or any range between about 0.0001 and 5,000) kg/ha. For example, about 0.0001 to about 0.01, about 0.01 to about 10, about 10 to about 1,000, about 1,000 to about 5,000 kg/ha.

### H. Therapeutic Methods

NLP compositions as described herein may be useful in a variety of therapeutic compositions and methods. For example, NLP compositions as described herein may be used for the prevention or treatment of pathogen infections in animals (e.g., humans). As used herein, the term “treatment” refers to administering a pharmaceutical composition to an animal for prophylactic and/or therapeutic purposes. To “prevent an infection” refers to prophylactic treatment of an animal who is not yet ill, but who is susceptible to, or otherwise at risk of, a particular disease. To “treat an infection” refers to administering treatment to an animal already suffering from a disease to improve or stabilize the animal's condition. Several embodiments relate to therapeutic methods comprising delivering an NLP composition as described herein to an animal, such as a human. For example, provided herein is a method of treating an animal having a fungal infection, wherein the method includes administering to the animal an effective amount of a NLP composition comprising an antifungal agent. In some instances, the method includes administering to the animal an effective amount of a therapeutic formulation of a plurality of NLP compositions, wherein the plurality of NLP compositions include an antifungal agent. In some instances, the antifungal agent is a nucleic acid that inhibits expression of a gene in a fungus that causes the fungal infection (e.g., Enhanced Filamentous Growth Protein (EFG1)). In another aspect, provided herein is a method of treating an animal having a bacterial infection, wherein the method includes administering to the animal an effective amount of a NLP composition comprising an antibacterial agent (e.g., Amphotericin B). In some instances, the method includes administering to the animal an effective amount of a therapeutic formulation of a plurality of NLP compositions, wherein the plurality of NLP compositions include an antibacterial agent. In some instances, the bacterium is a Streptococcus spp., Pneumococcus spp., Pseudomonas spp., Shigella spp, Salmonella spp., Campylobacter spp., or an Escherichia spp. In some instances, the method decreases or substantially eliminates the bacterial infection. In some instances, the animal is a human, a veterinary animal, or a livestock animal.

Several embodiments relate to formulation of an NLP composition as described herein for administration by any suitable method, including, for example, intravenously, intramuscularly, subcutaneously, intradermally, percutaneously, intraarterially, intraperitoneally, intralesionally, intracranially, intraarticularly, intraprostatically, intrapleurally, intratracheally, intrathecally, intranasally, intravaginally, intrarectally, topically, intratumorally, peritoneally, subconjunctivally, intravesicularly, mucosally, intrapericardially, intraumbilically, intraocularly, intraorbitally, orally, topically, transdermally, intravitreally (e.g., by intravitreal injection), by eye drop, by inhalation, by injection, by implantation, by infusion, by continuous infusion, by localized perfusion bathing target cells directly, by catheter, by lavage, in cremes, or in lipid compositions. Therapeutic formulations of NLP compositions as described herein can be administered systemically or locally. The method of administration can vary depending on various factors (e.g., the compound or composition being administered and the severity of the condition, disease, or disorder being treated).

In some instances, the amount of the NLP composition administered to individual (e.g., human) may be in the range of about 0.01 mg/kg to about 5 g/kg (e.g., about 0.01 mg/kg-0.1 mg/kg, about 0.1 mg/kg-1 mg/kg, about 1 mg/kg-10 mg/kg, about 10 mg/kg-100 mg/kg, about 100 mg/kg-1 g/kg, or about 1 g/kg-5 g/kg), of the individual's body weight. In some instances, the amount of the NLP composition administered to individual (e.g., human) is at least 0.01 mg/kg (e.g., at least 0.01 mg/kg, at least 0.1 mg/kg, at least 1 mg/kg, at least 10 mg/kg, at least 100 mg/kg, at least 1 g/kg, or at least 5 g/kg), of the individual's body weight. The dose may be administered as a single dose or as multiple doses (e.g., 2, 3, 4, 5, 6, 7, or more than 7 doses). In some instances, the NLP composition administered to the animal may be administered alone or in combination with an additional therapeutic agent.

### I. Encapsulation of Volatile Agents

In some embodiments herein, methods are provided for encapsulating bioactives with a high volatility, e.g. having a high vapor pressure. Exemplary volatile agents used in the field of agriculture include but are not limited to herbicides (e.g. Dicamba), fumigants, pheromones, and essential oils.

In some embodiments an NLPs composition comprising an encapsulated volatile bioactive is applied a foliar spray. In some embodiments an NLP composition comprising an encapsulated volatile bioactive is applied to soil. In some embodiments, the encapsulated fumigants treat or prevent plant disease caused by any of the pests described herein that live in soil. In some embodiments, encapsulated fumigants treat or prevent plant disease caused by any of the pests described herein that live in, on, or around plants or plant parts.

In some embodiments, the volatile bioactive is any of the bioactives listed in Tables 4-6 that exhibit a high vapor pressure. In some embodiments, the bioactive with a high vapor pressure is a herbicide. In some embodiments, the herbicide is Dicamba. In some embodiments the volatile herbicide is 2,4-D. In some embodiments, NLP encapsulation of Dicamba, or of 2,4-D, prevents off target injury to nearby sensitive crops. In some embodiments nearby crops that are prevented from off-target effects by using NLP encapsulated volatile herbicides are soybean, cotton, snap bean, peanut, watermelon, and grape vines that are all highly sensitive to very low doses of e.g. Dicamba.

The NLPs comprising a volatile bioactive can be produced by any of the methods described herein that does not comprise an evaporation step, e.g. the HHPH method. In some embodiments a method of altering the volatility of a heterologous functional agent is provided, the method comprising encapsulating the volatile heterologous functional agent in a composition comprising at least one phospholipid, at least one non-polar lipid; and at least one surface modifier, wherein the NLPs comprise a hydrophobic core. In some embodiments a method of sequestering a volatile heterologous functional agent is provided, the method comprising encapsulating the volatile heterologous functional agent in a composition comprising at least one phospholipid, at least one non-polar lipid; and at least one surface modifier, wherein the NLPs comprise a hydrophobic core. In some embodiments a method for the controlled release of a volatile heterologous agent into the environment is provided, the method comprising encapsulating the volatile heterologous functional agent in a composition comprising at least one phospholipid, at least one non-polar lipid; and at least one surface modifier, wherein the NLPs comprise a hydrophobic core.

### IV. Kits

The present invention also provides a kit including a container having a NLP composition described herein. The kit may further include instructional material for applying or delivering the NLP composition to a plant in accordance with a method of the present invention. The skilled artisan will appreciate that the instructions for applying the NLP composition in the methods of the present invention can be any form of instruction. Such instructions include, but are not limited to, written instruction material (such as, a label, a booklet, a pamphlet), oral instructional material (such as on an audio cassette or CD) or video instructions (such as on a video tape or DVD).

### Examples

The following are examples of the methods of the invention. It is understood that various other embodiments may be practiced, given the general description provided above.

### Table of Contents (Examples):

| | |
|---|---|
| Example 1: | Production of NLPs, and physicochemical characteristics of NLPs |
| Example 2: | Methods of making NLPs |
| Example 3: | Production of NLP formulations comprising two or more heterologous |
| | functional agents |
| Example 4: | Method of producing a mixture of NLP formulations each comprising a |
| | different heterologous functional agent |
| Example 5: | Method of producing a mixture of NLPs and an unencapsulated agent |
| Example 6: | Lyophilization and storage of NLPs |
| Example 7: | Characterization of NLP stability |
| Example 8. | Loading NLPs with cargo after NLP formation |
| Example 9: | NLP encapsulation alters soil-binding properties of deltamethrin |
| Example 10: | Correlating NLP soil leaching with NLP composition |
| Example 11: | NLP activity against corn rootworm in an in vitro corn root assay |
| Example 12: | NLP activity against corn rootworm when used as a soil drench |
| | application |
| Example 13: | NLP activity against corn rootworm when used as an in-furrow |
| | application |
| Example 14: | Measuring deltamethrin in soil leachate after seed coating |
| Example 15: | Control of WCRW by NLP comprising Deltamethrin (DE) leached in soil |
| | after seed coating |
| Example 16: | Control of WCRW by NLP comprising DE upon seed coating in a field |
| | trial |
| Example 17: | Loading of NLP compositions with an antimicrobial agent |
| Example 18: | Control of soil-borne fungal pathogens Fusarium graminearum or |
| | Rhizoctonia solani with seeds coated with NLP comprising fludioxonil on |
| | corn |
| Example 19: | Treatment of soil-borne fungal pathogen Pythium spp. or Phytophthora |
| | sojae with seeds coated with NLP comprising oxathiapiprolin on soybean |
| Example 20: | NLP formulations with polymers for seed application |
| Example 21: | Mixtures of small seeds encrusted and pelleted with NLP comprising DE |
| Example 22: | Uptake of NLP by green bean seeds |
| Example 23: | Biodistribution of emamectin benzoate (EM) into leaves of corn seedlings |
| | upon coating seeds with NLP comprising EM |
| Example 24: | Activity against Western Corn Root Worm (WCRW) upon coating seeds |
| | with NLP comprising DE |
| Example 25: | Protecting plants against foliar insects like fall armyworm and black |
| | cutworm by seed treatment |
| Example 26: | Foliar protection of tomato plants against insect tomato hornworm (THW) |
| | upon seed priming with NLP comprising DE |
| Example 27: | Corn seed coated with NLP comprising hydrophobic plant stimulant |
| | Brassinolide for improved plant mass |
| Example 28: | Uptake of NLP comprising DE and Exalite by Arabidopsis thaliana |
| Example 29: | Uptake of NLP comprising DE and Exalite by tomato root epidermis cells |
| Example 30: | Uptake and transport of NLP comprising DE and Exalite to different |
| | aerial organs of Arabidopsis thaliana |
| Example 31: | Uptake of NLP comprising DE and Exalite in to plant cells |
| Example 32: | Mechanical uptake of NLP comprising DE and Exalite in Nicotiana |
| | benthamiana leaves by infiltration |
| Example 33: | Mechanical uptake of NLP comprising DE and Exalite in melon plants by |
| | stem injection |
| Example 34: | Systemicity and transport of NLP comprising DE and Exalite to the leaf in |
| | melon plants upon stem injection |
| Example 35: | NLPs comprising DE are taken up by plant root tissue and protect against |
| | Colorado Potato Beetle (CPB) |
| Example 36: | NLPs comprising DE are taken up by plant root tissue and protect against |
| | Tomato Horn Worm |
| Example 37: | Incorporation of metal complexes (lanthanide) into NLP |
| Example 38: | Uptake of NLP comprising lanthanides by tomato seedlings |
| Example 39: | Root/foliar/injection in planta application of NLP comprising an |
| | antibacterial compound to control a bacterial disease |
| Example 40: | Application of NLP comprising deltamethrin to the roots of seedlings to |
| | control fall army worms (FAW) in corn |
| Example 41: | NLP application for the control of citrus greening |
| Example 42: | Root/foliar/injection in planta application of NLP comprising DE controls |
| | whiteflies feeding on tomato |
| Example 43: | Production of NLPs from carrot and algae lipid sources |
| Example 44: | NLP protection of deltamethrin against UV radiation |
| Example 45: | Uptake of NLPs and organ tissue distribution in Arabidopsis thaliana |
| Example 46: | Uptake of NLPs and meristem targeting in Arabidopsis thaliana |
| Example 47: | Subcellular localization of NLPs in Arabidopsis thaliana |
| Example 48: | Mechanical uptake of NLPs in Nicotiana benthamiana leaves by |
| | infiltration |
| Example 49: | Mechanical uptake of NLPs in melon plants by stem injection |
| Example 50 | NLP corn seed uptake and seed germination after NLP treatment |
| Example 51 | NLP injected in maize plants |
| Example 52 | Evaluation of nine NLP formulations comprising DE against WCRW in a |
| | small scale in furrow assay, and assessment of dose-response |
| Example 53 | Efficacy of NLP formulations against WCRW in field trial |
| Example 54 | Compositions comprising fungicides |
| Example 55 | The anti-fungal activity of AZO in NLPs |
| Example 56 | Soil mobility of NLPs comprising an antifungal agent |
| Example 57 | Antifungal activity of AZO in NLP soil leachates |
| Example 58 | NLP formulations comprising novel surface modifiers |
| Example 59 | Soil mobility of NLPs comprising novel surface modifiers |
| Example 60 | NLP compositions facilitating enhanced deltamethrin loading |
| Example 61 | Encapsulation of pelargonic acid in NLPs |
| Example 62 | NLPs comprising pelargonic acid for use as a pre-emergent herbicide |
| Example 63 | Corn seed coating with NLPs |
| Example 64 | Assessment of NLP particle stability in soil environment |
| Example 65 | Modulation of vapor pressure of a molecule by incorporation in NLPs |

### Example 1. Production of NLPs, and Physicochemical Characteristics of NLPs

This Example describes 1) sources and methods of producing NLP constituents; 2) ratios of constituents in NLP formulations produced; 3) measurement of physicochemical characteristics of the NLPs.

Most of the phospholipids (PL) and non-polar lipids (NP) and surface modifiers (SM) comprised in the NLPs were obtained commercially (Table 7). Some constituents, e.g. Phosphatidylethanolamine (PE), and lemon lipids, were isolated from crude materials, as described below.

### Experimental Procedure:

### a) Methods of Producing NLP Constituents

1) Method of Producing PE from E. coli Cells

To isolate PE from E. coli, A 10 g aliquot of spray-dried E. coli biomass was suspended in a chloroform/methanol/water mixture (60%/20%/20% v/v) while stirring at 900 rpm for 1.5 h at room temperature. The mixture was transferred to a Buchner and the chloroform phase containing a fraction enriched for PE was pipetted off the top. The chloroform was removed by rotary evaporator at 60 rpm, 40° C. and 425 bar.

2) Method of Producing Crude Lemon Lipids from Freeze-Dried Lemon Juice

A 10 g aliquot of freeze-dried lemon juice was suspended in 200 ml of a chloroform/methanol/water mixture (60%/20%/20% v/v). A magnetic stirrer was added to the mixture and stirred for 1.5 h at room temperature.

The mixture was transferred to a Buchner and the chloroform phase containing the dissolved extracted crude lemon lipids was pipetted off the top. The chloroform was removed by rotary evaporator at 60 rpm, 40° C. and 425 bar.

3) Method of Producing Crude Lemon Lipids (CLL) from Fresh Lemon Juice

190 lemons were soaked in 10% bleach for 20 min, washed with 1% liquinox soap, rinsed with water, and dried on clean paper towels. Lemon juicer was decontaminated by washing with 1% liquinox and wiped clean with 70% ethanol. About 10 liters of juice was produced from the lemons using the juicer. The juice was filtered with a 600 um filter, pH adjusted to 4.3 using 10N sodium hydroxide, and 0.5 Units/ml of pectinase was added and incubated for 2 hours. The treated juice was centrifuged twice serially at 3000 g at 4° C. for 20 min and at 10000 g at 4° C. for 40 min by transferring to new containers between the spins to clarify the juice. EDTA was added to the supernatant in a new container to a final concentration of 50 mM, the pH was adjusted to 7-7.5 with 10N sodium hydroxide, and allowed to stand for 30 min with stirring. The juice was filtered using a 25 uM filter prior to subjecting it to tangential flow filtration (TFF). TFF was performed using KrosFlo® KR2i TFF System, Hollow fiber filter TFF modules (790 cm2; 300 kDa cutoff), KR2i Fittings Kits and pump tubing from repligen. The permeate side of hollow fibers were flushed with 2 ml/cm² of water, then the retentate side was flushed with TMP 10 PSI with 2 ml/cm² of water. After priming the system with the treated juice, the system was set to auto mode (Cf/D/C) and the flow rate was set to 700 ml/min ((~4000 S⁻¹ shear rate for S02-e300-05-n), 10 psi TMP, 12.5× first concentration, 5 diavolumes, and 50× final concentration. Once the juice input container was empty, refilled with 1× phosphate buffered saline (PBS). Once complete, the permeate was clamped and the product was manually recirculated in the reverse pump direction for 5 min, and then emptied into a reservoir. Flush the instrument to clean and store the product at 4° C.

4) Method of Enriching Lemon Non-Polar and Polar Lipids from Crude Lemon Lipids

One g of crude lemon lipids (extracted as in Example 1 a) 2) and 1 a) 3)) was dissolved in 5 mL of hexane. Then 25 mL of acetone was added to the mixture and stored in an ice bath. The sample was then centrifuged at 4° C. at a relative centrifugal force of 1500 G for 5 minutes. The sample was then decanted and 10 mL of chilled acetone was used to wash the solid material. The cold acetone washes were then transferred to a round bottom flask and 5 mL of hexane was added to the sample containing the solids which was bath sonicated until dissolved. The hexane solution was then transferred to a separate flask. Solvents were then removed from both flasks by rotary evaporator and their final dry weights were recorded. Polar lipids were in the acetone washes and non-polar lipids were isolated in the hexane wash.

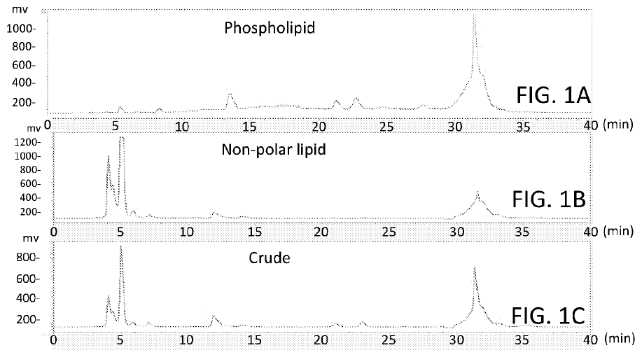

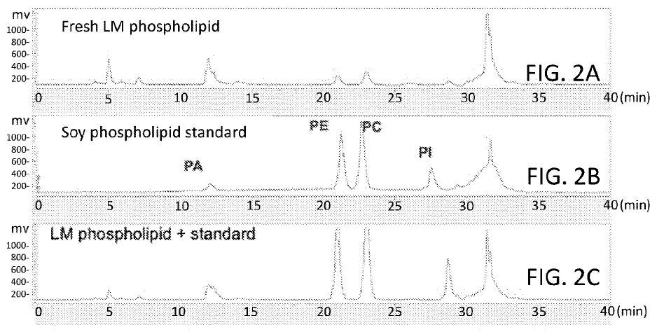

Lipid analysis of the enriched fractions was conducted by HPLC analysis and comparison to standards. FIG. 1 shows the lipid profile of extracted crude lipids (FIG. 1C) and the phospholipid profile and the non-polar lipid profile in the enriched fractions (FIG. 1A and FIG. 1B, respectively). FIG. 2A-2C depict a comparison of the phospholipids in the phospholipid-enriched fraction (FIG. 2A) with a soy phospholipid standard comprising phosphatidic acid (PA), phosphatidyl ethanolamine (PE), phosphatidyl choline (PC) and phosphatidyl inositol (PI) (FIG. 2B). FIG. 2C depicts the enriched sample spiked with the soy phospholipid standard, demonstrating that the PA, PE and PC peaks increased in height, and confirming their presence in the sample.

TABLE 7
NLP constituents and source

| NLP compound | Method of Isolation |
|---|---|
| Phospholipids | |
| Crude lemon lipids from fresh lemon juice (CLL-f) | Example 1a) 2) |
| Crude lemon lipids from freeze-dried lemon juice (CLL-d) | Example 1a) 3) |
| Enriched phospholipids from fresh lemon juice crude lipids | Example 1a) 4) |
| (LemonPL-f) | |
| Enriched non-polar lipids from fresh lemon juice crude lipids | Example 1a) 4) |
| (LemonNP-f) | |
| Enriched phospholipids from freeze-dried lemon crude lipids | Example 1a) 4) |
| (LemonPL-d) | |
| Enriched non-polar lipids from freeze-dried lemon crude | Example 1a) 4) |
| lipids (LemonNP-d) | |
| Phosphatidylethanolamine (PE) (from E. coli) | Example 1a |
| LIPOID H PS 70 (Phosphatidylserine) | |
| 14C-PA (Phosphatidic acid) | |
| LIPOID H90 (Phosphatidylcholine) | |
| Sunflower lecithin | |
| Soybean lecithin, | |
| De-oiled soybean lecithin | |
| Non-polar lipids | |
| Sunflower oil | |
| Canola oil | |
| Soybean oil | |
| Olive oil | |
| Coconut oil, | |
| Enriched fractions of lemon non-polar lipids | Example 1c |
| Surface modifiers | |
| Rhamnolipid | |
| Sophorolipid biosurfactant (SLM), | |
| Rhamnolipid-ABG-PJ | |
| 18:0 PE-PEG5000 | |
| 18:0 PE-PEG2000 | |
| Atlox CS100B, | |
| Atlox 4917 | |
| Atlox 500L | |
| Atlox AL-2575 | |
| Co-solvent | |
| Dichloromethane (DCM) | |
| Isopropyl myristate (IPM) | |
| Excipient | |
| Ethyl lactate | |
| Atlas G5002L | |
| Polyethylene Glycol | |
| NLP cargo | |
| Deltamethrin | |
| Exalite 594 | |
| Emamectin benzoate | |

### b) Methods of Making NLPs

Four Sets of NLPs were Produced:
i. DCM Method

To produce the NLPs shown in Table 8 (DCM method), an organic phase comprising the indicated phospholipids, non-polar lipids, dichloromethane, deltamethrin, Exalite 594 and where indicated a hydrophobic surface modifier (e.g. rhamnolipids) was mixed with an aqueous phase comprising de-ionized water and where indicated a hydrophilic surface modifier (e.g. Atlox 500L), and applying a source of energy to facilitate the formation of NLPs, followed by evaporation of DCM.

ii. HHPH Method

To produce the NLPs shown in Table 9 (HHPH method), an organic phase comprising the indicated phospholipids, non-polar lipids, and optionally a surface modifier (e.g. rhamnolipids), deltamethrin, and optionally Exalite 594, was mixed with an aqueous phase comprising de-ionized water and where indicated a hydrophilic surface modifier (e.g. Atlox 500L), and applying a source of energy to facilitate the formation of NLPs.

iii. HHPHE Method

To produce the NLPs shown in Table 10 (HHPHE method), an organic phase comprising the indicated phospholipids, non-polar lipids, co-solvent (Isopropyl myristate), excipients (Ethyl lactate, Atlas G5002L Polyethylene Glycol), and deltamethrin, was mixed with an aqueous phase comprising de-ionized water, where indicated a hydrophilic surface modifier (e.g. Atlox 500L), and applying a source of energy to facilitate the formation of NLPs.

iv. NanoAssemblr Method

To produce the NLPs shown in Table 11 (NanoAssemblr® method), an organic phase comprising the indicated phospholipids, non-polar lipids, and deltamethrin or emamectin benzoate was mixed with an aqueous phase comprising de-ionized water, and applying a source of energy to facilitate the formation of NLPs.

More extensive descriptions of the methods of making NLPs are provided in Example 2.

### c) NLP Compositions

Table 8 depicts the first set of NLPs produced. The starting ratios of phospholipid (PL), non-polar lipid (NP) and surface modifier (M) used, relative to each other is indicated. For example, a ratio of 5:4:1 for NP:PL:SM indicates that the relative amounts of NP to PL to S used at the time of preparation were 5:4:1. All NLPs of Table 8 comprise deltamethrin at 80 μg and Exalite at 1 ug per milliliter of the NLP suspension.

Table 9 depicts a second set of NLPs produced using the HHPH method, wherein the NLPs comprise three different doses of deltamethrin (80 ug per ml of the NLP suspension or 2,000 μg per ml of the NLP suspension; as indicated in the Table). A subset of the NLPs further comprises Exalite at 90 μg per ml of the NLP suspension.

Table 10 depicts a third set of NLPs produced, using the HHPH method plus excipients method (HHPHE). All NLPs produced using this method comprised the highest dose of deltamethrin (2,000 μg per ml of the NLP suspension) and no Exalite.

Table 11 comprises a fourth set of NLPs prepared comprising either deltamethrin or Emamectin, at 80 μg per ml of suspension and no Exalite.

### d) NLP Biophysical Characterization

NLP formation was verified by electron and cryo-electron microscopy on a JEOL 1010 transmission electron microscope, following the protocol from Wu et al., Analyst. 140(2): 386-406, 2015.

The NLP particle size, NLP particle size distribution, and zeta potential were measured using a Malvern Zetasizer or iZon qNano, following the manufacturer's instructions.

Incorporation of DE and Emamectin in the NLPs was confirmed by was confirmed by reverse phase (C18 column) HPLC with an UV detector and a gradient elution and comparison to the respective standards.

Incorporation of Exalite in NLPs was confirmed with a fluorescence plate reader (BioTek Synergy).

TABLE 8
Physicochemical characteristics of NLPs produced with DCM method ª f

| | Non-polar | Phospholipid | Surface | Weight ratios | Size^{c} | | ZP | Soil |
|---|---|---|---|---|---|---|---|---|
| NLP | lipid (NP)^{b} | (PL)^{b} | modifier (SM) | of NP:PL:SM | (nm) | PDI^{d} | (mV)^{d} | detachment |
| NLP018 | CLL | Crude | — | 1:1:0 | 171.7 | 0.24 | −37.6 | — |
| | | Lemon-f | | | | | | |
| NLP472 | LemonNP-f | LemonPL-f | — | 1:1:0 | 178.9 | 0.12 | N/A | N/A |
| NLP485 | LemonNP-f | PS | — | 1:1:0 | 237.7 | 0.11 | −13.4 | N/A |
| NLP486 | LemonNP-f | PA | — | 1:1:0 | 186.8 | 0.10 | N/A | N/A |
| NLP487 | Sunflower | sunflower | — | 1:1:0 | 196.6 | 0.12 | −30.7 | + |
| | | lecithin | | | | | | |
| NLP488 | Sunflower | soybean | — | 1:1:0 | 200.2 | 0.13 | N/A | N/A |
| | | lecithin | | | | | | |
| NLP492 | Soybean | de-oiled | — | 1:1:0 | 199.1 | 0.11 | −34.1 | N/A |
| | | soybean | | | | | | |
| NLP493 | Canola | PE | — | 1:1:0 | 200.6 | 0.15 | −36.7 | N/A |
| NLP494 | Coconut | PC | — | 1:1:0 | 214.6 | 0.23 | −35.2 | N/A |
| NLP495 | Soybean | LemonPL-f | — | 1:1:0 | 190.0 | 0.13 | −33.7 | N/A |
| NLP496 | Coconut | PS | — | 1:1:0 | 212.8 | 0.14 | −31.9 | N/A |
| NLP497 | Coconut | LemonPL-f | — | 1:1:0 | 184.6 | 0.12 | −34.9 | N/A |
| NLP498 | Coconut | de-oiled | — | 1:1:0 | N/A | N/A | N/A | N/A |
| | | soybean | | | | | | |
| NLP499 | Sunflower | PC | — | 1:1:0 | 216.1 | 0.25 | −29.0 | N/A |
| NLP501 | Sunflower | PS | — | 1:1:0 | N/A | N/A | N/A | N/A |
| | oil | | | | | | | |
| NLP502 | LemonNP-f | PC | — | 1:1:0 | N/A | N/A | N/A | N/A |
| NLP503 | Canola | soybean | — | 1:1:0 | 191.4 | 0.15 | −31.9 | N/A |
| | | lecithin | | | | | | |
| NLP504 | LemonNP-f | sunflower | — | 1:1:0 | 186.9 | 0.11 | −19.5 | N/A |
| | | lecithin | | | | | | |
| NLP505 | Canola | PS | — | 1:1:0 | 187.6 | 0.11 | −31.4 | N/A |
| NLP506 | Olive oil | LemonPL-f | — | 1:1:0 | 188.3 | 0.19 | −31.9 | N/A |
| NLP507 | Olive oil | PS | — | 1:1:0 | 196.2 | 0.15 | −31.3 | N/A |
| NLP508 | Soybean | soybean | Rhamnolipid | 5:4:1 | 179.7 | 0.11 | −28.9 | N/A |
| | | lecithin | | | | | | |
| NLP509 | LemonNP-f | LemonPL-f | Rhamnolipid | 5:4:1 | 176.1 | 0.09 | −34.6 | N/A |
| NLP510 | Sunflower | PE | Rhamnolipid | 5:4:1 | 181.9 | 0.10 | −30.4 | N/A |
| NLP511 | Coconut | soybean | Rhamnolipid | 5:4:1 | 176.7 | 0.10 | −33.4 | — |
| | | lecithin | | | | | | |
| NLP512 | Canola | LemonPL-f | Rhamnolipid | 5:4:1 | 182.1 | 0.14 | −33.1 | + |
| NLP513 | Canola | PS | Rhamnolipid | 5:4:1 | 189.6 | 0.10 | −31.9 | + |
| NLP514 | Coconut | PS | Rhamnolipid | 5:4:1 | 189.2 | 0.11 | −31.4 | — |
| NLP515 | LemonNP-f | de-oiled | Rhamnolipid | 5:4:1 | 170.4 | 0.11 | −33.5 | + |
| | | soybean | | | | | | |
| NLP516 | Canola | PE | Rhamnolipid | 5:4:1 | 170.4 | 0.11 | −33.5 | — |
| NLP517 | Soybean | sunflower | Rhamnolipid | 5:4:1 | 175.6 | 0.10 | −31.5 | + |
| | | lecithin | | | | | | |
| NLP518 | Sunflower | de-oiled | Rhamnolipid | 5:4:1 | 186.7 | 0.13 | −31.0 | — |
| | | soybean | | | | | | |
| NLP519 | Canola | PC | Rhamnolipid | 5:4:1 | 171.1 | 0.16 | −30.2 | — |
| NLP525 | Canola | soybean | Rhamnolipid | 5:4:1 | 180.8 | 0.13 | −33.7 | — |
| | | lecithin | | | | | | |
| NLP526 | LemonNP-f | PC | Rhamnolipid | 5:4:1 | 169.3 | 0.16 | −29.7 | — |
| NLP527 | Soybean | sunflower | Rhamnolipid | 5:4:1 | 196.7 | 0.12 | −30.9 | + |
| | | lecithin | | | | | | |
| NLP528 | LemonNP-f | PE | Rhamnolipid | 5:4:1 | 173.5 | 0.11 | −34.5 | — |
| NLP529 | Coconut | PE | Rhamnolipid | 5:4:1 | 182 | 0.09 | −35.9 | — |
| NLP530 | Soybean | soybean | Rhamnolipid | 5:4:1 | 181.1 | 0.14 | −33.5 | + |
| | | lecithin | | | | | | |
| NLP531 | Canola | LemonPL-f | Rhamnolipid | 5:4:1 | 206.3 | 0.14 | −40.3 | + |
| NLP532 | Sunflower | de-oiled | Rhamnolipid | 5:4:1 | 186.3 | 0.15 | −31.7 | + |
| | | soybean | | | | | | |
| NLP533 | Sunflower | sunflower | Rhamnolipid | 5:4:1 | 193.4 | 0.14 | −29.4 | + |
| | | lecithin | | | | | | |
| NLP534 | Soybean | PC | Rhamnolipid | 5:4:1 | 228.2 | 0.2 | −30.2 | — |
| NLP535 | Coconut | LemonPL-f | Rhamnolipid | 5:4:1 | 179.9 | 0.17 | −28.9 | + |
| NLP536 | Sunflower | PS | Rhamnolipid | 5:4:1 | 203.3 | 0.15 | −30.8 | — |
| NLP537 | Canola | de-oiled | Rhamnolipid | 5:4:1 | 184.2 | 0.1 | −29.6 | — |
| | | soybean | | | | | | |
| NLP538 | LemonNP-f | sunflower | Rhamnolipid | 5:4:1 | 170.1 | 0.1 | −30.7 | — |
| | | lecithin | | | | | | |
| NLP539 | Coconut | de-oiled | Sophoro | 5:4:1 | 179.9 | 0.1 | −31.9 | — |
| | | soybean | (SLM) | | | | | |
| NLP540 | Sunflower | PC | Sophoro | 5:4:1 | 237.8 | 0.24 | −30.3 | — |
| | | | (SLM) | | | | | |
| NLP541 | Sunflower | PA | Rhamnolipid | 5:4:1 | 172.2 | 0.15 | −29.6 | — |
| NLP542 | LemonNP-f | PA | Rhamnolipid | 5:4:1 | 176.2 | 0.19 | −29.1 | — |
| NLP543 | Sunflower | PA | Rhamnolipid | 5:4:1 | 166.7 | 0.14 | −30 | + |
| NLP544 | Soybean | PA | Rhamnolipid | 5:4:1 | 171.8 | 0.19 | −28.8 | + |
| NLP545 | Canola | soybean | Sophoro | 5:4:1 | 195.9 | 0.17 | −31.3 | — |
| | | lecithin | (SLM) | | | | | |
| NLP546 | Canola | PA | Sophoro | 5:4:1 | 184.4 | 0.24 | −37.9 | — |
| | | | (SLM) | | | | | |
| NLP547 | Soybean | LemonPL-f | Sophoro | 5:4:1 | 173.4 | 0.15 | −30.5 | — |
| | | | (SLM) | | | | | |
| NLP548 | Soybean | PC | Sophoro | 5:4:1 | 226.2 | 0.22 | −22.2 | — |
| | | | (SLM) | | | | | |
| NLP549 | LemonNP-f | PS | Sophoro | 5:4:1 | 193.9 | 0.10 | −29.9 | — |
| | | | (SLM) | | | | | |
| NLP550 | Canola | sunflower | Sophoro | 5:4:1 | 189.7 | 0.17 | −28.5 | + |
| | | lecithin | (SLM) | | | | | |
| NLP551 | Sunflower | sunflower | Sophoro | 5:4:1 | 189.3 | 0.19 | −32.9 | + |
| | | lecithin | (SLM) | | | | | |
| NLP552 | LemonNP-f | de-oiled | Sophoro | 5:4:1 | 186.9 | 0.18 | −30.84 | — |
| | | soybean | (SLM) | | | | | |
| NLP553 | Sunflower | PS | Sophoro | 5:4:1 | 213.5 | 0.19 | −30.845 | — |
| | | | (SLM) | | | | | |
| NLP554 | LemonNP-f | soybean | Sophoro | 5:4:1 | 194.1 | 0.13 | −30.83 | — |
| | | lecithin | (SLM) | | | | | |
| NLP555 | Soybean | PE | Sophoro | 5:4:1 | 193.8 | 0.13 | −33.25 | — |
| | | | (SLM) | | | | | |
| NLP556 | Coconut | PA | Sophoro | 5:4:1 | 200.0 | 0.27 | −36.03 | — |
| | | | (SLM) | | | | | |
| NLP557 | Coconut | PE | Sophoro | 5:4:1 | 190.1 | 0.10 | −33.34 | — |
| | | | (SLM) | | | | | |
| NLP558 | Canola | Lemon | Sophoro | 5:4:1 | 192.3 | 0.14 | −32.13 | — |
| | | | (SLM) | | | | | |
| NLP574 | Sunflower | sunflower | Rhamnolipid | 5:4:1 | 181.8 | 0.10 | −32.6 | — |
| | | lecithin | | | | | | |
| NLP575 | Sunflower | sunflower | Rhamnolipid | 4.6:3.7:91.7 | 488 | 0.47 | -17.4 | — |
| | | lecithin | ABG-PJ | | | | | |
| NLP576 | Sunflower | sunflower | 18:0 PE- | 5:4:1 | 200.6 | 0.19 | −29.4 | — |
| | | lecithin | PEG5000 | | | | | |
| NLP577 | Sunflower | sunflower | 18:0 PE- | 5:4:1 | 183.4 | 0.17 | −30.1 | + |
| | | lecithin | PEG2000 | | | | | |
| NLP578 | Sunflower | sunflower | Atlox | 4.6:3.7:91.7 | 172.5 | 0.13 | −42.9 | + |
| | | lecithin | CS100B | | | | | |
| NLP579 | Sunflower | sunflower | Atlox | 4.6:3.7:91.7 | 163.7 | 0.11 | −43.8 | — |
| | | lecithin | 4917 | | | | | |
| NLP580 | Sunflower | sunflower | Atlox | 4.6:3.7:91.7 | 177.3 | 0.1 | −40.3 | + |
| | | lecithin | 500L | | | | | |
| NLP581 | LemonNP-f | LemonPL-f | 18:0 | 5:4:1 | 165.8 | 0.19 | −32 | — |
| | | | PEG2000 | | | | | |
| | | | PE | | | | | |
| NLP582 | Soybean | PS | 18:0 | 5:4:1 | 201 | 0.16 | −25 | — |
| | | | PEG2000 | | | | | |
| | | | PE | | | | | |
| NLP583 | Coconut | sunflower | 18:0 | 5:4:1 | 181.5 | 0.23 | −30.1 | — |
| | | lecithin | PEG2000 | | | | | |
| | | | PE | | | | | |
| NLP584 | Soybean | PC | 18:0 | 5:4:1 | 185 | 0.32 | −32.7 | — |
| | | | PEG2000 | | | | | |
| | | | PE | | | | | |
| NLP585 | Canola | PA | 18:0 | 5:4:1 | 195.4 | 0.21 | −35.9 | — |
| | | | PEG2000 | | | | | |
| | | | PE | | | | | |
| NLP586 | Sunflower | soybean | 18:0 | 5:4:1 | 195.9 | 0.32 | −28.3 | — |
| | | lecithin | PEG2000 | | | | | |
| | | | PE | | | | | |
| NLP587 | Sunflower | PE | 18:0 | 5:4:1 | 188.5 | 0.21 | −32.6 | — |
| | | | PEG2000 | | | | | |
| | | | PE | | | | | |
| NLP588 | Sunflower | LemonPL-f | 18:0 | 5:4:1 | 153.6 | 0.19 | −40.5 | — |
| | | | PEG2000 | | | | | |
| | | | PE | | | | | |
| NLP589 | Coconut | de-oiled | 18:0 | 5:4:1 | 182.3 | 0.22 | −29 | — |
| | | soybean | PEG2000 | | | | | |
| | | | PE | | | | | |
| NLP590 | LemonNP-f | de-oiled | 18:0 | 5:4:1 | 200.1 | 0.16 | −32.5 | — |
| | | soybean | PEG2000 | | | | | |
| | | | PE | | | | | |
| NLP591 | LemonNP-f | PA | 18:0 | 5:4:1 | 128.6 | 0.26 | −38.8 | — |
| | | | PEG2000 | | | | | |
| | | | PE | | | | | |
| NLP592 | Canola | sunflower | 18:0 | 5:4:1 | 180.7 | 0.15 | −32.7 | — |
| | | lecithin | PEG2000 | | | | | |
| | | | PE | | | | | |
| NLP593 | Canola | PC | 18:0 | 5:4:1 | 184.1 | 0.17 | −31.0 | — |
| | | | PEG2000 | | | | | |
| | | | PE | | | | | |
| NLP594 | Coconut | soybean | 18:0 | 5:4:1 | 182.5 | 0.14 | −33.0 | — |
| | | lecithin | PEG2000 | | | | | |
| | | | PE | | | | | |
| NLP595 | Soybean | PE | 18:0 | 5:4:1 | 192.3 | 0.13 | −33.2 | — |
| | | | PEG2000 | | | | | |
| | | | PE | | | | | |
| NLP596 | LemonNP-f | PS | 18:0 | 5:4:1 | 206.9 | 0.18 | −33.4 | — |
| | | | PEG2000 | | | | | |
| | | | PE | | | | | |
| NLP597 | Coconut | PE | Atlox | | 192.0 | 0.22 | −44.9 | — |
| | | | 500L | | | | | |
| NLP598 | Coconut | LemonPL-f | Atlox | 4.6:3.7:91.7 | 177.2 | 0.11 | −40.5 | — |
| | | | 500L | | | | | |
| NLP599 | Canola | PE | Atlox | 4.6:3.7:91.7 | 209.9 | 0.15 | −43.9 | + |
| | | | 500L | | | | | |
| NLP600 | Canola | sunflower | Atlox | 4.6:3.7:91.7 | 180.5 | 0.15 | −43.4 | — |
| | | lecithin | 500L | | | | | |
| NLP601 | LemonNP-f | LemonPL-f | Atlox | 4.6:3.7:91.7 | 182.8 | 0.13 | −39.4 | — |
| | | | 500L | | | | | |
| NLP602 | Sunflower | PC | Atlox | 4.6:3.7:91.7 | 195.9 | 0.32 | −45.7 | — |
| | | | 500L | | | | | |
| NLP603 | Soybean | sunflower | Atlox | 4.6:3.7:91.7 | 186 | 0.27 | −45.0 | + |
| | | lecithin | 500L | | | | | |
| NLP604 | Coconut | PS | Atlox | 4.6:3.7:91.7 | 183.3 | 0.22 | −45.5 | + |
| | | | 500L | | | | | |
| NLP605 | Canola | de-oiled | Atlox | 4.6:3.7:91.7 | 181.6 | 0.25 | −44.1 | + |
| | | soybean | 500L | | | | | |
| NLP606 | LemonNP-f | PC | Atlox | 4.6:3.7:91.7 | 188.3 | 0.23 | −45.7 | — |
| | | | 500L | | | | | |
| NLP607 | Soybean | soybean | Atlox | 4.6:3.7:91.7 | 191.9 | 0.11 | −44.3 | — |
| | | lecithin | CS100B | | | | | |
| NLP608 | Sunflower | sunflower | Atlox | 4.6:3.7:91.7 | 186.6 | 0.13 | −44.3 | — |
| | | lecithin | CS100B | | | | | |
| NLP609 | Canola | PA | Atlox | 4.6:3.7:91.7 | 196.8 | 0.16 | −47.7 | + |
| | | | CS100B | | | | | |
| NLP610 | Coconut | PC | Atlox | 4.6:3.7:91.7 | 191.3 | 0.25 | −44.1 | — |
| | | | CS100B | | | | | |
| NLP611 | Sunflower | PA | Atlox | 4.6:3.7:91.7 | 190.8 | 0.10 | −47.4 | + |
| | | | CS100B | | | | | |
| NLP612 | Canola | PS | Atlox | 4.6:3.7:91.7 | 202.9 | 0.12 | −48.1 | + |
| | | | CS100B | | | | | |
| NLP613 | Sunflower | PE | Atlox | 4.6:3.7:91.7 | 200.0 | 0.13 | −44.5 | + |
| | | | CS100B | | | | | |
| NLP614 | Soybean | PS | Atlox | 4.6:3.7:91.7 | 197.8 | 0.12 | −48.7 | + |
| | | | CS100B | | | | | |
| NLP615 | LemonNP-f | sunflower | Atlox | 4.6:3.7:91.7 | 167.1 | 0.13 | −41.3 | — |
| | | lecithin | CS100B | | | | | |
| NLP616 | LemonNP-f | PC | Atlox | 4.6:3.7:91.7 | 177.5 | 0.13 | −48.4 | — |
| | | | CS100B | | | | | |
| NLP617 | LemonNP-f | de-oiled | Atlox | 4.6:3.7:91.7 | 186.1 | 0.12 | −44.9 | + |
| | | soybean | CS100B | | | | | |
| NLP618 | LemonNP-f | soybean | Atlox | 4.6:3.7:91.7 | 183.1 | 0.09 | −44.9 | + |
| | | lecithin | CS100B | | | | | |
| NLP619 | Sunflower | LemonPL-f | Atlox | 4.6:3.7:91.7 | 177.5 | 0.10 | −44.8 | — |
| | | | CS100B | | | | | |
| NLP620 | Coconut | soybean | Atlox | 4.6:3.7:91.7 | 177.4 | 0.12 | −43.3 | + |
| | | lecithin | CS100B | | | | | |
| NLP621 | Canola | de-oiled | Atlox | 4.6:3.7:91.7 | 183.8 | 0.13 | −43.8 | + |
| | | soybean | CS100B | | | | | |
| NLP622 | Soybean | LemonPL-f | Atlox | 4.6:3.7:91.7 | 190.9 | 0.12 | −42.6 | + |
| | | | CS100B | | | | | |
| NLP623 | Coconut | PE | Atlox | 4.6:3.7:91.7 | 185.8 | 0.13 | −44.7 | N/A |
| | | | CS100B | | | | | |
| NLP624 | Soybean | PA | N/A | 1:1:0 | 195.4 | 0.22 | −39.2 | N/A |
| NLP625 | Canola | PA | N/A | 1:1:0 | 195.6 | 0.20 | −37.7 | N/A |
| NLP626 | Coconut | PS | Atlox | 5:4:91 | 113.1 | 0.16 | −33.3 | N/A |
| | | | AL-2575 | | | | | |
| NLP627 | LemonNP-f | LemonPL-f | Atlox | 4.6:3.7:91.7 | 98.86 | 0.21 | −32.2 | N/A |
| | | | AL-2575 | | | | | |
| NLP628 | Coconut | PC | Atlox | 4.6:3.7:91.7 | 373.5 | 0.54 | -19.0 | N/A |
| | | | AL-2575 | | | | | |
| NLP629 | LemonNP-f | PE | Atlox | 4.6:3.7:91.7 | 98.65 | 0.16 | −34.5 | N/A |
| | | | AL-2575 | | | | | |
| NLP630 | Coconut | PA | Atlox | 4.6:3.7:91.7 | 130.0 | 0.15 | −37.0 | N/A |
| | | | AL-2575 | | | | | |
| NLP631 | Sunflower | PS | Atlox | 4.6:3.7:91.7 | 120.1 | 0.16 | −34.2 | N/A |
| | | | AL-2575 | | | | | |
| NLP632 | Sunflower | soybean | Atlox | 4.6:3.7:91.7 | 101.5 | 0.20 | −31.5 | — |
| | | lecithin | AL-2575 | | | | | |
| NLP633 | Soybean | PA | Atlox | 4.6:3.7:91.7 | 682.6 | 0.82 | −54.1 | — |
| | | | AL-2575 | | | | | |
| NLP634 | Canola | PC | Atlox | 4.6:3.7:91.7 | 115.7 | 0.17 | −16.9 | — |
| | | | AL-2575 | | | | | |
| NLP635 | Canola | de-oiled | Atlox | 4.6:3.7:91.7 | 133.2 | 0.38 | −28.9 | — |
| | | soybean | AL-2575 | | | | | |
| NLP636 | Coconut | sunflower | Atlox | 4.6:3.7:91.7 | 112 | 0.31 | −31.4 | — |
| | | lecithin | AL-2575 | | | | | |
| NLP637 | Canola | LemonPL-f | Atlox | 4.6:3.7:91.7 | 202.3 | 0.35 | −28.4 | — |
| | | | AL-2575 | | | | | |
| NLP638 | Soybean | de-oiled | Atlox | 4.6:3.7:91.7 | 121.6 | 0.20 | −36.5 | — |
| | | soybean | AL-2575 | | | | | |
| NLP639 | Soybean | soybean | Atlox | 4.6:3.7:91.7 | 116.1 | 0.23 | −32.7 | — |
| | | lecithin | AL-2575 | | | | | |
| NLP640 | Sunflower | PE | Atlox | 4.6:3.7:91.7 | 125.3 | 0.25 | −35.8 | — |
| | | | AL-2575 | | | | | |
| NLP644 | Sunflower | sunflower | Atlox | 28:22:50 | 203.8 | 0.15 | −32.5 | N/A |
| | | lecithin | 500L | | | | | |
| NLP645 | Sunflower | sunflower | Atlox | 42:33:25 | 220.5 | 0.10 | −26.8 | N/A |
| | | lecithin | 500L | | | | | |
| NLP646 | Sunflower | sunflower | Atlox | 5:4:1 | 190.4 | 0.17 | −37.31 | N/A |
| | | lecithin | 500L | | | | | |
| NLP647 | Sunflower | sunflower | Atlox | 28:22:50 | 202.5 | 0.11 | −36.61 | N/A |
| | | lecithin | CS100B | | | | | |
| NLP648 | Sunflower | sunflower | Atlox | 42:33:25 | 208.0 | 0.15 | −26.9 | N/A |
| | | lecithin | CS100B | | | | | |
| NLP649 | Sunflower | sunflower | Atlox | 5:4:1 | 216.2 | 0.16 | −26.3 | N/A |
| | | lecithin | CS100B | | | | | |

^{a}Selected NLPs were produced with 160 ug/ml or 400 ug/ml deltamethrin as indicated in the text. The NLPs optionally comprise Exalite at 1 ug per milliliter of the NLP suspension, as indicated in the text.
^{b}CLL-f : crude lemon lipids from fresh lemon juice; CLL-d : crude lemon lipids from freeze-fried lemon juice; LemonPL-f : enriched phospholipids from fresh lemon juice crude lipids; LemonNP-f : enriched non-polar lipids from fresh lemon juice crude lipids; LemonPL-d : enriched phospholipids from freeze-dried lemon crude lipids; LemonNP-d : enriched non-polar lipids from freeze-fried lemon crude lipids.
^{c}The particle size distribution, polydispersity index, and zeta potential were measured using a Malvern Panalytical Zetasizer Ultra Red Label. Measurements apply to NLPs comprising deltamethrin at 80 ug per ml of the NLP suspension. Similar values were measured for particles comprising 160 and 400 ug deltamethrin per ml of suspension.
^{d}Soil retention determination was described in Example 9.
+ indicates at least 10% detachment averaged in two replicate assays.
— indicates less than 10% detachment averaged in two replicate assays.
N/A: not available

TABLE 9
Physicochemical characteristics of NLPs produced with the DCM-free HHPH method

| | | | Surface | Deltamethrin | Weight | | | |
|---|---|---|---|---|---|---|---|---|
| NLP | Non-polar | Phospholipid | modifier | (ug/ml)/Exalite | ratios of | Size | | ZP |
| batch # | lipid (NP) | (PL) | (SM) | (ug/ml) | NP:PL:SM | (nm) | PDI | (mV) |
| NLP487 | Sunflower | Sunflower | N/A | 2000, — | 1:1:0 | 249.4 | 0.20 | −25.6 |
| | Oil | Lecithin | | | | | | |
| NLP530 | Soybean | Soybean | Rhamnolipid | 2000, — | 5:4:1 | 163.9 | 0.15 | −42.3 |
| | Oil | Lecithin | | | | | | |
| NLP533 | Sunflower | Sunflower | Rhamnolipid | 2000, — | 5:4:1 | 171.7 | 0.14 | −34.2 |
| | Oil | Lecithin | | | | | | |
| NLP551 | Sunflower | Sunflower | Sophorolipid | 2000, — | 5:4:1 | 171.8 | 0.15 | −25.5 |
| | Oil | Lecithin | (SLM) | | | | | |
| NLP646 | Sunflower | Sunflower | Atlox 500L | 80, 90 | 5:4:1 | 175.8 | 0.16 | −44.5 |
| | Oil | Lecithin | | | | | | |
| NLP644 | Sunflower | Sunflower | Atlox 500L | 2000, — | 2.8:2.2:5 | 172.2 | 0.14 | −40.7 |
| | Oil | Lecithin | | | | | | |
| NLP647 | Sunflower | sunflower | Atlox | 2000, — | 28:22:50 | 185.7 | 0.11 | −49.5 |
| | | lecithin | CS100B | | | | | |
| NLP649 | Sunflower | sunflower | Atlox | 80, 90 | 5:4:1 | 173.1 | 0.14 | −44.9 |
| | | lecithin | CS100B | | | | | |
| NLP654 | Sunflower | sunflower | Atlox 4917 | 2000, — | 28:22:50 | 170.1 | 0.15 | −46.8 |
| | | lecithin | | | | | | |
| NLP655 | Soybean | sunflower | Atlox 500L | 80, 90 | 5:4:1 | 177.3 | 0.11 | −43.4 |
| | | lecithin | | | | | | |
| NLP658 | Sunflower | PE | Atlox | 2000, — | 28:22:50 | 212.7 | 0.12 | −49.6 |
| | | | CS100B | | | | | |
| NLP659 | Coconut | soybean | Atlox | 2000, — | 28:22:50 | 189.8 | 0.16 | −52 |
| | | lecithin | CS100B | | | | | |

TABLE 10
Physicochemical characteristics of NLPs produced with the
HHPH plus excipients (HHPHE) method^{a}

| | | | NP:PL: | | | |
|---|---|---|---|---|---|---|
| | | | SM:ex- | Z- | Poly- | |
| | | | cipient: | Ave- | dispersity | Zeta |
| Formu- | Ex- | Co- | co- | rage | Index | Potential |
| lation | cipient | solvent | solvent^{b} | (nm) | (PI) | (mV) |
| NLP- | Ethyl | Isopropyl | 20:16:5: | 147.9 | 0.06393 | −41.19 |
| 646-1 | lactate | myristate | 24:35 | | | |
| NLP- | Atlas | Isopropyl | 20:16:5: | 135.3 | 0.09491 | −38.29 |
| 646-2 | G5002L | myristate | 24:35 | | | |
| NLP- | Poly- | Isopropyl | 20:16:5: | 99 | 0.1241 | −49.49 |
| 646-3 | ethylene | myristate | 24:35 | | | |
| | Glycol | | | | | |
| NLP- | N/A | Isopropyl | 27:21:6: | 187.2 | 0.05383 | −50.72 |
| 646-4 | | myristate | 46:0 | | | |

^{a}All comprising deltamethrin at 2,000 μg per ml of the NLP suspension
^{b}NP: Sunflower Oil; PL: Sunflower Lecithin; SM: Atlox 500L

TABLE 11
Physicochemical characteristics of NLPs produced with the NanoAssemblr ® method

| | Non- | | | Weight | | Z- | Polydis- | |
|---|---|---|---|---|---|---|---|---|
| | polar | Phospho- | Surface | ratios of | | Avera | persity | Zeta |
| | lipid | lipid | modifier | NP:PL: | DE/E | ge | Index | Potential |
| Formulation | (NP) | (PL) | (SM) | SM | M^{b} | (nm) | (PI) | (mV) |
| NLP018-1 | CLL-fª | CLL-f | — | 1:1:0 | DE | N/A | N/A | N/A |
| NLP018-2 | CLL-f | CLL-f | — | 1:1:0 | EM | N/A | N/A | N/A |

^{a}CLL-f; crude lemon lipids from fresh lemon juice.
^{b}Comprising either deltamethrin (DE) 80 μg/ml, or emamectin benzoate (EM) at 80 μg/ml.

### Example 2. Methods of Making NLPs

This Example describes the methods of producing NLPs. Four methods were employed: a) Sonication method (DCM method); b) Hot high-pressure homogenization (HHPH) method (DCM-free method); c) HHPH+excipients method; d) NanoAssemblr® method.

### a) Sonication Method (DCM Method) for Producing NLPs Comprising Deltamethrin and Exalite

Stock solutions were prepared as shown in Table 12. The organic phase was made by combining dichloromethane (DCM) stock solutions of nonpolar lipid, phospholipid, deltamethrin, Exalite, and optionally glycolipid by volume as shown in Table 13. For formulations with Atlox surface modifiers (Atlox 500L, Atlox CS100B, Atlox 4917, and Atlox 2575) the respective surface modifier was dissolved in de-ionized (DI) water at 0.5% w/w to be used as the aqueous phase. The aqueous phase consisted of DI water or DI water with the aqueous surface modifier. The organic phase was diluted 10× in the aqueous phase by combining 0.5 mL of organic phase with 5 mL of aqueous phase in a 20 mL scintillation vial. The mixture was then probe sonicated using a QSonica Q500 with a microtip probe with a tip diameter of 3.2 mm. The probe tip was placed in the center of the sample and submerged about one quarter through the liquid. The sample was then sonicated at 25% amplitude for 15 seconds pulsing every other second to prevent the sample from overheating. The DCM was then evaporated from the samples by magnetic stirring at 400 RPM for 30 minutes at room temperature. The final formulation was then filtered through a 1 um glass fiber syringe filter.

TABLE 12
Stock solutions prepared for sonication/DCM method

| NLP Component | Solvent | Concentration (mg/mL) |
|---|---|---|
| Non-polar lipid | Dichloromethane | 15 |
| Phospholipid | Dichloromethane | 15 |
| Glycolipid | Dichloromethane | 5 |
| Deltamethrin | Dichloromethane | 10 |
| Exalite 594 | Dichloromethane | 0.1 |
| Polymeric Surfactant | Water | 5 |

TABLE 13
Organic phase solution preparation for sonication/DCM
method where the ratio of NP:PL:SM is 5:4:1

| Stock | Amount (μL) |
|---|---|
| Non-polar lipid (NP; 15 mg/mL) | 83 |
| Phospholipid (P; 15 mg/mL) | 67 |
| Glycolipid (SM; 5 mg/mL) | 50 (0) |
| Deltamethrin (10 mg/mL)* | 40 |
| Exalite 594 (0.1 mg/mL)** | 50 |
| Dichloromethane | 210 (240) |
| Total | 500 |

*Final deltamethrin concentration: 80 μg/ml
**Final Exalite 594 concentration: 1 μg/ml

### b) Hot High Pressure Homogenization Method (HHPH; DCM-Free Method)

For this method the lipid phase contained components as indicated in Table 14. The aqueous phase contained components as indicated in Table 15. Both the lipid phase and aqueous phase were heated to 100° C. in separate bead baths. Once the deltamethrin powder had dissolved, the hot aqueous phase was poured into the lipid phase and homogenized while kept at 100° C. in the bead bath for 5 minutes at 13,000 RPM using an IKA T25 digital ULTRA-TURRAX with an S25N-18G dispersing tool. Once the formulation appeared homogenous with no visible solids, it was subject to five passes through an APV-1000 high pressure homogenizer at 12,000 PSI. The formulation was then cooled to room temperature before being filtered using a 1 um glass fiber syringe filter. Particle size, polydispersity index (PDI) and zeta potential were measured using a Malvern Panalytical Zetasizer Ultra Red Label.

TABLE 14
Solutions for HHPH method where the ratio of NP:PL:SM is 5:4:1

| Material | Amount (g) |
|---|---|
| Non-polar lipid (NP) | 4.448 |
| Polar lipid (P) | 3.552 |
| Glycolipid (SM) | 0.896 (0) |
| Deltamethrin | 0.400 |

TABLE 15
Aqueous phase preparation for HHPH method.

| Material | Amount (g) |
|---|---|
| Polymeric Surfactant | 0 (0.896) |
| DI Water | 190.704 |

### c) HHPH+Excipients Method

Deltamethrin and isopropyl myristate (IPM) were combined and placed in a water bath at 125° C. and stirred until the deltamethrin was dissolved. In a 250 mL glass beaker the non-polar lipid, polar lipid, and optionally glycolipid were combined by weight as shown in Table 16. The aqueous phase was then prepared by weight from DI water and optionally polymeric surface modifier was added. The aqueous solution was then heated to 100° C. in a bead bath. The deltamethrin/IPM solution was then added to the non-polar/polar lipid mixture while heated and stirred until the appearance was homogenous. The select co-solvent/surfactant was then added to the formulation while heated and magnetically stirred until the appearance was homogenous at which point to solution was removed from the water bath and allowed to cool. The aqueous phase was then added to the solution and homogenized for 5 minutes at 13,000 RPM using an IKA T25 digital ULTRA-TURRAX with an S25N-18G dispersing tool. The formulation was then subject to five passes through an APV-1000 high pressure homogenizer at 12,000 PSI. The final formulation was then filtered through a 1 μm glass fiber syringe filter.

Particle size, polydispersity index (PDI) and zeta potential were measured using a Malvern Panalytical Zetasizer Ultra Red Label, as described in more detail above.

TABLE 16
Solutions for HHPH plus excipients method
where the ratio of NP:PL:SM is 5:4:1.

| Ingredients | Wt(g) | % w/w |
|---|---|---|
| Deltamethrin | 0.400 | 0.20 |
| IPM (Isopropyl myristate) | 3.600 | 1.80 |
| Non-Polar Lipid | 4.448 | 2.22 |
| Polar Lipid | 3.552 | 1.78 |
| Glycolipid | 0.896 (0) | 0.45 (0) |
| Co-solvent/Surfactant | 2.670 | 1.34 |
| Polymeric Surface modifier | (0) 0.896 | (0) 0.45 |
| DI Water | 184.434 | 92.22 |
| Total | 200 | 100.0 |

### d) NanoAssemblr® (Microfluidic Mixing) Method for Producing Emamectin Benzoate-Containing NLPs

This example demonstrates the production of emamectin benzoate-containing NLPs using a NanoAssemblr® IGNITE™ microfluidic instrument (Precision NanoSystems) as a model microfluidic system. This method allows formation of NLPs via self-assembly by mixing an aqueous phase and a miscible solvent or a combination of miscible solvents containing dissolved lipids.

### Experimental Procedure:

An aliquot of 50 mg of dried lemon lipid is dissolved in 13.75 ml of dimethylformamide (DMF) and methanol (MeOH) (ratio of 4:1 v/v). An aliquot of 500 μL of 10 mg/mL emamectin benzoate (EM) in dimethyl sulfoxide (DMSO) was added into the dissolved lipid. An aliquot of 2.5 mL of the lipid solution (in a 3 mL syringe) on R channel (set at 37° C.) and 7.5 mL of MilliQ water (in a 10 mL syringe) on C channel were mixed using the NanoAssemblr® (NA) Precision NanoSystems with the following settings: total volume: 10 mL, flow rate: 12 mL/min, ratio: 3:1 (aqueous: organic), starting waste: 0.1 mL, ending waste: 0 mL). Free EM was removed by one round of centrifugation filtration and followed by dialysis.

After formulation the sample was transferred to two Amicon tubes (MWCO 100K). An aliquot of 10 mL of 25% DMF/MeOH in water was added to 5 mL of particle suspension. Free EM was removed by 1 round of centrifugal filtration (4000 g, 7 min, 4° C.). The particle suspension after filtration was collected. The suspension was then transferred to a dialysis cassette and transferred into 1 L of 10 mM MES buffer for dialysis over night to remove any trace of free EM.

Characterization-EM concentration was measured at two time points (post-NA, final) using LC/MS to calculate loading efficiency. Loading efficiency was calculated as follows: AI amount _Final (μg)/AI amount Post-NA (ug). Particle size and PDI was determined by DLS. For sample preparation, the NLP was diluted the 100 μL of each sample in 1 mL of water (pre-dialysis) or 10 mM MES buffer (post-dialysis and later time points).

### Example 3. Production of NLP Formulations Comprising Two or More Heterologous Functional Agents

This Example describes NLPs comprising more than one heterologous functional agent, e.g., deltamethrin and a biostimulant.

### Experimental Procedure:

To produce the NLPs comprising a first and a second heterologous functional agent, wherein both agents are hydrophobic, one of four methods can be utilized, as described below.

### a) DCM Method for Two Hydrophobic Heterologous Functional Agents

An organic phase comprising phospholipids, non-polar lipids, dichloromethane, a first heterologous functional agent and a second heterologous functional agent, and optionally a hydrophobic surface modifier, are mixed with an aqueous phase comprising de-ionized water and optionally a hydrophilic surface modifier, and applying a source of energy to facilitate the formation of NLPs, followed by evaporation of DCM.

### b) HHPH Method for Two Hydrophobic Heterologous Functional Agents

An organic phase comprising phospholipids, non-polar lipids, a first heterologous functional agent, a second heterologous functional agent, and optionally a hydrophobic surface modifier are mixed with an aqueous phase comprising de-ionized water and optionally a hydrophilic surface modifier, and applying a source of energy to facilitate the formation of NLPs.

### c) HHPHE Method for Two Hydrophobic Heterologous Functional Agents

An organic phase comprising phospholipids, non-polar lipids, isopropyl myristate, excipients (e.g., ethyl lactate, atlas G5002L or polyethylene glycol), a first heterologous functional agent, a second heterologous functional agent and optionally a hydrophobic surface modifier, are mixed with an aqueous phase comprising de-ionized water, and optionally a hydrophilic surface modifier, and applying a source of energy to facilitate the formation of NLPs.

### d) NanoAssemblr® Method for Two Hydrophobic Heterologous Functional Agents

An organic phase comprising phospholipids, non-polar lipids, a first heterologous functional agent, a second heterologous functional agent and optionally a hydrophobic surface modifier are mixed with an aqueous phase comprising de-ionized water and optionally a hydrophilic surface modifier, and applying a source of energy to facilitate the formation of NLPs.

When the heterologous functional agents are hydrophilic, the same methods are followed as above, except that the agents are both added to the aqueous phase instead of to the organic phase. Alternatively, one of the agents is hydrophobic, and one of the agents is hydrophilic. The same methods will be used as above, except that the agents will be added to the phase in which they are most soluble (either the hydrophobic phase for the hydrophobic agent or the hydrophilic phase for the hydrophilic agent). In some embodiments, three, four or five agents are combined in one NLP.

The ratio of NP:PL:SM can be any of the ratios described in the NLP formulations described in Example 1, e.g. a ratio of 5:4:1. The concentrations of the heterologous functional agents in the NLPs can range between 10-10,000 μg of the agent per ml of NLP suspension, e.g. 400 μg functional agent per ml of NLP suspension. Table 17 shows exemplary combinations of two agents, and their final concentrations in the NLPs.

TABLE 17
Production of NLPs comprising more than one heterologous functional agent

| | | Concentration | Biostimulant | Concentration |
|---|---|---|---|---|
| Combination^{a} | Insecticide | (μg/ml)^{b} | (μg/ml) | (μg/ml) |
| NLP(DE + BIO)1 | Deltamethrin | 80 | Brassinolide | 100 |
| NLP(DE + BIO)2 | Deltamethrin | 400 | Brassinolide | 100 |
| NLP(DE + BIO)3 | Deltamethrin | 2,000 | Brassinolide | 100 |
| NLP(DE + BIO)4 | Emamectin | 400 | Brassinolide | 100 |
| NLP(DE + BIO)5 | Emamectin | 400 | Brassinolide | 200 |
| NLP(DE + BIO)6 | Emamectin | 400 | Brassinolide | 300 |

^{a}DE, deltamethrin; BIO, biostimulant
^{b}Concentration refers ug DE comprised per ml of NLP suspension

### Example 4. Method of Producing a Mixture of NLP Formulations Each Comprising a Different Heterologous Functional Agent

This Example describes methods to produce mixtures of NLPs populations, e.g. a mixture of a population of NLPs comprising a first heterologous functional agent (e.g. deltamethrin) and a population of NLPs comprising a second heterologous functional agent (e.g. a biostimulant).

### Experimental Procedure:

To produce the two populations of NLPs each comprising a different heterologous functional agent, one of four methods are utilized, as described below. In case both heterologous functional agents are hydrophobic, the methods are as follows:

### a) DCM Method

For the first population of NLPs, an organic phase comprising phospholipids, non-polar lipids, dichloromethane, a first heterologous functional agent, and optionally a hydrophobic surface modifier, are mixed with an aqueous phase comprising de-ionized water and optionally a hydrophilic surface modifier, and applying a source of energy to facilitate the formation of NLPs, followed by evaporation of DCM.

For the second population of NLPs, an organic phase comprising phospholipids, non-polar lipids, dichloromethane, a second heterologous functional agent, and optionally a hydrophobic surface modifier, are mixed with an aqueous phase comprising de-ionized water and optionally a hydrophilic surface modifier, and applying a source of energy to facilitate the formation of NLPs, followed by evaporation of DCM.

The first and the second population of NLPs are then mixed, e.g. in equal volumes to produce the NLP mixture.

### b) HHPH Method for Two Hydrophobic Heterologous Functional Agents

For the first populations of NLPs, an organic phase comprising phospholipids, non-polar lipids, a first hydrophobic heterologous functional agent, and optionally a hydrophobic surface modifier are mixed with an aqueous phase comprising de-ionized water and optionally a hydrophilic surface modifier, and applying a source of energy to facilitate the formation of NLPs.

For the second population of NLPs, an organic phase comprising phospholipids, non-polar lipids, a first hydrophobic heterologous functional agent, and optionally a hydrophobic surface modifier are mixed with an aqueous phase comprising de-ionized water and optionally a hydrophilic surface modifier, and applying a source of energy to facilitate the formation of NLPs.

The first and the second population of NLPs are then mixed, e.g. in equal volumes to produce the NLP mixture.

### c) HHPHE Method for Two Hydrophobic Heterologous Functional Agents

For the first population of NLPs, an organic phase comprising phospholipids, non-polar lipids, isopropyl myristate, excipients (e.g., ethyl lactate, atlas G5002L or polyethylene glycol), a first hydrophobic heterologous functional agent, and optionally a hydrophobic surface modifier, are mixed with an aqueous phase comprising de-ionized water, and optionally a hydrophilic surface modifier, and applying a source of energy to facilitate the formation of NLPs.

For the second population of NLPs, an organic phase comprising phospholipids, non-polar lipids, isopropyl myristate, excipients (e.g., ethyl lactate, atlas G5002L or polyethylene glycol), a second hydrophobic heterologous functional agent, and optionally a hydrophobic surface modifier, are mixed with an aqueous phase comprising de-ionized water, and optionally a hydrophilic surface modifier, and applying a source of energy to facilitate the formation of NLPs.

The first and the second population of NLPs are then mixed, e.g. in equal volumes to produce the NLP mixture (Table 18).

### d) NanoAssemblr® Method for Two Hydrophobic Heterologous Functional Agents

For the first population of NLPs, an organic phase comprising phospholipids, non-polar lipids, a first hydrophobic heterologous functional agent, and optionally a hydrophobic surface modifier are mixed with an aqueous phase comprising de-ionized water and optionally a hydrophilic surface modifier, and applying a source of energy to facilitate the formation of NLPs.

For the second population of NLPs, an organic phase comprising phospholipids, non-polar lipids, a second hydrophobic heterologous functional agent, and optionally a hydophobic surface modifier are mixed with an aqueous phase comprising de-ionized water and optionally a hydrophilic surface modifier, and applying a source of energy to facilitate the formation of NLPs.

The first and the second population of NLPs are then mixed, e.g. in equal volumes to produce the NLP mixture.

When the heterologous functional agents are hydrophilic, the same methods are followed as above, except that the agents are added to the aqueous phase instead of to the organic phase. Alternatively, one of the agents is hydrophobic, and one of the agents is hydrophilic. The same methods will be used as above, wherein the agents will be added to the phase in which they are most soluble (either the hydrophobic phase or the hydrophilic phase). In some embodiments, three, four or five NLP populations are combined. The ratio of NP:PL:SM in any NLP formulations can be any of the ratios described in the NLP formulations described in Example 1, e.g. a ratio of 5:4:1. The concentrations of the heterologous functional agents comprised in any of the NLP formulations can range between 10-10,000 μg per ml of suspension, e.g. 400 ug per ml of suspension. The ratios in which the two NLP populations can be mixed is 50:50, or any other ratio, e.g. 10:90.

TABLE 18
Exemplary combinations of two NLP populations, each
comprising a different heterologous functional agent.

| NLP | NLP1 comprising | Concentration | NLP2 comprising | Concentration |
|---|---|---|---|---|
| Combination^{a} | insecticide | (μg/ml)^{b} | biostimulant | (μg/ml)^{b} |
| NLP1 (DE) + | Deltamethrin | 80 | Brassinolide | 100 |
| NLP2 (BIO)1 | | | | |
| NLP1 (DE) + | Deltamethrin | 400 | Brassinolide | 100 |
| NLP2 (BIO)2 | | | | |
| NLP1 (DE) + | Deltamethrin | 2,000 | Brassinolide | 100 |
| NLP2 (BIO)3 | | | | |
| NLP1 (DE) + | Emamectin | 400 | Brassinolide | 100 |
| NLP2 (BIO)4 | | | | |
| NLP1 (DE) + | Emamectin | 400 | Brassinolide | 200 |
| NLP2 (BIO)5 | | | | |
| NLP1 (DE) + | Emamectin | 400 | Brassinolide | 300 |
| NLP2 (BIO)6 | | | | |

^{a}BIO; biostimulant
^{b}Concentration refers ug DE or BIO comprised per ml of NLP suspension

### Example 5. Method of Producing a Mixture of NLPs and an Unencapsulated Agent

This Example describes methods to produce a mixture comprising an NLPs population comprising a first heterologous agent (e.g. deltamethrin), and an unencapsulated second heterologous functional agent (e.g. biothuricide, Bt).

### Experimental Procedure:

To produce NLPs comprising a first heterologous functional agent, one of four methods is utilized, as described below. When the first heterologous functional agent is hydrophobic, the methods are as follows:

### a) DCM Method

An organic phase comprising phospholipids, non-polar lipids, dichloromethane, a first heterologous functional agent, and optionally a hydrophobic surface modifier, are mixed with an aqueous phase comprising de-ionized water and optionally a hydrophilic surface modifier, and applying a source of energy to facilitate the formation of NLPs, followed by evaporation of DCM.

### b) HHPH Method

An organic phase comprising phospholipids, non-polar lipids, a first hydrophobic heterologous functional agent, and optionally a hydrophobic surface modifier are mixed with an aqueous phase comprising de-ionized water and optionally a hydrophilic surface modifier, and applying a source of energy to facilitate the formation of NLPs.

### c) HHPHE Method

An organic phase comprising phospholipids, non-polar lipids, isopropyl myristate, and excipients (e.g., ethyl lactate, atlas G5002L or polyethylene glycol), a first hydrophobic heterologous functional agent, and optionally a hydrophobic surface modifier, are mixed with an aqueous phase comprising de-ionized water, and optionally a hydrophilic surface modifier, and applying a source of energy to facilitate the formation of NLPs.

### d) NanoAssemblr® Method

An organic phase comprising phospholipids, non-polar lipids, a first hydrophobic heterologous functional agent, and optionally a hydophobic surface modifier are mixed with an aqueous phase comprising de-ionized water and optionally a hydrophilic surface modifier, and applying a source of energy to facilitate the formation of NLPs.

The NLPs composition produced by any of the methods above is then mixed with an unencapsulated heterologous functional agent, e.g. thuricide, thereby producing a new composition. Exemplary mixtures are shown in Table 19.

TABLE 19
Production of a mixture comprising a plurality of NLPs and unencapsulated agent

| | Insecticide | Concentration | Insecticide | Concentration |
|---|---|---|---|---|
| Combination^{a} | (NLP1) | (μg/ml)^{b} | (NLP2) | (μg/ml)^{b} |
| NLP1 (DE) + | Deltamethrin | 80 | Thuricide (Bt) | 100 |
| Bt 1 | | | | |
| NLP1 (DE) + | Deltamethrin | 400 | Thuricide (Bt) | 100 |
| Bt 2 | | | | |
| NLP1 (DE) + | Deltamethrin | 2,000 | Thuricide (Bt) | 100 |
| Bt 3 | | | | |
| NLP1 (DE) + | Deltamethrin | 400 | Thuricide (Bt) | 100 |
| Bt 4 | | | | |
| NLP1 (DE) + | Deltamethrin | 400 | Thuricide (Bt) | 200 |
| Bt 5 | | | | |
| NLP1 (DE) + | Deltamethrin | 400 | Thuricide (Bt) | 300 |
| Bt 6 | | | | |

^{a}Bt; biothuricide
^{b}Concentration refers ug DE or Bt comprised per ml of NLP suspension

### Example 6. Lyophilization and Storage of NLPs

This Example demonstrates that NLP can be freeze-dried and stored at ambient or higher temperature for an extended time.

### Experimental Procedure:

An aliquot of 1 ml of NLP formulation is mixed with 1 ml of 20% lyoprotectant comprising maltodextrin 12, trehalose, sucrose, or mannitol in DI water. After freezing at −80° C. the suspensions are lyophilized in a LABCONCO FreeZone −84C Benchtop Freeze Dryer. The method is performed with the collector at −100° C. under vacuum to 0.000 mbar. The primary drying step is run for 10 hours with the shelf temperature set to −20° C. The secondary drying step is run for 4 hours with the shelf temperature set to 20° C. Dried NLP suspensions are stored at room temperature. Aliquots of dried NLPs are resuspended in 1 ml of DI water.

Reconstituted NLP's are intact. Stability is assessed as described in Example 7. Dried NLPs have an anticipated higher shelf life than NLPs in suspension, and this method shows that lyophilization and reconstitution does not negatively impact on the structure of the NLPs.

### Example 7. Characterization of NLP Stability

This example describes measuring the stability of NLPs under a wide variety of storage and physiological conditions.

### Experimental Procedure:

NLPs produced as described in Examples 1 and 2 are subjected to various conditions. NLPs are suspended in water, 5% sucrose, or PBS and left for 1, 7, 30, and 180 days at −20° C., 4° C., 20° C., and 37° C. NLPs are also suspended in water and dried using a rotary evaporator system and left for 1, 7, and 30, and 180 days at 4° C., 20° C., and 37° C. NLPs are also suspended in water or 5% sucrose solution, flash-frozen in liquid nitrogen and lyophilized. After 1, 7, 30, and 180 days, dried and lyophilized NLPs are then resuspended in water. The previous three experiments with conditions at temperatures above 0° C. are also exposed to an artificial sunlight simulator to determine content stability in simulated outdoor UV conditions. NLPs are also subjected to temperatures of 37° C., 40° C., 45° C., 50° C., and 55° C. for 1, 6, and 24 hours in buffered solutions with a pH of 1, 3, 5, 7, and 9 with or without the addition of 1 unit of trypsin or in other simulated gastric fluids.

After each of these treatments, NLPs are bought back to 20° C., neutralized to pH 7.4, and characterized using some or all of the methods described in Example 1.
Example 8. Loading NLPs with Cargo after NLP Formation

This example describes methods of loading NLPs with additional small molecules, proteins, and nucleic acids to use as probes to determine NLP uptake efficiency in plants.

a) Loading Additional Small Molecules into NLPs

NLPs are produced as described in Example 1 and Example 2. To load small molecules into NLPs, NLPs are placed in PBS solution with the small molecule either in solid form or solubilized. The solution is left for 1 hour at 22° C., according to the protocol in Sun, Mol. Ther., 2010. Alternatively, the solution is sonicated to induce poration and diffusion into the NLPs according to the protocol from Wang et al, Nature Comm., 4: Article number: 1867, 2013. Alternatively, NLPs are electroporated according to the protocol from Wahlgren et al, Nucl. Acids. Res., 40 (17): e130, 2012.

Before use, the loaded NLPs are purified to remove unbound small molecules.
b) Loading Proteins or Peptides into NLPs after NLP Formation

NLPs are produced as described in Example 1 and Example 2. To load additional proteins or peptides into NLPs, NLPs are placed in solution with the protein or peptide in PBS. If the protein or peptide is insoluble, pH is adjusted until it is soluble. If the protein or peptide is still insoluble, the insoluble protein or peptide is used. The solution is then sonicated to induce poration and diffusion into the NLPs according to the protocol from Wang et al, Nature Comm., 4: Article number: 1867, 2013. Alternatively, NLPs are electroporated according to the protocol from Wahlgren et al, Nucl. Acids. Res., 40 (17): e130, 2012.

Before use, the loaded NLPs are purified using the methods as described in Example 2 to remove unbound peptides and protein. To measure loading of the protein or peptide, the Pierce Quantitative Colorimetric Peptide Assay is used on a small sample of the loaded and unloaded NLPs.

c) Loading Nucleic Acids into NLPs after NLP Formation

NLPs are produced as described in Example 1 and Example 2. To load nucleic acids into NLPs, NLPs are placed in solution with the nucleic acid in PBS. The solution is then sonicated to induce poration and diffusion into the NLPs according to the protocol from Wang et al, Nature Comm., 4: Article number: 1867, 2013. Alternatively, NLPs are electroporated according to the protocol from Wahlgren et al, Nucl. Acids. Res., 40(17): e130, 2012.

Before use, the NLPs are purified using the methods as described in Example 2 to remove unbound nucleic acids. Nucleic acids that are loaded in the NLPs are quantified using either a Quant-lt assay from Thermo Fisher following manufacturer's instructions, or fluorescence is quantified with a plate reader if the nucleic acids are fluorescently labeled.

### Example 9. NLP Encapsulation Alters Soil-Binding Properties of Deltamethrin

This Example describes two assays to assess binding of NLP to soil, 1) a soil retention assay and 2) a soil mobility assay. Deltamethrin (DE) is an insecticide in the pyrethroid class, and it is an extremely hydrophobic molecule (solubility of 0.002 mg/l at 20° C. in water) with a high LogP (octanol-water partition coefficient) of 6.2. The assays test if NLPs comprising DE can lower DE binding to soil, and hence enhance DE mobility in soil.

### Experimental Procedure:

### 1) Soil Retention Assay.

This Example uses a soil suspension where a non-saturating amount of NLP comprising DE is mixed with the soil suspension and the leachate is examined.

### a) Preparation of Soil Leachates

The NLP formulations of Table 8, comprising deltamethrin (80 μg/ml) and Exalite (1 μg/ml) were tested for soil binding. For each formulation, three Eppendorf tubes were filled with 0.27 g soil (Silt loam soil, “Iowa Fayette”, purchased from Agvise) each. An aliquot of 1.6 mL artificial rain (AR) comprising 0.11% CaCl2 in Milli-Q ultrapure water, pH 7.0, was added to each soil tube. Subsequently, an aliquot of 27.5 μL NLP formulation was added to each of three tubes per NLP formulation.

For the DE controls, a 2.75 μL aliquot from a deltamethrin stock solution (800 μg/ml in Dichloromethane (DCM) was added to each of 3 samples of soil in AR. For the Exalite controls, an aliquot of 2.75 μL Exalite working solution (10 μg/ml) was added to each of three samples of soil in AR. For the “water” control, 5.4 g soil is weighed into a 50-mL centrifuge tube and 32 mL AR is added. Tubes are incubated for 1 hr, centrifuged and the resultant supernatant is the soil water solution. An aliquot of 1.6 mL soil water solution is added to a 2-mL tube. An aliquot of 27.5 μL of NLP sample is added in triplicate.

All tubes were then placed in a microtube holder and incubated on the horizontal shaker for 1 hr at 100 rpm. The soil in the soil-containing samples was precipitated by centrifugation, and 1 ml of the supernatant (the leachate) was removed. Fluorescence was detected in the leachate as described below.

b) Calculation of the Percent NLP Leachate from Exalite Levels in the Leachate

An aliquot of 200 μL NLP leachate sample or soil water sample is pipetted into each well of a black-walled 96-well plate with 2 technical replicates per sample. Fluorescence is read using a Biotek plate reader setting an Excitation wavelength of 510 nm, and an emission wavelength of 570 nm. The percent detachment is calculated by:

$$\% detachment = \frac{{F}_{S L} - N}{{F}_{S W}} * 100$$

where F_{SL} is the average fluorescence of the soil leachate sample, N is the average fluorescence of the negative control (baseline fluorescence) and F_{SW} is the average fluorescence of the soil water sample.
c) Calculation of Percent NLP Leachate from DE Levels in the Leachate

Deltamethrin was extracted from the soil under agitation by methanol. Samples were mixed well and centrifuged to remove any soil particles before transfer to an HPLC vial. Final determination of DE in the extracts was made by high performance liquid chromatography with triple quadrupole mass spectrometric detection (LC-MS/MS) using ESI in positive ionization mode. Samples were analyzed at a flow rate: 0.7 mL/min, with a mobile phase solvent A of 10 mM ammonium acetate in water/methanol (4:1 v/v), and solvent B of 0.1% formic acid in methanol/acetonitrile (1:1 v/v), applying a gradient from 5% B to 95% B in 8 min, using a Waters Sunfire® 50×2.1 mm, 5 μm column and a Sciex 4000 Q-Trap triple quadrupole mass spectrometer with analyst 1.6.3 software for detecting and quantitating deltamethrin in the samples.

The percent NLP detachment is calculated by comparing the soil leachate result with the deltamethrin concentration in the original NLP formulation sample:

$$\% detachment = \frac{{[ AI ]}_{SL} * D}{{[ AI ]}_{U} * 1000} ,$$

where [AI]_{SL} is the average concentration of deltamethrin in the soil leachate in ng/mL, [AI]_{U} is the average concentration of deltamethrin in the original NLP formulation sample in ug per mL of suspension, and D is the dilution factor (total volume/volume of sample)—in this case,

$$D = \frac{{V}_{U} + {V}_{AR}}{{V}_{U}} = 59.18182 .$$

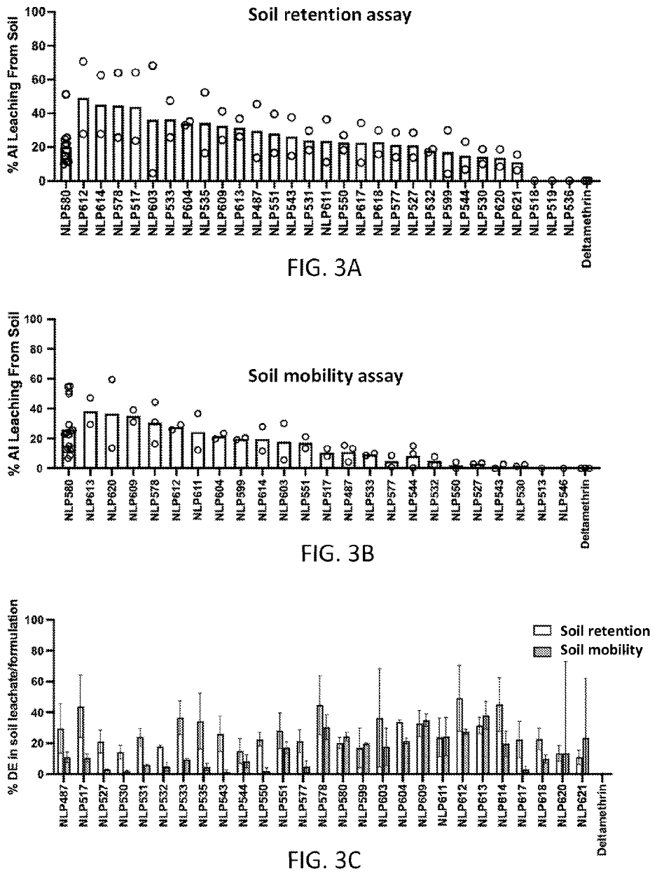

A total of 127 formulations selected from Table 8 were screened in the soil retention assay. The percent leaching from soil is indicated in the right column of Table 8. In FIG. 3A, a subset of the 127 samples were plotted. In total, 27 of the 127 formulations passed the QC criteria of having greater than 10% soil detachment (average of the two replicates) indicating that 27 of the 127 formulations comprise at least a fraction that did not bind to soil, with a maximum percent of deltamethrin recovered of about 50% (e.g. NLP612). Conversely, unformulated deltamethrin could not be recovered from soil showing the advantage of encapsulating DE in NLP.

### 2) Soil Mobility Assay

This Example uses a soil column where a non-saturating amount of NLP is applied to soil packed in a column and the leachate is examined. A selection of the NLP formulations were tested in this assay. The NLP compositions selected were those that showed more than 10% detachment in the soil retention assay under 1), and further excluding those NLP formulations comprising lemon lipids due to the time-consuming process to isolate lemon lipids for preparing new NLP batches.

### Experimental Procedure:

### a) Preparation and Running of Samples Over the Soil Columns:

The NLP formulations of Table 8, comprising deltamethrin (80 μg/ml) but no Exalite (1 μg/ml) were tested for soil binding. Flash cartridges (soil columns) (Sorbent Technologies, Cat #FCSTLL-4-20) were obtained and the white frit filters were removed from the top of the soil columns. An aliquot of 2.7 g soil (Silt loam soil, “Iowa Fayette”, purchased from Agvise) was weighed and added to each of 3 columns per sample. The column was saturated with artificial rain solution (0.11% CaCl2 in Milli-Q ultrapure water, pH 7.0). Subsequently, a non-saturating 1 mL aliquot of NLP formulation was gently loaded onto the top of each column. Negative controls were DE only or no sample added. Subsequently, 14 mL of artificial rain was pipetted onto the column. A syringe plunger was used to gently press down and induce flow through the column into the 15 mL collection tube. The plunger was removed and further elution was made by gravity (about 2 h).

For the control “soil water sample”, the leachate from a soil column to which no sample was added was taken, and to 1.4 mL of this leachate, 0.1 mL of NLP formulation was added.

### b) Calculation of Percent NLP Leachate

The percent NLP in leachate was determined by quantifying Exalite and deltamethrin levels, as described in the Soil Retention assay section above.

The percent NLP detachment is calculated by comparing the soil leachate result with the deltamethrin concentration in the original NLP formulation sample.

$$\% detachment = \frac{{[ AI ]}_{SL} * D}{{[ AI ]}_{U} * 1000}$$

Where [AI]_{SL} is the average concentration of deltamethrin in the soil leachate in ng/mL, [AI]_{U} is the average concentration of deltamethrin in the original unknown sample in μg/mL, and D is the dilution factor (total volume/volume of sample)—in this

$$Example D = \frac{{V}_{U} + {V}_{AR}}{{V}_{U}} = 15.$$

Results plotted in FIG. 3B show the percentage of the deltamethrin comprised in NLP leaching out from soil in the soil mobility assay. FIG. 3C compares the percent leachate of the same formulations in both the soil retention assay under 1) and the soil mobility assay under 2). In general, good reproducibility was observed in that formulations that leach from soil in the soil retention assay also leached from soil in the soil mobility assay, confirming non-binding of the identified formulations in either assay.

Example 10. Correlating NLP Soil Leaching with NLP Composition

This Example explores a correlation between function (soil binding) and structural characteristics of the NLP particles.

### Experimental Procedure:

Deltamethrin detachment readouts from the soil retention assay (Example 9) are reduced into binary classes, either “binding” for those observations with low detachment or “non-binding” for those with >40% detachment. Models are then tasked with classifying an NLP record as either “binding” or “non-binding”, given the NLP attributes visible to it during training.

Tree-based classifier approaches are attractive for their open decision processes; unlike other machine learning methods, one can inspect a fitted tree-based classifier and see which questions it asks of the data as it tries to sort it into one of the classes defined in the tasked problem. From this inspection, one can derive weights of feature importance- or in other words, relative ranking of features the model considers important in making a prediction.

As an important caveat, feature importance is specific to a fitted model; it does not necessarily translate to true factors driving a desired response in an assay. scikit-learn, the primary machine learning library in the Python programming language, makes this important distinction in its documentation on the methods used for inspecting feature importance:

Features that are deemed of low importance for a bad model (low cross-validation score) could be very important for a good model. Therefore, it is always important to evaluate the predictive power of a model using a held-out set (or better with cross-validation) prior to computing importances. Permutation importance does not reflect the intrinsic predictive value of a feature by itself but how important this feature is for a particular model.

Given this caveat, one must first ensure to have a well-fit model before making any claims about feature importance. We will build and validate several ensembled, tree-based classifier methods. In the scenario where zeta potential is available to the model, the selected classifier has a recall score of 1 and a precision score of 0.68. In the scenario where zeta potential is not available to the model, the selected classifier also achieves a recall score of 1.0 but has severely degraded skill in precision, with a score of 0.19. A Table covering the key metrics of both classifiers follows (Table 20).

TABLE 20
Key metrics

| | | Recall | Precision | F₁ | AUC |
|---|---|---|---|---|---|
| Model | Feature set | [0, 1] | [0, 1] | [0, 1] | [0, 1] |
| Gradient | Zeta- | 1.0 | 0.68 | 0.81 | 0.98 |
| boosting tree- | inclusive | | | | |
| based ensemble | | | | | |
| Gradient | Zeta- | 1.0 | 0.19 | 0.32 | 0.85 |
| boosting tree- | exclusive | | | | |
| based ensemble | | | | | |

When using the F₁ score as the measure of reference, then the predictive skill of the classifier trained with the zeta-inclusive feature set permits us to inspect its feature importance and expect that the marginal predictive values of top features do in fact reflect feature weights of a robust model. In the case of the classifier trained with the zeta-exclusive feature set, the model has identical recall but very poor precision skill, meaning it more frequently identifies “binding” NLP instances as “non-binding” in its predictions.

In both model training scenarios, the selected models use the gradient boosting method in its classification algorithm. Core features of a gradient boosting classifier, as implemented by scikit-learn, include:
1. a tree-based decision process, where information is gained in a series of yes/no questions that attempt to sort heterogenous input into homogenous output as efficiently and accurately as possible;
2. an ensembled modeling approach, where a member set of models give their vote on a prediction and the final prediction is a weighted evaluation of all member models' votes;
3. a boosting training approach, where the model sequentially trains a set of weak learners; when each weak learner is trained, the method then identifies subsets of records where predictions are poor and then devotes the subsequent learner to improving upon the persistent prediction errors made by prior models.

With the selected, best-fit model for the scenario where zeta potential is available, we then use permutation feature importance to determine what features the models consider most informative in making accurate class predictions (“binding” or “non-binding”). From the scikit-learn documentation:

The permutation feature importance is defined to be the decrease in a model score when a single feature value is randomly shuffled. This procedure breaks the relationship between the feature and the target, thus the drop in the model score is indicative of how much the model depends on the feature.

The estimator is required to be a fitted estimator. X can be the data set used to train the estimator or a hold-out set. The permutation importance of a feature is calculated as follows. First, a baseline metric, defined by scoring, is evaluated on a (potentially different) dataset defined by the X. Next, a feature column from the validation set is permuted and the metric is evaluated again. The permutation importance is defined to be the difference between the baseline metric and metric from permutating the feature column.

In the permutation feature importance stage, we use the F₁ score as the reference metric for assessing the marginal value of a given feature. The F₁ score is the harmonic mean of precision and recall, defined as:

$${F}_{1} = 2 * \frac{( precision * recall )}{( precision + recall )}$$

In the model trained on the zeta-inclusive feature set, zeta potential's marginal contribution to the F₁ score is clear. The permutation importance method estimated that zeta potential on average had a marginal contribution to the F₁ score of 0.43. The next most important feature had a marginal contribution of 0.05.

Comparing the model trained on the zeta-inclusive feature set to the model trained without zeta potential as a feature, it appears that the latter model is able to use structural components of an NLP instance to successfully predict all “non-binding” instances in the held-out test set. However, relying on these structural components in its predictions leads it to identify many more false positives, or hits that aren't truly hits, than the model trained with zeta potential as a feature,

### Example 11. NLP Activity Against Corn Rootworm in an In Vitro Corn Root Assay

This Example tests the efficacy of NLP and NLP soil column leachates towards corn rootworms.

### Experimental Procedure:

### a) Preparation of Corn Germination Boxes

Large plastic boxes were sterilized by soaking in 10% bleach for ≥20 min, followed by spraying with 70% EtOH and drying. An aliquot of 500 ml of Phytagel containing 0.7 g of Phytagel and 0.65 g of Hoagland's Basal Salt No. 2, pH 6.5, was poured into the boxes. The boxes were allowed to cool and firmly covered with aluminum foil once solidified.

### b) Sterilization of Corn Seeds

Seeds were placed in a large container in 1.5% bleach solution with 0.002% Triton X-100 under gentle agitation. Seeds were rinsed three times with sterile water and planted the same day. Corn seeds were placed into a Conviron reach-in incubator (27C, 50% relative humidity, 16 h L: 8 h D).

### c) Cultivation of Seeds

Seeds were placed in a 4×6 grid pattern following the height×length of the box in which phytagel was poured. Seeds were placed embryo side up (scoop up) and gently pressed into gel. Containers were resealed with aluminum foil. On day −4, After 1 day of germination, the foil was removed and replaced with a plastic lid, and seedlings were left to grow for 4 more days. After 4 days, the seedlings had one exposed leaf collar and a small but robust root system.

### c) Root Treatment

On Day −1 or Day 0, Phytagel Magenta Boxes were prepared the day before and stored sealed at 4° C. Sterilized magenta boxes were filled with 25 ml of Phytagel solution containing per 500 ml 0.7 g of Phytagel and 0.65 g of Hoagland's Basal Salt No. 2, pH 6.5. Boxes were allowed to cool, covered with foil or sterilized magenta cage lids and stored at 4° C. On Day 0, corn was removed from germination boxes and excess Phytagel around roots was removed.

Care was taken to not break roots when removing Phytagel. Cleaned seedlings were placed on paper towels and covered with wet paper towel to preserve plant rigor. Corn roots were treated with one of the following treatment solutions: 1) negative control: untreated soil leachate; 2) positive control: 80 μg/ml Bifenthrin (Bifenture® LFC, UPL); 3) NLP580 comprising deltamethrin at 80 μg per ml of suspension (NLP580 [80 ug/ml DE]); 4) Soil leachate of NLP580 comprising deltamethrin at 80 μg per ml of suspension (leachate NLP580 [80 ug/ml DE]); 5) NLP487 comprising deltamethrin at 80 μg per ml of suspension (NLP487 [80 ug/ml DE]); 6) Soil leachate of NLP487 comprising deltamethrin at 80 μg per ml of suspension (leachate NLP580 [80 ug/ml DE]); 7) NLP578 comprising deltamethrin at 80 μg per ml of suspension (NLP578 [80 ug/ml DE]); 8) Soil leachate of NLP578 comprising deltamethrin at 80 μg per ml of suspension (leachate NLP580 [80 ug/ml DE]); 9) 80 ug/ml of deltamethrin (Suspend SC, Bayer)—non-NLP formulated, commercially available formulation for foliar application of deltamethrin; 10) Soil leachate of Suspend SC (diluted to 80 ug/ml deltamethrin in water). At least 2 ml of treated solution was used for root treatment. Using a 5 ml serological pipet, at least 2 ml of treatment solutions were slowly dripped down a single seedling's roots into a petri dish to evenly distribute across radicle (tap root) and any lateral seminal roots. Roots were dipped and dragged through excess deltamethrin collected in petri dish. Treated seedlings were moved to a new petri dish (or its lid) to dry. Two seedlings were treated this way for each of the treatment solutions

d) Infestation with Western Corn Root Worm (WCRW)

Treated seedlings were placed into Phytagel magenta boxes and gently pressed into gel. A total of 20 early- to mid-second instar WCRW were sorted, and gently deposited into one magenta box. Care was taken to not touch roots. Magenta boxes with corn and WCRW were placed into Percival Incubator (25° C. 16 h Light: 8 h Dark, 60-80% Relative Humidity). On Day 2, For each magenta cage, the number of alive, dead, and missing WCRW larvae were counted and recorded under dissecting microscope. Corn seedlings were placed into petri dish and any larvae that are on or in Phytagel were gently collected. Corn seedings were also dissected to find any larvae that may have bored into the mesocotyl/coleoptile (stalk), large roots, or kernel.

Larvae were probed with forceps to check for movement. If larvae do not vigorously move when probed, they were considered dead. If less than 20 larvae were retrieved the number less than 20 were recorded as missing. The percentage mortality and percentage control for each cage and each treatment were calculated.

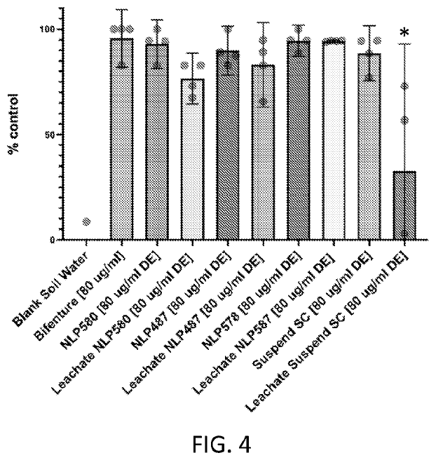

Soil leachates from three NLP preparations comprising deltamethrin formulations leachate NLP580 [80 ug/ml DE], leachate NLP487 [80 ug/ml DE], leachate NLP578 [80 ug/ml DE] displayed a higher average efficacy against corn root worms than the soil leachate of a non-NLP, commercially available deltamethrin formulation (Suspend SC) used at the same starting concentration as deltamethrin (80 ug/ml) (FIG. 4) indicating the efficacy of the NLP formulation comprising DE against corn root worm.

Example 12. NLP Activity Against Corn Rootworm when Used as a Soil Drench Application

This Example describes NLP tested against corn root worm in a soil drench application.

### Experimental Procedure:

### a) Corn Seed Germination

Corn seeds were germinated in a 27° C. incubator for 3 days and seeds that germinated uniformly were selected for the assay. Germinated seeds were planted in 8″ tall and 1.5″ diameter cylindrical containers with approximately 130 g of field-collected silt loam soil in each. Soil was then watered with about 50 ml of water. Containers with the germinated seeds were then grown for an additional 2-3 days prior to Western Corn Root Worm (WCRW) infestation.

### b) Corn Rootworm Infestation

Ten 2nd-instar WCRW larvae were purchased from Crop Characteristics Inc. (Farmington, MN USA), and released at the base of each plant. Larvae were given 24 hours to burrow and settle into soil. After 24 hr, every container was drenched with 20 ml of the respective treatment using a 25 ml serological pipette. The treatments were chosen from 1) water; 2) Bifenture® LFC; 3) deltamethrin SL; and 4) NLP580 comprising deltamethrin at 400 ug per ml of suspension (NLP580-DE). The NLP580 comprising deltamethrin at 400 ug per ml of suspension was prepared as shown in Example 1 by increasing all the lipid and surface modifier components 5-fold relative to the amount of water used. The particle size, PDI and zeta potential of these NLPs are similar to those prepared with 80 ug/ml of DE in the suspension as shown in example 1 (Table 8). Bifenture® LFC is a commercial soil-applicable insecticide (AI=Bifenthrin) made by UPL. Deltamethrin SL was prepared in house and is deltamethrin (20 mg/ml) dissolved in a mix of 2 solvents: Genagen NBP (Clariant Produkte (Deutschland) GmbH, Cat #293617), at 49%; TOXIMUL TA-15 (Stepan, Cat #0329) at 49%. After the containers stopped dripping from the added treatment solution (about 1 hr), the leachate was either disposed of or collected and stored at 4° C. to measure deltamethrin concentration on an LC-MS. Plants were placed in their assigned location in the greenhouse, and were watered as needed throughout the experiment by adding 25 ml of water to the container roughly every 3 days On day 7 after infestation, all plants were removed from the greenhouse and transferred to the lab for analysis.

### c) Analysis

Root damage was assessed visually, and the mass of each plant was measured after rinsing and drying plants on paper towels.

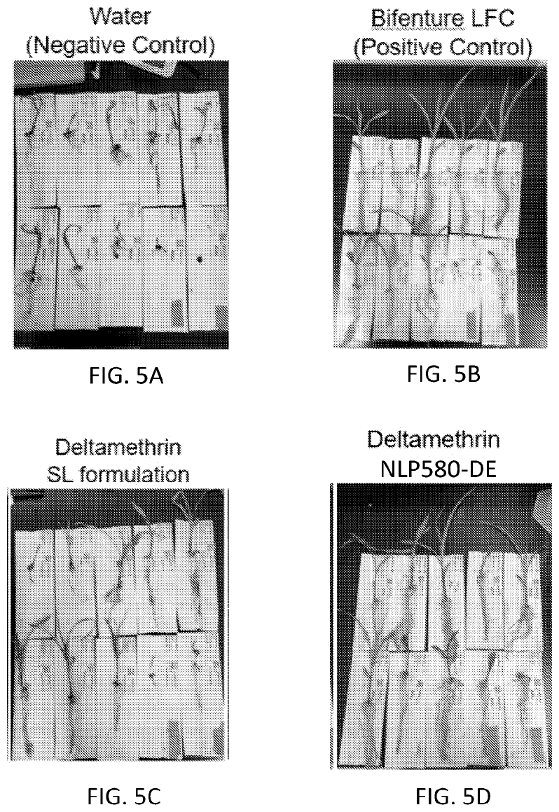

NLP580-DE improves plant mass of corn seedlings by preventing damage from corn rootworm larvae. As expected, the roots of seedlings treated with water were not rescued from WCRW damage (FIG. 5A). Seedlings treated with Bifenture® were protected from WCRW damage. The level of WCRW protection afforded by NLP580-DE matches that of Bifenture® (FIG. 5B-5D, results quantitated in FIG. 5E), indicating the efficacy of the NLP580-DE formulation against WCRW in a soil drench application.

Example 13. NLP Activity Against Corn Rootworm when Used as an in-Furrow Treatment

This Example describes NLP compositions tested in an in-furrow application to control root worm.

### Experimental Procedure:

i. Small Scale (Green House 8″ Pot) in-Furrow Treatment

### a) in Furrow Treatment

Jumbo cotton balls were packed into the bottom of 8″ tall and 1.5″ diameter cylindrical containers. Wide straws were inserted for infestation later, then packed with ~120-130 g of silt loam soil. Soil was then watered with about 50 ml of water in two 25 ml increments 24 hrs before planting. A hole was made at a depth of 1.5 inch from the top of the soil. The soil was treated by pipetting 3 ml of treatments selected from 1) water; 2) Bifenture® LFC; 3) NLP580 comprising deltamethrin at 400 ug per ml of suspension (NLP580-DE). The NLP580 comprising deltamethrin at 400 ug per ml of suspension was prepared as shown in Example 1 by increasing all the lipid and surface modifier components 5-fold relative to the amount of water used. The particle size, PDI and zeta potential of these NLPs are similar to those prepared with 80 ug/ml of DE in the suspension as shown in Example 1 (Table 8). The treatments were added around the edge of the hole for planting. A seed was then planted in the hole and covered with soil. Containers with seeds were then placed in the greenhouse to continue growing for 5 days until ready for infestation.

### b) WCRW Infestation

2nd instar WCRW larvae were shipped from the supplier (Crop Characteristic Inc., Farmington, MN USA)) and stored at 4° C. until ready for use (less than a week). Approximately 10 larvae were transferred to 1.5 ml microcentrifuge tube and released into soil 5 days after seed planting via dumping into straws inserted when the pots were filled with soil. After WCRW infestation, plants were allowed to grow for another 7 days to day 12. Some pots treated with water were not infested to act as a control for the assay to determine the plant health when not infested with WCRW. On Day 12, the fresh whole seedlings were pulled out of the containers and roots were rinsed by tap water and air-dried for 30 min on paper towel.

### c) Analysis

The fresh weight for each whole seedling was measured using a scale and recorded.

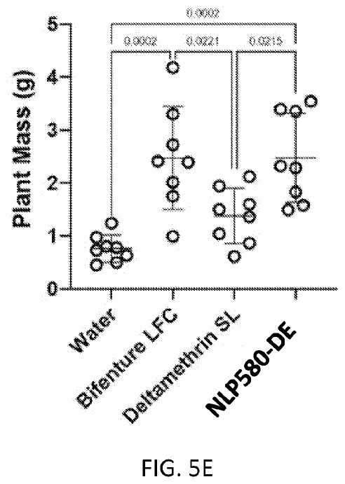

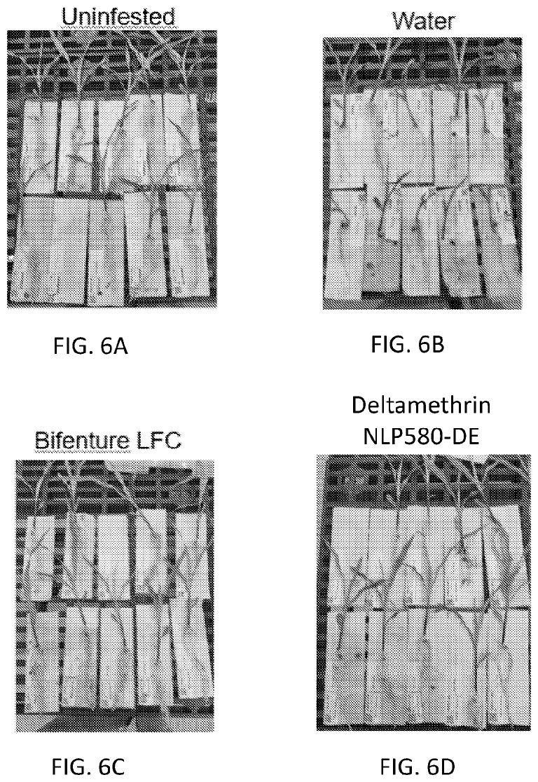

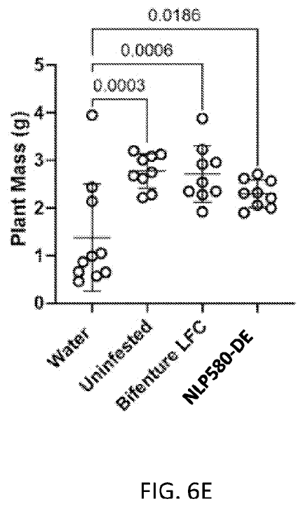

NLP580-DE improved plant mass of corn seedlings by preventing damage from corn rootworm larvae. Water treatment did not rescue the seedlings from WCRW damage (FIG. 6A). NLP580-DE treatment matches the level of control achieved by Bifenture® (FIGS. 6C and 6D respectively, results quantitated in FIG. 6E), indicating the efficacy of the NLP580-DE formulation against WCRW in a small scale in-furrow application.

ii. Field-Scale in-Furrow Treatment

### a) Field Plot Design

The experimental design is a randomized complete block with four replications. Corn rootworm field plots are either 2 or 4 rows wide and 35 feet in length. Plots are cut back to 30 feet in length after planting to facilitate root digging.

### b) Seed Planting

The field with silt loam soil is not tilled before the planting. The corn seeds are pre-bagged in the laboratory and then planted with a four-row John Deere Max Emerge™ 7100 Integral Rigid Frame Planter that has 30-inch row spacing. Seeds are planted at a depth of 2 inches with a spacing of 6 inches between seeds (35,600 seeds per acre).

c) in-Furrow Application of NLP

Treatments selected from 1) NLP646-HHPH formulations comprising deltamethrin at 2 mg per ml of the suspension; 2) NLP646-HHPH comprising no DE; 3) unencapsulated DE (DE at 2 mg/ml); 4) Bifenture® (Bifenthrin at 2 mg/ml); or 5) water are applied in-furrow at planting with a compressed-air system built directly into the planter by Almaco manufacturing (Nevada, IA). All liquid formulations are applied at 6 liters per 1000 row feet. All liquid NLP formulations are applied with a Teejet XR80015EVS spray nozzles at 21 psi to deliver 5 GPA of finished spray at a tractor speed of 4 mph. Before the field season began, new spray nozzles are installed and calibrated with water to ensure proper application of product. For these liquid applications each row is checked for correct spray pattern prior to plot application and monitored during application to ensure that insecticides are applied correctly. The T-band spraying aims at the center of the furrow with a width of 7 inch from left to right.

### d) Data Collection

Fresh weight of the whole seedling: Randomly selected 5 seedlings from the middle 2 rows per plot for each treatment are pulled out of the soil at V2 (plants with 2 fully emerged leaves) and V5 (plants with 5 fully emerged leaves) stages. The whole seedling weight is measured using a scale and recorded after the soil on root is washed off and dried.

Root injury: Randomly selected 5 seedlings from the middle 2 rows per plot for each treatment are pulled out of the soil at R1 stage, when silk is visible outside the husks. Roots are first soaked in water for 2 to 8 hours and then washed with a hose to remove any remaining soil. Roots are evaluated for rootworm feeding injury following the Iowa State University 0 to 3 node-injury scale. Node-Injury Scale (0-3):
0—No feeding injury (lowest rating that can be given).
1—One node (circle of roots), or the equivalent of an entire node, pruned to within 1.5 inches of the stalk or soil line.
2—Two nodes pruned.
3—Three or more nodes pruned. (Highest rating that can be given).

### e) Data Analysis:

Data are analyzed with analysis of variance (ANOVA) procedures using SAS Enterprise Guide7.1. When a significant treatment effect is present pairwise comparisons made among means with an experimentwise error rate of P<0.05.

NLPs comprising DE and Bifenture® treatments improve whole plant weight of corn seedlings at both the V2 and V5 stages compared to water, unencapsulated DE, or NLP comprising no DE by preventing root damage from corn rootworm larvae. NLPs comprising DE, and Bifenture® treated plants have smaller root injury scores at the R1 stage than water, unencapsulated DE, or NLP comprising no DE by preventing root damage from corn rootworm larvae. Both results indicate the enhanced efficacy of the NLP formulations comprising DE against WCRW as compared to unencapsulated DE in an in-furrow application in the open field.

Example 14. Measuring Deltamethrin in Soil Leachate after Seed Coating

This Example demonstrates the leaching of deltamethrin containing NLP particles into soil after seed coating.

### Experimental Procedure:

### a) Seed Coating

A 25 g aliquot of corn seed (var. MBS, PLT026-021, approx. 100 seeds) are weighed into each of 4 weigh boats. A 50 mg aliquot of the corn polymer (Kannar™ SeedKOTE™ Corn Neutral v2.8, Kannar Earth Science) is weighed into each of 3 2-mL tubes. A 16 mg/mL stock solution of deltamethrin in DMSO is diluted 40× in water to final concentration of 400 ug/ml DE while vortexing to resuspend any particles.

An aliquot of 25 g of seeds is incubated with 800 μl of one of four solutions: 1) Water, 2) Diluted deltamethrin (400 μg/ml), 3) NLP comprising deltamethrin, or 4) A 20% solution of Acceleron® IX-409 in water. Seeds are vortexed, poured out on a piece of aluminum foil, and then left to dry overnight.

### b) Plant Setup and Treatment

Jumbo cotton balls are packed into the bottom of an 8″ tall and 1.5″ diameter cylindrical container (cone-tainer, cat #CN-SS-SC-10B, Greenhouse Megastore) and then packed with about 120-130 g of silt-loam soil while shaking. The soil is then watered with about 50 ml of tap water 24 hr before planting of seeds. Seeds are planted in holes of 1.5 inch deep and covered with soil.

### c) Sample Processing and Data Collection

Immediately after the planting (Day 0), after 1 day, 4 days and 7 days, the plants are watered with 20 ml of tap water and the leachate is collected. The deltamethrin concentration is measured by LC-MS and, the DE concentration in leachates between NLP+deltamethrin and unformulated deltamethrin treatments are compared.

NLP comprising the active ingredient stably leaches into the soil from the coated seeds, thus the seeds function as a delivery vehicle, thereby generating a zone in the soil of active ingredient surrounding the germinated seed.

Example 15. Control of WCRW by NLP Comprising DE Leached in Soil after Seed Coating

This example describes an assay showing that the amount of the compound that leaches out from the formulation-coated seeds in surrounding soil rhizosphere is enough to show activity against corn rootworms as evidenced by a lower reduction in plant mass in an in vitro assay.

### Experimental Procedure:

### a) Seed Coating

A 25 g aliquot of corn seed (var. MBS, approx. 100 seeds) are weighed into each of 4 weigh boats. A 50 mg aliquot of the corn polymer (Kannar™ SeedKOTE™ Corn Neutral v2.8, Kannar Earth Science) is weighed into each of 3 2-mL tubes. A 16 mg/mL stock solution of deltamethrin in DMSO is diluted 40× in water to final concentration of 400 ug/ml DE while vortexing to resuspend any particles.

An aliquot of 25 g of seeds is incubated with 800 μl of one of four solutions: 1) Water, 2) Diluted deltamethrin (400 μg/ml), 3) NLP comprising deltamethrin at 400 ug DE per ml of NLP suspension, or 4) A 20% solution of Acceleron® IX-409 (active imidacloprid, a neonicotinoid insecticide) in water. Seeds are vortexed, poured out on a piece of aluminum foil, and then left to dry overnight.

### b) Plant Setup and Treatment

Jumbo cotton balls are packed into the bottom of an 8″ tall and 1.5″ diameter cylindrical container (cone-tainer, cat #CN-SS-SC-10B, Greenhouse Megastore), a drinking straw is added such that the top of the straw is above the lip of the container, and then packed with about 120-130 g of soil while shaking. The soil is then watered with about 50 ml of tap water 24 hr before planting of seeds. Coated seeds are planted in holes of 1.5 inch deep and covered with soil. Seeds are allowed to germinate and seedlings grow for 7 days at about 25° C. while being watered with approximately 20 ml every 3 days, until ready for infestation.

### c) Corn Rootworm Infestation

A batch of 2nd instar WCRW larvae are shipped from the supplier (Crop Characteristic Inc., Farmington, MN USA) and stored at 4° C. until ready for use (less than a week). 7 days after planting, approximately 10 larvae are transferred via a paintbrush to 1.5 ml microcentrifuge tube and released via dumping into straws inserted into soil at the time pots were filled. After WCRW infestation, plants are allowed to grow for another 7 days to Day 14. On Day 14, the above ground shoot of whole seedlings are cut out of the containers and the fresh weight of the shoot is determined and recorded.

Seedlings from seeds treated with NLPs comprising deltamethrin and Acceleron® IX-409 have higher shoot mass compared to the diluted deltamethrin and water treatments by preventing root damage from corn rootworm larvae.

### Example 16. Control of WCRW by NLP Comprising DE Upon Seed Coating in a Field Trial

This example describes an assay showing that seeds coated with NLP-HHPH comprising deltamethrin at 20 mg/ml show activity against WCRW in soil in a field trial.

### Experimental Procedure:

### a) Seed Coating

A 25 g aliquot of corn seed (var. MBS, approx. 100 seeds) are weighed into each of 4 weigh boats. A 50 mg aliquot of the corn polymer (Kannar™ SeedKOTE™ Corn Neutral v2.8, Kannar Earth Science) is weighed into each of 3 2-mL tubes. A 16 mg/mL stock solution of deltamethrin in DMSO is diluted 40× in water to final concentration of 400 ug/ml DE while vortexing to resuspend any particles.

An aliquot of 25 g of seeds is incubated with 800 μl of one of four solutions: 1) Water, 2) Diluted deltamethrin (400 μg/ml), 3) NLP comprising deltamethrin at 400 ug per ml of suspension, 4) NLP without DE, or 5) A 20% solution of Acceleron® IX-409 in water. Seeds are vortexed, poured out on a piece of aluminum foil, and then left to dry overnight. Repeat the process to treat all 625 g of seeds (N=~2500).

### b) Field Trial-Seed Planting and Germination

The field trial procedure follows the randomized block procedure which consists of 4 replicates for each treatment. The coated seeds from each treatment are planted in the field with soil type of silt loam. The row spacing is 30 inches. The seed in-furrow spacing is 6 inches. About 600 seeds from each treatment are planted as 1 replicate. The field site is chosen such that the WCRW density is expected to cause about rating 2 damage on the Iowa State University (ISU) 0-3 Node-Injury Scale (NIS). The corn seeds germinate and grow with normal agronomical practice with regular watering and fertilization schedule.

### c) Field Trial-Data Collection

Fresh weight of the whole seedling: Randomly selected 5 seedlings from the middle 2 rows per plot for each treatment are pulled out of the soil at V2 (plants with 2 fully emerged leaves) and V5 (plants with 5 fully emerged leaves) stages. The whole seedling weight is measured using a scale and recorded after the soil on root is washed off and dried.

Root injury: Randomly selected 5 seedlings from the middle 2 rows per plot for each treatment are pulled out of the soil at R1 stage, when silk is visible outside the husks. Roots are first soaked in water for 2 to 8 hours and then washed with a hose to remove any remaining soil. Roots are evaluated for rootworm feeding injury following the Iowa State University 0 to 3 node-injury scale. Node-Injury Scale (0-3):
0—No feeding injury (lowest rating that can be given).
1—One node (circle of roots), or the equivalent of an entire node, pruned to within 1.5 inches of the stalk or soil line.
2—Two nodes pruned.
3—Three or more nodes pruned. (Highest rating that can be given).

### d) Data Analysis:

Data are analyzed with analysis of variance (ANOVA) procedures using SAS Enterprise Guide7.1. When a significant treatment effect is present pairwise comparisons made among means with an experimentwise error rate of P<0.05.

NLPs comprising deltamethrin and Acceleron® IX-409 improve whole plant weight of corn seedlings at both the V2 and V5 stages compared to unencapsulated DE, NLP without DE, or water by preventing root damage from corn rootworm larvae. NLP comprising deltamethrin, and Acceleron® IX-409 have smaller root injury scores at the R1 stage than unencapsulated DE, NLP without DE, or water by preventing root damage from corn rootworm larvae.

Example 17. Loading of NLP Compositions with an Antimicrobial Agent

This Example describes the preparation of NLPs comprising roxithromycin (RO), fludioxonil (FL) or oxathiapiprolin (OX).

### Experimental Procedure:

a) Loading NLPs with RO with DCM Method

Stock solutions for NLP preparation using the DCM method are prepared as shown in Table 21. The organic phase is prepared by combining the ethyl acetate (EA) and tert-Butyl acetate (tBA) 1:3 stock solution with the stock solutions of nonpolar lipid, phospholipid, fludioxonil (FL) (or oxathiapiprolin (OX)), and optionally glycolipid by volume as shown in Table 21. For formulations with Atlox surface modifiers (Atlox 500L, Atlox CS100B, Atlox 4917, and Atlox 2575) the respective polymeric surfactant is dissolved in DI water at 0.5% w/w to be used as the aqueous phase. The aqueous phase consists of only DI water for formulations with glycolipids or no surface modifiers. The organic phase is then diluted 10× in the aqueous phase by combining 0.5 mL of organic phase with 5 mL of aqueous phase in a 20 mL scintillation vial. The mixture is then probe sonicated using a QSonica Q500 with a microtip probe with a tip diameter of 3.2 mm. The probe tip is placed in the center of the sample and submerged about one quarter through the liquid. The sample is then sonicated at 25% amplitude for 15 seconds pulsing every other second to prevent the sample from overheating. The EA: tBA, 1:3 solvent is then evaporated from the samples by magnetic stirring at 600 RPM for 30 minutes. The final formulation is then filtered through a 1 μm glass fiber syringe filter. Particle size, polydistribution index (PDI) and zeta potential are measured using a Malvern Panalytical Zetasizer Ultra Red Label. Fluorescence is measured on a BioTek Synergy HIM plate reader. Active concentrations are measured by LC-MS. Organic phase solution preparation for DCM method is shown in Table 22. Final compositions are shown in Table 23.

TABLE 21
Stock solutions prepared for solvent-evaporation method
using a solution consisting of one part ethyl acetate
(EA) and three parts tert-Butyl acetate (tBA).

| NLP Component | Solvent | Concentration (mg/mL) |
|---|---|---|
| Non-polar lipid | EA:tBA, 1:3 | 15 |
| Phospholipid | EA:tBA, 1:3 | 15 |
| Glycolipid | EA:tBA, 1:3 | 5 |
| Roxithromycin | EA:tBA, 1:3 | 10 |
| Exalite 594 | EA:tBA, 1:3 | 0.1 |
| Polymeric Surfactant | Water | 5 |

TABLE 22
Organic phase solution preparation for DCM method.

| Stock | Amount (mL) |
|---|---|
| Non-polar lipid (15 mg/mL) | 0.083 |
| Phospholipid (15 mg/mL) | 0.067 |
| Glycolipid (5 mg/mL) | 0.050 (0) |
| Roxithromycin (10 mg/mL) | 0.040 |
| EA:tBA, 1:3 | 0.260 (0.290) |
| Total | 0.500 |

TABLE 23
NLP compositions comprising RO

| | | | | | RO |
|---|---|---|---|---|---|
| | | | | | Concentration |
| Formulation | Oil | PL | SM | Oil:PL:SM | (ug/mL) ^{a} |
| NLP580 | Sunflower | Sunflower | Atlox 500L | 4.6:3.7:91.7 | 80 |
| | oil | lecithin | | | |
| NLP608 | Sunflower | Sunflower | Atlox | 4.6:3.7:91.7 | 80 |
| | oil | lecithin | CS100B | | |
| NLP600 | Canola oil | Sunflower | Atlox 500L | 4.6:3.7:91.7 | 80 |
| | | lecithin | | | |
| NLP602 | Sunflower | PC | Atlox 500L | 4.6:3.7:91.7 | 80 |
| | oil | | | | |
| NLP533 | Sunflower | Sunflower | Rhamnolipid | 5:4:1 | 80 |
| | oil | lecithin | | | |
| NLP551 | Sunflower | Sunflower | Sophoro | 5:4:1 | 80 |
| | oil | lecithin | (SLM) | | |
| NLP487 | Sunflower | Sunflower | N/A | 5:4:1 | 80 |
| | oil | lecithin | | | |

^{a} Concentration refers to ug RO comprised per ml of NLP suspension

b) Loading NLPs with FL or OX with HHPH Method

The process described in Example 2b is followed with the substitution of deltamethrin with either FL or OX such that the final concentration of the antimicrobial agent is 2 mg per ml of suspension.

Example 18. Control of Soil-Borne Fungal Pathogens Fusarium graminearum or Rhizoctonia solani with Seeds Coated with NLP Comprising Fludioxonil on Corn

This example describes a method to coat seeds using NLP comprising fludioxonil for activity against soil-borne fungal pathogen in an in vitro assay.

### Experimental Procedure:

### a) Preparation of Corn Germination Boxes:

Germination boxes are sterilized and phytagel poured one day in advance (Day-6) and stored covered at 4° C. for one day. Large systema lunchboxes are sterilized by soaking in 10% bleach for ≥20 min. 70% EtOH is sprayed to completely coat the boxes and dried. A 500 ml aliquot of Phytagel comprising 0.7 g of Phytagel and 0.65 g of Hoaglands' basal Salt No. 2, pH 6.5, is poured into the boxes and allowed to cool.

### b) Sterilize Corn Seeds

Seeds are placed in a large, open-mouthed container and 15% bleach solution poured just below the container fill line to soak for 15 min. Seeds are rinsed three times with sterile water and placed on the same day as sterilization.

### c) Seed Coating

An aliquot of 25 g of corn seeds is incubated with 800 μl of one of four solutions: 1) Water, 2) fludioxonil (2 mg/ml), 3) NLP-HHPH comprising fludioxonil at 2 mg per ml of suspension (as described in example 17), or 4) A 0.36% solution of Vibrance® (active Sedaxane, a pyrazole carboxamide fungicide) in water. Seeds are vortexed, poured out on a piece of aluminum foil, and then left to dry overnight.

d) Corn Seed Infection by Fungus (Cited from DOI: 10.1094/PDIS.2002.86.2.143)

A mixture of sand (1900 ml), corn meal (380 ml), and water (110 ml) is autoclaved in bags for 1 h at 121° C. on two consecutive days. Each bag is then inoculated by injecting 2 ml of a spore suspension (10\hat{ }6 spores/ml) of the Fusarium, prepared from culture on CLA (carnation leaf agar). The bags are then incubated in the dark at ambient temperature (20 to 24° C.) for 6 days, with mixing every day. Sterilized 21-cm-tall PVC cones are filled to 16 cm with sterilized sand. A small piece of paper towel is placed in the bottom of each cone to partially retard drainage. One seed per cone is placed on top of the sand and covered with 3 cm of the fungal inoculum (or sterile sand for the control). There are 7 plants for each treatment combination. Treatments are randomized and placed in a growth chamber at 15° C., 50% relative humidity, and a 12-h photoperiod.

Emergence is assessed after 8, 13, and 20 days, and after 21 days, the plants are removed from the cones and washed. Root and shoot lengths are measured, and root health is assessed on a 1 to 5 scale: 1=lateral roots nearly absent and >60% of root system with symptoms of decay, 2=lateral roots sparse and >40 to 60% root system with symptoms of decay, 3=lateral roots reduced and >20 to 40% root system with symptoms of decay, 4=well developed lateral roots and ≤20% root system with decay symptoms, and 5=well developed root system with negligible decay symptoms. Whole plants were oven-dried at 150° C. for 24 h and weighed for comparison of plant dry weights among treatments.

### e) Data Analyses:

ANOVA is conducted on data for emergence, shoot and root lengths, root health, and dry weight. Each experiment is considered as a replicate block for the analysis; individual observations are the means for the seven plants receiving a given treatment in each experiment. Mean separation is conducted using the Waller-Duncan k-ratio (k=100) to compare fungicide treatments.

Seeds treated with NLP comprising fludioxonil and Vibrance^{ó} have higher emergence, produce seedlings with larger shoot length, and larger root length than those treated with fludioxonil (unformulated) and water treatments.

Example 19. Treatment of Soil-Borne Fungal Pathogen Pythium Spp, or Phytophthora sojae with Seeds Coated with NLP Comprising Oxathiapiprolin on Soybean

This example describes that oxathiapiprolin can be made soil mobile, and leaches out from formulation-coated seeds into the surrounding soil rhizosphere, and that the leached material is enough to show activity against soil-borne fungal pathogen in an in vitro assay with soybean seedlings grown in soil.

### Experimental Procedure:

### a) Preparation of Soybean Germination Boxes:

Germination boxes are sterilized and Phytagel poured one day in advance (Day-6) and stored covered at 4° C. for one day. Plastic containers (Sistema) are sterilized by soaking in 10% bleach for ≥20 min. 70% EtOH is sprayed to completely coat the boxes and then let to dry. 500 ml of Phytagel comprising 0.7 g of Phytagel and 0.65 g of Hoaglands' basal Salt No. 2, pH 6.5, is poured into the boxes and allowed to cool.

### b) Sterilize Soybean Seeds

Seeds are placed in a large, open-mouthed container and 15% bleach solution poured just below the container fill line to soak for 15 min. Seeds are rinsed three times with sterile water and placed on the same day as sterilization.

c) Seed coating

An aliquot of 25 g of soybean seeds is incubated with 800 μl of one of four solutions: 1) Water, 2) oxathiapiprolin (2 mg/ml), 3) NLP-HHPH comprising fludioxonil at 2 mg per ml of suspension (as described in Example 17), or 4) A 0.36% solution of Vibrance^{ó} (active Sedaxane, a pyrazole carboxamide fungicide) in water. Seeds are vortexed, poured out on a piece of aluminum foil, and then left to dry overnight.

### d) Soybean Seed Infection by Fungus

Pythium spp. are grown on a sterilized semisolid medium consisting of 600 ml of Redi-Earth 3 CP (Grace-Sierra, Milpitas, CA), 330 ml of 60% V8 juice, 10 g of potato dextrose broth powder (Difco), and 0.6 g of CaCO3 in foil-covered polypropylene flats (12×23×45 cm). The flats are autoclaved for 1 h on each of two successive days, inoculated with PDA plugs of the isolates, and incubated for 2 weeks at 23±2° C. The inocula contain approximately 10⁵ CFU/g as determined by the most probable number (MPN) assay. After incubation, the inoculum is air-dried for 3 days and milled in a blender to pass a 3.36-mm screen. The inoculum contains 10⁴ to 10⁵ CFU/g as determined by serial dilution on a peptone pentachloronitrobenzene (PCNB) medium.

Pathogen inocula are applied to soil at a rate of 5 g of Pythium per 150 g of soil. The infested soil and non-infested soil (control) are placed in 10-cm-diameter plastic pots and immediately planted with 3 seeds per pot of treated or nontreated corn seeds. The experimental procedure is a randomized complete block with 10 replicate pots per treatment. The pots are kept at 25° C. and watered daily for 18 days; then seedlings are harvested to determine plant stand and root rot severity.

A root rot severity index is used in which 1=<2% (healthy plant), 2=3 to 30% (slight disease), 3=31 to 60% (moderate disease), 4=61 to 90% (severe disease), and 5=>91% (dead plant). Plant height and fresh weight are evaluated (based on all planted seeds). Values of 0 cm and 0.3 g are given for plant height and fresh weight, respectively, when the seeds did not germinate.

### e) Statistical Analyses.

Statistical analyses are conducted using SAS (SAS Inc., Cary, NC) for all parameters in both tests, and for coating treatments across temperatures and the interaction between temperature and coatings in the first series of tests only. Mean separation is accomplished using Duncan's Multiple Range Test, and all tests of significance are conducted at P≤0.05.

Seeds treated with NLP comprising oxathiapiprolin and Vibrance^{ó} have higher emergence, produce seedlings with larger shoot length, and larger root length than those treated with oxathiapiprolin (unformulated) and water treatments.

### Example 20. NLP Formulations Polymers for Seed Application

This example describes NLP comprising deltamethrin mixed with polymers (e.g. Kannar SeedKOTE Corn Neutral v2.8) and coating of seeds. The formulation leaching in surrounding soil rhizosphere is enough to show activity against corn rootworms in an in vitro assay with corn seedlings grown in soil.

### Experimental Procedure:

### a) Preparation of Corn Germination Boxes:

Germination boxes are sterilized and Phytagel poured one day in advance (Day-6) and stored covered at 4° C. for one day. Large systema lunchboxes are sterilized by soaking in 10% bleach for ≥20 min. 70% EtOH is sprayed to completely coat the boxes and then let to dry. 500 ml of Phytagel comprising 0.7 g of Phytagel and 0.65 g of Hoaglands' basal Salt No. 2, pH 6.5, is poured into the boxes and allowed to cool.

### b) Sterilize Corn Seeds

Seeds are placed in a large, open-mouthed container and 15% bleach solution poured just below the container fill line to soak for 15 min. Seeds are rinsed three times with sterile water and placed on the same day as sterilization.

### c) Seed Coating

An aliquot of 200 μL NLP-HHPH comprising deltamethrin at 2 mg per ml of suspension 1) with or 2) without polymer (i.e. Kannar™ SeedKOTE™ Corn Neutral v2.8, Kannar Earth Science) is added to 4 g (about 25 seeds) in 50 mL tube in dropwise fashion while vortexing. Seeds are removed and placed on a paper towel to air dry.

### d) Germination of Seeds on Phytagel

Corn seeds are placed into a Conviron reach-in incubator (27C, 50% relative humidity, 16 h L:8 h D). Seeds are placed in a 4×6 grid pattern following the height×length of the box in which phytagel is poured. Seeds are placed embryo side up (scoop up) and gently pressed into gel. Containers are resealed with aluminum foil.

On day −4, after 1 day germination time foil is removed and replaced with clear systema lid and let grow for 4 more days.

On Day 0, Phytagel Magenta Boxes are prepared for corn and rootworm placement. Magenta boxes are prepared the day before and stored sealed at 4° C. Sterilized magenta boxes are filled with 25 ml of Phytagel solution, allowed to cool, covered with foil or sterilized magenta cage lids and stored at 4° C. if not used immediately.

### e) Corn Rootworm Infestation

Seedlings are placed into Phytagel magenta boxes and gently pressed into gel to make sure as much root surface as possible was in contact with Phytagel. Twenty early to mid-second instar WCRW are sorted using a paintbrush or forceps, and gently deposited into one magenta box making sure they do not stick to sides of magenta cages. Care is taken to not touch roots with paintbrush or forceps. WCRW larvae feed on corn roots for 2 days.

### f) Data Collection

After 2 days (Day 7), the fresh whole seedlings are pulled out of Phytagel, and roots are rinsed by tap water and air-dried for 30 min on paper towel. The fresh weight for each whole seedling is measured by scale and recorded.

### g) Samples Collection for Analytical Analyses

The treated seeds from Day 0 and roots from Day 7 are processed for measuring the DE concentration by LC-MS.

Seeds coated with NLP comprising deltamethrin mixed with polymer have a higher amount of deltamethrin on the seeds than those coated with NLP comprising deltamethrin only. The plant mass is higher in seedlings that emerged from seeds treated with NLP comprising DE with polymer than those treated with NLP comprising DE only.

Example 21. Mixtures of Small Seeds Encrusted and Pelleted with NLP Comprising DE

This example describes a method of encrusting NLP comprising DE on small seeds, and that the small seeds retain the active on the seed surface as well as some of it leaching into the surrounding soil over time.

### Experimental Procedure:

### a) Coating Materials

Table 24 shows seed treatment and coating materials grouped as active components (active ingredient), liquids and solid particulates. Each group of material is further classified by function and composition. Abbreviations for material source/origin: Synthetic Chemicals—SYN, Natural products or derivatives—NP, Biologicals—BIO, Mineral—MIN, substances may be Organically approved (OR).

TABLE 24
Seed treatment and coating materials

| Active Components | Liquids | Solid Particulates |
|---|---|---|
| Biostimulants | Water | Binders |
| SYN, NP, | Colorants | Also, under Liquids |
| BIO (OR) | SYN, NP (OR) | Soy flour: NP (OR) |
| Plant nutrients | Adjuvants | Fillers |
| SYN, MIN (OR) | SYN (OR) | Diatomaceous earth |
| Abiotic stress: | Binders | (DE): MIN (OR) |
| Drought | Polyvinyl alcohol | Limestone: MIN (OR) |
| and Salinity | (PVOH) and | Gypsum: MIN (OR) |
| SYN, BIO (OR) | Polyvinyl acetate | Bentonite: MIN (OR) |
| Plant Protectants | (PVAc): SYN | Vermiculite: MIN (OR) |
| SYN, NP, BIO, | Methyl cellulose: SYN | Talc: MIN (OR) |
| MIN (OR) | Carboxymethyl | Zeolite: MIN (OR) |
| Inoculants | cellulose (CMC): SYN | Silica: MIN (OR) |
| BIO, MIN (OR) | Plant starches: NP (OR) | BaSO4: MIN |
| | Gum Arabic: NP (OR) | |

(https://www.mdpi.com/2077-0472/10/11/526/htm)

### b) Lettuce Seed Coating and Pelleting

Dry powder binders (e.g. soy flour) are mixed with filler materials (e.g. Talcum powder) to produce a coating blend. An aliquot of two ml of the NLP formulation (e.g. NLP580-HHPH comprising deltamethrin at 20 or 200 mg per ml of suspension) and 2 gram of coating blend are added to 4 g of seeds in a rotary coater or coating pan [e.g. R-6, Universal Coating Systems, Independence, OR, USA]. The seeds are rotated in the rotary coater at 100 rpm for 1 min. Coated seeds are then removed and dried.

### c) Plant Setup and Treatment

Jumbo cotton balls are packed into the bottom of each container and then packed with ~120-130 g of soil while shaking. Soil is then watered with about 50 ml of tap water 24 hr before planting. Seeds are planted at 1.5 inch and covered with soil.

### d) Sample Processing and Data Collection:

Immediately after the planting (Day 0), after 1 day, 4 days and 7 days, the plant in container is watered with 50 ml of water and the leachate is collected. The deltamethrin concentration in the leachates is measured by LC-MS. The plant shoots and roots are harvested at the end of the assay (day 7) and the deltamethrin concentration is measured by LC-MS.

The leachates collected from the container with seeds coated with NLP comprising deltamethrin at different time points contain deltamethrin. The plant tissues collected at the end of day 7 also contain deltamethrin.

### Example 22. Uptake of NLP by Green Bean Seeds

This example describes the uptake of a hydrophobic fluorescent dye encapsulated in NLP particles by green been seeds. Exalite is a fluorescent dye that is hydrophobic and does not fluoresce in aqueous solutions. Exalite is fluorescent when dissolved in oils, cell membranes, certain lipids and certain organic solvents.

### Experimental Procedure:

Garden bean seeds (N=4) were incubated in four treatment solutions: 1. water only; 2. 12 ppm Acid Red 52 dye solution in water (positive control, Acid Red 52 is a water-soluble dye that is known to be taken up by seeds); 3. NLP580 comprising Exalite dye at 1 ug per ml suspension (NLP+Exalite dye), and 4. Exalite dye only at 1 ug/ml. Four aliquots of four beans each were soaked in the four solutions in a 1-oz Solo cup for 24 hours at 20° C. in the dark. The seeds were then washed with de-ionized water three times. Seed coats were removed, and the seeds were split in half. The split halves of the seeds were imaged under white light to distinguish the edges of the seed halves using an EVOS fluorescent imager (Thermo Fisher). The split halves of the seeds were also imaged using the red fluorescent channel (590 nm) in the EVOS fluorescent imager to quantify Exalite uptake into the seeds. The fluorescence reading from each seed half was randomly determined by the software on the EVOS fluorescent imager and the mean fluorescence from the 4 seed halves that underwent the same treatment was averaged.

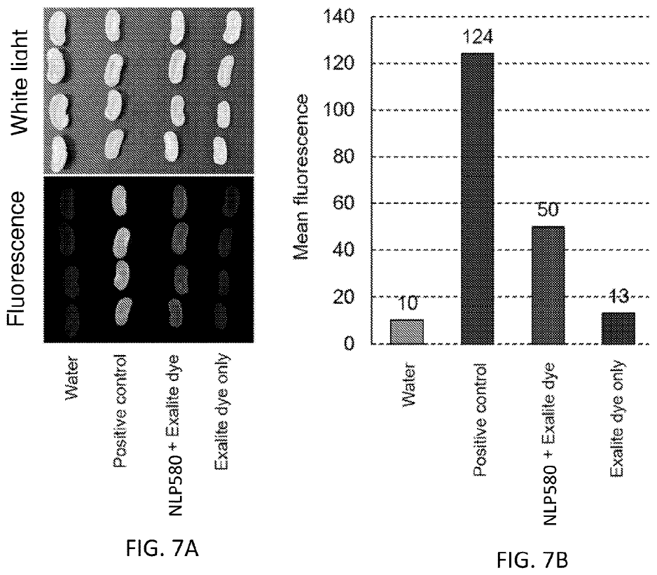

In beans incubated in a solution containing NLP comprising Exalite, the Exalite dye can be seen inside the seeds (FIG. 7A). The dye is not taken up by seeds when they are incubated in a solution containing the unformulated dye. The quantitation of the fluorescent signal is shown in FIG. 7B. Formulation of a fluorescent hydrophobic dye in NLP particles facilitates uptake of the dye by green bean seeds.

Example 23. Biodistribution of Emamectin Benzoate (EM) into Leaves of Corn Seedlings Upon Coating Seeds with NLP Comprising EM

This example describes the assay for the measuring the biodistribution of emamectin (EM) in a plant following coating of seeds with NLP comprising EM (EM-NLP). Some hydrophobic active ingredients such as emamectin benzoate have a low water solubility. This Example shows that NLP can facilitate seed uptake of such hydrophobic agents.

### Experimental Procedure:

Lemon NLP comprising EM were prepared as described in Example 2. Corn seeds (Ambrosia var.; N=60) were coated in 12 ml of treatment solution in a 50 ml tube for 1 min. After soaking of the corn for 1 min, 30 corn seeds per treatment were collected for the assay (6 replicate containing 5 seeds per replicate). Corn seeds were treated with one of 1) NLP comprising EM at 32 ug per ml of suspension (NLP-EM); 2) Free EM; or 3) no EM. Corn seeds were planted on Day 0 in a soil/sand mixture (50/50 w/w). Leaves (shoots) of the seedlings were harvested on Day 5. Samples of both treated seeds from Day 0 and leaves on Day 5 were processed for measuring the EM concentration by LC-MS.

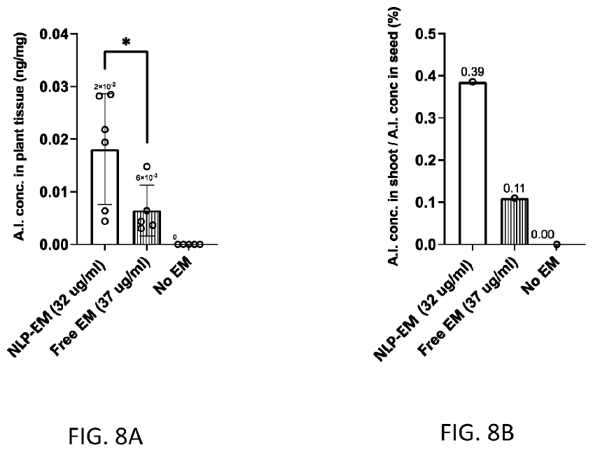

When corn seeds were coated with NLP-EM, and germinated in soil/sand mix, the EM could be detected on the seeds and in the corn leaves (shoots). This indicated that EM was taken up and translocated into the leaves (shoots) of the corn seedling. NLP-EM significantly increased the EM concentration in corn leaves compared to the unformulated EM (in water) (FIG. 8A). The ratio of EM concentration in leaves normalized for the EM concentration in seeds was higher in NLP-EM treatment than in the unformulated EM (in water) treatment (FIG. 8B), indicating that NLP facilitated the uptake and biodistribution of EM.

Example 24. Activity Against Western Corn Root Worm (WCRW) Upon Coating Seeds with NLP Comprising DE

This example describes the coating of corn seeds with NLP comprising a hydrophobic agent such as deltamethrin (DE), and efficacy of the seed coating in killing corn root worm on phytagel.

### Experimental Procedure:

### a) Preparation of Corn Germination Boxes

Germination boxes were sterilized and Phytagel poured one day before the experiment. Boxes were stored covered at 4° C. for one day. Large plastic boxes were sterilized by soaking in 10% bleach for ≥20 min. 70% EtOH was sprayed over the large boxes and dried. An aliquot of 500 ml of phytagel containing 0.7 g phytagel and 0.65 g Hoaglands' basal salt No. 2, Ph 6.5, was poured into large boxes and cooled.

### b) Sterilization of Corn Seeds

Seeds were placed in a large, open-mouthed container and soaked in 15% bleach solution for 15 min under gentle agitation. Seeds were then rinsed three times with sterile water.

### c) Seed Coating

NLP580 comprising 400 ug DE per ml of suspension (NLP580-DE) was prepared as described in Examples 1 and 2. A 200 uL aliquot of the 1) Water; 2) Deltamethrin at 400 μg/ml (unformulated); 3) NLP580 comprising 400 ug deltamethrin per ml of suspension (NLP580-DE (400 ug/ml)); or 4) A 20% solution of Acceleron® IX-409 (active imidacloprid, a neonicotinoid insecticide) in water was added to 4 g (about 25 corn seeds (var. MBS, PLT026-021)) in 50 mL tube in a dropwise fashion. The seeds were vortexed for 15 sec, followed by removal of the seeds and air drying. Seeds were placed into the large corn germination box comprising Phytagel and salts. Boxes were covered with foil and incubated at in reach-in incubator at 25° at 50% relative humidity. On Day 4, the foil was removed, and the lid cracked to allow for airflow. Seeds were germinated for 5 days, and the germination rate was scored as healthy, stunted, or not germinated. Healthy plants had developed shoots and roots, while stunted seedlings had shoots less than 1 cm in length. Seedlings that had not germinated showed neither shoot nor root.

### d) Western Corn Rootworm (WCRW) Infestation

The corn seedlings that germinated well in the plastic boxes were transferred to Magenta vessels (Sigma-Aldrich, Cat #V8505-100EA) containing 30 ml phytagel containing 0.7 g Phytagel and 0.65 g Hoaglands' basal salt No. 2, pH 6.5. A batch of 2nd instar larvae are shipped from the supplier (Crop Characteristic Inc., Farmington, MN USA) and stored at 4° C. until ready for use (less than a week). A total of 20 early to mid-second instar WCRW were sorted, and gently deposited into one Magenta vessel making sure they do not stick to sides of the Magenta vessels. Care was taken to not touch roots with paintbrush or forceps. Magenta boxes with corn seedlings and WCRW were placed into a Percival Incubator (25° C. 16Light: 8Dark, 60-80% Relative Humidity). After 2 days, for each magenta cage, the number of alive, dead, and missing WCRW larvae were counted and recorded under a dissecting microscope. Corn seedlings were placed into petri dish and any larvae that were on or in phytagel were gently collected. Corn seedings were also dissected to find any larvae that may have bored into the mesocotyl/coleoptile (stalk), large roots, or kernel. The fresh weight of corn seedling was measured with an analytical balance. The larvae were probed with forceps to check for movement. If larvae did not vigorously move when probed, they were considered dead. If less than 20 larvae were retrieved, the number less than 20 were recorded as missing. The percentage mortality and percentage WCRW control for each cage and each treatment were calculated.

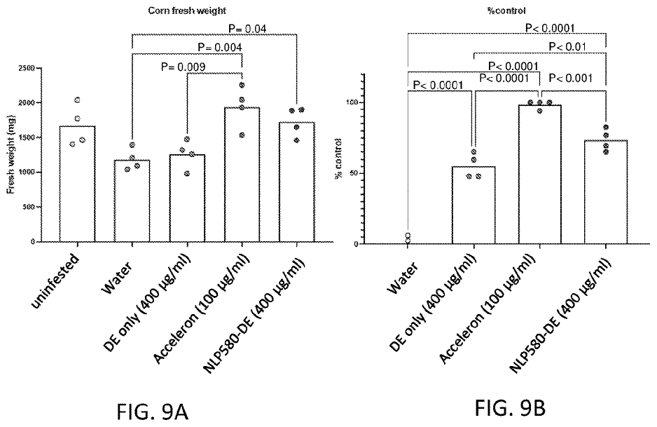

Assessment of In vitro efficacy of NLP580-DE (400 ug/ml) against WCRW in a corn seed treatment phytagel assay showed that NLP580-DE (400 ug/ml) treatment had a greater effect on fresh corn seedling weight than unformulated deltamethrin (DE-only) (FIG. 9A). FIG. 9B shows that the NLP580-DE (400 ug/ml) treatment had a higher WCRW control percentage than unformulated deltamethrin (DE-only).

### Example 25. Protecting Plants Against Foliar Insects Like Fall Armyworm and Black Cutworm by Seed Treatment

The Example describes an assay showing that NLP can translocate hydrophobic active ingredients (AI) such as deltamethrin (DE) systematically in plant leaves by coating the seeds with the NLP formulation. The assay further shows that AI translocated to the leaves is enough to show activity against foliar insect pest fall armyworm (FAW) and black cutworm (BCW) in an in vitro assay with corn seedlings grown in soil.

### Experimental Procedure:

### a) Seed Coating

A 25 g aliquot of corn seed (var. MBS, PLT026-021, approx. 100 seeds) are weighed into each of 4 weigh boats. A 50 mg aliquot of the corn polymer (Kannar™ SeedKOTE™ Corn Neutral v2.8, Kannar Earth Science) is weighed into each of 3 2-mL tubes. A 16 mg/mL stock solution of deltamethrin in DMSO is diluted 40× in water to final concentration of 400 ug/ml DE while vortexing to resuspend any particles.

An aliquot of 25 g of seeds is incubated with 800 μl with one of four solutions: 1) Water, 2) deltamethrin at 400 ug/ml, 3. NLP580 comprising 400 ug deltamethrin per ml of suspension, 4) A 20% solution of Acceleron® IX-409 (active imidacloprid, a neonicotinoid insecticide) in water. Seeds are vortexed and then let to dry overnight.

### b) Plant Setup and Treatment

Jumbo cotton balls are packed into the bottom of an 8″ tall and 1.5″ diameter cylindrical container (cone-tainer, cat #CN-SS-SC-10B, Greenhouse Megastore) and then packed with about 120-130 g of silt-loam soil while shaking. The soil is then watered with about 50 ml of tap water 24 hr before planting of seeds. Seeds are planted in holes of 1.5 inch deep and covered with soil. Plants are then placed inside a cage in the growth chamber to continue growing at about 25° C. until ready for 5-7 days for infestation, while watered with 10 ml tap water approximately every 3 days.

### c) Infestation (24 Hrs Before Drenching Soil)

Fall armyworm (FAW) eggs and black cutworm (BCW) eggs are purchased from Benzon Research ( ) and are hatched on artificial diet until larvae reach to 2^{nd} instars stage. Approximately 10 larvae are transferred to 1.5 ml microcentrifuge tube and released at the base of each plant. Plants are allowed to grow for 7 days after infestation before collecting data.

### d) Sample Processing and Data Collection—Plant Mass and Larvae Assessment

On day 5, germination is observed and recorded. On day 7 after infestation, all plants are removed from the cages and processed for data collection. For plant mass assessment, the above ground seedling mass (g) is measured for each plant after removal of the seedlings from soil. For FAW and BCW larvae assessments, the larvae from each plant are recovered and counted, and scored dead or alive.

### e) Statistical Analyses

To test for statistical significance between treatment groups, ANOVA+Dunnett's Post Hoc (a=0.05) is performed for count and mass data (continuous data). All treatments are compared to water control. Krukal-Wallis+Dunn's Post Hoc (a 0.05) is used for proportional data.

Treatment of the seeds with NLP-DE better protects the plants from a negative effect of FAW and BCW on plant mass compared to water or deltamethrin at 400 ug/ml treatments.

Example 26. Foliar Protection of Tomato Plants Against Insect Tomato Hornworm (THW) Upon Seed Priming with NLP Comprising DE

This Example describes an assay showing that NLP can translocate hydrophobic active ingredients (AI) such as deltamethrin (DE) systematically in tomato plant leaves by priming the seeds with the NLP formulation. It shows that AI accumulated in the tomato leaves is sufficient to show activity against foliar insect pest tomato hornworm (THW) in an in vitro assay with tomato seedlings grown hydroponically.

### Experimental Procedure:

### a) Tomato Seed Priming

Tomato seeds are surface-sterilized by 1 ml 25% Bleach with 0.025% Triton X-100 in 1.5 ml centrifuge tube, then washed 3 times with 1 ml sterile water. Tomato seeds (N=50) are primed in 0.3 ml of below treatment solutions in a 1.5 ml centrifuge tube for 24 hr. Seeds (N=26) are saved for analyzing deltamethrin concentration by LC-MS. Treatments include: 1) water; 2) NLP-HHPH comprising deltamethrin at 20 mg per ml of suspension; 3) Unformulated deltamethrin at 20 mg/ml; 4) clothianidin in water (100 ug/ml)

### b) Tomato Seed Germination and Tomato Hornworm (THW) Infestation

The primed tomato seeds (N=14) are germinated and grown on a precut mesh (0.08″×0.025″ Opening; Mcmaster-Carr) in 20 ml half strength Murashige and Skoog Basal Medium (MP Bio, Cat #0926231—CF) in a deep petri dish (100 mm×25 mm). The petri dishes are placed in large plastic container (236 Oz) with holes on both sides of the container and 100 ml MilliQ water to maintain high humidity. The containers are placed in a Percival incubator (about 25° C., 50% relative humidity). After 10 days, the mesh along with the seedlings on it is moved from the petri dish containing half strength MS media and excess media on mesh is dried by damping the roots on paper towels. After 3 days, the mesh with seedlings is removed from the petri dish and the roots are washed twice with MilliQ water and placed on paper towel to blot off excess water. The mesh with tomato seedlings is transferred to a new petri dish with 25 ml of 1% Phytagel (P8169-1 KG, Sigma-Aldrich).

c) Infestation with Tomato Hornworm

Infest 5 THWs (Tomato Horn Worms; Carolina Biological Supply Company, Burlington, NC USA) on the tomato seedlings on mesh in each petri dish and the petri dish is placed in a container (101 Oz). Briefly, 5 larvae are carefully transferred to the top of the tomato foliage with a soft forceps. The larvae start feeding on the foliage in a top-down fashion. The petri dish containing the larvae and the tomato seedlings grown on the mesh are placed into a secondary container to prevent larvae from escaping.

### d) Data Collection:

The insect mortality is scored after 2 days, and the mortality is normalized against negative control (water treatment) to calculate the % larval control.

Insects feeding on seedlings that emerged from seeds coated with NLP comprising deltamethrin and clothianidin have a significantly higher mortality and stunting compared to the water and unformulated deltamethrin treatments.

Example 27. Corn Seed Coated with NLP Containing Hydrophobic Plant Stimulant Brassinolide for Improved Plant Mass

Brassinolide is a plant hormone. This Example shows that NLP can translocate a hydrophobic plant stimulant such as brassinolide systematically inside plant by coating the seeds with the NLP formulation comprising brassinolide. Also, it demonstrates that the plant stimulant translocated inside the plant is sufficient to enhance plant growth in an in vitro assay.

### Experimental Procedure:

### a) Preparation of Corn Germination Boxes:

Germination boxes are sterilized and Phytagel poured one day in advance and stored covered at 4° C. for one day. Large plastic boxes are sterilized by soaking in 10% bleach for ≥20 min. 70% EtOH is sprayed to completely coat the boxes and dried. A 500 ml aliquot of Phytagel comprising 0.7 g of Phytagel and 0.65 g of Hoaglands' basal Salt No. 2, pH 6.5, is poured into the boxes and allowed to cool.

### b) Sterilization of Corn Seeds

Seeds are placed in a large, open-mouthed container and 15% bleach solution poured just below the container fill line to soak for 15 min. Seeds are rinsed three times with sterile water and planted on the same day as sterilization.

### c) Seed Coating

A 200 uL aliquot of formulation encapsulated with Brassinolide is added to 4 g (~25 seeds) in 50 mL tube in dropwise fashion while vortexing. The coated seeds are removed and air dried. Seeds are placed in a large plastic container with 500 ml Phytagel in each container and boxes are covered and placed in the Leela reach-in (25° C., 50% relative humidity). On Day 4, foil is removed, and lid cracked for airflow. Seeds are germinated for 14 days, and the germination rate is scored by the ratio of the number of germinated seeds over the number of planted seeds. On day 14, fresh weights of corn seedling and root are determined.

Treatment of the seeds with NLP-Brassinolide increases the plant mass (both whole seedling and root) compared to those of unformulated Brassinolide.

Example 28. Uptake of NLP comprising DE and Exalite by Arabidopsis thaliana

This example describes the root uptake of various NLP lipid compositions in Arabidopsis thaliana seedlings following exposure of the roots of seedlings to NLP formulations comprising deltamethrin and Exalite (a hydrophobic fluorescent dye that is not fluorescent in water but fluoresces in lipids and certain organic solvents).

### Experimental Procedure:

### a) Seed Sterilization and Plating

Seeds were surface sterilized using bleach solution (30% commercial bleach) for 5 min, washed five times with sterile water, and placed at 4° C. for 48 hours prior to plating to allow vernalization. Seeds were plated in squared petri dishes onto Murashige and Skoog (MS) salt mixture diluted 1:1 with water (0.5×MS) including vitamins and without sucrose (Duchefa, Cat. #NM0222) and 0.8% plant agar (Duchefa at. N #P1001) and grown for six days.

b) Treatments with NLP

Six-day-old seedlings were transferred to a 24 multi-well plates containing 400 μl of the treatment solution in 0.5×MS. The treatment solutions were one of the following 1) Exalite at 1 μg/ml in 0.5×MS; 2) NLP580 comprising Exalite at 1 ug per ml of suspension (NLP580-EX); 3) NLP580 comprising 1 ug Exalite and 80 ug deltamethrin per ml of suspension (NLP580-EX-DE); 4) NLP487 comprising 1 ug Exalite and 80 ug deltamethrin per ml of suspension (NLP487); 5) NLP544 comprising 1 ug Exalite and 80 ug deltamethrin per ml of suspension (NLP544).

Treatment lasted for 30 min or 24 hours (as indicated the Figure) and fluorescence was visualized under a confocal microscope (FV 1000 Olympus confocal microscope) using the 40× objective and selecting Excitation and Emission wavelengths of 510 nm and 570 nm, respectively (Em/Ex 510/570). The experiment was conducted three independent times and at least ten independent roots were visualized for each treatment.

The confocal microscopy images of 6-day-old Arabidopsis roots reveal the in-planta uptake of NLP. Upon 30 minutes (FIG. 10A-H), 24 h (FIG. 10I-R) of incubation, NLP were taken up and transported along the Arabidopsis root tissue, but unformulated Exalite is not taken up. Differential NLP accumulation within different cellular compartments is visualized for different NLP compositions, insets show endomembrane localization. Arrows point to NLP580-EX and NLP580-EX-DE accumulation in the root vasculature (v), whereas NLP487 and NLP544 preferentially accumulated in the epidermis (ep).

### Example 29. Uptake of NLP Comprising DE and Exalite by Tomato Root Epidermis Cells

This example describes the uptake of NLP formulations by a crop species.

### Experimental Procedure:

### A) Seed Sterilization and Plating

Tomato seeds were surface sterilized using bleach solution (30% commercial bleach) for 10 minutes min, washed 5 times with sterile water, and placed at 4° C. for 72 h prior to plating to allow vernalization. Seeds were plated in squared petri dishes onto 0.5× Murashige and Skoog (MS) salt mixture including vitamins without sucrose (Duchefa, Cat. #M0222) and 0.8% plant agar (Duchefa Cat. #P1001) and grown for six days at 22° C. in long day conditions.

B) Treatments with NLP

Six-day-old tomato seedlings were transferred to a 24 multi-well plates containing 400 μl of the treatment solution. The treatment solutions were one of the following: 1) NLP580, produced with the DCM method and comprising 1 ug of Exalite and 80 ug of deltamethrin per ml of suspension; and 2) Exalite (1 μg/ml) in 0.5×MS. Incubations were conducted for 24 hours and fluorescence was visualized using a confocal microscope (FV 1000 Olympus confocal microscope) using the 40× objective with confocal settings of Ex/Em: 510/570 nm. The experiment was performed with 10 replicate seedlings.

Confocal image visualization of NLP580 within epidermal cells of tomato seedlings shows that NLP580 is taken up by tomato roots when treated 24 hours in solution (triplicates, FIG. 11B-11D) whereas dye control with Exalite showed no fluorescence in root epidermis cells (FIG. 11A).

Example 30. Uptake and Transport of NLP Comprising DE and Exalite to Different Aerial Organs of Arabidopsis thaliana

This Example describes the transport of a selection of NLP compositions across the organs of Arabidopsis thaliana.

### Experimental Procedure:

### a) Seed Sterilization and Plating

Arabidopsis seeds were surface sterilized with bleach solution (30% commercial bleach) for 5 minutes, washed 5 times with sterile water, and placed at 4C for 48 hours prior to plating. Seeds were plated in squared petri dishes onto 0.5× Murashige and Skoog (MS) salt mixture including vitamins and without sucrose (Duchefa, Cat. n #M0222) and 0.8% plant agar (Duchefa Cat. n #P1001) and grown for six days in the darkness at 22° C.

b) Treatments with NLP

Seedlings were transferred to 70 μm cell strainers (bd falcon) to 6-well plates containing 1 ml of NLP solution and 1 ml of 0.5×MS including vitamins and without sucrose (Duchefa, Cat. N #M0222) and 0.8% plant agar (Duchefa Cat. n #P1001)). Treatment solutions were one of the following: 1) No treatment; 2) Exalite (1 μg/ml) in 0.5×MS; 3) NLP580; 4) NLP487; 5) and NLP544. All NLPs were produced with the method and comprised 1 ug of Exalite and 80 ug of deltamethrin per ml of suspension. Incubations were conducted for 24 hours and in the dark to avoid dye degradation. Seedlings were visualized using a confocal microscope (FV 1000 Olympus confocal microscope) using 20× objective and confocal microscope settings of Ex/Em: 510/570 nm. The experiment was performed three times and at least ten independent roots were visualized for each treatment.

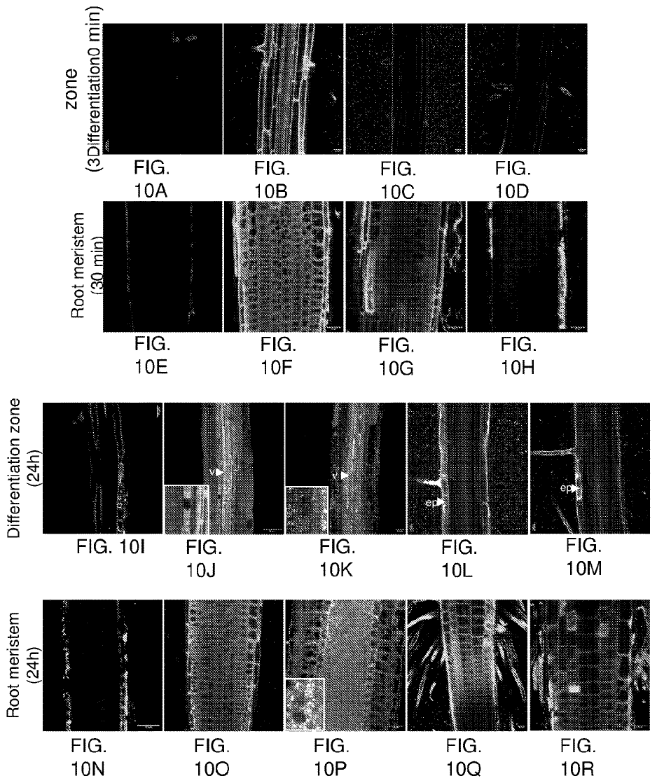

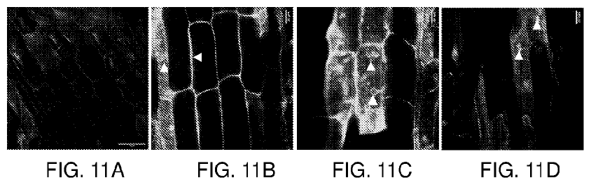

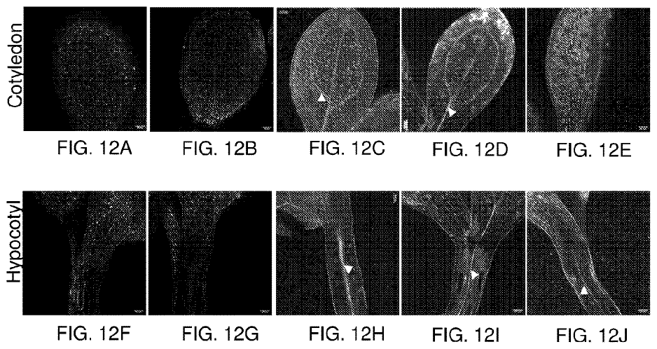

Results show that NLPs were transported across the different plant organs. After 24 hours, roots treated with NLP comprising Exalite showed fluorescence in cotyledons (FIGS. 12A-12E) and hypocotyls (FIG. 12F-12J). Arrows point to the vascular tissue. Control experiments with 1 μg/ml Exalite only (FIGS. 12B and 12G, for the cotyledon and hypocotyl, resp.) and untreated plants (FIGS. 12A and 12F, respectively) showed no fluorescence in any of the roots nor in any aerial plant tissues analyzed.

### Example 31. Uptake of NLP Comprising DE and Exalite in to Plant Cells

This example describes the subcellular localization of the different NLP compositions in Arabidopsis thaliana.

### Experimental Procedure:

### a) Seed Sterilization and Plating

Arabidopsis seeds were surface sterilized with bleach solution (30% commercial bleach) for 5 minutes, washed 5 times with sterile water, and placed at 4C for 48 hours prior to plating. Seeds were plated in squared petri dishes onto 0.5× Murashige and Skoog (MS) salt mixture including vitamins and without sucrose (Duchefa, Cat. n #M0222) and 0.8% plant agar (Duchefa Cat. n #P1001) and grown for six days in long day at 22° C.

### b) NLP Treatments

Five-day-old seedlings were transferred to 24-well plates containing 400 μl of the treatment solution. Treatment solutions were one of the following: 1) Exalite at 1 μg/ml in 0.5×MS; 2) NLP580; 3) NLP487; 4) and NLP544, all produced with the DCM method and comprising 1 ug of Exalite and 80 ug of deltamethrin per ml of suspension. Incubations were carried out for 24 hours.

### c) BFA Treatments

After 24 hours of NLP treatment, 50 μM Brefeldin A (BFA) (Merk, Cat n #B5936) in the NLP containing media was added for 90 minutes.

### d) Calcofluor White Staining

Seedlings were transferred to a new well containing 1.5 μg/ml of Calcofluor white (Merk, 18909) under vacuum for five minutes and 10 minutes more in normal conditions. Then roots were visualized under the confocal microscope (FV 1000 Olympus confocal microscope) using the 40× objective. The experiment was performed two times and at least 10 independent roots were observed in each condition every time.

Results show the subcellular localization of NLP. NLP and BFA treatment (FIG. 13A-13D) with the counter staining with calcofluor white (1 μg/ml) (FIG. 13E-13H), showed that NLP580 (FIG. 13B) and NLP487 (FIG. 13C) are aggregating in endomembranes (arrows point endomembranes aggregating in BFA bodies), whereas NLP544 (FIG. 13D) is insensitive to BFA. Control experiments using 1 μg/ml Exalite and BFA show low fluorescence in outer tissues but no fluorescence detection in the cytoplasm or endomembranes. The number of BFA bodies per cell were quantitated and are shown in Table 25, indicating the highest number of inclusion bodies for the NLP580 formulation.

TABLE 25
Quantification of number of BFA bodies
per cell according to NLP treatment1

| | Exalite 594 | NLP580 | NLP487 | NLP544 |
|---|---|---|---|---|
| # BFA bodies/cell | 0.06 | 0.86 | 0.36 | 0.09 |
| # cells | 96 | 191 | 175 | 100 |

¹number of BFA aggregates per cell having sizes between 1-3 μm.

Example 32. Mechanical Uptake of NLP Comprising DE and Exalite in Nicotiana benthamiana Leaves by Infiltration

This example describes the detection of NLP in planta following mechanical application of NLP into the leaves using leaf infiltration in Nicotiana benthamiana to complement the results obtained by root uptake and transport in Arabidopsis (natural uptake). These experiments study the subcellular localization and dynamics of NLP entering the cell via mechanical means.

### Experimental Procedure:

### a) Leaf Infiltration Assay

Nicotiana benthamiana plants were grown for 3-4 weeks in greenhouse conditions.

On day 1, an infiltrate 0.1 ml of NLP solutions was infiltrated into the leaf using a 2.5 ml syringe. Treatment solutions were selected from 1) Exalite at 1 μg/ml in 0.5×MS; 2) non-infiltrated leaves as a control; 3) NLP487; 4) NLP580; 5) NLP533; 6) NLP527; and 7) NLP530, produced with the DCM method and comprising 1 ug Exalite and 80 ug deltamethrin per ml of suspension. Further tested were 8) NLP646; 9) NLP655; and 10) NLP649, produced with the HHPH method and comprising 90 ug Exalite and 2 mg deltamethrin per ml of a suspension that is diluted 10-fold. Injections were made at different locations near the bottom of young leaves.

### b) Visualization

On day 2, a square piece of the infiltrated leaf was cut and visualized under the confocal microscope (FV 1000 Olympus confocal microscope or Leica SP5) using a 20× objective.

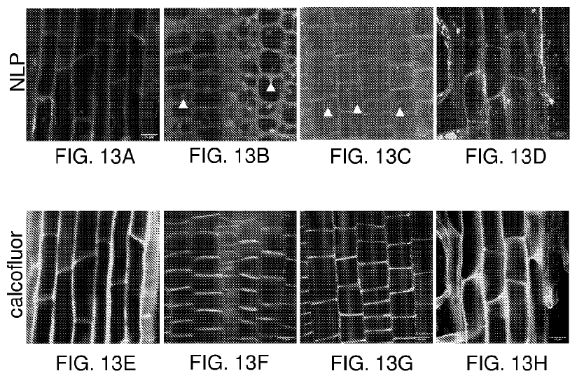

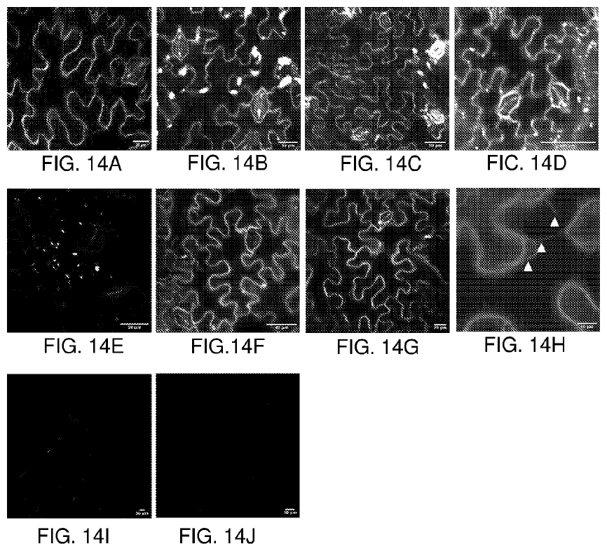

Results show that different NLP localize differently in Nicotiana benthamiana leaves. NLP were infiltrated and visualized after 24 hours. NLP487 (FIG. 14A) is localized at the plasma membrane whereas NLP530 (FIG. 14E) is mainly localized in aggregates next to the membranes and NLP580 (FIG. 14B), NLP533 (FIG. 14C) and NLP527 (FIG. 14D) presented localization in both subcellular compartments. Control experiments using 1 ug/ml Exalite and untreated plants showed that Exalite alone displays no fluorescence in any of the roots nor in aerial plant tissues analyzed.

### Example 33. Mechanical Uptake of NLP Comprising DE and Exalite in Melon Plants by Stem Injection

This Example describes NLP uptake in melon plants upon injection into the melon plant stem. Mechanical uptake of NLP, using leaves infiltration in Nicotiana benthamiana and Invaio's 3 mm Trecise™ injector in melon are different approaches to complement the results obtained by root uptake and transport in Arabidopsis thaliana (natural uptake). The rational is to check if after injection, NLP can be detected in the hypocotyls, confirming the NLP uptake. The Trecise™ injector is described in WO2020021041, which is incorporated in its entirety herein.

### Experimental Procedure:

### a) Injection

Four to six-week-old Melon (Cucumis melo., var. Piel de Sapo) plants were grown in a greenhouse. On day 1, 0.1 ml of NLP solutions were injected into the stem of the melon plant. Formulations were selected from 1) NLP487; 2) NLP544; and 3) NLP580, all produced with the DCM method and comprising 1 ug Exalite and 80 ug deltamethrin per ml of suspension; 4) Exalite at 1 μg/ml (control); 5) Untreated (control). Injections were made into the lower part of the stem of the melon plant using Invaio's 3 mm Trecise™ injector (in a 1 ml disposable syringe).

### b) Visualization

On day 2, the hypocotyls were hand cut near the injection site in transversal slides using a rectangular (new) razor blade on top of parafilm with a drop of water. Pictures were taken of the melon seedling before the cuttings were taken. Pictures were taken of the stem slides and the leaves using fluorescence red spectra filters of the stereoscope microscope Olympus SZX16.

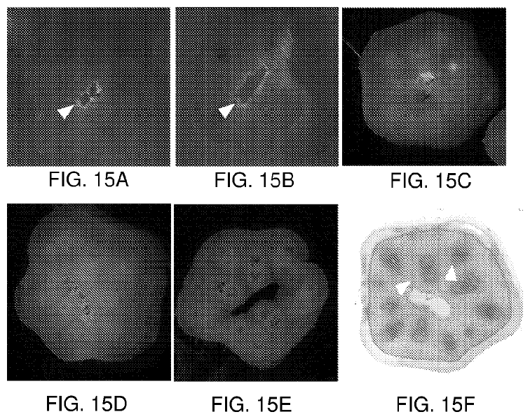

Injected NLPs are localized in the vascular system of the melon plant as evidenced by biodistribution (FIG. 15A-15F). Detection of an NLP signal after 24 hours of the injection, from left to right, upper panel NLP487 (FIG. 15A), NLP544 (FIG. 15B) and NLP580 (FIG. 15C). All NLP analyzed were localized in the pith and NLP580 was also detected in the vascular bundle (white arrows). Control experiments (lower panel) using 1 ug/ml Exalite (FIG. 15D) and untreated plants (FIG. 15E) showed that Exalite fluorophore alone displays no fluorescence in any of the roots nor in aerial plant tissues analyzed. FIG. 15F depicts a stem slide image under bright field. Arrows point to pith and vascular bundles.

### Example 34. Systemicity and Transport of NLP Comprising DE and Exalite to the Leaf in Melon Plants Upon Stem Injection

This Example describes that NLP can be detected in the hypocotyls following a stem injection in melon plants, confirming the NLP uptake.

### Experimental Procedure:

### a) Injection

Four to six-week-old Melon (Cucumis melo., var. Piel de Sapo) plants were grown in a greenhouse. On day 1, 0.1 ml of NLP580 comprising 1 ug Exalite and 80 ug deltamethrin per ml of suspension (NLP580) was injected in the lower part of the stem of the melon plant using Invaio's 3 mm Trecise™ injector (in a 1 ml disposable syringe).

### b) Visualization

On day 2, a square piece of a leaf was cut of the injected plant (as described in example 6UP) and visualized under the confocal microscope (FV 1000 Olympus confocal microscope or Leica SP5) using a 20× objective.

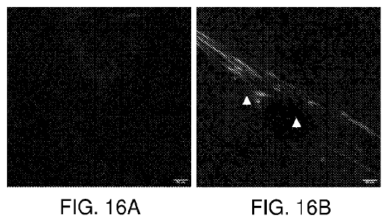

NLP580 is transported from stem to leaf. Detection of NLP580 signal in the vasculature (arrows point to the leaf vasculature) is shown 24 hours after injection (FIG. 16B). Control experiments using 1 μg/ml Exalite and untreated plants showed no such localization (FIG. 16A, representative).

### Example 35. NLPs Comprising DE are Taken Up by Plant Root Tissue Protect Against Colorado Potato Beetle (CPB)

This example tests if the biodistribution of NLP following root uptake is sufficient to offer protection of a tomato plant against Colorado potato beetle (CPB).

### Experimental Procedure:

### a) Cultivation of Tomato Plants

Tomato seeds (N=14) were germinated and grown on a precut mesh (0.08″×0.025″ Opening; Mcmaster-Carr, Cat #1100T45) in 20 ml 0.5×MS media (0.2 μM filtered without sucrose added) in a deep petri dish (100 mm×25 mm). The petri dishes were placed in a plastic container (236 Oz) with holes on both sides of the container and 100 ml MilliQ water to maintain high humidity.

The plastic containers with plants were placed in a Percival incubator (25° C., 50% relative humidity).

b) Incubation with NLP Formulations

After 10 days, the mesh along with the seedlings on it was moved from the petri dish containing 0.5×MS media and excess media on the mesh was dried by damping the roots on paper towels. The seedlings on the mesh were placed in a new deep petri dish containing formulation solution (20 ml) in the same large plastic container and Percival incubator. The treatment solutions were selected from 1) water; 2) NLP018 comprising no deltamethrin (empty NLP018); 3) NLP018 comprising 160 ug deltamethrin per ml of suspension (NLP018 [160 ug/ml DE]); 4) treatment #1 diluted 10-fold such that the deltamethrin concentration was 16 ug per ml of suspension (NLP018 [16 ug/ml DE]); 5) treatment #1 diluted 100-fold such that deltamethrin concentration was 1.6 ug per ml of suspension (NLP018 [1.6 ug/ml DE]); 6) NLP472 comprising 160 ug deltamethrin per ml of suspension (NLP472 [160 ug/ml DE]); 7) NLP495 comprising 160 ug per ml of suspension (NLP495 [160 ug/ml DE]); 8) deltamethrin at 160 ug/ml in DCM (unformulated); 9) clothianidin at 100 ug/ml. NLP018 [160 ug DE per ml of suspension], NLP472 [160 ug DE per ml of suspension], and NLP495 [160 DE per ml of suspension] were prepared as shown in example 1 by increasing all the lipid and surface modifier components 2-fold relative to the amount of water used. The particle size, PDI and zeta potential of these NLPs are similar to those prepared with 80 ug/ml of DE in the suspension as shown in example 1 (Table 8). After 3 days, the mesh with seedlings was taken out of petri dish and the roots were washed with MilliQ water 2 times and placed on a paper towel to blot off excess water. The mesh with tomato seedlings was transferred to a new petri dish with 25 ml of 1% phytagel (P8169-1 KG, Sigma-Aldrich).

### c) Infestation

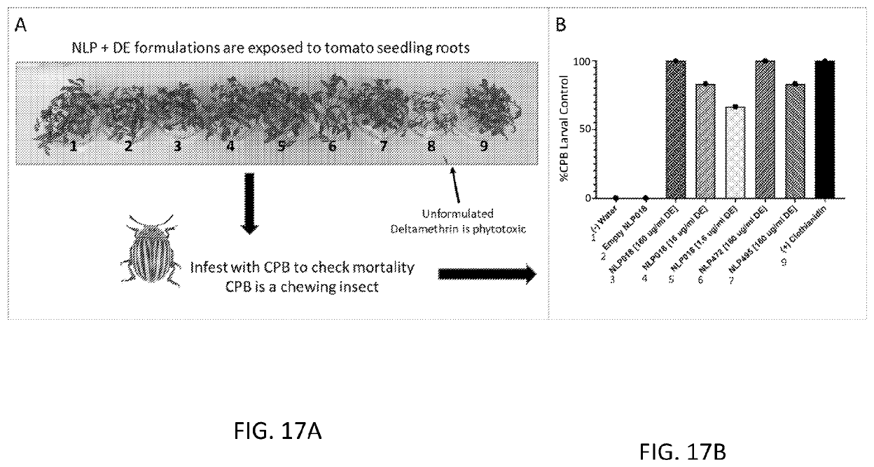

Five CPB larvae were placed on the tomato seedlings on mesh in each petri dish and the petri dish was placed in a large plastic container (101 Oz). The insect mortality was scored after 2 days, and the mortality was normalized against negative control (water treatment) to calculate the % larval control. The Experimental setup is shown in FIG. 17A.

NLPs comprising DE are taken up by tomato seedlings when administered via roots and causes mortality of CPB, a foliar chewing Coleopteran insect (FIG. 17B). Plants treated with empty NLP (no deltamethrin) showed no control of CPB when compared to plants treated with water while, plants treated with unformulated deltamethrin caused phytotoxicity to the tomato seedlings which made them unsuitable for supporting CPB feeding and the feeding assay. All NLP formulation treatments showed higher CPB mortality and better control of CPB. NLP018 [160 ug/ml DE], NLP472 [160 ug/ml DE], and NLP495 [160 ug/ml DE] all caused very high to near complete control of the insect. Lower concentrations of deltamethrin encapsulated in NLP018 caused decreasing control in a dose dependent manner.

### Example 36. NLPs Comprising DE are Taken Up by Plant Root Tissue and Protect Against Tomato Horn Worm (THW)

This example tests if the biodistribution of NLP following root uptake is sufficient to offer protection of a tomato plant against Tomato Horn Worm (THW).

### Experimental Procedure:

### a) Cultivation of Tomato Plants

Tomato seeds (N=14) were germinated and grown on a precut mesh (0.08″×0.025″ Opening; Mcmaster-Carr, Cat #1100T45) in 20 ml 0.5×MS media (0.2 μM filtered without sucrose added) in a deep petri dish (100 mm×25 mm). The petri dishes were placed in a plastic container (236 Oz) with holes on both sides of the container and 100 ml MilliQ water to maintain high humidity. The plastic containers with plants were placed in a Percival incubator (25° C., 50% relative humidity).

b) Incubation with NLP Formulations

After 10 days, the mesh along with the seedlings on it was moved from the petri dish containing 0.5×MS media and excess media on mesh was dried by damping the roots on paper towels. The seedlings on the mesh were placed in a new deep petri dish containing formulation solution (20 ml) in the same large plastic container and Percival incubator. The treatment solutions were selected from 1) water; 2) clothianidin at 50 ug/ml; 3) clothianidin at 25 ug/ml; 4) clothianidin at 12.5 ug/ml; 5) clothianidin at 6.25 ug/ml; 6) NLP580 comprising 400 ug deltamethrin per ml of suspension (NLP580 [400 ug/ml]). After 3 days, the mesh with seedlings was taken out of petri dish and the roots were washed with MilliQ water 2 times and placed on a paper towel to blot off excess water. The mesh with tomato seedlings was transferred to a new petri dish with 25 ml of 1% phytagel (P8169-1 KG, Sigma-Aldrich).

### c) Infestation

Five THW larvae were placed on the tomato seedlings on mesh in each petri dish and the petri dish was placed in a large plastic container (101 Oz). The insect mortality was scored after 2 days, and the mortality was normalized against negative control (water treatment) to calculate the % larval control.

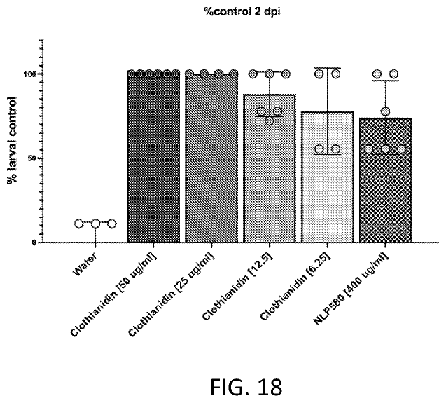

NLP comprising deltamethrin is taken up by tomato seedlings when administered via roots and causes mortality of THW, a foliar chewing Lepidopteran insect (FIG. 18). Deltamethrin without encapsulation was omitted from the experimental procedure due to phytotoxicity (wilting and chlorosis of plant tissue) observed in previous experiments. NLP formulation comprising deltamethrin was effective and did not cause phytotoxicity in this or any previous experiments.

Example 37. Incorporation of Metal Complexes (Lanthanide) into NLP

This example describes the preparation of lanthanide comprising NLPs.

### Experimental Procedure:

### a) Eu-DOTA Chelate Preparation

A 10 mg aliquot of axido-mono-amide-DOTA was dissolved in 1 mL of Milli-Q water. A 6.5 mg aliquot of europium(III) chloride hexahydrate was added then added to the DOTA solution. The pH of the solution was then adjusted to pH 5-6 using 1 N NaOH. The pH was monitored until it was stable for over 1 hour. The solution was then transferred to a rotator and incubated at 37° C. overnight while mixing. A 150 μL aliquot of 1 N NaOH was then added, and white precipitates were observed. The solution was then rotated for 1 hour at room temperature. The precipitates were removed by filtering through a 0.2 μm PTFE syringe filter. The solution was then freeze dried overnight under strong vacuum at 0.000 mbar and the collector set to −100° C. The dried powder was then redispersed in 1 mL of ethanol with brief vortexing. The solution was then centrifuged at 3000 g for 2 minutes and the resulting supernatant was transferred to a glass vial. Two additional ethanol washed were performed for a total of three washes. The ethanol was then removed using a rotary evaporator with the water bath set to 30C and the vacuum set to 123 mbar.

### b) Gd and Eu Loaded NLP/LNP Preparation (for 60 mL Formulation)

Stock solutions were prepared as shown in Table 26. The aqueous phase was prepared by diluting 600 μL of 10 mM Eu-DOTA stock in 60 mL Milli-Q water. For formulations containing Atlox surface modifiers the Eu-DOTA stock was diluted in a 0.5% solution of Atlox in Milli-Q water. The organic phase was prepared by combining the components volumetrically as shown in Table 27 (NLP) and Table 28 (HSPC). The organic phase was then added to the aqueous phase and probe sonicated for 1 minute at 50% amplitude on ice. The formulation was then transferred to a 20 KD MWCO dialysis cassette and dialyzed against 5 L of Milli-Q water for 24 hours changing the water every hour when possible. The sample was then filtered through a 1 μm glass fiber syringe filter. Particle size, PDI, and zeta potential were measured on a Malvern Zetasizer-Ultra Red. Lanthanide concentrations were measured by ICP-MS.

TABLE 26
Stock solutions prepared for the organic
phase of lanthanide loaded particles.

| | | Concentration |
|---|---|---|
| Material | Solvent | (mg/mL) |
| Non-Polar lipid | Chloroform:Methanol (4:1) | 15 |
| Polar Lipid | Chloroform:Methanol (4:1) | 15 |
| Surface Modifier | Chloroform:Methanol (4:1) | 5 |
| Hydrogenated Soybean | Chloroform:Methanol (4:1) | 20 |
| Phosphatidylcholine | | |
| (HSPC) | | |
| Cholesterol | Chloroform:Methanol (4:1) | 20 |
| 14C-PEG2000 | Chloroform:Methanol (4:1) | 10 |
| PE-DTPA (Gd) | Chloroform:Methanol (4:1) | 2 |

TABLE 27
Organic phase preparation for lanthanide loaded NLP particles.

| Stock | Volume (mL) |
|---|---|
| Non-Polar Lipid (15 mg/mL) | 1.083 |
| Polar Lipid (15 mg/mL) | 0.867 |
| Surface Modifier (5 mg/mL) | 0.650 (0*) |
| PE-DTPA (Gd) (2 mg/mL) | 0.390 |
| Chloroform:Methanol (4:1) | 3.510 (4.160*) |
| Total | 6 |

*indicates amounts for formulations with Atlox surface modifier that is added through the aqueous phase.

TABLE 28
Organic phase preparation for lanthanide loaded HSPC particles.

| Stock | Volume (mL) |
|---|---|
| HSCP (20 mg/mL) | 1.145 |
| Cholesterol (20 mg/mL) | 0.358 |
| 14C-PEG2000 (10 mg/mL) | 0.244 |
| PE-DTPA (Gd) (2 mg/mL) | 0.390 |
| Chloroform:Methanol (4:1) | 4.363 |
| Total | 6 |

### Example 38. Uptake of NLP Comprising Lanthanides by Tomato Seedlings

This Example describes the production of NLPs comprising lanthanides (e.g. Gd), and measuring the amount of Gd in plant tissues upon exposure to NLPs comprising Gd.

### Experimental Procedure:

### a) Cultivation of Tomato Plants

Tomato seeds (N=14) were germinated and grown on a precut mesh (0.08″×0.025″ Opening; Mcmaster-Carr, Cat #1100T45) in 20 ml 0.5×MS media (0.2 μM filtered without sucrose added) in a deep petri dish (100 mm×25 mm). The petri dishes were placed in a plastic container (236 Oz) with holes on both sides of the container and 100 ml MilliQ water to maintain high humidity.

The plastic containers with plants were placed in a Percival incubator (25° C., 50% relative humidity).

b) Incubation with NLP Formulations

After 10 days, the mesh along with the seedlings on it was moved from the petri dish containing 0.5×MS media and excess media on mesh was dried by damping the roots on paper towels. The seedlings on the mesh were placed in a new deep petri dish containing formulation solution (20 ml) in the same large plastic container and Percival incubator. The treatment solutions were selected from free Gd salt, Gd chelated to DOTA (Gd DOTA), Gd-DTPE incorporated into NLP527 (NLP527 (Gd)), Gd-DTPE incorporated into NLP529 (NLP529 (Gd)), Gd-DTPE incorporated into NLP580 (NLP580 (Gd)), Gd-DTPE incorporated into nanoparticles prepared from HSPC lipids, where all the solutions are at 10 nM of Gd. After 3 days, the mesh with seedlings was taken out of petri dish and the roots were washed with MilliQ water 2 times and placed on a paper towel to blot off excess water. The mesh with tomato seedlings was transferred to a new petri dish with 25 ml of 1% phytagel (P8169-1 KG, Sigma-Aldrich).

### c) Measuring the Amount of Gd in Plant Tissues

Isolated organs were weighed out, digested in 1 mL HNO₃ (trace metal grade after multi-step distillation) in closed Teflon vials at 85° C. for 30 min. Once the mixture appeared homogenized it was left at room temperature overnight. Following digestion, total volume for each sample was measured and adjusted into 1 mL or factored as 1 mL. A 0.64 mL aliquot was removed, diluted 10× with Milli-Q water to 7% HNO₃ and then mixed with Ho as internal standard at final concentration of 1 ppb. Standards were prepared using pure Gd, Eu, Tm, Yb and Ho (1 ppb Ho as internal standard) at concentrations of 0.002, 0.004, 0.006, 0.008, 0.01, 0.05, 0.1, 0.25, 0.5, 0.75, 1, 2.5, 5, 10, 25 and 50 ppb in 7% HNO₃. During the ICP-MS analytical run, the blanks were run at the beginning and the samples were introduced to the instrument with standards interspersed throughout the run. Once blanks were subtracted from the signal, a calibration curve was generated by analyzing standards and this curve had R² of 0.9999. Final metal concentrations were determined by comparing the signal intensity of samples from the calibration curve.

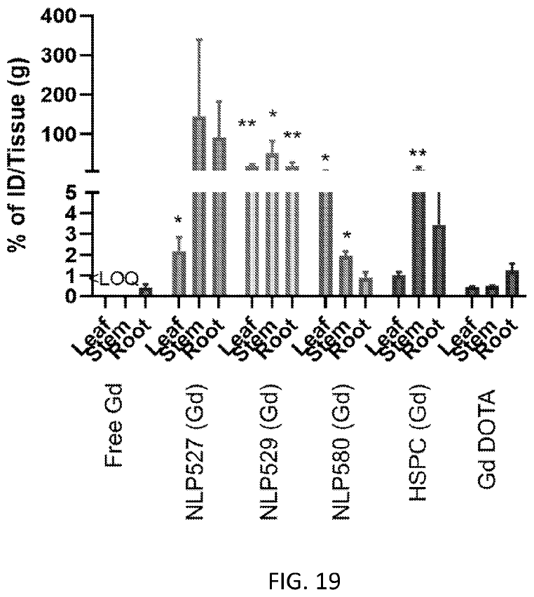

Gd as a free salt or when chelated into DOTA are not systemic in plants, however, when incorporated into NLP, Gd can be seen distributed in various plant organs upon admistration through the roots (FIG. 19).

### Example 39. Root/Foliar/Injection in Planta Application of NLP Comprising an Antibacterial Compound to Control a Bacterial Disease

This Example describes that NLP loaded roxithromycin can control bacterial infection in a plant.

### Experimental Procedure:

NLP formulations are prepared as described in example 17.

1. Tomato Root Uptake and Distribution Assay for Pseudomonas syringae

### a) Tomato Cultivation

Tomato seeds (N=14) are germinated and grown on a precut mesh (0.08″×0.025″ Opening; Mcmaster-Carr, Cat #1100T45) in 20 ml 0.5×MS media (0.2 μM filtered without sucrose added) in a deep petri dish (100 mm×25 mm). The petri dishes are placed in a large plastic container (236 Oz) with holes on both sides of the container and 100 ml MilliQ water to maintain high humidity. The containers are placed in a Percival incubator (25C, 50% relative humidity). After 10 days, the mesh along with the seedlings on it is moved from the petri dish containing 0.5×MS media and excess media on mesh is dried by damping the roots on paper towels.

### b) NLP Treatment

The seedlings on the mesh are placed in a new deep petri dish containing formulation solution (20 ml) in the same plastic container and Percival incubator. Treatment solutions were one of the following: 1) water; 2) NLP comprising no roxithromycin; 3) NLP comprising roxithromycin at 80 ug per ml of suspension; 4) roxithromycin at 80 ug/ml unformulated. After 3 days, the mesh with seedlings is taken out of petri dish and the roots are washed with MilliQ water twice and placed on a paper towel to blot off excess water. The mesh with tomato seedlings is transferred to a new petri dish with 25 ml of 1% phytagel (P8169-1 KG, Sigma-Aldrich). Tomato seedlings are flood-inoculated with Pst DC3000 in sterile conditions by pouring 15 mL of buffer (10 mM MgCl₂, 0.025% v/v Silwet-L77, control) or Pst DC3000 inoculum in buffer at 5×10⁷ Cfu mL⁻¹. Afterward, plates are decanted after 20 s, sealed, and returned to the growth room for 4 h at 24° C., under 150 μmol m⁻² s⁻¹ light. Subsequently, the flood-inoculated seedlings are transplanted to a new plate to new plate (0.5 MS including vitamins 8 g/L agar) and are grown under long day (8-h light/16-h dark) at 22° C.

### c) Quantification of the Disease Severity.

The quantification of the disease severity is calculated according to Jeger et al 2001, Theor. Appl. Genet. 102:32-40. The area of the leaf presenting chlorosis/necrosis is measured by using image J software and the % of the disease severity is calculated as shown in Section 3 below.

### d) Counting of Bacteria in Infected Plants

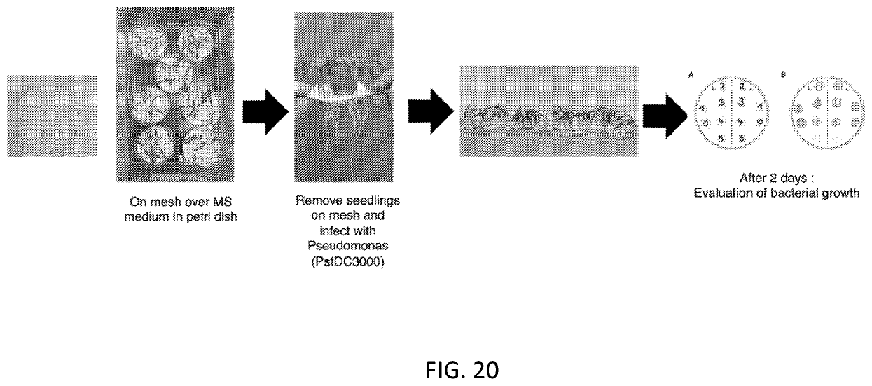

Infected plants are sampled, washed thoroughly with distilled water to remove bacteria present on the leaf surface, and weighed. The leaf tissue is collected and ground with a pestle in 1 ml of sterile distilled water until the extract is homogenous. The extract is serially diluted with sterile water and 5 μL drops are applied on King's broth agar plates and incubated at 25° C. After two days of incubation, the number of colonies in each drop is counted and expressed as Cfu/mg⁻¹ of tissue. The Experimental setup is shown in FIG. 20.

Plants treated with NLP comprising roxithromycin present a reduction in disease severity as evidenced from a reduction in the area of cells that present chlorosis/necrosis and the reduced number of bacterial counts (FIG. 20) compared to the other three treatments.

2. Tomato Leaf Uptake Assay Pseudomonas syringae.

### a) Tomato Cultivation

Tomato seeds (N=14) are germinated and grown on a precut mesh (0.08″×0.025″ Opening; Mcmaster-Carr, Cat #1100T45) in 20 ml 0.5×MS media (0.2 μM filtered without sucrose added) in a deep petri dish (100 mm×25 mm). The petri dishes are placed in a large plastic container (236 Oz) with holes on both sides of the container and 100 ml MilliQ water to maintain high humidity. The large containers are placed in a Percival incubator (25° C., 50% relative humidity). After 10 days, the mesh along with the seedlings on it is moved from the petri dish containing ½ MS media and excess media on mesh was dried by damping the roots on paper towels.

### b) Foliar NLP Treatment

The seedlings are sprayed with NLP formulation solution in the same large container and Percival incubator once every 24 hours for three days. Treatment solutions are? one of the following: 1) water; 2) NLP empty; 3) NLP containing roxithromycin; 4) roxithromycin. After 3 days, the mesh with seedlings is taken out of petri dish and the roots are washed with MilliQ water 2 times and placed on a paper towel to blot off excess water. The mesh with tomato seedlings is transferred to a new petri dish with 25 ml of 1% phytogel (P8169-1 KG, Sigma-Aldrich). Tomato seedling are flood-inoculated with Pst DC3000 in sterile conditions by pouring 15 mL of buffer (10 mM MgCl₂, 0.025% v/v Silwet-L77, control) or Pst DC3000 inoculum in buffer at 5×10⁷ Cfu mL⁻¹. Afterward, plates are decanted after 20 s, sealed, and returned to the growth room for 4 hours at 24° C., under 150 μmol m⁻² s⁻¹ light.

Plants treated with NLP containing roxithromycin present a reduction in disease severity as evidenced from a reduction in the area of cells that present chlorosis/necrosis and the reduced number of bacterial counts compared the other three treatments.

3. Methods for Pseudomonas syringae proliferation assay.
a) Quantification of the disease severity.

The quantification of the disease severity is calculated according to Jeger et al 2001, Theor. Appl. Genet. 102:32-40. The area of the leaf presenting chlorosis/necrosis is measured by using image J software and the % of the disease severity is calculated by using the following formula.

$$\% disease severity = \frac{disease leaf area}{total leaf area} \times 100$$

### b) Counting of Bacteria in Infected Plants

Infected plants are sampled, washed thoroughly with distilled water to remove bacteria present on the leaf surface, and weighed. The leaf tissue is collected and ground with a pestle in 1 ml of sterile distilled water until the extract is homogenous. The extract is serially diluted with sterile water and 5 μL drops are applied on King's broth agar plates and incubated at 25° C. After two days of incubation, the number of colonies in each drop is counted and expressed as Cfu/mg⁻¹ of tissue. The Experimental setup of the Experiment is shown in FIG. 20.

The extracts of plants treated with NLP containing roxithromycin present a reduced number of colonies when compared with the controls.

### Example 40. Application of NLP Comprising Deltamethrin to the Roots of Seedlings to Control Fall Army Worms (FAW) in Corn

This Example describes the methods for root application of NLP to control FAW.

### Experimental Procedure:

### a) Corn Seedling Uptake

Two hundred corn seeds of the MBS Hybrid line are sterilized in 15% bleach sterilization solution by placing 50 seeds each in 4 separate 50 mL Falcon tubes and adding 25 mL sterilization solution into each tube. The tubes containing seeds are shaken on an orbital shaker at low speed for 15 min, after which the seeds are rinsed 3 times with sterile MilliQ water in the biological safety cabinet to ensure sterility. Six seeds are then selected from each tube and placed into CYG germination pouches (PhytoAB ca #CYG-38 LB) with 50 ml of sterile DI water. Seeds are allowed to germinate in the dark for 3 days at 25° C. and 60% relative humidity. After 3 days seedlings are moved to climate-controlled chambers with a light: dark cycle of 16:8 at 25° C. and 60% RH. At this time 25 ml of treatment solutions suspended in Hoagland's solution (Sigma-Alderich H2395-1L, 1.3 g/L, pH 6.5) are added to germination pouches. The treatment solutions are selected from 1) water; 2) clothianidin at 50 ug/ml; 3) clothianidin at 25 ug/ml; 4) clothianidin at 12.5 ug/ml; 5) clothianidin at 6.25 ug/ml; 6) NLP580 comprising 400 ug deltamethrin per ml of suspension (NLP580-DE); and 7) deltamethrin at 400 ug/ml (unformulated). Seedlings are allowed to grow and uptake solution for 3 days before FAW infestation.

### b) Infestation

Six-day-old plants are infested with non-diapausing FAW at a rate of two 2nd instar larvae per plant. A minimum of 10 plants are selected for infestation and any plants that failed to germinate are removed. Before infestation germination pouches are sealed to prevent FAW from making direct contact with nutrient and NLP solutions. FAW are then allowed to feed on plants for a duration of 2 days in a Percival incubator (25° C., 50% RH, 16:8 Light: dark cycle).

### c) Mortality and Plant Mass Scoring

FAW mortality is scored two days post-infestation by removing larvae from plants and probing 3 times. Larvae that are unresponsive to probing or not recovered are considered dead and the proportion of surviving larvae over initial infestation numbers are compared across treatments. Plant mass is also recorded by weighing individual seedlings after larvae are removed and average mass of seedlings are compared across treatments. FAW mortality is the highest in plants treated with deltamethrin in NLP580 and clothianidin, while no mortality is observed in plants treated with just water. Unformulated deltamethrin causes none or very low mortality.

The plant mass is the highest in plants treated with NLP580-DE and clothianidin, while the plants treated with just water have the lowest fresh weight. Plants treated with unformulated deltamethrin have fresh weight comparable to the water treated plants.

### Example 41. NLP Application for the Control Citrus Greening

This Example describes the uptake, canopy distribution, phytotoxicity and injection site damage from injection of NLP loaded with a heterologous functional agent.

### Experimental Procedure:

2-4 years old Valencia citrus trees with approximately 4-inch trunk diameter and disease index of less than 15 are used. A tip setter bit is placed in a hammer drill. Tubing to an injection tip is connected and placed into the tip setter bit. A top-click cannister holder is connected to the other end of the tubing that is attached to the tip. The injection tip is pressed lightly against the trunk at a distance greater than 10 cm from the graft union. The hammer drill trigger is squeezed until the tip is completely set into the tree trunk. A pressurized cannister containing 60 ml of the treatment solution is clicked into the cannister holder attached to tree via the tip and checked to ensure that there are no leaks from the injection site. The injection site is treated with Ridomil Gold fungicide. The treatment solutions in the cannister that are injected into the tree comprise of one of the following: 1) water; 2) antibiotic solution unformulated (mixed into water); 3) NLP comprising antibiotic; 4) NLP comprising no antibiotic; 5) untreated (not injected). 25 trees per treatment are used, and each tree is injected once. An exemplary antibiotic for this experiment is oxytetracycline (OTC).

### b) Injection Process:

The tip setter bit is put in hammer drill. The injection tip (connected to tubing) is put into bit. The top-click canister holder is connected to the open end of the tubing. The injection tip is pressed lightly against the tree trunk 5 cm from the ground. The trigger is squeezed and held until tip is set in the tree. The prefilled canister is clicked onto the canister holder hanging from the tree.

### c) Trials Readouts:

Uptake is determined on day 2, day 7, day 14, and day 21. Phytotoxicity is determined at day 2, day 7, day 14 and day 30. Biodistribution is determined on day 2, day 7, day 14 and day 21 (depending on canopy size). Injection site damage is determined on day 90 and day 120.

Uptake: Cannisters are weighted to determine the uptake volume.

Phytotoxicity for tree injections: three categories: leaf drop, whole plant Chlorosis and interveinal chlorosis/burn are determined. Each is read on a scale of 1 to 10.

Distribution: Analytical methods-HPLC, HRMS are used to determine biodistribution of the active.

Injection site damage: rated using a scale of 1 to 10.

Yield: The number and total weight of the fruit that is harvested from the tree at the end of the season.

Fruit drop: The floor of each tree is cleared 3 months before the harvest and the amount of fruit collected on the floor every two weeks until the time of harvest is measured. Fruit drop is calculated as the percentage of number of fruit collected from the ground in the total pool of fruit collected from the ground and tree together.

Tree canopy: The tree height, the skirt height (distance from canopy to the ground), the distance between the widest point in north-south orientation and the distance between the widest points in east-west orientation.

### Results:

Uptake of treatment solutions: Water, NLP comprising antibiotic, and NLP comprising no antibiotic are taken up completely. Unformulated antibiotic is not taken up, and/or clogs the entry.

Phytotoxicity: No leaf drop or chlorosis in any of the treatments

Distribution of antibiotic: Unformulated antibiotic is found at variable rates across the tree, mostly concentrated in the trunk near the site of injection. Antibiotic in NLP comprising antibiotic distributes more evenly throughout the tree and doesn't accumulate at the site of injection as much as the unformulated antibiotic.

Injection site damage: Treatments with water, NLP comprising antibiotic, and NLP comprising no antibiotic leave no visible damage apart from the opening due to the insertion of the injection tip (less visible damage).

Unformulated antibiotic causes widening of the opening, blackening, splitting of the trunk, and gummosis at the site of injection.

Yield: Trees treated with water, untreated, antibiotic unformulated, and NLP comprising no antibiotic have reduced yields in comparison to trees treated with NLP comprising antibiotic.

Fruit drop: Trees treated with water, untreated, unformulated antibiotic, and NLP comprising no antibiotic have higher fruit drop in comparison to trees treated with NLP comprising antibiotic.

Tree canopy: Trees treated with water, untreated, antibiotic unformulated, and NLP comprising no antibiotic have reduced tree canopy size in comparison to trees treated with NLP comprising antibiotic.

### Example 42. Root/Foliar/Injection in Planta Application of NLP Comprising DE Controls Whiteflies Feeding on Tomato

This Example describes an experiment to determine if treatment of tomato seedlings with NLPs comprising deltamethrin can kill whiteflies feeding on tomato plants Experimental procedure:

### a) Treatment of Tomato Seedlings

Tomato seeds (N=14) are germinated and grown on a precut mesh (0.08″×0.025″ Opening; Mcmaster-Carr, Cat #1100T45) in 20 ml ½ MS media (0.2 M filtered without sucrose added) in a deep petri dish (100 mm×25 mm). The petri dishes are placed in a large plastic container (Sistema; 236 Oz) with holes on both sides of the container and 100 ml MilliQ water to maintain high humidity. Large plastic containers are placed in a Percival incubator (25° C., 50% RH). After 10 days, the mesh along with the seedlings on it is moved from the petri dish containing half strength MS media, and excess media on mesh is dried by blotting the roots on paper towels. The seedlings on the mesh are placed in a new deep petri dish containing 20 ml formulation solution comprising one of 1) water, 2) unformulated deltamethrin at 400 μg/ml, 3) NLP comprising 400 ug deltamethrin per ml of suspension (NLP-DE), 4) clothianidin at 10 ug/ml in the same plastic container back in the incubator. After 3 days, the mesh with seedlings is taken out of petri dish and the roots are washed with MilliQ water 2 times and placed on a paper towel to blot off excess water. The mesh with tomato seedlings is transferred to a new petri dish with 25 ml of 1% phytogel (P8169-1 KG, Sigma-Aldrich).

### b) Whitefly Exposure

From a whitefly infested plant in a rearing cage, leaves that are infested with about 200 white flies are excised using scissors and placed in a petri dish. The petri dish is placed at the base of the tomato plants on the phytagel taking care to not damage the tomato plant roots. The boxes with the tomato plant and the whiteflies are placed in an incubator with 16 h light/8 hr dark photoperiod, 26° C. and 50% humidity. After one day, the old leaves are removed from the petri dishes at base of the plants. Whiteflies still on those leaves are blown off into the box using an airbrush sprayer if necessary. After 7 days, count the number of living and dead white flies on the tomato plants and on the walls of the cages.

After 7 days, the number of live whiteflies in the container with plants that were treated with NLP-DE and clothianidin are significantly lower than on the plants that were treated with DE unformulated or with water.

Example 43. Production of NLPs from Lemon, Carrot and Algae Lipid Sources

This Example describes that NLP can be made from plant lipid (lemon) and plant cell culture lipids (e.g. carrot and algae (autotrophic and mixotrophic)) to encapsulate the hydrophobic active deltamethrin.

### Experimental Procedure:

### a) Plant (Lemon) and Plant Cell Cultures (Carrot and Algae (Autotrophic and Mixotrophic)) Lipid Extraction

Lipids were extracted from lemon, algae, and carrot powder, using the Bligh-Dyer method: Bligh, E. G. and Dyer, W. J. 1959. A rapid method for total lipid extraction and purification. Can.J.Biochem.Physiol. 37:911-917, which is incorporated herein by reference. NLPs are generated using the NanoAssemblr method as follows. An aliquot of 50 mg of dried lipids (selected from fresh lemon juice, two types of algae cell powder (Mixotrophic & Autotrophic), and Carrot cell powder, dissolved in DMF/MeOH solution at 4 mg/mL, unfiltered) is dissolved in 13.75 ml of Dimethylformamide (DMF) and methanol (MeOH) (ratio of 4:1). An aliquot of 500 μL of 10 mg/mL deltamethrin (DE) in Dimethyl sulfoxide (DMSO) was added to the dissolved lipid solution.

### b) NLP Formation

NLPs were formed using the NanoAssemblr (Precision NanoSystems) equipment by injecting 2.5 mL of the lipid solution (in a 3 mL syringe) on R channel (set at 37° C.) and 7.5 mL of MilliQ water (in a 10 mL syringe) on C channel which are then mixed using the NanoAssmblr (total volume: 10 mL, Flow rate: 12 mL/min, Ratio: 3:1 (aqueous: organic), starting waste: 0.1 mL, ending waste: 0 mL). Free DE was removed by one round of centrifugation filtration using Amicon Ultra-15 tubes [MW 100 kD]. Residual organic solvent in NLPs was removed by dialysis [MW 20 kD] against PBS. For NLP characterization, the DE concentration is measured at two time points (post-formation) using LC-MS to calculate loading efficiency. Loading efficiency is calculated as follows: AI amount final (ug)/AI amount post-formation (ug). The particle size is measured using the Zetasizer Ultra (Malvern Panalytical). The DE concentration in 4 NLP formulations is shown in Table 29.

TABLE 29
Deltamethrin concentration in NLPs comprising
lemon, carrot and algae lipids.

| | | Averaged | Repeat | Repeat |
|---|---|---|---|---|
| Treatment | | deltamethrin | 1 | 2 |
| no. | Treatment Description | Concentration | (μg/mL) | (μg/mL) |
| 1 | Deltamethrin in | 40.9 μg/mL | 42.3 | 39.4 |
| | Lemon NLP | | | |
| 2 | Deltamethrin in | 32.8 μg/mL | 33.3 | 32.3 |
| | Carrot NLP | | | |
| 3 | Deltamethrin in Algae- | 27.5 μg/mL | 25.6 | 29.4 |
| | Autotropic NLP | | | |
| 4 | Deltamethrin in Algae- | 28.7 μg/mL | 29.1 | 28.3 |
| | Mixotropic NLP | | | |

### Example 44. NLP Protection of Deltamethrin Against UV Radiation

This example describes the sensitivity of deltamethrin in different NLP formulations to decomposition by ultraviolet irradiation.

### Experimental Procedure:

Twenty aliquots of 100 μl of deltamethrin solution in methanol or NLPs comprising total lipid from lemon, total lipid from carrot, total lipid from autotrophic algae and total lipid from mixotrophic algae along with deltamethrin (as described in Example 43) were pipetted each into 2 ml Eppendorf tubes (info from conditions Table 29). In addition, the four NLP formulations were also mixed with lignosulfonate (Borresperse NA, Borregaard), a widely used UV absorption agent at 3% final concentration, ten samples were exposed to UV light, and ten represented control samples that were not exposed to UV light.

Table 30 shows the concentration of deltamethrin in NLPs of different lipid sources without and with lignosulfonate.

TABLE 30
Deltamethrin concentration in NLPs comprising lemon, carrot
and algae lipids without and with lignosulfonate.

| | | Initial | | Repeat | Repeat | |
|---|---|---|---|---|---|---|
| Treatment | | deltamethrin | | 1 | 2 | Standard |
| no. | Treatment Description | Concentration | | (μg/mL) | (μg/mL) | Deviation |
| 1 | Deltamethrin in | 109 | μg/mL | 104 | 114 | 5.00 |
| | Methanol | | | | | |
| 2 | Deltamethrin in | 40.9 | μg/mL | 42.3 | 39.4 | 1.45 |
| | Lemon NLP | | | | | |
| 3 | Deltamethrin in | 32.8 | μg/mL | 33.3 | 32.3 | 0.50 |
| | Carrot NLP | | | | | |
| 4 | Deltamethrin in Algae- | 27.5 | μg/mL | 25.6 | 29.4 | 1.90 |
| | Autotropic NLP | | | | | |
| 5 | Deltamethrin in Algae- | 28.7 | μg/mL | 29.1 | 28.3 | 0.40 |
| | Mixotropic NLP | | | | | |
| 6 | Deltamethrin in | 42.8 | μg/mL | 43.1 | 42.5 | 0.30 |
| | Lemon NLP + | | | | | |
| | 3% Lignosulfonat | | | | | |
| 7 | Deltamethrin in | 35.5 | μg/mL | 35.9 | 35.0 | 0.45 |
| | Carrot NLP + | | | | | |
| | 3% Lignosulfonat | | | | | |
| 8 | Deltamethrin in Algae- | 28.9 | μg/mL | 29.4 | 28.3 | 0.55 |
| | Autotropic NLP + | | | | | |
| | 3% Lignosulfonat | | | | | |
| 9 | Deltamethrin in Algae- | 27.2 | μg/mL | 28.6 | 25.7 | 1.45 |

Mixotropic NLP +
3% Lignosulfonat

For the samples to be exposed to UV exposure, the cap of the Eppendorf tube was removed, and a single layer of Saran wrap (SC Johnson) was pulled across the top and secured with a rubber band. For the control samples, the Eppendorf tube was capped and wrapped entirely in aluminum foil to completely block UV radiation.

All samples were placed 15 cm below the UV light (Hortilux PowerVEG Full Spectrum with UV Bulb, Growershouse, Cat #901678) with the UV radiation intensity at round 150 milliwatts per square centimeter (mW/cm²). For each treatment, two samples were analyzed by LC-MS at t=0 (immediately after preparation), at day 1, day 2, day 3, and day 6. For each timepoint two UV samples and 2 control samples were removed for analysis by LC-MS/MS. Prior to analysis, the samples were diluted to 1 ml with methanol in the original 2 mL Eppendorf tubes. A further 100× dilution was performed in methanol and the samples were transferred to HPLC vials for analysis by LC-MS.

The percent recovery of deltamethrin was calculated relative to the initial deltamethrin concentration for each formulation found in Table 30. Deltamethrin concentrations were determined from a calibration curve of freshly prepared deltamethrin concentrations in methanol (stored at −20° C.).

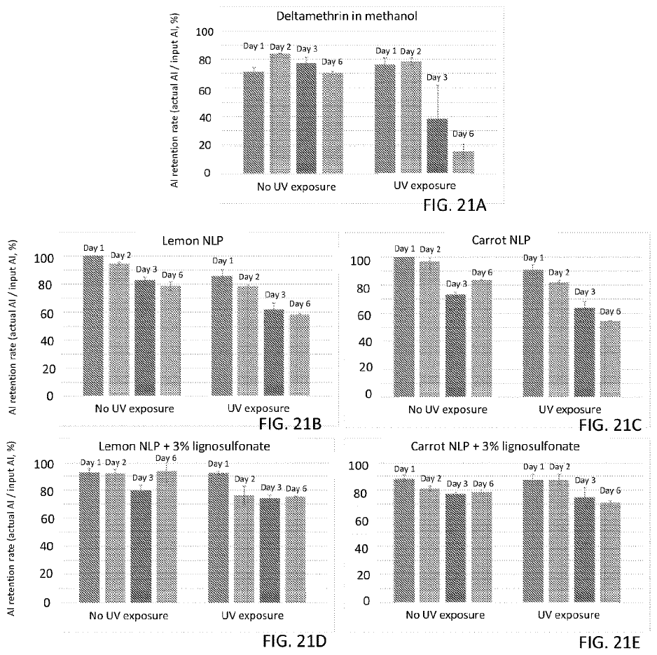

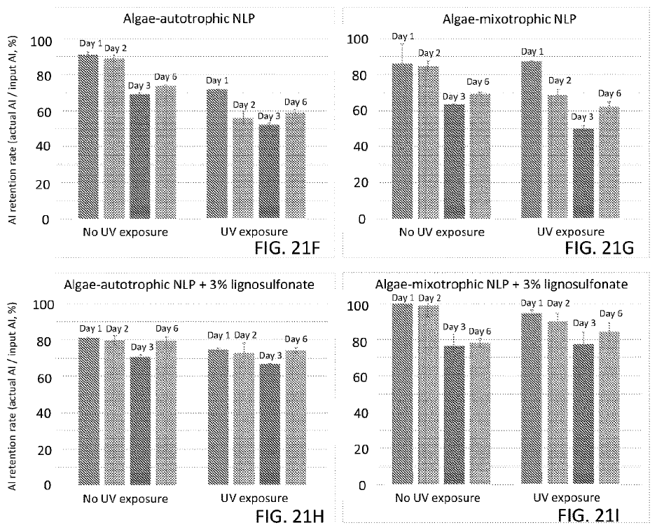

Results are shown in FIG. 21. The percent recovery of deltamethrin when deltamethrin in methanol was exposed to UV light for 6 days was 15.8%, while the recovery in the control with no UV exposure was 70.5% showing that deltamethrin degraded in the presence of UV light (FIG. 21A). When NLPs prepared from lemon (FIG. 21B), carrot (FIG. 21C), algae (autotrophic) (FIG. 21F), or algae (mixotrophic) lipids (FIG. 21G) comprising deltamethrin were exposed to UV light for 6 days, the percent recovery of deltamethrin was 58.3%, 54.6%, 59.1%, and 62.2% respectively, which was significantly higher than for deltamethrin in methanol, and close the non-UV exposed controls which stood at 78.7%, 83.5%, 73.5%, and 69.3% respectively. This shows that NLPs comprising deltamethrin protect deltamethrin from UV degradation. This protective effect was further enhanced upon the addition of lignosulfonate (FIG. 21D, 21E, 21H, 21I).

Example 45. Uptake of NLPs and Organ Tissue Distribution in Arabidopsis thaliana

This Example describes the transport of a selection of NLP compositions across the organs of Arabidopsis thaliana.

### Experimental Procedure:

### a) Seed Sterilization and Plating

Arabidopsis seeds were surface sterilized with bleach solution (30% commercial bleach) for 5 minutes, washed 5 times with sterile water, and placed at 4° C. for 48 hr prior to plating. Seeds were plated in squared petri dishes onto 0.5× Murashige and Skoog (MS) salt mixture including vitamins and without sucrose (Duchefa, Cat. n #M0222) and 0.8% plant agar (Duchefa Cat. n #P1001) and grown for six days in the darkness at 22° C.

b) Treatments with NLP

Seedlings were transferred to 70 μm cell strainers (bd falcon) to 6-well plates containing 1 ml of NLP solution and 1 ml of 0.5×MS including vitamins and without sucrose (Duchefa, Cat. N #M0222) and 0.8% plant agar (Duchefa Cat. n #P1001)). Treatment solutions were one of the following NLPs each comprising 1 ug of Exalite and 80 ug of deltamethrin per ml of suspension: 1) NLP533; 2) NLP578; 3) NLP551; 4) NLP544; 5) NLP600; 6) NLP620.

Incubations were conducted for 24 hr and in the dark to avoid dye degradation. Seedlings were visualized using a confocal microscope (FV 1000 Olympus confocal microscope) using 20× objective and confocal microscope settings of Ex/Em: 510/570 nm. The experiment was performed three times and at least ten independent roots were visualized for each treatment.

Results for NLP transport from root to the aerial plant organs for the various NLP suspensions is shown in FIG. 22A-22P. Upon 24 h of root treatment with the indicated NLPs compositions comprising Exalite and deltamethrin, fluorescence can be detected in this experiment for NLP533, NLP578, and NLP544 in cotyledons (FIG. 22C, 22D, 22J, resp.) and hypocotyls (FIGS. 22G, 22H and 22N, resp.). Control experiments were plants treated with 1 ug/ml Exalite only, and water-treated plants. Exalite only showed no fluorescence in any of the roots nor in areal plant tissues analyzed. In conclusion, NLPs comprising a surface modifier (NLP533, NLP578, NLP544) performed better in this experiment in the uptake compared to NLPs without a surface modifier (NLP600, NLP620).

Example 46. Uptake of NLPs and Meristem Targeting in Arabidopsis thaliana

This example describes the uptake of NLP formulations by A. thaliana.

### Experimental Procedure:

NLP formulations tested in the uptake experiments were NLP533, NLP551, NLP578, NLP600, NLP620, NLP699, and NLP700, prepared with the DCM method, and comprising 80 ug/ml of deltamethrin and 1 ug/ml of Exalite. For detailed information on the composition see Table 8 above. Two control NLP compositions not comprising surface modifier were prepared with the DCM method, having the composition as described in Table 31 below.

TABLE 31
Two NLP compositions not comprising surface modifier

| | | | Surface | |
|---|---|---|---|---|
| | Non-polar | Phospholipid | modifier | Weight ratios of |
| NLP | lipid (NP) | (PL) | (SM) | NP:PL:SM |
| NLP699 | Coconut | Soybean | — | 5.56:4.44:0 |
| | | lecithin | | |
| NLP700 | Canola | Sunflower | — | 5.56:4.44:0 |
| | | lecithin | | |

Incubation with Arabidopsis Root Tissues:

### a) Seed Sterilization and Plating

Seeds were surface sterilized using bleach solution (30% commercial bleach) for 5 min, washed five times with sterile water, and placed at 4° C. for 48 hr prior to plating to allow vernalization. Seeds were plated in squared petri dishes onto Murashige and Skoog (MS) salt mixture diluted 1:1 with water (0.5×MS) including vitamins and without sucrose (Duchefa, Cat. #NM0222) and 0.8% plant agar (Duchefa at. N #P1001) and grown for six days.

b) Treatments with NLP

Six-day-old seedlings were transferred to a 24 multi-well plates containing 400 μl of the treatment solution in 0.5×MS. The treatment solutions were one of the following: 1) NLP533; 2) NLP551; 3) NLP578; 4) NLP600; 5) NLP620; 6) NLP699; and 7) NLP700. All suspension comprise 1 ug of Exalite and 80 ug of deltamethrin per ml of suspension. Confocal laser scanning microcopy of the NLPs with exalite in planta was performed by using either the Fluo View™ FV1000 microscope (Olympus), or Zeiss LSM 980, with 40× objective and confocal microscope settings of Ex/Em: 510/570 nm.

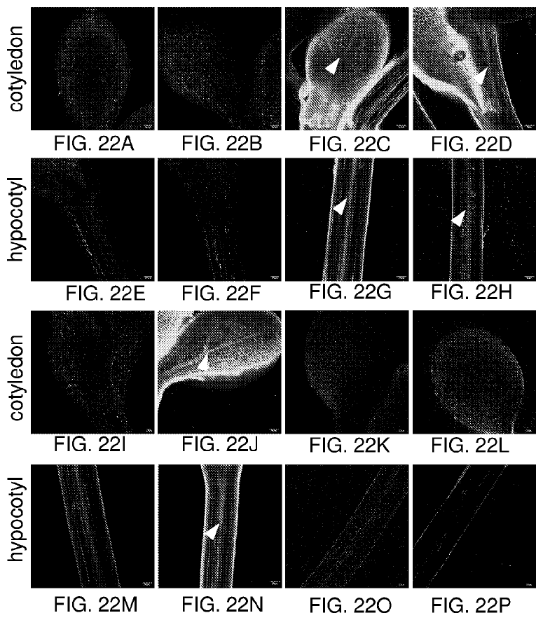

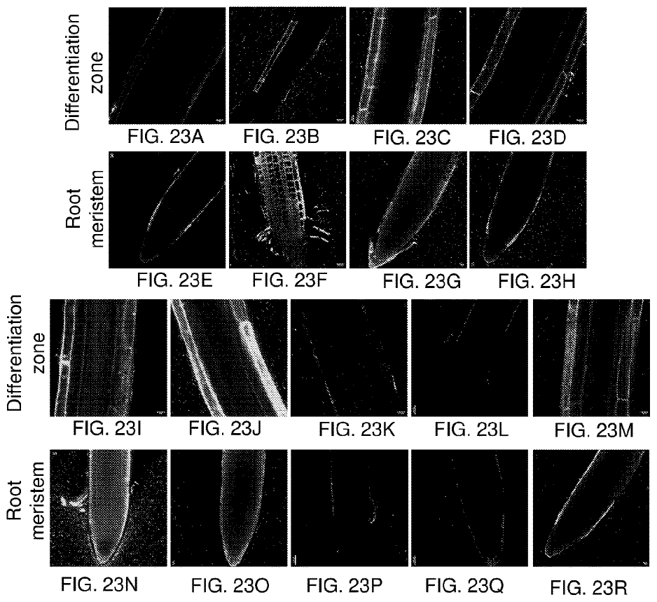

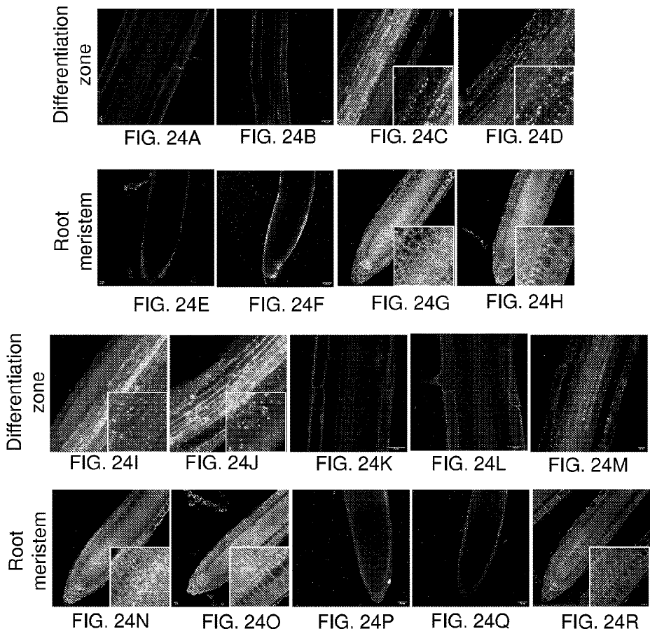

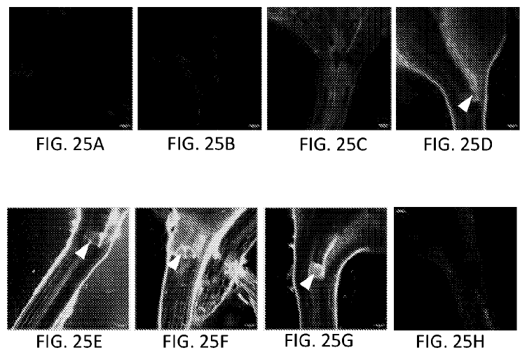

Confocal images of 5-day-old primary roots of Arabidopsis show the uptake of NLPs in the plant differentiation zone and root meristem tissues, after 30 min of incubation (FIG. 23) and after 24 h of incubation conducted in the dark to avoid dye degradation (FIG. 24 and FIG. 25). Exalite only (FIG. 23A, 23E) showed very low fluorescence in the epidermis region but not penetrating to the inner cell layers. Noticeably, NLP compositions not comprising surface modifier (NLP699 and NLP700) showed no uptake (FIGS. 23P and 23Q, resp.). NLPs comprising a surface modifier (NLP533, NLP578, NLP600, NLP620) performed better with regard to uptake as compared to NLPs not comprising a surface modifier (NLP600, NLP620).

For 24 h NLP treatments, Exalite only (FIG. 24A, 24E) showed very low fluorescence in the epidermis region but not penetrating to the inner cell layers. Noticeably, NLP compositions not comprising surface modifier (NLP699 and NLP700) showed no uptake (FIGS. 24K, 24L, 24P and 24Q). NLPs comprising a surface modifier (NLP533, NLP578, NLP600, NLP620, NL544) showed uptake in the root vasculature.

Differential accumulation within different cell and cellular compartments are visualized in FIG. 25A-25H. Fluorescence was detected with compositions NLP578, NLP580, NLP 533, and NLP 544 close to the shoot apical meristem and the leaf primordia (FIGS. 25D, 25E, 25F, and 25G). Control experiments were using water treated plants (FIG. 25A) and 1 ug/ml Exalite only (FIG. 25B), and showed no fluorescence in the roots or in aerial plant tissues analyzed. In conclusion, NLPs are capable of reaching the meristem, offering opportunities for the delivery of bioactives in this region.

Example 47. Subcellular Localization of NLPs in Arabidopsis thaliana

This example describes the subcellular localization of the different NLP compositions in Arabidopsis thaliana.

### Experimental Procedure:

### a) Seed Sterilization and Plating

Arabidopsis seeds were surface sterilized with bleach solution (30% commercial bleach) for 5 minutes, washed 5 times with sterile water, and placed at 4C for 48 hr prior to plating. Seeds were plated in squared petri dishes onto 0.5× Murashige and Skoog (MS) salt mixture including vitamins and without sucrose (Duchefa, Cat. n #M0222) and 0.8% plant agar (Duchefa Cat. n #P1001) and grown for six days in long day at 22° C.

### b) NLP Treatments

Five-day-old seedlings were transferred to 24-well plates containing 400 μl of the treatment solution. Treatment solutions were one of the following: 1) Exalite at 1 μg/ml in 0.5×MS; 2) NLP544; 3) NLP533; 4) NLP580; 5) NLP699; 6) NLP578; 7) NLP551; 8) NLP600; 9) NLP620; and 10) NLP700. All NLPs comprised 1 ug of Exalite and 80 ug of deltamethrin per ml of suspension. Incubations were carried out for 24 hr.

### c) BFA Treatments

After 24 hr of NLP treatment, 50 μM Brefeldin A (BFA) (Merk, Cat n #B5936) in the NLP containing media was added for 90 minutes.

### d) Calcofluor White Staining

Seedlings were transferred to a new well containing 1.5 μg/ml of Calcofluor white (Merk, 18909) under vacuum for five minutes and 10 minutes more in normal conditions. Then roots were visualized under the confocal microscope (FV 1000 Olympus confocal microscope) using the 40× objective and confocal microscope settings of Ex/Em: 510/570 nm for Exalite and Ex/Em: 415/465 nm for calcofluor white. The experiment was performed two times and at least 10 independent roots were observed in each condition every time.

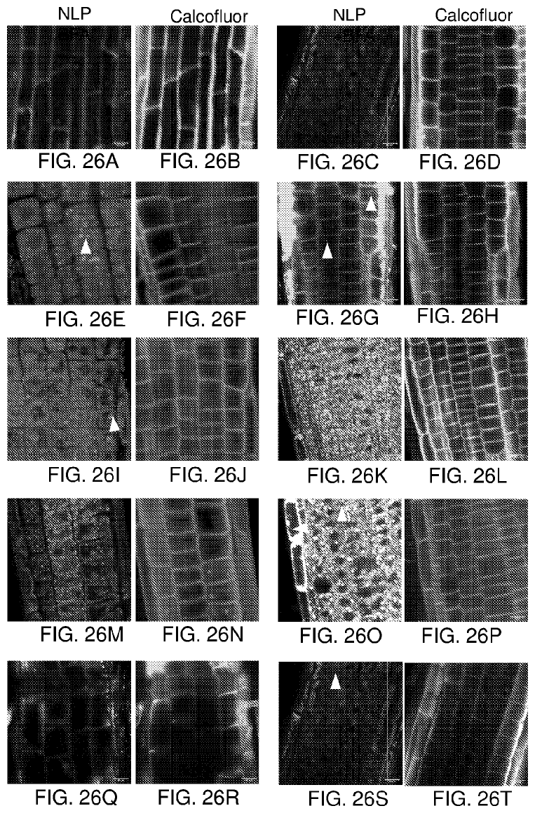

Results show the subcellular localization of the NLP suspensions tested in FIG. 26A-26T. Control experiments (FIG. 26A-26B) using 1 μg/ml Exalite and BFA only showed low fluorescence in outer tissues but no fluorescence in cytoplasm or endomembranes. By contrast, the NLP compositions tested colocalized with the endomembranes (FIG. 26C-26T).

Example 48. Uptake of NLPs in Nicotiana benthamiana Leaves by Infiltration

This example describes the detection of NLP in planta following mechanical application of NLP into the leaves using leaf infiltration in Nicotiana benthamiana to complement the results obtained by root uptake and transport in Arabidopsis (natural uptake). These experiments study the subcellular localization and dynamics of NLP entering the cell via mechanical means.

### Experimental Procedure:

### a) Leaf Infiltration Assay

Nicotiana benthamiana plants were grown for 3-4 weeks in greenhouse conditions.

On day 1, an infiltrate 0.1 ml of NLP solutions was infiltrated into the leaf using a 2.5 ml needleless? syringe. Treatment solutions were selected from 1) Exalite at 1 μg/ml in 0.5×MS; 2) non-infiltrated leaves as a control; 3) NLP544; 4) NLP551; 5) NLP578; 6) NLP600; and 7) NLP620. All NLPs comprised 1 ug Exalite and 80 ug deltamethrin per ml of suspension. Infiltrations were made at different locations near the bottom of young leaves.

### b) Visualization

On day 2, a square piece of the infiltrated leaf was cut and visualized under the confocal microscope (FV 1000 Olympus confocal microscope or Leica SP5) using a 20× objective and confocal microscope settings of Ex/Em: 510/570 nm.

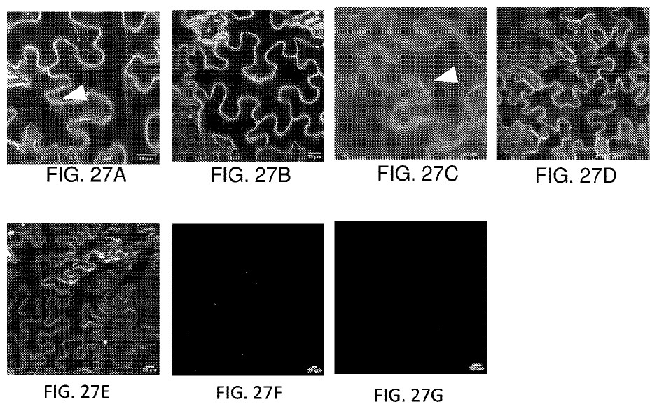

NLP were infiltrated and visualized after 24 hr. Results are shown in FIG. 27A-27G. All NLP formulations were located close to the plasma membrane (FIG. 27A-27E). However, only NLP544 and NLP578, corresponding to FIG. 27A and FIG. 27C, respectively, localized in the nuclear envelope (white arrows). Control treatments using water (FIG. 27F) and 1 ug/ml exalite (FIG. 27G) showed no visible fluorescence in the tissue.

### Example 49. Uptake of NLPs in Melon Plants by Stem Injection

This Example describes NLP uptake in melon plants upon injection into the melon plant stem. Mechanical uptake of NLP, using leaves infiltration in Nicotiana benthamiana and using Invaio's 3 mm Trecise™ injector injection in melon are different approaches to complement the results obtained by root uptake and transport in Arabidopsis thaliana (natural uptake). The rational is to check if after injection, NLP can be detected in the hypocotyls, confirming the NLP uptake.

### Experimental Procedure:

### a) Injection

Four to six-week-old Melon (Cucumis melo., var. Piel de Sapo) plants were grown in a greenhouse. On day 1, 0.1 ml of NLP solutions were injected into the stem of the melon plant. Formulations were selected from 1) NLP533; 2) NLP551; 3) water treated (control), and 4) Exalite at 1 μg/ml (control). Both NLP compositions comprised 1 ug Exalite and 80 ug DE per ml of suspension. Injections were made into the lower part of the stem of the melon plant using Invaio's 3 mm Trecise™ injector (in a 1 ml disposable syringe).

### b) Visualization

On day 2, the hypocotyls were hand cut near the injection site in transversal slides using a rectangular (new) razor blade on top of parafilm with a drop of water. Pictures were taken of the melon seedling before the cuttings were taken. Pictures were taken of the stem slides and the leaves using fluorescence red spectra filters of the stereoscope microscope Olympus SZX16 with 5× magnification.

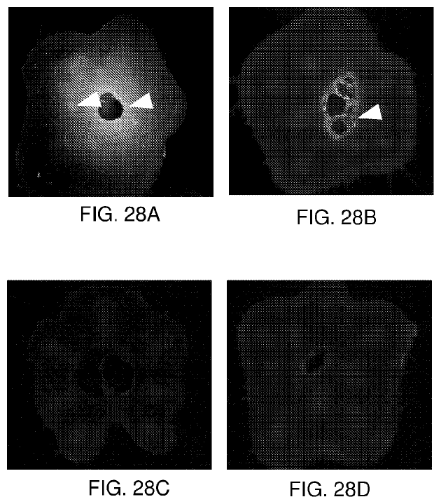

Injected NLPs are localized in the vascular system of the melon plant as evidenced by biodistribution of the fluorescent signal (FIG. 28A-28B). NLPs localized in the pith and in the vascular bundle (white arrows). Control treatments using water (FIG. 28C) and 1 ug/ml Exalite (FIG. 28D) showed no visible fluorescence in the tissue.

Example 50. NLP Corn Seed Uptake and Seed Germination after NLP Treatment

This example describes uptake of NLP by seeds and germination after treatment of seeds with NLPs.

### Experimental Procedure:

### a) Pre-Germination Assays:

B104 corn seeds were incubated in water (control) or NLP suspension (diluted 1:2 in MS 0.5×) in a 24-well plate in a volume of 200 μl. Treatment solutions were one of the following: 1) water only; 2) NLP620; and 3) NLP600. NLPs comprised 1 ug Exalite and 80 ug DE per ml of NLP suspension. Seeds were cross sectioned at 24 h and at 48 h and imaging of embryos was conducted using a stereomicroscope Olympus SZX16 (RFP filters)

### b) Germination in NLP Solution:

B104 corn seeds were incubated in water (control) or NLP suspension (diluted 1:2 in MS 0.5×) in a 24-well plate in a volume of 200 ul. Treatment solutions were one of the following: 1) water only; 2) NLP580 comprising 1 ug of Exalite and 80 ug of deltamethrin per ml of suspension. Seeds were cross sectioned at 4 days and maize root at 5 days for examination using a stereomicroscope Olympus SZX16 (RFP filters) with 5× magnification.

c) Imbibition with NLP Suspension for 24 h and Germination in Water for 5 Days:

Golden Bantam seeds were incubated in water (control) or in NLP suspension (diluted 1:2 in MS 0.5×) in a 24-well plate in a volume of 200 μl for 24 h. Treatment solutions were one of the following: 1) water only; 2) NLP580 comprising 1 ug of Exalite and 80 ug of deltamethrin per ml of suspension. Seeds were subsequently germinated in water for 5 days. Seed cross sections were analyzed using a stereomicroscope Olympus SZX16 (RFP filters) with 5× magnification.

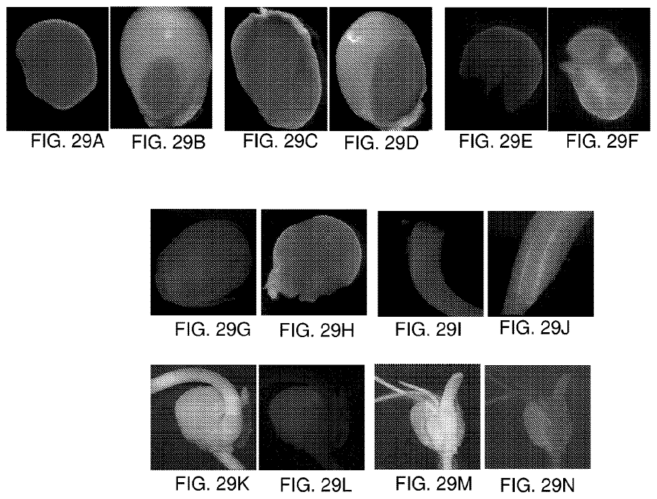

Results are shown in FIG. 29A-29N. Results show that corn seeds can germinate in NLP solution and that there was seed and root uptake of NLPs.

### Example 51. NLP Injected in Maize Plants

This example describes distribution of NLP injected in maize plants.

### Experimental Procedure:

Material: Young maize plants 7-week-old B73 inbreed line. At day 0, use 2-3-week-old corn plants and were injected with 0.1 ml of NLP suspensions in the lower part of the stem, using the TIPS injection system. An additional 0.1 ml of NLP solution was injected in the upper part of the stem close to the first leave. Treatment solutions were one of the following: 1) water only; 2) NLP487; 3) NLP646; and 4) NLP544. All NLPs comprised 1 ug of Exalite and 80 ug of deltamethrin per ml of suspension.

Plants were allowed to grow and transport to occur for 24 h in greenhouse conditions (28° C., 60% RH, L:D 16:8). After 24 h of transport 1 cm pieces were cut of the stem where the injection point is in the center of the cut section. 8% agar blocks were prepared and submerged in the stem section until the block solidified. After trimming the agarose block, vibratome was used to cut sections of the stem of approximately 200 micrometers in thickness, and they were placed on cover slides for imaging. For imaging the leaf, 2 cm sections of the leaf were excised and mounted on cover slides.

Pictures were taken using stereomicroscope Olympus SZX16 (RFP filters) with 5× magnification. Pictures were also taken of the controls and patterns of distribution were compared.

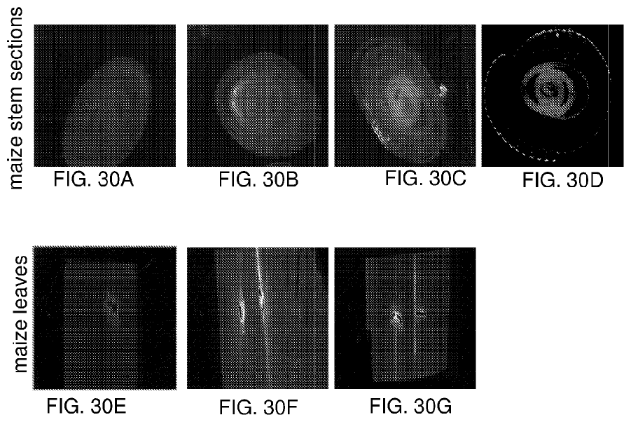

Results are shown in FIG. 30A-30G. At 24 h post injection NLPs are taken up by the stem and can be observed in the vasculature and distal tissues (e.g., leaves) of the plant.

Example 52. Evaluation of Nine NLP Formulations Comprising DE Against WCRW in a Small Scale in-Furrow Assay, and Assessment of Dose-Response

This example describes a method to assess the efficacy of NLPs comprising encapsulated deltamethrin in protecting corn plants against corn rootworm damage. Small scale (Green house 10″ pot) in-furrow treatment

### a) In-Furrow Treatment

Jumbo cotton balls were packed into the bottom of 10″ tall and 2.7″ diameter cylindrical containers. Wide straws were inserted for later use during the infestation process, then packed with ~660 g of silt loam soil. Soil was then watered with about 150 ml of water in three 50 ml increments 24 hrs before planting. A hole was made at a depth of 1.5 inch from the top of the soil. The soil was treated by pipetting 3 ml of treatments selected from 1) water; 2) Bifenture® LFC; 3) the indicated nine NLPs comprising deltamethrin at 2 mg per ml of suspension. The nine NLPs comprising deltamethrin at 2 mg per ml of suspension was prepared with the HHPH method by increasing all the lipid and surface modifier components 5-fold relative to the amount of water used. The particle size, PDI and zeta potential of these NLPs are similar to those prepared with 80 ug/ml of DE in the suspension (Table 8). The treatments were added around the edge of the hole for planting. A seed was then planted in the hole and covered with soil. Containers with seeds were then placed in the greenhouse to continue growing for 7 days until ready for infestation.

### b) WCRW Infestation

2nd instar WCRW larvae were shipped from the supplier (Crop Characteristic Inc., Farmington, MN USA) and stored at 10° C. until ready for use (less than a week). The 1^{st} and 2^{nd} infestations were conducted 7 and 14 days after seed planting, respectively. For each infestation, approximately 10 larvae were transferred to 0.5 ml microcentrifuge tube and released into soil via dropping the tube with the open mouth facing down into straws inserted when the pots were filled with soil. After 2^{nd} WCRW infestation, plants were allowed to grow for another 14 days to day 28. Some pots treated with water were not infested to act as a control for the assay to determine the plant health when not infested with WCRW. On Day 28, the fresh whole seedlings were pulled out of the containers and roots were rinsed by tap water and air-dried for 30 min on paper towel.

### c) Analysis

The fresh weight for each whole seedling was measured using a scale and recorded.

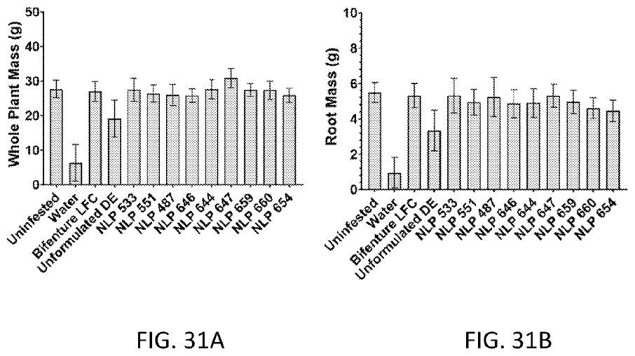

Results presented in FIG. 31 show the efficacy of 9 NLP compositions comprising 2 mg/ml DE produced with the HHPH method against WCRW tested in an in-furrow greenhouse assay. All nine compositions were effective in protecting against WCRW-induced loss of both whole plant and root mass. Also, the NLP formulations are more effective than unencapsulated (unformulated) DE at the same dose.

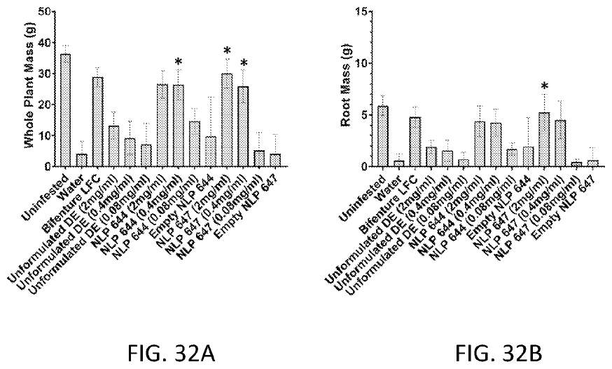

Further selected NLP compositions (NLP644 and NLP647) were produced comprising DE at 0.08-2 mg/ml using the HHPH method. Efficacy testing showed a clear dose-response effect, with the NLPs comprising 0.08 mg/ml DE being the least effective. Both the fresh whole seedling mass (FIG. 32A) and root mass (FIG. 32B) indicate the efficacy of the treatment against WCRW. Uninfested plants show normal growth as expected. Water treatment (WCRW-infested plants treated with water) did not protect the seedlings (or roots) from WCRW damage, which has less whole seedling mass and less root mass. Bifenture® was used as the positive control. The efficacy of NLP644 and NLP647 comprising deltamethrin at 0.04 and 2 mg/ml treatments matches the efficacy by Bifenture® treatment, and both showed a trend of being more effective than unencapsulated DE tested at the same concentrations.

Overall, the efficacy of NLP644 and NLP647 comprising 2 mg/ml DE match the efficacy of Bifenture® treatment, comprising 2 mg/ml Bifentrin. Moreover, the efficacy of NLP644 and NLP647 comprising 0.4 mg/ml DE matches the efficacy by Bifenture® treatment. Furthermore, the NLP compositions comprising 0.4 or 2 mg/ml DE showed a trend of being more effective than unencapsulated DE tested at the same concentrations.

### Example 53. Efficacy of NLP Formulations Against WCRW in Field Trial

This example describes the efficacy of two NLP formulations tested in a WCRW field trial in furrow treatment.

### Experimental Procedure

Field-Scale in-Furrow Treatment

### a) Field Plot Design

The experimental design was a randomized complete block with four replications. Corn rootworm field plots were either 2 or 4 rows wide and 35 feet in length. Plots were cut back to 30 feet in length after planting to facilitate root digging.

### b) Seed Planting

The field with silt loam soil was not tilled before the planting. The corn seeds were pre-bagged in the laboratory and then planted with 30-inch row spacing. Seeds were planted at a depth of 2 inches with a spacing of 6 inches between seeds (35,600 seeds per acre).

c) in-Furrow Application of NLP

Treatments were selected from 1) NLP644 formulation produced with the HHPH method, comprising deltamethrin at 2 mg per ml of the suspension; 2) empty NLP644 formulation not comprising deltamethrin; 3) unformulated deltamethrin at 2 mg/ml; 4) Bifenture® (Bifenthrin at 2 mg/ml); 5) Force® 3G (Tefluthrin at 3% w/w) treatment, or 6) water are applied in-furrow at planting with a compressed-air system built directly into the planter. All liquid formulations are applied at 6 liters per 1000 row feet. All liquid NLP formulations are applied with spray nozzles at 21 psi to deliver 5 GPA (gallon per acre) of finished spray at a tractor speed of 4 mph. Force® 3G is a granular formulation and was applied at the rate of 2.55 gram bioactive per 1000 row feet. Before the field season began, new spray nozzles are installed and calibrated with water to ensure proper application of product. For these liquid applications each row is checked for correct spray pattern prior to plot application and monitored during application to ensure that insecticides are applied correctly. The T-band spraying aims at the center of the furrow with a width of 5 inch from left to right.

### d) Data Collection

Fresh weight of the whole seedling: Randomly selected 5 seedlings from the middle 2 rows per plot for each treatment are pulled out of the soil at V2 (plants with 2 fully emerged leaves) and V5 (plants with 5 fully emerged leaves) stages. The whole seedling weight is measured using a scale and recorded after the soil on root is washed off and dried.

Root injury: Randomly selected 5 seedlings from the middle 2 rows per plot for each treatment are pulled out of the soil at R1 stage, when silk is visible outside the husks. Roots are first soaked in water for 2 to 8 hr and then washed with a hose to remove any remaining soil. Roots are evaluated for rootworm feeding injury following the Iowa State University 0 to 3 node-injury scale. Node-Injury Scale (0-3):
0—No feeding injury (lowest rating that can be given).
1—One node (circle of roots), or the equivalent of an entire node, pruned to within 1.5 inches of the stalk or soil line.
2—Two nodes pruned.
3—Three or more nodes pruned. (Highest rating that can be given).

### e) Data Analysis:

Data are analyzed with analysis of variance (ANOVA) procedures using SAS Enterprise Guide7.1. When a significant treatment effect is present pairwise comparisons made among means with an experimentwise error rate of P<0.05.

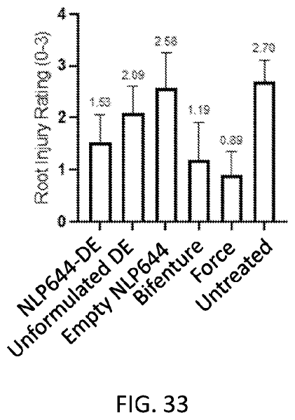

Results are shown in FIG. 33. The root injury rating ranging from 0 to 3 indicates the severity of corn root damage by the western corn rootworm (WCRW) and indicates the efficacy of the treatment against WCRW. The higher the rating, the more severe the damage is caused by WCRW. Untreated corn plants had the highest root injury rating (highest root damage from WCRW) and was the same as NLP644 without deltamethrin treatment (empty NLP644). Bifenture® LFC treated plants, as the positive control, showed similar level of root damage from WCRW as the other positive control, Force® (Tefluthrin as the active). The efficacy of NLP644 comprising deltamethrin at 2 mg/ml treatment was statistically indistinguishable (p>0.05) from Bifenture® LFC treatment. The unformulated deltamethrin at 2 mg/ml had higher root damage than the NLP644 comprising deltamethrin at 2 mg/ml treatment.

### Example 54. Compositions Comprising Fungicides

This Example describes the preparation of NLPs comprising azoxystrobin (AZO), oxathiapiprolin (OX), fludioxonil (FDN), and thiabendazole (TBZ).

### Experimental Procedure

NLPs comprising azoxystrobin (AZO), oxathiapiprolin (OX), fludioxonil (FDN), and thiabendazole (TBZ) at 80 ug/ml or 400 ug/ml were prepared with the DCM method. The physicochemical characteristics of the particles produced are shown in Table 32.

TABLE 32
NLP compositions comprising fungicides

| | | | | | | Measured | |
|---|---|---|---|---|---|---|---|
| | | | | | Active | concentra- | |
| | | | | | concen- | tion of the | |
| | | | | zeta | tration | active in the | |
| | | size | | potential | intended | formulation | Percentage |
| NLP | Name of active | (nm) | PDI | (mV) | (ug/ml) | (ug/ml)ª | encapsulation |
| NLP487 | Azoxystrobin | 198 | 0.12 | −35 | 80 | 51 | 64 |
| NLP487 | Azoxystrobin | 196 | 0.19 | −34 | 400 | 377 | 94 |
| NLP527 | Azoxystrobin | 205 | 0.12 | −29 | 80 | 35 | 43 |
| NLP527 | Azoxystrobin | 161 | 0.16 | −33 | 400 | 215 | 54 |
| NLP530 | Azoxystrobin | 200 | 0.10 | −33 | 80 | 19 | 24 |
| NLP530 | Azoxystrobin | 147 | 0.13 | −36 | 400 | 277 | 69 |
| NLP532 | Azoxystrobin | 193 | 0.13 | −34 | 80 | 26 | 33 |
| NLP532 | Azoxystrobin | 156 | 0.12 | −39 | 400 | 403 | 101 |
| NLP533 | Azoxystrobin | 195 | 0.12 | −34 | 80 | 48 | 60 |
| NLP533 | Azoxystrobin | 193 | 0.15 | −33 | 400 | 285 | 71 |
| NLP551 | Azoxystrobin | 197 | 0.17 | −36 | 80 | 58 | 72 |
| NLP551 | Azoxystrobin | 178 | 0.19 | −33 | 400 | 351 | 88 |
| NLP580 | Azoxystrobin | 177 | 0.10 | −44 | 80 | 47 | 59 |
| NLP580 | Azoxystrobin | 194 | 0.16 | −45 | 400 | 282 | 71 |
| NLP600 | Azoxystrobin | 194 | 0.13 | 42 | 80 | 50 | 63 |
| NLP600 | Azoxystrobin | 153 | 0.13 | −40 | 400 | 409 | 102 |
| NLP603 | Azoxystrobin | 184 | 0.08 | −43 | 80 | 38 | 48 |
| NLP603 | Azoxystrobin | 154 | 0.10 | −42 | 400 | 444 | 111 |
| NLP608 | Azoxystrobin | 184 | 0.14 | −42 | 80 | 53 | 66 |
| NLP608 | Azoxystrobin | 172 | 0.14 | −39 | 400 | 314 | 78 |
| NLP487 | Fludioxonil | 165 | 0.13 | −32 | 80 | 16 | 20 |
| NLP530 | Fludioxonil | 141 | 0.15 | −37 | 80 | 15 | 19 |
| NLP533 | Fludioxonil | 151 | 0.16 | −38 | 80 | 14 | 18 |
| NLP580 | Fludioxonil | 138 | 0.11 | −45 | 80 | 13 | 16 |
| NLP600 | Fludioxonil | 145 | 0.14 | −40 | 80 | 16 | 19 |
| NLP603 | Fludioxonil | 143 | 0.17 | −40 | 80 | 15 | 19 |
| NLP608 | Fludioxonil | 145 | 0.13 | −41 | 80 | 21 | 27 |
| NLP683 | Fludioxonil | 152 | 0.20 | −35 | 80 | 33 | 42 |
| NLP687 | Fludioxonil | 110 | 0.19 | −32 | 80 | 70 | 88 |
| NLP689 | Fludioxonil | 165 | 0.21 | −38 | 80 | 45 | 56 |
| NLP487 | Oxathiapiprolin | 185 | 0.13 | −30 | 80 | 20 | 25 |
| NLP533 | Oxathiapiprolin | 209 | 0.15 | −34 | 80 | 30 | 38 |
| NLP551 | Oxathiapiprolin | 179 | 0.07 | −34 | 80 | 26 | 32 |
| NLP580 | Oxathiapiprolin | 188 | 0.12 | −44 | 80 | 36 | 45 |
| NLP600 | Oxathiapiprolin | 185 | 0.13 | −30 | 80 | 4 | 4 |
| NLP608 | Oxathiapiprolin | 186 | 0.12 | −31 | 80 | 5 | 6 |
| NLP487 | Thiabendazole | 161 | 0.15 | −30 | 80 | 21 | 26 |
| NLP533 | Thiabendazole | 156 | 0.16 | −43 | 80 | 21 | 26 |
| NLP551 | Thiabendazole | 152 | 0.07 | −47 | 80 | 21 | 26 |
| NLP580 | Thiabendazole | 149 | 0.12 | −46 | 80 | 21 | 26 |
| NLP600 | Thiabendazole | 168 | 0.14 | −31 | 80 | 20 | 24 |
| NLP608 | Thiabendazole | 159 | 0.15 | −28 | 80 | 20 | 25 |
| NLP683 | Thiabendazole | 99 | 0.24 | −32 | 80 | 60 | 75 |
| NLP687 | Thiabendazole | 85 | 0.20 | −31 | 80 | 58 | 73 |
| NLP689 | Thiabendazole | 63 | 0.22 | −31 | 80 | 61 | 76 |

^{a}Actual load determined by RP-HPLC relative to the respective fungicide standard

### Example 55. The Anti-Fungal Activity of AZO in NLPs

This example describes a method to measure the anti-fungal activity of azoxystrobin (AZO) against Fusarium using a resazurin based assay.

### Experimental Procedure:

The purpose of this assay was to quantify the effect of encapsulation of AZO, an antifungal agent, in NLP particles on its efficacy against a fungal pathogen (e.g., Fusarium oxysporum). Encapsulated AZO was compared to unencapsulated counterparts to determine if there is any change in efficacy. Formulations were tested in a 96-well plate and incubated with F. oxysporum conidia (spores) for 24 hr, after which resazurin dye was added. After 4 hr of incubation the color change of resazurin from blue to a fluorescent pink due to fungal respiration was assessed spectrophotometrically and the percent inhibition of respiration, as a measure of fungal growth, was determined by comparison to a conidia-only negative control. NLP particles with no fungicide loaded (empty NLPs) were also tested for each formulation to account for any potential inhibition caused by the NLP components.

Fusarium oxysporum was cultured on 50% potato dextrose broth (PDB) agar plates. Using a pipette tip, a small mycelium aliquot was transferred to a 50-mL flask containing carboyxymethyl cellulose medium (CMC). After about 10 days, conidia were harvested by filtering the culture over a cheesecloth, following by centrifugation at 7,500 rpm. Conidia were counted in the resuspended pellet using a hemocytometer, and diluted to 1×10⁶ conidia/mL in 20% glycerol solution, from which a 1×10⁵ conidia/mL working solution was prepared.

An AZO stock solution of 10 ug/mL was prepared in 50% PDB, from which a dilution series was prepared in a 96-well microtiter plate. NLPs were similarly diluted to match the free AZO concentrations. A 50 μL AZO or NLP solution was mixed with a 50 μL aliquot of conidia suspension. Controls were AZO only, NLP only, conidia without AZO or NLP and media only. Plates were incubated at 25° C. for 24 hr. After 24 h, 10 μL of PrestoBlue reagent was added to each well of the plate, followed by 4 h incubation, after which the fluorescence was read at 570/620 nm with a read height of 7 mm.

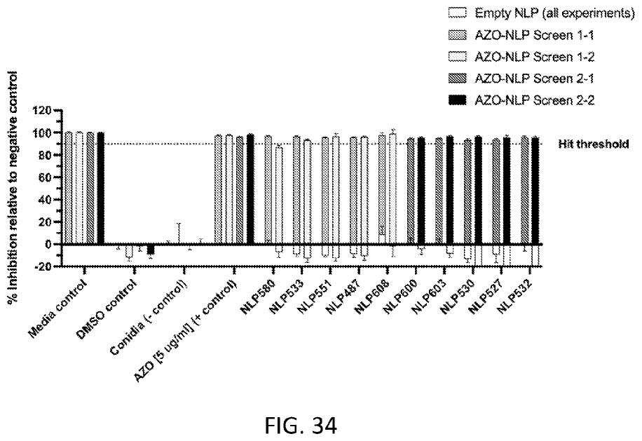

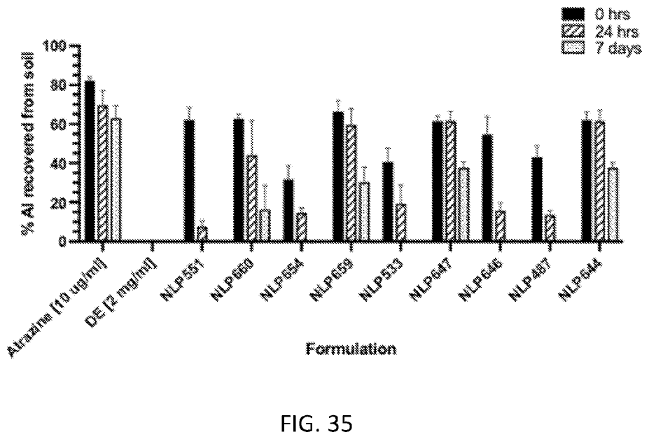

The effective concentration of AZO encapsulated by the various NLPs is shown in Table 33. Results show that NLP encapsulation of AZO does not reduce AZO activity since encapsulated AZO was as effective as unformulated AZO (FIG. 34). The minimum amount of azoxystrobin required for >90% inhibition of Fusarium in the resazurin assay compared to the negative controls (DMSO) was 5 ug/ml. NLPs comprising less than or equal to 5 ug/ml of azoxystrobin were also effective in inhibiting Fusarium, while the NLPs without azoxystrobin (empty NLP) did not inhibit Fusarium.

TABLE 33
Batches and the concentrations of azoxystrobin
in the NLPs comprising azoxystrobin that were
used in the resazurin Fusarium inhibition assay

| | | AZO in | Effective concentration |
|---|---|---|---|
| | | formulation | of AZO in assay |
| NLP-batch | Screen | (ug/ml)^{a} | (ug/ml) |
| NLP608-1 | Screen 1-1 | 48.21 | 3.01 |
| NLP487-1 | Screen 1-1 | 54.24 | 3.39 |
| NLP551-1 | Screen 1-1 | 60.78 | 3.80 |
| NLP533-1 | Screen 1-1 | 59.73 | 3.73 |
| NLP580-1 | Screen 1-1 | 59.15 | 3.70 |
| NLP608-2 | Screen 1-2 | 66.989 | 4.19 |
| NLP487-2 | Screen 1-2 | 53.806 | 3.36 |
| NLP551-2 | Screen 1-2 | 67.227 | 4.20 |
| NLP533-2 | Screen 1-2 | 27.742 | 1.73 |
| NLP580-2 | Screen 1-2 | 16.623 | 1.04 |
| NLP532-1 | Screen 2-1 | 41.176 | 2.57 |
| NLP527-1 | Screen 2-1 | 45.308 | 2.83 |
| NLP530-1 | Screen 2-1 | 29.06 | 1.82 |
| NLP603-1 | Screen 2-1 | 62.324 | 3.90 |
| NLP600-1 | Screen 2-1 | 59.064 | 3.69 |
| NLP532-2 | Screen 2-2 | 21.135 | 1.32 |
| NLP527-2 | Screen 2-2 | 62.773 | 3.92 |
| NLP530-2 | Screen 2-2 | 25.521 | 1.60 |
| NLP603-2 | Screen 2-2 | 59.751 | 3.73 |
| NLP600-2 | Screen 2-2 | 37.472 | 2.34 |

^{a}Determined by RP-HPLC relative to an AZO standard.

### Example 56. Soil Mobility of NLPs Comprising an Antifungal Agent

This example describes an assay to assess the mobility of NLP comprising azoxystrobin in soil.

### Experimental Procedure:

### 1) Soil Retention Assay.

This Example uses a soil suspension where a non-saturating amount of NLP comprising DE is mixed with the soil suspension and the leachate is examined.

### a) Preparation of Soil Leachates

The NLP formulations of Table 32, comprising AZO (80 μg/ml) and optionally Exalite (1 μg/ml) are tested for soil binding. For each formulation, three Eppendorf tubes are filled with 0.27 g soil (Silt loam soil, “Iowa Fayette”, purchased from Agvise) each. An aliquot of 1.6 mL artificial rain (AR) comprising 0.11% CaCl2 in Milli-Q ultrapure water, pH 7.0, is added to each soil tube. Subsequently, an aliquot of 27.5 μL NLP formulation is added to each of three tubes per NLP formulation.

For the AZO controls, a 2.75 μL aliquot from an azoxystrobin stock solution (800 μg/ml in Dichloromethane (DCM) is added to each of 3 samples of soil in AR. For the Exalite controls, an aliquot of 2.75 μL Exalite working solution (10 μg/ml) is added to each of three samples of soil in AR. For the “water” control, 5.4 g soil is weighed into a 50-mL centrifuge tube and 32 mL AR is added. Tubes are incubated for 1 hr, centrifuged at 1000 g for 5 min and the resultant supernatant is the soil water solution. An aliquot of 1.6 mL soil water solution is added to a 2-mL tube. An aliquot of 27.5 μL of NLP sample is added in triplicate.

All tubes are then placed in a microtube holder and incubated on the horizontal shaker for 1 hr at 100 rpm. The soil in the soil-containing samples is precipitated by centrifugation, and 1 ml of the supernatant (the leachate) is removed.
b) Calculation of the Percent NLP Leachate from Exalite Levels in the Leachate

An aliquot of 200 μL NLP leachate sample or soil water sample is pipetted into each well of a black-walled 96-well plate with 2 technical replicates per sample. Fluorescence is read using a Biotek plate reader setting an Excitation wavelength of 510 nm, and an emission wavelength of 570 nm. The percent detachment is calculated by: % detachment=(F_SL−N)/F_SW*100 where F_SL is the average fluorescence of the soil leachate sample, N is the average fluorescence of the negative control (baseline fluorescence) and F_SW is the average fluorescence of the soil water sample.

c) Calculation of Percent NLP Leachate from AZO Levels in the Leachate

AZO is extracted from the leachates under agitation with acetonitrile. Samples are mixed well and centrifuged to remove any soil particles before transfer to an HPLC vial. Final determination of azoxystrobin in the extracts is made by high performance liquid chromatography with triple quadrupole mass spectrometric detection (LC-MS/MS) using ESI in the positive ionization mode. Samples are analyzed at a flow rate: 0.7 mL/min, with a mobile phase solvent A of 10 mM ammonium acetate in water/methanol (4:1 v/v), and solvent B of 0.1% formic acid in methanol/acetonitrile (1:1 v/v), applying a gradient from 5% B to 95% B in 8 min, using a Waters Sunfire® 50×2.1 mm, 5 μm column and a Sciex 4000 Q-Trap triple quadrupole mass spectrometer with analyst 1.6.3 software for detecting and quantitating deltamethrin in the samples.

The percent NLP detachment is calculated by comparing the soil leachate result with the azoxystrobin concentration in the original NLP formulation sample: % detachment=( [symbol] [AI] [symbol] _SL*D)/( [symbol] [AI]_U*1000), where [AI]_SL is the average concentration of azoxystrobin in the soil leachate in ng/mL, [symbol] [AI]_U is the average concentration of azoxystrobin in the original NLP formulation sample in ug per mL of suspension, and D is the dilution factor (total volume/volume of sample), in this case, D=(V_U+V_AR)/V_U=59.18182.

Results show that some NLP compositions enable better movement of the fungicide in the soil compared to the unencapsulated fungicide.

### Example 57. Antifungal Activity of AZO in NLP Soil Leachates

This Example describes the antifungal activity in soil leachates of NLPs comprising a fungicide towards the fungus F. oxysporum.

### Experimental Procedure:

The purpose of this assay was to quantify the effect antifungal agents against a fungal pathogen (e.g., Fusarium oxysporum). Formulations are tested in a 96-well plate and incubated with F. oxysporum conidia (spores) for 24 hr, after which resazurin dye is added. After 4 hr of incubation the color change of resazurin from blue to a fluorescent pink due to fungal respiration is assessed spetrophotometrically and the percent inhibition of respiration, as a measure of fungal growth, is determined by comparison to a conidia only negative control. NLP particles with no fungicide loaded (empty NLPs) are also tested for each formulation to account for any potential inhibition caused by the NLP components. Soil leachates from columns that were not loaded with any formulation are tested to ensure no soil components or microbial contaminants from the soil contribute to the change in dye color.

Fusarium oxysporum is cultured on 50% potato dextrose broth (PDB) agar plates. Using a pipette tip, a small mycelium aliquot is transferred to a 50-mL flask containing carboyxymethyl cellulose medium (CMC). After about 10 days, conidia are harvested by filtering the culture over a cheesecloth, following by centrifugation at 7,500 rpm. Conidia are counted in the resuspended pellet using a hemocytometer, and diluted to 1×10⁶ conidia/mL in 20% glycerol solution, from which a 1×10⁵ conidia/mL working solution is prepared.

An AZO stock solution of 10 μg/mL is prepared in 50% PDB, from which a dilution series was prepared in a 96-well microtiter plate. NLPs are similarly diluted to match the free AZO concentrations. The leachates from the soil columns to which the NLPs are added are used as is without any further dilution. A 50 μL AZO, NLP solution, or the leachate from the soil column is mixed with a 50 μL aliquot of conidia suspension. Controls are AZO only, NLP only (no active encapsulated), soil leachate from a column to which no NLP or AZO has been added, conidia without AZO or NLP and media only. Plates are incubated at 25° C. for 24 hr. After 24 h, 10 μL of PrestoBlue reagent is added to each well of the plate, followed by 4 h incubation, after which the fluorescence is read at 570/620 nm with a read height of 7 mm.

Results show that some NLP compositions enable better movement of the fungicide in the soil compared to the unencapsulated fungicide. The leachates from the NLPs that improve AZO mobility in soil have higher AZO concentration, and they confer higher anti-fungal activity compared to the leachate using unencapsulated AZO.

### Example 58. NLP Compositions Comprising Novel Surface Modifiers

The Example describes the characteristics of NLP formulations with novel surface modifiers.

### Experimental Procedure:

### Preparations of NLPs Comprising Novel Surface Modifiers

Three stock solutions are prepared (Table 34-36). The stock solutions from Tables 34-36 are combined to make the Oil Phase Stock Solution of Table 37. The oil phase stock solution is then added to a water phase stock solution, containing deionized water and a surface modifier, at a ratio of 5 mL:50 g, Table 38. The Table 38 blend is emulsified by sonicating at 50% for 1 minute using a SONICS Ultrasonic Processor (Part No. VCX750), Ultrasonic Converter (Part No. CV334), and a 0.5″ diameter standard probe (Part No. 630-0220. DCM is then driven off by stirring the emulsion at 400 rpm for 2 hr. The target concentration of the bioactive is 162 ug/mL, though variation can occur during the evaporation of DCM. Table 39 lists the surface modifiers used in Table 38.

TABLE 34
Oil stock solution

| Component | Target volume (mL) | Target Mass (g) |
|---|---|---|
| Dichloromethane (DCM) | 50 | |
| Sunflower oil | | 0.375 |

TABLE 35
Bioactive stock solution

| Component | Target volume (mL) | Target Mass (g) |
|---|---|---|
| Dichloromethane (DCM) | 50 | |
| Bifenthrin | | 0.25 |

TABLE 36
Surfactant stock solution

| Component | Target volume (mL) | Target Mass (g) |
|---|---|---|
| Dichloromethane (DCM) | 50 | |
| Sunflower lecithin | | 0.375 |

TABLE 37
Oil phase stock solution (combining
ingredients from Tables 34-36)

| Component | Target volume (mL) |
|---|---|
| Oil phase stock solution | 6.64 |
| Surfactant stock solution | 5.28 |
| AI stock solution (e.g. bifenthrin) | 6.40 |
| Dichloromethane (DCM) | 1.68 |

TABLE 38
NLP blend formulation

| Component | Target volume (mL) | Target Mass (g) |
|---|---|---|
| Deionized water | | 49.75 |
| Surface modifier | | 0.25 |
| Oil phase stock solution | 5.0 | |

TABLE 39
Surface modifiers

| Surface modifier | Class of chemistry | CAS# |
|---|---|---|
| Atlox ™ Metasperse | Modified Styrene Acrylic | Unknown |
| 500L | Polymer | |
| STEP-FLOW ® 5000 | Anionic Modified | Unknown |
| | Styrene/Acrylic Copolymer | |
| STEP-FLOW ® 4000 | Non-ionic Acrylic | 119724-54-8 |
| | Copolymer | |
| STEP-FLOW ® 3000 | Anionic Acrylic | 119724-54-8 |
| | Copolymer | |
| NINEX ® MT-615 | Fatty Acid Ethoxylate | 61791-00-2 |
| STEPFAC ® TSP-PE K | Tristyrlphenol Ethoxylate | 163436-84-8 |
| | Phosphate Ester Potassium | |
| | Salt | |
| TOXIMUL ® 8240 | Castor Oil Ethoxylate | 61791-12-6 |
| TOXIMUL ® 8241 | Castor Oil Ethoxylate | 61791-12-6 |
| AMMONYX ® CETAC- | Cetyl Trimethyl | 112-02-7 |
| 30 | Ammonium Chloride | |
| BIO-SOFT ® N-411 | Linear Isopropylamine | 48584-24-7 |
| | Dodecylbenzene Sulfonate | |
| NINEX ® MT-603 | Fatty Acid Ethoxylate | 61791-00-2 |
| BIO-SOFT ® N91-8 | Linear Alcohol Ethoxylate | 68439-46-3 |
| Zonix ™ Biofungicide | Rhamnolipid Biosurfactant | 4348-76-8 |

A total of 17 modifications, Table 40, were blended consisting of 13 surface modifiers of various chemistries with four modifications containing more than one surface modifier at a 1:1 or 1:1:1 ratio. Table 40 looks at pH, particle size and zeta potential of the NLP formulation blends with different surface modifiers.

TABLE 40
Characteristics of the NLPs produced with the surface modifiers listed in in Table 39.

| | | | | Particle | Zeta | | Particle | Zeta | Bifenthrin % |
|---|---|---|---|---|---|---|---|---|---|
| | Surface | Bifenthrin | pH | Size | Potential | pH | Size | Potential | Recovered |
| NLP^{a} | modifier | (ug/mL), | day | (nm) | (mV) | day | (nm) | (mV) | from soil |
| (sample) | (SM) | day 0 | 0 | day 0 | day 0 | 7 | day 7 | day 7 | column^{b} |
| NLP677 | BIO-SOFT | 222.7 | 4.66 | 288.15 | −27.4 | 4.44 | 190.21 | −20.46 | 2.63 |
| | N91-1 | | | | | | | | |
| NLP671 | TOXIMUL | 171.2 | 5.51 | 172.28 | −6.93 | 5.34 | 185.93 | 13.09 | 5.74 |
| | 8241 | | | | | | | | |
| NLP672 | BIO-SOFT | 231.6 | 4.16 | 61.8 | −99.93 | 4.02 | 55.21 | −60.33 | 8.3 |
| | N−411 | | | | | | | | |
| NLP664 | Step-flow | 166.6 | 5.56 | 207.14 | −27.94 | 5.14 | 211.13 | −29.75 | 10.8 |
| | 4000 | | | | | | | | |
| NLP670 | Step-flow ® | 166.6 | 6.25 | 165.86 | −8.08 | 6.24 | 176.78 | −27.13 | 11.32 |
| | 1500 | | | | | | | | |
| NLP667 | STEPFAC | 191.7 | 7.7 | 169.35 | −63.1 | 7.37 | 154.11 | −70.44 | 11.77 |
| | TSP-PE K | | | | | | | | |
| NLP674 | Step-flow ® | 176.0 | 8.2 | 184.71 | −53.03 | 7.6 | 169.97 | −61.21 | 13.49 |
| | 3000 | | | | | | | | |
| NLP668 | TOXIMUL | 172.6 | 14.91 | 162.22 | −23.83 | 4.69 | 175.52 | −33.04 | 18.32 |
| | 8240 | | | | | | | | |
| NLP678 | Step-flow ® | 178.2 | 8.06 | 188.55 | −66.16 | 7.86 | 176.32 | −59.53 | 23.69 |
| | 5000 | | | | | | | | |
| NLP680 | ZONIX 8.5% | 299.9 | 6.56 | 173.08 | −35.88 | 6.25 | 40.51 | −35.34 | 25.36 |
| | Rhamnolipid | | | | | | | | |
| NLP676 | TOXIMUL | 263.0 | 7.85 | 117.07 | −35.69 | 7.64 | 109.17 | 0.64 | 28.48 |
| | 8241, Atlox | | | | | | | | |
| | 500L | | | | | | | | |
| NLP663 | Atlox 500L | 168.8 | 8.28 | 254.3 | −64.43 | 8.04 | 215.63 | −64.86 | 30.83 |
| NLP669 | Step-flow ® | 282.9 | 7.81 | 135.03 | −38.88 | 7.56 | 127.97 | −49.81 | 30.93 |
| | 5000, | | | | | | | | |
| | TOXIMUL | | | | | | | | |
| | 8241 | | | | | | | | |
| NLP679 | Step-flow ® | 218.7 | 7.68 | 111.17 | −37.12 | 7.35 | 102.8 | −38.54 | 34.71 |
| | 5000, | | | | | | | | |
| | TOXIMUL | | | | | | | | |
| | 8241 | | | | | | | | |
| NLP675 | Step-flow ® | 208.6 | 7.81 | 151.65 | −55.89 | 7.41 | 144.52 | −57.62 | 43.29 |
| | 5000, Atlox | | | | | | | | |
| | 500L | | | | | | | | |
| NLP673 | NINEX MT- | 134.8 | 6.33 | 31.21 | N/A | 6.49 | 41.23 | NA | 63.7 |
| | 603 | | | | | | | | |
| NLP665 | NINEX ® | 166.3 | 5.71 | 212.9 | −16.69 | 5.93 | 209.61 | −25.21 | NA |
| | MT-615 | | | | | | | | |
| Bifenthrin | None | 164.3 | | | | | | | 0.05 |
| in water | | | | | | | | | |

^{a}Compositions were prepared with the DCM method
^{b}Determined by RP-HPLC relative to a Bifenthrin standard

### Example 59. Soil Mobility of NLPs Comprising New Surface Modifiers

This example describes the effect of incorporation of the new surface modifiers on NLP mobility in soil, and how NLP encapsulation alters the soil-binding properties of bifentrin in soil.

### Experimental Procedure:

A disposable column fitted with a 50 μm frit was packed with desired soil (silt loam, clay, sandy mix, low pH, high pH, etc.). The formulated bioactive, e.g. NLPs comprising a bioactive, e.g. comprising deltametrin, is diluted [per the label instructions for the product], and a pre-determined amount is loaded to the top of the soil column that is pre-saturated with rainwater. A predetermined amount of artificial rain (0.11% CaCl2), which is a standard in OECD guidelines instead of DI water, is passed through the soil bed. The eluent is analyzed for bioactive content using an appropriate analytical method (typically HPLC). Success is 40-50% of input material leaching out through 2″ column containing silt loam.

Specifically, a gravity flow column was prepared by installing a 49.4 mm, 55 μm stainless steel disc into a 300 mL gravity flow column (e.g. Cat #: 12-0280, Marvelgent Biosciences or equivalent). A 50.0 g+/−0.01 g soil was added to the column. The column was soaked in 0.01M artificial rainwater, allowing artificial rainwater to enter column from the luer at the bottom of the column to prevent soil disturbance. The column was secured to a ring stand via a clamp and excess artificial rainwater was collected in waste beaker until drop rate falls below 1 drop/min. The sample was prepared and the active ingredient concentration was determined. The column was loaded with 5 mL of diluted active ingredient dropwise using a serological pipette being careful not to disturb the soil layer. A 45 mL aliquot of artificial rainwater was added to the column. Stopper was removed from bottom of column to initiate rainwater flow through column. The leachate was collected and the concentration of the active ingredient was analyzed using HPLC-UV or other appropriate analytical method by comparison to the appropriate standard.

A total of 18 formulations in Table 40 were screened in the soil mobility assay. The percentage leaching from soil is indicated in the right column of Table 40. In total, 14 of the 18 formulations had greater than 10% soil mobility (average of the two replicates). Only 0.5% of unformulated bifenthrin could be recovered from soil showing the advantage of encapsulating bifenthrin in NLP.

### Example 60. NLP Compositions Facilitating Enhanced Deltamethrin Loading

This example describes the production of NLP compositions comprising increased concentrations of deltamethrin.

### Experimental Procedure:

Compositions were generated as indicated below (Table 41) using the HHPH method.

Measuring DE concentration in the formulation: The NLP solutions were passed through a 1 μm filter to remove any large particles. An aliquot of 0.1 ml of the NLP solution was diluted with 0.9 ml of acetonitrile, vortexed to mix completely, sonicated for 2 min at 24° C., and centrifuged at 14,500 g for 15 min at 4° C. The supernatant was then loaded into an HPLC vial for measuring DE concentration using HPLC-UV detector. Calibration standards at 0, 1, 5, 10, 50, 100, 500, 1000 ug/ml of DE were prepared, and the peak surface areas were plotted as a function of concentration. The unknown DE concentration in the diluted NLP samples was then determined by reference to that standard. Table 41, second column records the DE encapsulated in the indicated NLP formulations.

TABLE 41
Physicochemical characteristics of NLPs comprising elevated DE levels.

| | | | | | | weight | | | |
|---|---|---|---|---|---|---|---|---|---|
| | | | | | | ratios | | | |
| | DE | | | | | (NP:PL: | Dia- | | Zeta |
| NLP | Encaps. | | | | co- | SM:co- | meter | | po- |
| # | (ug/mL)^{a} | NP | PL | SM | solvent | solvent) | (nm) | PDI | tential |
| NLP694 | 10532.1 | SFb | SF | Atlox | n/a | 91:0:7:2 | 344.4 | 0.343 | −46.6 |
| | | oil | lecithin | 500L | | | | | |
| NLP696 | 9041.6 | SF | SF | Atlox | n/a | 55:0:44:1 | 259.2 | 0.124 | −35.2 |
| | | oil | lecithin | 500L | | | | | |
| NLP697 | 5843.0 | SF | SF | Atlox | n/a | 55:0:44:1 | 288.4 | 0.234 | |
| | | oil | lecithin | 500L | | | | | |
| NLP698 | 13613.3 | SF | SF | Atlox | Genagen | 25:25:41: | 641.6 | 0.418 | −36 |
| | | oil | lecithin | 500L | 4166 | 9 | | | |
| NLP701 | 14845.6 | SF | SF | Atlox | Genagen | 68:23:7:2 | 163.4 | 0.074 | −41.1 |
| | | oil | lecithin | 500L | 4166 | | | | |
| NLP702 | 14879.3 | SF | SF | Atlox | Genagen | 82:9:7:2 | 220.7 | 0.196 | −50.2 |
| | | oil | lecithin | 500L | 4166 | | | | |
| NLP703 | 14508.8 | SF | SF | Atlox | Genagen | 68:23:7:2 | 159.9 | 0.095 | −42.3 |
| | | oil | lecithin | 500L | 4166 | | | | |
| | | | powder | | | | | | |
| NLP704 | 11467.1 | SF | SF | Atlox | Genagen | 82:9:7:2 | 217.1 | 0.215 | −54.9 |
| | | oil | lecithin | 500L | 4166 | | | | |
| | | | powder | | | | | | |
| NLP705 | 18569.9 | SF | SF | Atlox | Genagen | 67:22:7:4 | 149.5 | 0.095 | −43.3 |
| | | oil | lecithin | 500L | 4166 | | | | |
| NLP706 | 16534.4 | SF | SF | Atlox | Genagen | 64:21:7:8 | 141 | 0.061 | −42.5 |
| | | oil | lecithin | 500L | 4166 | | | | |
| NLP707 | 4909.7 | SF | SF | n/a | Genagen | 67:11:22: | 210.5 | 0.16 | −20.6 |
| | | oil | lecithin | | 4166 | 0 | | | |
| NLP708 | 18251.4 | SF | SF | Atlox | Genagen | 67:22:7:4 | 144.3 | 0.0953 | −43.7 |
| | | oil | lecithin | 500L | NBP | | | | |
| NLP709 | 18185.9 | SF | SF | Atlox | Genagen | 67:22:7:4 | 151.9 | 0.106 | −56.5 |
| | | oil | lecithin | 500L | PA | | | | |
| NLP710 | 18636.3 | SF | SF | Atlox | Genagen | 67:22:7:4 | 165.5 | 0.164 | −61.98 |
| | | oil | lecithin | 500L | 4296 | | | | |
| NLP711 | 16245.1 | SF | SF | Atlox | Stepan | 67:22:7:4 | 223.1 | 0.230 | −55.9 |
| | | oil | lecithin | 500L | 108 | | | | |

^{a}DE encapsulation determined by RP-HPLC relative to a DE standard
^{b}SF, sunflower

### Example 61. Encapsulation of Pelargonic Acid in NLPs

This example describes methods and components for producing NLPs comprising pelargonic acid.

### Experimental Procedure:

NLPs comprising pelargonic acid were produced with the high pressure homogenization method akin to the HHPH method described in Example 2, except that the oil and water phases were not heated and mixing was carried out at room temperature. The lipid phase contained components as indicated in Table 14. The aqueous phase contained components as indicated in Table 1. Both the lipid phase and aqueous phase were mixed for 5 minutes at 10,000 RPM using an IKA T25 digital ULTRA-TURRAX with an S25N-18G dispersing tool. Once the formulation appeared homogenous with no visible solids, it was subject to three passes through an LV-1 high pressure homogenizer at 15,000 PSI. The formulation was then filtered using a 1 μm glass fiber syringe filter. Particle size, polydispersity index (PDI) and zeta potential were measured using a Malvern Panalytical Zetasizer Ultra Red Label. NLP compositions produced are shown in Table 42.

TABLE 42
NLP compositions comprising pelargonic acid^{a}

| | | | | Pelargonic | Weight | Day 0, | | Day 0, | Day 7, | |
|---|---|---|---|---|---|---|---|---|---|---|
| | | | | acid | ratios of | Size | Day 0, | ZP | Size | Day 7, |
| NLP # | NP | PL | SM | (μg/ml) | NP:PL:SM | (nm) | PDI | (mV) | (nm) | PDI |
| NLP907-1 | SF | SF | N/A | 50 | 33.3:66.6 | 119 | 0.07 | — | 173 | 0.4 |
| | oil | Lecithin | | | | | | | | |
| NLP907-2 | SF | SF | N/A | 100 | 33.3:66.6 | 121 | 0.04 | −30.8 | 226 | 0.64 |
| | oil | Lecithin | | | | | | | | |
| NLP908 | SF | Tween | N/A | 100 | 71.4:28.6 | 168 | 0.03 | — | 159 | 0.05 |
| | oil | 20 | | | | | | | | |
| NLP919-1 | SF | SE | Rhamnolipid | 100 | 29.4:58.8: | 101 | 0.07 | −30.2 | 91 | 0.12 |
| | oil | Lecithin | | | 11.8 | | | | | |
| NLP909-2 | SF | SF | Rhamnolipid | 200 | 29.4:58.8: | 140 | 0.07 | −30.9 | 140 | 0.16 |
| | oil | Lecithin | | | 11.8 | | | | | |

^{a}SF, sunflower; NP, non-polar lipid; PL, polar lipid; SM, surface modifier

### Example 62. NLPs Comprising Pelargonic Acid for Use as a Pre-Emergent Herbicide

Pelargonic acid is a non-selective post-emergent contact herbicide that causes burn-down of green tissues. This example describes the use of NLPs comprising pelargonic acid as a pre-emergent herbicide upon soil application.

### Experimental Procedure:

### a) Greenhouse Experimental Design

NLPs comprising pelargonic acid are prepared as described in example 61. Greenhouse experimental design closely follows what is described in Zhao et. al., Sci Rep. 2017; 7:12690. In brief, the greenhouse conditions are maintained as follows: 30±2/21±2° C. (day/night), 75±5% relative humidity, 14/10 h (light/dark), achieved with natural light and augmented with supplemental lights. Setaria viridis, Echinochloa crus-galli, Eleusine indica, Digitaria sanguinalis, and Cyperus rotundus are the monocot weed species used, and Cirsium arvense, Amaranthus retroflexus, Abutilon theophrasti, Portulaca oleracea, Solanum nigrum, Eclipta prostrata, and Xanthium strumarium are the dicot weed species used. Pre-germinated seeds were sown in 20-cm-diameter, 11-cm-deep plastic pots containing loam soils (pH 6.4 and 1.7% organic matter). NLPs comprising pelargonic, unformulated pelargonic acid, or NLPs not comprising pelargonic acid, are sprayed on pots containing pre-germinated seeds 24 hours after planting at the rate equivalent to the IC10 of pelargonic acid for each of the species mentioned, along with a water-treated control for comparison. Readouts are the number of surviving plants and the dry mass of shoots as described in Zhao et al., 2017.

### b) Soil Stability of Pelargonic Acid

Using the same soil that is used in the greenhouse assay as described above, soil stability experiments are conducted as described in Poiger et. al., Environ Sci Eur 36, 4 (2024). Soil incubation, soil extraction, and LC-MS/MS analysis are performed as described in Poiger et. al., 2024, with the exception of the time pelargonic acid is incubated with soils. Soil samples incubated with NLPs comprising pelargonic acid or unformulated pelargonic acid are retrieved immediately after exposure of pelargonic acid to soil, every 2 hours thereafter up to 8 hours, and finally at 24 hours.

Pelargonic acid has a very short half life in soil, but NLPs comprising pelargonic acid significantly extend the half of pelargonic acid in soil. Pelargonic acid has no known pre-emergent herbicidal properties, but NLPs comprising pelargonic acid are taken up by weed seedlings at the time of germination and by the roots of seedlings and cause phytotoxicity and burn down.

NLPs comprising pelargonic acid are significantly more effective in controlling the growth of the weed species compared to unformulated pelargonic acid in the greenhouse assay. The number of weed plants surviving and the dry mass of shoots of any surviving plants is significantly lower with the spray of NLPs comprising pelargonic acid compared to unformulated pelargonic acid. Further, NLPs comprising pelargonic acid improve the stability of pelargonic acid in soil compared to unformulated pelargonic acid. Pelargonic acid rapidly degrades in soil with a half-life of less than an hour when used unformulated, while the half-life is significantly improved when applied as NLPs comprising pelargonic acid.

Example 63. Corn Seed Coating with NLPs

This method describes the coating of corn seeds with NLPs and biodistribution of NLPs following the coating.

### Experimental Procedure:

### a) Seed Sterilization

Corn seeds are surface sterilized with 100% Ethanol for 3 minutes, subsequently rinsed in a bleach solution (30% commercial bleach 0.01% Tween) for 10 minutes and finally washed ×5 times with sterile water.

### b) NLP Treatment and Plating

An aliquot of 750 ul of NLP580 or NLP487 formulations comprising Exalite at 1 ug/ml, 750 ul of unformulated Exalite at 1 ug/ml, or 750 ul of water is added to 25 g of corn seeds in a 50 ml conical tube and shaken with a vortex for 15 seconds to coat the seeds. The coated seeds are emptied onto a flat metal pan and dried under the flow hood overnight. The seeds are then germinated in a petri dish containing a wet filter paper and grown at 25° C. in darkness for 5 days.

### c) Imaging

Cross sections of the seeds, roots and shoots are prepared at on day 5 for imaging with a stereomicroscope Olympus SZX16 (RFP filters) with 5× magnification in the far red channel.

Seeds coated with select NLPs comprising Exalite show fluorescence in all plant organs imaged, whereas treatment with unformulated Exalite or water does not produce appreciable fluorescence inside the plant tissues.

### Example 64. Assessment of NLP Particle Stability in Soil Environment

This Example describes an assay to assess the stability of encapsulated deltamethrin (DE) in NLPs using a variant of the soil mobility assay as described in Example 9. Deltamethrin binds tightly to soil and is not leached out of a soil column unless encapsulated in NLP formulations. Accordingly, NLP particle stability can be assessed by measuring Deltamethrin leached out of the column. Highly soil mobile particles NLP551, NLP660, NLP654, NLP659, NLP533, NLP647, NLP646, NLP487, and NLP644 were used to test NLP stability at t=0, after 24 h, and after 7 days of incubation in soil.

### Experimental Procedure:

### a) Preparation and Running of Samples Over the Soil Columns:

The NLP formulations of Table 9 (NLP551, NLP660, NLP654, NLP659, NLP533, NLP647, NLP646, NLP487, and NLP644), comprising deltamethrin (2,000 μg/ml) but no Exalite were tested for soil binding. Flash cartridges (soil columns) (Sorbent Technologies, Cat #FCSTLL-4-20) were obtained and the white frit filters were removed from the top of the soil columns. An aliquot of 2.7 g air-dried soil (silt loam soil, “Iowa Fayette”, purchased from Agvise) was weighed and added to each of 3 columns per sample. The column was saturated with artificial rain solution (0.11% CaCl₂) in Milli-Q ultrapure water, pH 7.0). Subsequently, a non-saturating 1 mL aliquot of NLP formulation was gently loaded onto the top of each column. Negative controls were DE only or no sample added. The positive control was atrazine dissolved in water with 1 mL of solution added at 10 ug/ml. The columns were sealed with the screw caps and allowed to stand for 1) 0 h; 2) 24 h; or 3) 7 days at room temperature, after which 14 mL of artificial rain was pipetted onto the column. A syringe plunger was used to gently press down and induce flow through the column into the 15 mL collection tube. The plunger was removed and further elution was made by gravity (about 2 h).

For the control “soil water sample”, the leachate from a soil column to which no sample was added was taken, and to 1.4 mL of this leachate, 0.1 mL of NLP formulation was added.

### b) Calculation of Stability of Deltamethrin Encapsulation in NLPs in Soil

Unformulated deltamethrin does not leach from soil in a soil mobility assay as previously described. However, encapsulation in some NLPs drastically increases the mobility of deltamethrin in soil as evidenced by the observation of deltamethrin in the leachate of the soil mobility assay. Here we improvise this assay to assess the stability of the NLPs by using deltamethrin in the leachate as the read out. Incubating the NLPs comprising deltamethrin for varying durations of time in the soil column followed by leaching with simulated rainwater and measuring the deltamethrin in the leachate reveals the degree to which NLPs are stable over time and are found in the leachate. By comparing the amount of deltamethrin found in the leachate when the column is leached immediately (t=0) after the application of the NLPs to the soil column to when the column is leached 24 h or 7 d after the application of NLPs to the soil column, the stability of the NLPs can be calculated at 24 h or 7 d relative to t=0.

The percent deltamethrin in the leachate was calculated as follows

$$\frac{{[ AI ]}_{SL} * D}{{[ AI ]}_{U} * 1000}$$

Where [AI]_{SL} is the average concentration of deltamethrin in the soil leachate in ng/mL, [AI]_{U} is the average concentration of deltamethrin in the original unknown sample in μg/mL, and D is the dilution factor (total volume/volume of sample)—in this

$$Example D = \frac{{V}_{U} + {V}_{AR}}{{V}_{U}} = 15.$$

Free (unencapsulated) Deltamethrin was not observed in the leachates of the unformulated deltamethrin treatment at t=0 h, 24 h, or 7 d (FIG. 65). However, deltamethrin was observed in the leachates of all NLPs used when leached immediately, which is a measure of NLP soil mobility and intactness of the particles. When particles were eluted after 24 h soil incubation, less deltamethrin is recovered from the leachate as compared to t=0. After 7 days, deltamethrin was observed in the leachates of some NLPs (NLP660, NLP659, NLP647, and NLP644) but not others. This showed that there was a range of NLP particle stability in the soil environment and that deltamethrin can remain stably encapsulated in soil at least for 7 days if comprised within certain NLPs. The results offer opportunities for combining NLP compositions differing in stability profiles for tuning the release of encapsulated bioactives.

### Example 65. Modulation of Vapor Pressure of a Molecule by Incorporation in NLPs

This example describes the alteration of vapor pressure (volatility) of a compound by formulating it in NLPs. Certain insecticides (e.g. tefluthrin), insect pheromones (e.g. C10-C18 monounsaturated or diunsaturated acetates, alcohols, and aldehydes), herbicides (such as Dicamba) are highly volatile. Formulating these volatile molecules in NLPs can result in altering the vapor pressure and potentially improving the functional output of these molecules.

This example describes a method to reduce the volatility of tefluthrin before or after the application of the product into soil. Tefluthrin (TEF) is a known skin irritant, and reducing the vapor pressure pre-application improves the user safety profile. Further, lowering the volatility could prolong the release of the vapor phase of TEF in soil to lengthen the duration of protection of the plant against soil insect pests targeted by TEF.

### Experimental Procedure:

NLP551, NLP660, NLP654, NLP659, NLP533, NLP647, NLP646, NLP487, and NLP644 are prepared with the HHPH method as described in Example 2. TEF is incorporated as the bioactive at 250 ug/ml (NLP-TEF). Force® Evo is a commercially available formulation of TEF and is chosen as the control for measuring the baseline vapor pressure. Force® Evo is diluted 1000 fold in water to achieve 250 ug/ml concentration.

The method to measure the volatility of a formulation in humidomes is described in Mueller et al., Weed Technol. 33:541-546 (2019) which is incorporated by reference in its entirety herein. The following treatments are applied to either a Teflon sheet or to the soil in trays as described in Mueller et al., 2019: 1) Water; 2) NLP-TEF comprising TEF at 250 ug/ml (several NLPs applied independently); 3) Force® Evo diluted 1000-fold in water such that the final concentration of TEF is 250 ug/ml; 4) No spray (no treatment control). The Teflon sheet is then introduced into the same setup as the soil trays, except without any soil in the humidome. The concentrations of TEF in the gas phase above the soil or the Teflon plate are measured every hour for 7 days as described in Mueller et al., 2019.

Water and no treatment controls show no TEF in the gas phase above the soil or the Teflon plate at all time points. NLPs comprising TEF show diverse profiles of releasing TEF into the gas phase. Some NLPs show a significantly slower and prolonged release of TEF into the gas phase above the soil or Teflon plate compared to Force® Evo treatment.

### ENUMERATED EMBODIMENTS

1. An agricultural composition, the composition comprising a plurality of nature-derived lipid particles (NLPs) each comprising:
at least one phospholipid;
at least one non-polar lipid; and
at least one surface modifier;
   wherein the NLPs comprise a hydrophobic core.
   2. The agricultural composition of paragraph 1, wherein the at least one phospholipid is selected from the group consisting of phosphatidylcholine, phosphatidylethanolamine, phosphatidylinositol, phosphatidic acid, phosphatidyl serine, and 1,2-dimyristoyl-sn-glycero-3-phosphate.
   3. The agricultural composition of paragraph 1, wherein the at least one phospholipid is derived from a lecithin.
   4. The agricultural composition of paragraph 1, wherein the at least one non-polar lipid comprises at least one fatty acid chain selected from the group consisting of a poly-unsaturated fatty acid chain, a mono-unsaturated fatty acid chain, and a saturated fatty acid chain.
   5. The agricultural composition of paragraph 1, wherein the NLPs comprises at least one phospholipid layer.
   6. The agricultural composition of paragraph 5, wherein the NLP phospholipid layer is a phospholipid bilayer.
   7. The agricultural composition of paragraph 1, wherein the NLPs have a micellar structure.
   8. The agricultural composition of paragraph 1, wherein the hydrophobic core comprises at least one non-polar lipid.
   9. The agricultural composition of paragraph 1, wherein the hydrophobic core is solid.
   10. The agricultural composition of paragraph 1, wherein the surface modifier is integrated in the phospholipid layer.
   11. The agricultural composition of paragraph 1, wherein the surface modifier is selected from the group consisting of a glycolipid, a polysaccharide, a fatty acid ethyxylate, a linear alcohol ethoxylate, a cetyl trimethyl, a Linear isopropylamine dodecybenzene sulfonate, a tristyrlphenol ethoxylate phosphate ester, a modified styrene acrylic co-polymer, a hydrophobically modified polycarboxylate polymer, an anionic polymer, a non-ionic acrylic copolymer, a non-ionic combination polymer, a tristyrlphenol polyalkylene oxide block copolymer, or a head group modified PEG lipid.
   12. The agricultural composition of paragraph 11, wherein the head group modified PEG lipid is PEG2000-C18, or PEG5000-C18.
   13. The agricultural composition of paragraph 11, wherein the glycolipid is a rhamnolipid, or a sophorolipid.
   14. The agricultural composition of paragraph 11, wherein the anionic polymer is Atlox 500L, Atlox 4917, or Atlox CS100B.
   15. The agricultural composition of paragraph 11, wherein the polysaccharide is a C8-C10 alkylpolysaccharide.
   16. The agricultural composition of paragraph 1, wherein the surface modifier stabilizes the integrity of the NLP.
   17. The agricultural composition of paragraph 1, wherein the surface modifier affects the binding of the NLP to one or more components present in soil.
   18. The agricultural composition of paragraph 1, wherein the surface modifier affects the affinity of the NLP for one or more components present in soil.
   19. The agricultural composition of paragraph 1, wherein the surface modifier affects the surface charge of the NLP.
   20. The agricultural composition of paragraph 1, wherein the NLP exhibits a negative surface charge as evidenced from a negative zeta potential.
   21. The agricultural composition of paragraph 20, wherein the negative zeta potential ranges between −10 and −100 mV.
   22. The agricultural composition of paragraph 21, wherein the negative zeta potential increases the mobility of the NLP through soil.
   23. The agricultural composition of paragraph 1, further comprising a co-solvent.
   24. The agricultural composition of paragraph 23, wherein the co-solvent is selected from the group consisting of a fatty acid methyl ester, a non-ionic emulsifier, propylene glycol, ethyl lactate, a non-ionic block copolymer surfactant, or a nonionic polyalkylene glycol ether, dichloromethane and isopropyl myristate.
   25. The agricultural composition of paragraph 1, further comprising one or more excipients.
   26. The agricultural composition of paragraph 25, wherein the one or more excipients is selected from the group consisting of Ethyl lactate, Atlas G5002L, and Polyethylene Glycol.
   27. The agricultural composition of any of paragraph 1-26, wherein the composition further comprises at least one heterologous functional agent.
   28. The agricultural composition of paragraph 27, wherein the heterologous functional agent is selected from the group consisting of a pesticidal agent, a fertilizing agent, a herbicidal agent, a plant-modifying agent, an insect attractant, a plant growth promoting agent, a biostimulant, and a plant immunity elicitor.
   29. The agricultural composition of paragraph 28, wherein the pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.
   30. The agricultural composition of paragraph 29, wherein
(a) the antifungal agent includes at least one of azoxystrobin, mancozeb, prothioconazole, folpet, tebuconazole, difenoconazole, captan, bupirimate, fosetyl-AI, a strobilurin, dimoxystrobin, enestroburin, fluoxastrobin, kresoxim-methyl, metominostrobin, picoxystrobin, pyraclostrobin, trifloxystrobin, orysastrobin, a carboxamide, a carboxanilide, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M, methfuroxam, metsulfovax, ofurace, oxadixyl, oxycarboxin, penthiopyrad, pyracarbolid, salicylanilide, tecloftalam, thifluzamide, tiadinil, an N-biphenylamide, bixafen, boscalid, a carboxylic acid morpholide, dimethomorph, flumorph, a benzamide, flumetover, fluopicolid, zoxamid, carpropamid, diclocymet, mandipropamid, silthiofam, an azole, a triazole, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, an imidazole, cyazofamid, imazalil, pefurazoate, prochloraz, triflumizole, a benzimidazole, benomyl, carbendazim, fuberidazole, thiabendazole, ethaboxam, etridiazole, hymexazol, a pyridine, fuazinam, pyrifenox, pyrimidines, cyprodinil, ferimzone, fenarimol, mepanipyrim, nuarimol, pyrimethanil, a piperazine, triforine, a pyrrole, fludioxonil, fenpiclonil, a morpholine, aldimorph, dodemorph, fenpropimorph, tridemorph, a dicarboximide, iprodione, procymidone, vinclozolin, acibenzolar-S-methyl, anilazine, captafol, dazomet, diclomezin, fenoxanil, folpet, fenpropidin, famoxadon, fenamidon, octhilinone, probenazole, proquinazid, pyroquilon, quinoxyfen, tricyclazole, a carbamate, a dithiocarbamate, ferbam, maneb, metiram, metam, propineb, thiram, zineb, ziram, diethofencarb, flubenthiavalicarb, iprovalicarb, propamocarb, a guanidine, dodine, iminoctadine, guazatine, kasugamycin, a polyoxin, streptomycin, validamycin A, a fentin salt, a sulfur-containing heterocyclyl compound, isoprothiolane, dithianone, an organophosphorous compound, edifenphos, fosetyl, fosetyl-aluminum, iprobenfos, pyrazophos, tolclofos-methyl, an organochlorine compound, thiophanate-methyl, chlorothalonil, dichlofluanid, tolylfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon, N-2-cyanophenyl-3,4-dichloroisothiazol-5-carboxamide, N-(3′,4′,5′-trifluorobiphenyl-2-yl)-3-difluoromethyl-1-methylpyrazole-4-carboxamide, 3-[5-(4-chlorophenyl)-2,3-dimethylisoxazolidin-3-yl]-pyridine, N-(3′,4′-dichloro-4-fluorobiphenyl-2-yl)-3-difluoromethyl-1-methylpyrazol-e-4-carboxamide, 5-chloro-7-(4-methylpiperidin-1-yl)-6-(2,4,6-trifluorophenyl)-[1,2,4]tria-zolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazo-le-1-sulfonamide, methyl-(2-chloro-5-[1-(3-methylbenzyloxyimino)-ethyl]benzyl)carbamate, methyl-(2-chloro-5-[1-(6-methylpyrid in-2-ylmethoxy-imino)ethyl]benzyl)carbamate, methyl 3-(4-chlorophenyl)-3-(2-isopropoxycarbonylamino-3-methyl butyryl-amino)propionate, 4-fluorophenyl N-(1-(1-(4-cyanophenyl)ethanesulfonyl)but-2-yl)carbamate, N-(2-(4-[3-(4-chlorophenyl)prop-2-ynyloxy]-3-methoxyphenyl)ethyl)-2-metha-nesulfonylamino-3-methylbutyramide, N-(2-(4-[3-(4-chlorophenyl)prop-2-ynyloxy]-3-methoxyphenyl)ethyl)-2-ethan-esulfonylamino-3-methylbutyramide, N-(4′-bromobiphenyl-2-yl)-4-difluoromethyl-2-methylthiazol-5-carboxamide, N-(4′-trifluoromethylbiphenyl-2-yl)-4-difluoromethyl-2-methylthiazol-5-carboxamide, N-(4′-chloro-3′-fluorobiphenyl-2-yl)-4-difluoromethyl-2-methylt-hiazol-5-carboxamide, methyl 2-(ortho-((2,5-dimethylphenyloxy-methylene)phenyl)-3-methoxyacrylate, oxathiapiprolin, and esters and salts thereof;
(b) the antibacterial agent includes at least one of a hypochlorite, sodium hypochlorite, a chloramine, dichloroisocyanurate, trichloroisocyanurate, wet chlorine, chlorine dioxide, a peroxide, peracetic acid, potassium persulfate, sodium perborate, sodium percarbonate, urea perhydrate, iodine, iodpovidone, ethanol, 1-propanol, 2-propanol, 2-phenoxyethanol, phenol, a cresol, a halogenated phenol, hexachlorophene, triclosan, trichlorophenol, tribromophenol, pentachlorophenol, a cationic surfactant, benzalkonium chloride, cetyl trimethylammonium bromide, cetyl trimethylammonium chloride, didecyldimethylammonium chloride, cetylpyridinium chloride, benzethonium chloride, chlorhexidine, glucoprotamine, octenidine dihydrochloride, an ozone solution, colloidal silver, silver nitrate, mercury chloride, phenylmercury salts, copper sulfate, copper oxide-chloride, copper hydroxide, copper octanoate, copper oxychloride sulfate, copper sulfate pentahydrate, phosphoric acid, nitric acid, sulfuric acid, amidosulfuric acid, toluenesulfonic acid, sodium hydroxide, potassium hydroxide, calcium hydroxide, sorbic acid, benzoic acid, lactic acid, salicylic acid, a penicillin, a cephalosporin, vancomycin, a polymyxin, a rifamycin, a lipiarmycin, a quinolone, a sulfonamide, an aminoglycoside, kasugamycin, a macrolide, a lincosamide, a tetracycline, a cyclic lipopeptide, daptomycin, a glycylcycline, tigecycline, an oxazolidinone, linezolid, fidaxomicin, rifampicin, ciprofloxacin, doxycycline, ampicillin, polymyxin B, gramicidin, isoniazid, pyrazinamide, ethambutol, myambutol, streptomycin, and esters and salts thereof;
(c) the insecticidal agent includes at least one of a chloronicotinyl, a neonicotinoid, acetamiprid, clothianidin, dinotefuran, imidacloprid, nitenpyram, nithiazine, thiacloprid, thiamethoxam, imidaclothiz, (2E)-1-[(2-chloro-1,3-thiazol-5-yl)methyl]-3,5-dimethyl-N-nitro-1,3,5-tri-azinan-2-imine, an acetylcholinesterase (AChE) inhibitor, a carbamate, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chloethocarb, dimetilan, ethiofencarb, fenobucarb, fenothiocarb, formetanate, furathiocarb, isoprocarb, metam-sodium, methiocarb, methomyl, metolcarb, oxamyl, phosphocarb, pirimicarb, promecarb, propoxur, thiodicarb, thiofanox, triazamate, trimethacarb, XMC, xylylcarb, an organophosphate, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, a pyrethroid, acrinathrin, allethrin (d-cis-trans, d-trans), cypermethrin (alpha-, beta-, theta-, zeta-), permethrin (cis-, trans-), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cyphenothrin, DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda, metofluthrin, phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralocythrin, tralomethrin, transfluthrin, ZXI 8901, a pyrethrin, pyrethrum, an oxadiazine, indoxacarb, an acetylcholine receptor modulator, a spinosyn, Spinosad, a cyclodiene, camphechlor, chlordane, endosulfan, gamma-HCH, HCH, heptachlor, an organochlorine, lindane, methoxychlor, a fiprole, acetoprole, ethiprole, vaniliprole, fipronil, a mectin, abamectin, avermectin, emamectin, emamectin-benzoate, fenoxycarb, hydroprene, kinoprene, methoprene, ivermectin, lepimectin, epofenonane, pyriproxifen, milbemectin, milbemycin, triprene, a diacylhydrazine, chromafenozide, halofenozide, methoxyfenozide, tebufenozide, a benzoylurea, bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron, an organotin, azocyclotin, cyhexatin, fenbutatin oxide, a pyrrole, chlorfenapyr, a dinitrophenol, binapacyrl, dinobuton, dinocap, DNOC, a METI, fenazaquin, fenpyroximate, pyrimidifen, pyridaben, tebufenpyrad, tolfenpyrad, rotenone, acequinocyl, fluacrypyrim, a microbial disrupter of the intestinal membrane of insects, a Bacillus thuringiensis strain, an inhibitor of lipid synthesis, a tetronic acid, a tetramic acid, spirodiclofen, spiromesifen, spirotetramat, cis-3-(2,5-dimethylphenyl)-8-methoxy-2-oxo-1-azaspi ro[4.5]dec-3-en-4-yl ethyl carbonate, a carboxamide, flonicamid, an octopaminergic agonist, amitraz, an inhibitor of the magnesium-stimulated ATPase, propargite, a ryanodin receptor agonist, a phthalamide, rynaxapyr, N2-[1,1-dimethyl-2-(methylsulphonyl)ethyl]-3-iodo-N1-[2-methyl-4-[1,2,2,2-tetrafluoro-1-(trifluoromethyl)ethyl]phenyl]-1,2-benzenedi-carboxamide, spidoxamat, nicofluprole, tetraniliprole, tioxazafen, flupyradifuron, fluopyram, flubendiamide, deltametrin, permethrin, dimpropyridaz, broflanilide, afidopyropen, fluopyram, fluazaindolizine, triflumezopyrim, sulfoxaflor, spinetoram, chlorpyrifos, spinosad, cyantraniliprole, chlorantraniliprole, cypermethrin, plinazolin, cyclobutrifluram, spiropidion, fluensulfone, pymetrozine, thiamethoxam, lamda cyhalothrin, oxazosulfyl, benzpyrimoxan, dichloromezotiaz, flupentiofenox, fluhexafon, fluxametamide, flupyrimin, cyhalodiamide, acynonapyr, cyclaniliprole, cyetpyrafen, cyproflanilide, tetrachlorantraniliprole, isocycloseram, broflanilide, spiropidion, and esters and salts thereof;
(d) the molluscicidal agent includes at least one of a metal salt, iron phosphate, aluminium sulfate, ferric sodium EDTA, metaldehyde, methiocarb, and an acetylcholinesterase inhibitor;
(e) the nematicidal agent includes at least one of a fumigant, D-D, 1,3-dichloropropene, ethylene dibromide, 1,2-dibromo-3-chloropropane, methyl bromide, chloropicrin, metam sodium, dazomet, methyl Isothiocyanate (MITC), sodium tetrathiocarbonate, a carbamate, aldicarb, aldoxycarb, carbofuran, oxamyl, cleothocarb, an organophosphate, ethoprophos, fenamiphos, cadusafos, fosthiazate, fensulfothion, thionazin, Isazofos, and a biochemical; and
(f) the herbicidal agent includes at least one of glufosinate, propaquizafop, metamitron, metazachlor, pendimethalin, flufenacet, diflufenican, clomazone, nicosulfuron, mesotrione, pinoxaden, sulcotrione, prosulfocarb, sulfentrazone, bifenox, quinmerac, triallate, terbuthylazine, atrazine, oxyfluorfen, diuron, trifluralin, chlorotoluron, a benzoic acid herbicide, dicamba, a phenoxyalkanoic acid herbicide, 2,4-D, MCPA, a 2,4-DB ester, an aryloxyphenoxypropionic acid herbicide, clodinafop, cyhalofop, fenoxaprop, fluazifop, haloxyfop, a quizalofop ester, a pyridinecarboxylic acid herbicide, aminopyralid, picloram, a clopyralid ester, a pyrimidinecarboxylic acid herbicide, an aminocyclopyrachlor ester, a pyridyloxyalkanoic acid herbicide, fluoroxypyr, triclopyr, a hydroxybenzonitrile herbicide, bromoxynil, ioxynil, an arylpyridine carboxylic acid, an arylpyrimidine carboxylic acid, acetochlor, acifluorfen, alachlor, ametryn, amitrole, asulam, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate, DCPA, desmedipham, dichlobenil, diclofop, diclosulam, diethatyl, difenzoquat, diflufenzopyr, dimethenamid-p, diquat, DSMA, endothall, EPTC, ethalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glyphosate, halosulfuron, haloxyfop, hexazinone, imazamethabenz, imazamox, imazapic, imazaquin, imazethapyr, isoxaben, isoxaflutole, lactofen, linuron, MCPB, methazole, metolachlor-s, metribuzin, metsulfuron, molinate, MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triflusulfuron, vernolate, and esters and salts thereof.
   31. The agricultural composition of paragraph 30, wherein the pyrethroid is deltamethrin.
   32. The agricultural composition of paragraph 27, wherein the heterologous functional agent comprises a plant-modifying agent.
   33. The agricultural composition of paragraph 27, wherein the heterologous functional agent comprises an insect-modifying agent.
   34. The agricultural composition of any of paragraphs 27-33, wherein the heterologous functional agent is encapsulated in the NLP.
   35. The agricultural composition of any of paragraphs 1-34, wherein the composition is formulated for application to soil.
   36. The agricultural composition of any of paragraphs 1-35, wherein the at least one surface modifier alters the mobility of the agricultural composition through soil as compared to a composition not comprising the surface modifier.
   37. The agricultural composition of paragraph 36, wherein the mobility of the heterologous functional agent in soil is increased.
   38. The agricultural composition of paragraph 36, wherein the mobility of the heterologous functional agent in soil is decreased.
   39. The agricultural composition of any of paragraphs 1-38, wherein the composition is formulated for delivery to a plant, a plant part, or a plant pest.
   40. The agricultural composition of paragraph 39, wherein the plant part is a plant seed.
   41. The agricultural composition of paragraph 39, wherein NLPs are detected in germinated seeds.
   42. The agricultural composition of paragraph 1, wherein the heterologous functional agent is a volatile agent.
   43. The method of any of paragraphs 1-42, wherein the volatile heterologous functional agent is a pesticidal agent, a fertilizing agent, a herbicidal agent, a plant-modifying agent, an insect attractant, a plant growth promoting agent, a biostimulant, or a plant immunity elicitor.
   44. The method of paragraph 43, wherein the volatile pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.
   45. The method of paragraph 43, wherein the herbicidal agent is Dicamba.
   46. The method of paragraph 44, wherein the insecticidal agent is tefluthrin.
   47. The agricultural composition of any of paragraphs 1-46, wherein the at least one surface modifier enhances the uptake of the agricultural composition by a plant or plant part as compared to a composition not comprising the surface modifier.
   48. The agricultural composition of any of paragraphs 1-46, wherein the at least one surface modifier enhances the biodistribution of the agricultural composition by a plant or plant part as compared to a composition not comprising the surface modifier.
   49. The agricultural composition of any of paragraphs 1-46, wherein the NLP targets the meristem region.
   50. The agricultural composition of any of paragraphs 1-46, wherein the encapsulated heterologous functional agent is protected from UV radiation.
   51. An agricultural composition, the composition comprising a mixture of:
a) a first plurality of NLPs comprising:
   at least one phospholipid;
   at least one non-polar lipid; and
   at least one surface modifier; and
   a first heterologous functional agent; and
b) a second plurality of NLPs comprising:
   at least one phospholipid;
   at least one non-polar lipid; and
   at least one surface modifier; and
   a second heterologous functional agent;
wherein the first plurality of NLPs comprise a hydrophobic core.
   52. The agricultural composition of claim 48, wherein the first and the second plurality of NLPs differ in stability.
   53. An agricultural composition, the composition comprising a mixture of:
a) a plurality of NLPs comprising:
   at least one phospholipid;
   at least one non-polar lipid; and
   at least one surface modifier; and
   a first heterologous functional agent; and
b) an unencapsulated second heterologous functional agent,
wherein the plurality of NLPs comprise a hydrophobic core.
   54. An agricultural composition comprising a plurality of NLPs each comprising a heterologous functional agent, wherein the NLPs are produced by the process of applying energy to a solution comprising:
at least one phospholipid;
at least one non-polar lipid;
at least one surface modifier;
a heterologous functional agent; and
an aqueous solution;
   wherein the plurality of NLPs comprise a hydrophobic core.
   55. A method of making an agricultural composition comprising a plurality of NLPs each comprising a heterologous functional agent, the method comprising the step of:
applying energy to a solution comprising:
   at least one phospholipid;
   at least one non-polar lipid;
   at least one surface modifier;
   a heterologous functional agent; and
   an aqueous solution;
thereby forming the NLPs, wherein the NLPs comprise a hydrophobic core.
   56. A method of altering the binding of a heterologous functional agent to at least one component in soil, the method comprising:
applying to soil an NLP composition comprising a heterologous functional agent encapsulated in the NLP, wherein the NLP comprises:
   at least one phospholipid;
   at least one non-polar lipid; and
   at least one surface modifier;
      wherein the binding of the encapsulated heterologous functional agent to soil is different than the binding of the unencapsulated heterologous functional agent to soil.
      57. A method of altering the mobility of a heterologous functional agent in soil, the method comprising:
applying to soil an NLP composition comprising a heterologous functional agent encapsulated in the NLP, wherein the NLP comprises:
   at least one phospholipid;
   at least one non-polar lipid; and
   at least one surface modifier;
      wherein the mobility of the encapsulated heterologous functional agent in soil is different than the mobility of the unencapsulated heterologous functional agent in soil.
      58. A method of reducing the viability of a root worm, the method comprising: applying to soil infested with root worm an NLP composition comprising:
at least one phospholipid;
at least one non-polar lipid;
at least one surface modifier; and
a heterologous functional agent;
   wherein the heterologous functional agent contacts the root worm, thereby reducing the viability of the root worm.
   59. The method of paragraph 58, wherein the NLPs are applied to soil as a soil drench.
   60. The method of paragraph 58, wherein the NLPs are applied to soil in furrow.
   61. The method of paragraph 58, wherein the root worm is a member of the Diabrotica genus.
   62. The method of paragraph 58, wherein the root worm is Diabrotica virgifera virgifera.
   63. A method of reducing the viability or a fungus, the method comprising:
applying to soil comprising a fungus an NLP composition comprising:
   at least one phospholipid;
   at least one non-polar lipid;
   at least one surface modifier; and
   a heterologous functional agent;
      wherein the heterologous functional agent contacts the fungus, thereby reducing the viability of the fungus in the soil.
      64. The method of paragraph 63, wherein the fungus belongs to a family selected from the group consisting of Sciaridae, Diadocidiidae, Ditomyiidae, Keroplatidae, Bolitophilidae, and Mycetophilidae and Sclerotiniaceae.
      65. The method of paragraph 64, wherein the fungus is Botrytis cinerea.
      66. A method of preventing a plant from developing a disease caused by a plant pest, the method comprising:
applying to soil an NLP composition comprising:
   at least one phospholipid;
   at least one non-polar lipid;
   at least one surface modifier; and
   a heterologous functional agent;
      wherein the NLPs comprise a hydrophobic core, and
      wherein the heterologous functional agent contacts the plant pest, thereby killing the pest, thereby preventing the plant from developing a disease.
      67. The method of paragraph 66, wherein the NLPs are applied to soil as a soil drench.
      68. The method of paragraph 66, wherein the NLPs are applied to soil in furrow.
      69. The method of paragraph 66, wherein the plant pest is a member of the Coleopteran or the Hemipteran order.
      70. The method of paragraph 66, wherein the plant pest is a member of the Diabrotica genus.
      71. The method of paragraph 66, wherein the plant pest is Diabrotica virgifera virgifera.
      72. The method of paragraph 67, wherein the plant pest is a fungus.
      73. The method of paragraph 72, wherein the fungus belongs to a family selected from the group consisting of Sciaridae, Diadocidiidae, Ditomyiidae, Keroplatidae, Bolitophilidae, and Mycetophilidae and Sclerotiniaceae.
      74. The method of paragraph 73, wherein the fungus is Botrytis cinerea.
      75. A method of increasing the uptake of a heterologous functional agent by a plant or plant part, the method comprising:
contacting a plant or plant part with an NLP composition comprising a heterologous functional agent encapsulated in the NLP, wherein the NLP comprises:
   at least one phospholipid;
   at least one non-polar lipid; and
   at least one surface modifier;
      wherein the NLPs comprise a hydrophobic core, and
      wherein the uptake of the encapsulated heterologous functional agent by the plant or plant part is higher than the uptake of the unencapsulated heterologous functional agent by the plant or plant part.
      76. A method for delivering a heterologous functional agent to a plant or a plant part, the method comprising:
contacting a plant or plant part with an NLP composition comprising:
   at least one phospholipid;
   at least one non-polar lipid;
   at least one surface modifier; and
   a heterologous functional agent;
      wherein the NLPs comprise a hydrophobic core, thereby delivering the heterologous functional agent to the plant.
      77. A method of delivering a heterologous functional agent to the meristem, the method comprising:
contacting a plant or plant part with an NLP composition comprising a heterologous functional agent encapsulated in the NLP, wherein the NLP comprises:
   at least one phospholipid;
   at least one non-polar lipid; and
   at least one surface modifier
      78. The method of any of paragraph 75-77, wherein the plant part is a plant seed.
      79. A method of distributing a heterologous functional agent in soil, the method comprising:
contacting a plant seed with an NLP composition comprising:
   at least one phospholipid;
   at least one non-polar lipid;
   at least one surface modifier; and
   a heterologous functional agent;
      wherein the NLPs comprise a hydrophobic core, and
incubating the plant seed in soil, thereby distributing the heterologous functional agent in the soil.

80. A method of distributing a heterologous functional agent in a plant, the method comprising:
contacting a plant seed with an NLP composition comprising:
   at least one phospholipid;
   at least one non-polar lipid;
   at least one surface modifier; and
   a heterologous functional agent;
      wherein the NLPs comprise a hydrophobic core, and
incubating the plant seed under conditions that cause germination, thereby distributing the heterologous functional agent in the plant.
   81. The method of paragraph 80, wherein the contacting is by means of injecting the composition in the plant or plant part.
   82. The method of paragraph 81, wherein the composition is injected or infiltrated into one or more leaves.
   83. The method of paragraph 81, wherein the composition is injected into a tree.
   84. The method of paragraph 83, wherein the composition is injected at several positions into a tree.
   85. A method of treating a disease in a plant, the method comprising:
contacting a plant or plant part with an NLP composition comprising:
   at least one phospholipid;
   at least one non-polar lipid;
   at least one surface modifier; and
   a heterologous functional agent;
      wherein the NLPs comprise a hydrophobic core, thereby treating the disease in a plant.
      86. The method of paragraph 85, wherein the disease is caused by Candidatus Liberibacter asiaticus (CLas).
      87. The method of paragraph 85, wherein the disease is citrus greening.
      88. The method of paragraph 85, wherein the disease is caused by Xylella.
      89. A method of preventing a plant from developing a disease, the method comprising:
contacting a plant or plant part with an NLP composition comprising:
   at least one phospholipid;
   at least one non-polar lipid;
   at least one surface modifier; and
   a heterologous functional agent;
      wherein the NLPs comprise a hydrophobic core, thereby preventing a disease in a plant.
      90. A method of reducing the volatility of a heterologous functional agent, the method comprising encapsulating the volatile heterologous functional agent in the composition of paragraph 1.
      91. A method of sequestering a volatile heterologous functional agent, the method comprising encapsulating the heterologous functional agent in the composition of paragraph 1.
      92. A method for the controlled release of a volatile heterologous functional agent into the environment, the method comprising encapsulating the heterologous functional agent in the composition of paragraph 1, wherein the release of the agent is inversely proportional to the stability of the NLP.
      93. A method for the controlled release of at least one volatile heterologous functional agent into the environment, the method comprising encapsulating at least one volatile heterologous functional agent in the composition of paragraph 48, wherein the release of the agent is inversely proportional to the stability of the at least one plurality of NLPs.
      94. The method of any of paragraphs 90-93, wherein the volatile heterologous functional agent is a pesticidal agent, a fertilizing agent, a herbicidal agent, a plant-modifying agent, an insect attractant, a plant growth promoting agent, a biostimulant, or a plant immunity elicitor.
      95. The method of paragraph 94, wherein the volatile pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.
      96. The method of paragraph 94, wherein the herbicidal agent is Dicamba.
      97. The method of paragraph 95, wherein the insecticidal agent is tefluthrin.
      98. A kit comprising an agricultural composition, the composition comprising a plurality of nature-derived lipid particles (NLPs) each comprising:
at least one phospholipid;
at least one non-polar lipid;
at least one surface modifier; and
a heterologous functional agent;
   wherein the NLPs comprise a hydrophobic core.

What is claimed is:

1. An agricultural composition, the composition comprising a plurality of nature-derived lipid particles (NLPs) each comprising:
at least one phospholipid;
at least one non-polar lipid; and
at least one surface modifier;
wherein the NLPs comprise a hydrophobic core.

2. The agricultural composition of claim 1, wherein the at least one phospholipid is selected from the group consisting of phosphatidylcholine, phosphatidylethanolamine, phosphatidylinositol, phosphatidic acid, phosphatidyl serine, and 1,2-dimyristoyl-sn-glycero-3-phosphate.

3. The agricultural composition of claim 1, wherein the at least one phospholipid is derived from a lecithin.

4. The agricultural composition of claim 1, wherein the at least one non-polar lipid comprises at least one fatty acid chain selected from the group consisting of a poly-unsaturated fatty acid chain, a mono-unsaturated fatty acid chain, and a saturated fatty acid chain.

5. The agricultural composition of claim 1, wherein the NLPs comprises at least one phospholipid layer.

6. The agricultural composition of claim 5, wherein the NLPs comprise at least one a phospholipid bilayer.

7. The agricultural composition of claim 1, wherein the NLPs have a micellar structure.

8. The agricultural composition of claim 1, wherein the hydrophobic core comprises at least one non-polar lipid.

9. The agricultural composition of claim 1, wherein the hydrophobic core is solid.

10. The agricultural composition of claim 1, wherein the surface modifier is integrated in the phospholipid layer.

11. The agricultural composition of claim 1, wherein the surface modifier is selected from the group consisting of a glycolipid, a polysaccharide, a fatty acid ethyxylate, a linear alcohol ethoxylate, a cetyl trimethyl, a Linear isopropylamine dodecybenzene sulfonate, a tristyrlphenol ethoxylate phosphate ester, a modified styrene acrylic co-polymer, a hydrophobically modified polycarboxylate polymer, an anionic polymer, a non-ionic acrylic copolymer, a non-ionic combination polymer, a tristyrlphenol polyalkylene oxide block copolymer, or a head group modified PEG lipid.

12. The agricultural composition of claim 11, wherein the head group modified PEG lipid is PEG2000-C18 or PEG5000-C18.

13. The agricultural composition of claim 11, wherein the glycolipid is a rhamnolipid, or a sophorolipid.

14. The agricultural composition of claim 11, wherein the anionic polymer is Atlox 500L, Atlox 4917, or Atlox CS100B.

15. The agricultural composition of claim 11, wherein the polysaccharide is a C8-C10 alkylpolysaccharide.

16. The agricultural composition of claim 1, wherein the surface modifier stabilizes the integrity of the NLPs.

17. The agricultural composition of claim 1, wherein the surface modifier affects the binding of the NLPs to one or more components present in soil.

18. The agricultural composition of claim 1, wherein the surface modifier affects the affinity of the NLPs for one or more components present in soil.

19. The agricultural composition of claim 1, wherein the surface modifier affects the surface charge of the NLPs.

20. The agricultural composition of claim 1, wherein the NLPs exhibit a negative surface charge as evidenced from a negative zeta potential.

21. The agricultural composition of claim 20, wherein the negative zeta potential ranges between −10 and −100 mV.

22. The agricultural composition of claim 21, wherein the negative zeta potential increases the mobility of the NLPs through soil.

23. The agricultural composition of claim 1, further comprising a co-solvent.

24. The agricultural composition of claim 23, wherein the co-solvent is selected from the group consisting of a fatty acid methyl ester, a non-ionic emulsifier, propylene glycol, ethyl lactate, a non-ionic block copolymer surfactant, or a nonionic polyalkylene glycol ether, dichloromethane and isopropyl myristate.

25. The agricultural composition of claim 1, further comprising one or more excipients.

26. The agricultural composition of claim 25, wherein the one or more excipients is selected from the group consisting of Ethyl lactate, Atlas G5002L, and Polyethylene Glycol.

27. The agricultural composition of any of claim 1-26, wherein the composition further comprises at least one heterologous functional agent.

28. The agricultural composition of claim 27, wherein the heterologous functional agent is selected from the group consisting of a pesticidal agent, a fertilizing agent, a herbicidal agent, a plant-modifying agent, an insect attractant, a plant growth promoting agent, a biostimulant, and a plant immunity elicitor.

29. The agricultural composition of claim 28, wherein the pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.

30. The agricultural composition of claim 29, wherein
(a) the antifungal agent includes at least one of azoxystrobin, mancozeb, prothioconazole, folpet, tebuconazole, difenoconazole, captan, bupirimate, fosetyl-AI, a strobilurin, dimoxystrobin, enestroburin, fluoxastrobin, kresoxim-methyl, metominostrobin, picoxystrobin, pyraclostrobin, trifloxystrobin, orysastrobin, a carboxamide, a carboxanilide, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M, methfuroxam, metsulfovax, ofurace, oxadixyl, oxycarboxin, penthiopyrad, pyracarbolid, salicylanilide, tecloftalam, thifluzamide, tiadinil, an N-biphenylamide, bixafen, boscalid, a carboxylic acid morpholide, dimethomorph, flumorph, a benzamide, flumetover, fluopicolid, zoxamid, carpropamid, diclocymet, mandipropamid, silthiofam, an azole, a triazole, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, an imidazole, cyazofamid, imazalil, pefurazoate, prochloraz, triflumizole, a benzimidazole, benomyl, carbendazim, fuberidazole, thiabendazole, ethaboxam, etridiazole, hymexazol, a pyridine, fuazinam, pyrifenox, pyrimidines, cyprodinil, ferimzone, fenarimol, mepanipyrim, nuarimol, pyrimethanil, a piperazine, triforine, a pyrrole, fludioxonil, fenpiclonil, a morpholine, aldimorph, dodemorph, fenpropimorph, tridemorph, a dicarboximide, iprodione, procymidone, vinclozolin, acibenzolar-S-methyl, anilazine, captafol, dazomet, diclomezin, fenoxanil, folpet, fenpropidin, famoxadon, fenamidon, octhilinone, probenazole, proquinazid, pyroquilon, quinoxyfen, tricyclazole, a carbamate, a dithiocarbamate, ferbam, maneb, metiram, metam, propineb, thiram, zineb, ziram, diethofencarb, flubenthiavalicarb, iprovalicarb, propamocarb, a guanidine, dodine, iminoctadine, guazatine, kasugamycin, a polyoxin, streptomycin, validamycin A, a fentin salt, a sulfur-containing heterocyclyl compound, isoprothiolane, dithianone, an organophosphorous compound, edifenphos, fosetyl, fosetyl-aluminum, iprobenfos, pyrazophos, tolclofos-methyl, an organochlorine compound, thiophanate-methyl, chlorothalonil, dichlofluanid, tolylfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon, N-2-cyanophenyl-3,4-dichloroisothiazol-5-carboxamide, N-(3′,4′,5′-trifluorobiphenyl-2-yl)-3-difluoromethyl-1-methylpyrazole-4-carboxamide, 3-[5-(4-chlorophenyl)-2,3-dimethylisoxazolidin-3-yl]-pyridine, N-(3′,4′-dichloro-4-fluorobiphenyl-2-yl)-3-difluoromethyl-1-methylpyrazol-e-4-carboxamide, 5-chloro-7-(4-methylpiperidin-1-yl)-6-(2,4,6-trifluorophenyl)-[1,2,4]tria-zolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazo-le-1-sulfonamide, methyl-(2-chloro-5-[1-(3-methylbenzyloxyimino)-ethyl]benzyl)carbamate, methyl-(2-chloro-5-[1-(6-methylpyrid in-2-ylmethoxy-imino)ethyl]benzyl)carbamate, methyl 3-(4-chlorophenyl)-3-(2-isopropoxycarbonylamino-3-methyl butyryl-amino)propionate, 4-fluorophenyl N-(1-(1-(4-cyanophenyl)ethanesulfonyl)but-2-yl)carbamate, N-(2-(4-[3-(4-chlorophenyl)prop-2-ynyloxy]-3-methoxyphenyl)ethyl)-2-metha-nesulfonylamino-3-methylbutyramide, N-(2-(4-[3-(4-chlorophenyl)prop-2-ynyloxy]-3-methoxyphenyl)ethyl)-2-ethan-esulfonylamino-3-methylbutyramide, N-(4′-bromobiphenyl-2-yl)-4-difluoromethyl-2-methylthiazol-5-carboxamide, N-(4′-trifluoromethylbiphenyl-2-yl)-4-difluoromethyl-2-methylthiazol-5-carboxamide, N-(4′-chloro-3′-fluorobiphenyl-2-yl)-4-difluoromethyl-2-methylt-hiazol-5-carboxamide, methyl 2-(ortho-((2,5-dimethylphenyloxy-methylene)phenyl)-3-methoxyacrylate, oxathiapiprolin, and esters and salts thereof;
(b) the antibacterial agent includes at least one of a hypochlorite, sodium hypochlorite, a chloramine, dichloroisocyanurate, trichloroisocyanurate, wet chlorine, chlorine dioxide, a peroxide, peracetic acid, potassium persulfate, sodium perborate, sodium percarbonate, urea perhydrate, iodine, iodpovidone, ethanol, 1-propanol, 2-propanol, 2-phenoxyethanol, phenol, a cresol, a halogenated phenol, hexachlorophene, triclosan, trichlorophenol, tribromophenol, pentachlorophenol, a cationic surfactant, benzalkonium chloride, cetyl trimethylammonium bromide, cetyl trimethylammonium chloride, didecyldimethylammonium chloride, cetylpyridinium chloride, benzethonium chloride, chlorhexidine, glucoprotamine, octenidine dihydrochloride, an ozone solution, colloidal silver, silver nitrate, mercury chloride, phenylmercury salts, copper sulfate, copper oxide-chloride, copper hydroxide, copper octanoate, copper oxychloride sulfate, copper sulfate pentahydrate, phosphoric acid, nitric acid, sulfuric acid, amidosulfuric acid, toluenesulfonic acid, sodium hydroxide, potassium hydroxide, calcium hydroxide, sorbic acid, benzoic acid, lactic acid, salicylic acid, a penicillin, a cephalosporin, vancomycin, a polymyxin, a rifamycin, a lipiarmycin, a quinolone, a sulfonamide, an aminoglycoside, kasugamycin, a macrolide, a lincosamide, a tetracycline, a cyclic lipopeptide, daptomycin, a glycylcycline, tigecycline, an oxazolidinone, linezolid, fidaxomicin, rifampicin, ciprofloxacin, doxycycline, ampicillin, polymyxin B, gramicidin, isoniazid, pyrazinamide, ethambutol, myambutol, streptomycin, and esters and salts thereof;
(c) the insecticidal agent includes at least one of a chloronicotinyl, a neonicotinoid, acetamiprid, clothianidin, dinotefuran, imidacloprid, nitenpyram, nithiazine, thiacloprid, thiamethoxam, imidaclothiz, (2E)-1-[(2-chloro-1,3-thiazol-5-yl)methyl]-3,5-dimethyl-N-nitro-1,3,5-tri-azinan-2-imine, an acetylcholinesterase (AChE) inhibitor, a carbamate, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chloethocarb, dimetilan, ethiofencarb, fenobucarb, fenothiocarb, formetanate, furathiocarb, isoprocarb, metam-sodium, methiocarb, methomyl, metolcarb, oxamyl, phosphocarb, pirimicarb, promecarb, propoxur, thiodicarb, thiofanox, triazamate, trimethacarb, XMC, xylylcarb, an organophosphate, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, a pyrethroid, acrinathrin, allethrin (d-cis-trans, d-trans), cypermethrin (alpha-, beta-, theta-, zeta-), permethrin (cis-, trans-), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cyphenothrin, DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda, metofluthrin, phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralocythrin, tralomethrin, transfluthrin, ZXI 8901, a pyrethrin, pyrethrum, an oxadiazine, indoxacarb, an acetylcholine receptor modulator, a spinosyn, Spinosad, a cyclodiene, camphechlor, chlordane, endosulfan, gamma-HCH, HCH, heptachlor, an organochlorine, lindane, methoxychlor, a fiprole, acetoprole, ethiprole, vaniliprole, fipronil, a mectin, abamectin, avermectin, emamectin, emamectin-benzoate, fenoxycarb, hydroprene, kinoprene, methoprene, ivermectin, lepimectin, epofenonane, pyriproxifen, milbemectin, milbemycin, triprene, a diacylhydrazine, chromafenozide, halofenozide, methoxyfenozide, tebufenozide, a benzoylurea, bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron, an organotin, azocyclotin, cyhexatin, fenbutatin oxide, a pyrrole, chlorfenapyr, a dinitrophenol, binapacyrl, dinobuton, dinocap, DNOC, a METI, fenazaquin, fenpyroximate, pyrimidifen, pyridaben, tebufenpyrad, tolfenpyrad, rotenone, acequinocyl, fluacrypyrim, a microbial disrupter of the intestinal membrane of insects, a Bacillus thuringiensis strain, an inhibitor of lipid synthesis, a tetronic acid, a tetramic acid, spirodiclofen, spiromesifen, spirotetramat, cis-3-(2,5-dimethylphenyl)-8-methoxy-2-oxo-1-azaspi ro[4.5]dec-3-en-4-yl ethyl carbonate, a carboxamide, flonicamid, an octopaminergic agonist, amitraz, an inhibitor of the magnesium-stimulated ATPase, propargite, a ryanodin receptor agonist, a phthalamide, rynaxapyr, N2-[1,1-dimethyl-2-(methylsulphonyl)ethyl]-3-iodo-N1-[2-methyl-4-[1,2,2,2-tetrafluoro-1-(trifluoromethyl)ethyl]phenyl]-1,2-benzenedi-carboxamide, spidoxamat, nicofluprole, tetraniliprole, tioxazafen, flupyradifuron, fluopyram, flubendiamide, deltametrin, permethrin, dimpropyridaz, broflanilide, afidopyropen, fluopyram, fluazaindolizine, triflumezopyrim, sulfoxaflor, spinetoram, chlorpyrifos, spinosad, cyantraniliprole, chlorantraniliprole, cypermethrin, plinazolin, cyclobutrifluram, spiropidion, fluensulfone, pymetrozine, thiamethoxam, lamda cyhalothrin, oxazosulfyl, benzpyrimoxan, dichloromezotiaz, flupentiofenox, fluhexafon, fluxametamide, flupyrimin, cyhalodiamide, acynonapyr, cyclaniliprole, cyetpyrafen, cyproflanilide, tetrachlorantraniliprole, isocycloseram, broflanilide, spiropidion, and esters and salts thereof;
(d) the molluscicidal agent includes at least one of a metal salt, iron phosphate, aluminium sulfate, ferric sodium EDTA, metaldehyde, methiocarb, and an acetylcholinesterase inhibitor;
(e) the nematicidal agent includes at least one of a fumigant, D-D, 1,3-dichloropropene, ethylene dibromide, 1,2-dibromo-3-chloropropane, methyl bromide, chloropicrin, metam sodium, dazomet, methyl Isothiocyanate (MITC), sodium tetrathiocarbonate, a carbamate, aldicarb, aldoxycarb, carbofuran, oxamyl, cloethocarb, an organophosphate, ethoprophos, fenamiphos, cadusafos, fosthiazate, fensulfothion, thionazin, Isazofos, and a biochemical; and
(f) the herbicidal agent includes at least one of glufosinate, propaquizafop, metamitron, metazachlor, pendimethalin, flufenacet, diflufenican, clomazone, nicosulfuron, mesotrione, pinoxaden, sulcotrione, prosulfocarb, sulfentrazone, bifenox, quinmerac, triallate, terbuthylazine, atrazine, oxyfluorfen, diuron, trifluralin, chlorotoluron, a benzoic acid herbicide, dicamba, a phenoxyalkanoic acid herbicide, 2,4-D, MCPA, a 2,4-DB ester, an aryloxyphenoxypropionic acid herbicide, clodinafop, cyhalofop, fenoxaprop, fluazifop, haloxyfop, a quizalofop ester, a pyridinecarboxylic acid herbicide, aminopyralid, picloram, a clopyralid ester, a pyrimidinecarboxylic acid herbicide, an aminocyclopyrachlor ester, a pyridyloxyalkanoic acid herbicide, fluoroxypyr, triclopyr, a hydroxybenzonitrile herbicide, bromoxynil, ioxynil, an arylpyridine carboxylic acid, an arylpyrimidine carboxylic acid, acetochlor, acifluorfen, alachlor, ametryn, amitrole, asulam, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate, DCPA, desmedipham, dichlobenil, diclofop, diclosulam, diethatyl, difenzoquat, diflufenzopyr, dimethenamid-p, diquat, DSMA, endothall, EPTC, ethalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glyphosate, halosulfuron, haloxyfop, hexazinone, imazamethabenz, imazamox, imazapic, imazaquin, imazethapyr, isoxaben, isoxaflutole, lactofen, linuron, MCPB, methazole, metolachlor-s, metribuzin, metsulfuron, molinate, MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triflusulfuron, vernolate, and esters and salts thereof.

31. The agricultural composition of claim 30, wherein the pyrethroid is deltamethrin.

32. The agricultural composition of claim 27, wherein the heterologous functional agent comprises a plant-modifying agent.

33. The agricultural composition of claim 27, wherein the heterologous functional agent comprises an insect-modifying agent.

34. The agricultural composition of any of claims 27-33, wherein the heterologous functional agent is encapsulated in the NLP.

35. The agricultural composition of claim 1, wherein the composition is formulated for application to soil.

36. The agricultural composition of claim 1, wherein the at least one surface modifier alters the mobility of the agricultural composition through soil as compared to a composition not comprising the surface modifier.

37. The agricultural composition of claim 36, wherein the mobility of the heterologous functional agent in soil is increased.

38. The agricultural composition of claim 36, wherein the mobility of the heterologous functional agent in soil is decreased.

39. The agricultural composition of claim 1, wherein the composition is formulated for delivery to a plant, a plant part, or a plant pest.

40. The agricultural composition of claim 39, wherein the plant part is a plant seed.

41. The agricultural composition of claim 39, wherein NLPs are detected in germinated seeds.

42. The agricultural composition of claim 1, wherein the heterologous functional agent is a volatile agent.

43. The method of any of claims 1-42, wherein the volatile heterologous functional agent is a pesticidal agent, a fertilizing agent, a herbicidal agent, a plant-modifying agent, an insect attractant, a plant growth promoting agent, a biostimulant, or a plant immunity elicitor.

44. The method of claim 42, wherein the volatile pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.

45. The method of claim 43, wherein the herbicidal agent is Dicamba.

46. The method of claim 44, wherein the insecticidal agent is tefluthrin.

47. The agricultural composition of any of claims 1-46, wherein the at least one surface modifier enhances the uptake of the agricultural composition by a plant or plant part as compared to a composition not comprising the surface modifier.

48. The agricultural composition of any of claims 1-46, wherein the at least one surface modifier enhances the biodistribution of the agricultural composition by a plant or plant part as compared to a composition not comprising the surface modifier.

49. The agricultural composition of any of claims 1-46, wherein the NLPs target the meristem region.

50. The agricultural composition of any of claims 1-46, wherein the encapsulated heterologous functional agent is protected from UV radiation.

51. An agricultural composition, the composition comprising a mixture of:
a) a first plurality of NLPs comprising:
at least one phospholipid;
at least one non-polar lipid; and
at least one surface modifier; and
a first heterologous functional agent; and
b) a second plurality of NLPs comprising:
at least one phospholipid;
at least one non-polar lipid; and
at least one surface modifier; and
a second heterologous functional agent;
wherein the first plurality of NLPs comprise a hydrophobic core.

52. The agricultural composition of claim 51, wherein the first and the second plurality of NLPs differ in stability.

53. An agricultural composition, the composition comprising a mixture of:
a) a plurality of NLPs comprising:
at least one phospholipid;
at least one non-polar lipid; and
at least one surface modifier; and
a first heterologous functional agent; and
b) an unencapsulated second heterologous functional agent,
wherein the plurality of NLPs comprise a hydrophobic core.

54. An agricultural composition comprising a plurality of NLPs each comprising a heterologous functional agent, wherein the NLPs are produced by the process of applying energy to a solution comprising:
at least one phospholipid;
at least one non-polar lipid;
at least one surface modifier;
a heterologous functional agent; and
an aqueous solution;
wherein the plurality of NLPs comprise a hydrophobic core.

55. A method of making an agricultural composition comprising a plurality of NLPs each comprising a heterologous functional agent, the method comprising the step of:
applying energy to a solution comprising:
at least one phospholipid;
at least one non-polar lipid;
at least one surface modifier;
a heterologous functional agent; and
an aqueous solution;
thereby forming the NLPs, wherein the NLPs comprise a hydrophobic core.

56. A method of altering the binding of a heterologous functional agent to at least one component in soil, the method comprising:
applying to soil an NLP composition comprising a heterologous functional agent encapsulated in the NLP, wherein the NLP comprises:
at least one phospholipid;
at least one non-polar lipid; and
at least one surface modifier;
wherein the binding of the encapsulated heterologous functional agent to soil is different than the binding of the unencapsulated heterologous functional agent to soil.

57. A method of altering the mobility of a heterologous functional agent in soil, the method comprising:
applying to soil an NLP composition comprising a heterologous functional agent encapsulated in the NLP, wherein the NLP comprises:
at least one phospholipid;
at least one non-polar lipid; and
at least one surface modifier;
wherein the mobility of the encapsulated heterologous functional agent in soil is different than the mobility of the unencapsulated heterologous functional agent in soil.

58. A method of reducing the viability of a root worm, the method comprising:
applying to soil infested with root worm an NLP composition comprising:
at least one phospholipid;
at least one non-polar lipid;
at least one surface modifier; and
a heterologous functional agent;
wherein the heterologous functional agent contacts the root worm, thereby reducing the viability of the root worm.

59. The method of claim 58, wherein the NLP composition is applied to soil as a soil drench.

60. The method of claim 58, wherein the NLP composition is applied to soil in furrow.

61. The method of claim 58, wherein the root worm is a member of the Diabrotica genus.

62. The method of claim 58, wherein the root worm is Diabrotica virgifera virgifera.

63. A method of reducing the viability of a fungus, the method comprising:
applying to soil comprising a fungus an NLP composition comprising:
at least one phospholipid;
at least one non-polar lipid;
at least one surface modifier; and
a heterologous functional agent;
wherein the heterologous functional agent contacts the fungus, thereby reducing the viability of the fungus in the soil.

64. The method of claim 63, wherein the fungus belongs to a family selected from the group consisting of Sciaridae, Diadocidiidae, Ditomyiidae, Keroplatidae, Bolitophilidae, and Mycetophilidae and Sclerotiniaceae.

65. The method of claim 64, wherein the fungus is Botrytis cinerea.

66. A method of preventing a plant from developing a disease caused by a plant pest, the method comprising:
applying to soil an NLP composition comprising:
at least one phospholipid;
at least one non-polar lipid;
at least one surface modifier; and
a heterologous functional agent;
wherein the NLPs comprise a hydrophobic core, and
wherein the heterologous functional agent contacts the plant pest, thereby killing the pest, thereby preventing the plant from developing a disease.

67. The method of claim 66, wherein the NLP composition is applied to soil as a soil drench.

68. The method of claim 66, wherein the NLP composition is applied to soil in furrow.

69. The method of claim 66, wherein the plant pest is a member of the Coleopteran or the Hemipteran order.

70. The method of claim 66, wherein the plant pest is a member of the Diabrotica genus.

71. The method of claim 70, wherein the plant pest is Diabrotica virgifera virgifera.

72. The method of claim 66, wherein the plant pest is a fungus.

73. The method of claim 68, wherein the fungus belongs to a family selected from the group consisting of Sciaridae, Diadocidiidae, Ditomyiidae, Keroplatidae, Bolitophilidae, and Mycetophilidae and Sclerotiniaceae.

74. The method of claim 72, wherein the fungus is Botrytis cinerea.

75. A method of increasing the uptake of a heterologous functional agent by a plant or plant part, the method comprising:
contacting a plant or plant part with a composition comprising a heterologous functional agent encapsulated in a NLP, wherein the NLP comprises:
at least one phospholipid;
at least one non-polar lipid; and
at least one surface modifier;
wherein the NLPs comprise a hydrophobic core, and
wherein the uptake of the encapsulated heterologous functional agent by the plant or plant part is higher than the uptake of the unencapsulated heterologous functional agent by the plant or plant part.

76. A method for delivering a heterologous functional agent to a plant or a plant part, the method comprising:
contacting a plant or plant part with an NLP composition comprising:
at least one phospholipid;
at least one non-polar lipid;
at least one surface modifier; and
a heterologous functional agent;
wherein the NLPs comprise a hydrophobic core, thereby delivering the heterologous functional agent to the plant.

77. A method of delivering a heterologous functional agent to the meristem, the method comprising:
contacting a plant or plant part with a composition comprising a heterologous functional agent encapsulated in a NLP, wherein the NLP comprises:
at least one phospholipid;
at least one non-polar lipid; and
at least one surface modifier.

78. The method of any of claim 75-77, wherein the plant part is a plant seed.

79. A method of distributing a heterologous functional agent in soil, the method comprising:
contacting a plant seed with an NLP composition comprising:
at least one phospholipid;
at least one non-polar lipid;
at least one surface modifier; and
a heterologous functional agent;
wherein the NLPs comprise a hydrophobic core,
and
incubating the plant seed in soil, thereby distributing the heterologous functional agent in the soil.

80. A method of distributing a heterologous functional agent in a plant, the method comprising:
contacting a plant seed with an NLP composition comprising:
at least one phospholipid;
at least one non-polar lipid;
at least one surface modifier; and
a heterologous functional agent;
wherein the NLPs comprise a hydrophobic core,
and
incubating the plant seed under conditions that cause germination, thereby distributing the heterologous functional agent in the plant.

81. The method of claim 80, wherein the contacting is by means of injecting the composition in the plant or plant part.

82. The method of claim 81, wherein the composition is injected or infiltrated into one or more leaves.

83. The method of claim 80, wherein the composition is injected into a tree.

84. The method of claim 81, wherein the composition is injected at several positions into a tree.

85. A method of treating a disease in a plant, the method comprising:
contacting a plant or plant part with an NLP composition comprising:
at least one phospholipid;
at least one non-polar lipid;
at least one surface modifier; and
a heterologous functional agent;
wherein the NLPs comprise a hydrophobic core, thereby treating the disease in a plant.

86. The method of claim 85, wherein the disease is caused by Candidatus Liberibacter asiaticus (CLas).

87. The method of claim 85, wherein the disease is citrus greening.

88. The method of claim 85, wherein the disease is caused by Xylella.

89. A method of preventing a plant from developing a disease, the method comprising:
contacting a plant or plant part with an NLP composition comprising:
at least one phospholipid;
at least one non-polar lipid;
at least one surface modifier; and
a heterologous functional agent;
wherein the NLPs comprise a hydrophobic core, thereby preventing a disease in a plant.

90. A method of reducing the volatility of a heterologous functional agent, the method comprising encapsulating the volatile heterologous functional agent in the composition of claim 1.

91. A method of sequestering a volatile heterologous functional agent, the method comprising encapsulating the heterologous functional agent in the composition of claim 1.

92. A method for the controlled release of a volatile heterologous functional agent into the environment, the method comprising encapsulating the heterologous functional agent in the composition of claim 1, wherein the release of the agent is inversely proportional to the stability of the NLP.

93. A method for the controlled release of at least one volatile heterologous functional agent into the environment, the method comprising encapsulating at least one volatile heterologous functional agent in the composition of claim 48, wherein the release of the agent is inversely proportional to the stability of the at least one plurality of NLPs.

94. The method of any of claims 90-93, wherein the volatile heterologous functional agent is a pesticidal agent, a fertilizing agent, a herbicidal agent, a plant-modifying agent, an insect attractant, a plant growth promoting agent, a biostimulant, or a plant immunity elicitor.

95. The method of claim 94, wherein the volatile pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.

96. The method of claim 94, wherein the herbicidal agent is Dicamba.

97. The method of claim 95, wherein the insecticidal agent is tefluthrin.

98. A kit comprising an agricultural composition, the composition comprising a plurality of nature-derived lipid particles (NLPs) each comprising:
at least one phospholipid;
at least one non-polar lipid;
at least one surface modifier; and
a heterologous functional agent;
wherein the NLPs comprise a hydrophobic core.
